(19) United States
(12) Patent Application Publication
(10) Pub. No.: US 2007/0123075 A1
(43) Pub. Date: May 31, 2007

(54) Remote receptacle control

(75) Inventors: Robert W. Insalaco, Holland, MI (US); James B. Long, Kentwood, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(73) Assignee: Herman Miller, Inc., Zeeland, MI (US)

(21) Appl. No.: 11/598,536

(22) Filed: Nov. 13, 2006

Related U.S. Application Data
(63) Continuation-in-part of application No. PCT/US05/30932, filed on Aug. 31, 2005.
(60) Provisional application No. 60/605,970, filed on Aug. 31, 2004.

(51) Int. Cl. H01R 25/00

(52) U.S. Cl. 439/120

(57) ABSTRACT

Remote duplex receptacle systems (1600, 1600¹) are used with power poles (1622), walls, floors or the like. One receptacle system (1600) includes a junction box (1602) with a conduit (1608) and patch cord (1614) extending therefrom. The system (1600) is programmable using a wand (892) to effect control relationships between the system (1600) and controlling devices (967).

### CROSS-REFERENCE TO RELATED APPLICATIONS

This application is a continuation-in-part of International PCT Patent Application Serial No. PCT/US05/30932, filed Aug. 31, 2005, which is based on and claims priority of U.S. Provisional Application Ser. No. 60/605,970, filed Aug. 31, 2004.

### STATEMENT REGARDING FEDERALLY SPONSORED RESEARCH OR DEVELOPMENT

Not applicable.

### REFERENCE TO A MICROFISHE APPENDIX

Not applicable.

### BACKGROUND OF THE INVENTION

1. Field of the Invention

The invention relates to power and control systems for commercial interiors (i.e., commercial, industrial and office environments), residential interiors and temporary structural environments (e.g., trade show pavilions) requiring power for energizing lighting, audio-visual, acoustical management, electrical devices, security and other applications and, more particularly, to receptacle devices remotely located from a network and programmable so as to be selectively controlled through the use of communications for establishing (and reconfiguring) control relationships among application devices.

2. Background Art

Interior infrastructure continues to evolve in today's commercial, residential and temporary structural environments. For purposes of description in this specification, the term “interior environments” shall be used to collectively designate these environments. Interior environments may include, but are clearly not limited to, office, industrial, retail facilities, medical and other health care operations, educational, religious and governmental institutions, factories, residential environments, temporary structures and others. Residential environments include, but are not limited to, household building interiors but are also applicable to living and working environments such as a boat. Temporary structures include, but are not limited to, environments such as trade show pavilions and exhibits.

Historically, interior environments consisted of large rooms with fixed walls and doors. Lighting, heating and cooling (if any) were often centrally controlled. Interiors would often be composed of large, heavy and “stand-alone” equipment and operations, such as in factories (e.g., machinery and assembly lines), offices (desks and files), retail (built-in counters and shelves) and the like. Interiors were frequently constructed with very dedicated purposes in mind. Given the use of stationary walls and heavy equipment, any reconfiguration of an interior was a time-consuming and costly undertaking.

In the latter part of the 20th century, interiors began to change. A major impetus for this change was the need to accommodate the increasing “automation” that was being introduced in commercial interiors and, with such automation, the need for electrical power to support the same. The automation took many forms, including: (i) increasingly sophisticated machine tools and powered equipment in factories; (ii) electronic cash registers and security equipment in retail establishments; (iii) electronic monitoring devices in health care institutions; and (iv) copy machines and electric typewriters requiring high voltage power supplies in office environments. In addition, during this period of increased automation, other infrastructure advancements occurred. For example, alternative lighting approaches (e.g., track lighting with dimmer control switches) and improved air ventilation technologies were introduced, thereby placing additional demands on power availability and access.

In recent decades, information technology has become commonplace. Computer and computer-related technologies have become ubiquitous. As an example, computer-numerically-controlled (CNC) production equipment has been applied extensively in factory environments. Point-of-sale electronic registers and scanners are commonplace in retail establishments. Sophisticated computer simulation and examination devices are used throughout medical institutions. Increased sophistication of computer electronics associated with the examination devices is particularly increasing rapidly, with regard to the greater use of “noninvasive” procedures. Modular “systems” furniture has evolved to support the computers and related hardware used throughout office environments. The proliferation of computers and information technology has resulted not only in additional demands for power access and availability, but also in a profusion of wires needed to power and connect these devices into communications networks. These factors have added considerably to the complexity of planning and managing interior environments.

The foregoing conditions can be characterized as comprising: dedicated interior structures with central control systems; increasing needs for power and ready access for power; and information networks and the need to manage all of the resulting wire and cable. The confluence of these conditions has resulted in interiors being inflexible, and difficult and costly to change. Today's world requires businesses and other institutions to respond quickly to “fast-changing” interior needs.

Interiors may be structurally designed by architects and engineers, and initially laid out in a desired format with respect to building walls, lighting fixtures, switches, data lines and other functional accessories and infrastructure. However, when these structures, which can be characterized as somewhat “permanent” in most buildings, are designed, the actual occupants may not move into the building for several months or even years. Designers almost need to “anticipate” the requirements of future occupants of the building being designed. Needless to say, in situations where the building will not be commissioned for a substantial period of time after the design phase, the infrastructure of the building may not be appropriately laid out for the actual occupants. That is, the prospective tenants' (or other occupants) needs may be substantially different from the designers' ideas and concepts. However, most interiors permit little reconfiguration after completion of the initial design. Reconfiguring a structure for the needs of a particular tenant can be extremely expensive and time consuming. During structural modifications, the interior is essentially “down” and provides no positive cash flow to the buildings' owners.

It would be advantageous to always have the occupants' activities and needs “drive” the structures and functions of the infrastructure layout. Today, however, relatively “stationary” (in function and structure) infrastructure essentially operates in reverse. That is, it is not uncommon for prospective tenants to evaluate a building's infrastructure and determine how to “fit” their needs (retail sales areas, point-of-sale centers, conference rooms, lighting, HVAC, and the like) into the existing infrastructure.

Further, and again in today's business climate, a prospective occupant may have had an opportunity to be involved in the design of a building's interior, so that the commercial interior is advantageously “set up” for the occupant. However, many organizations today experience relatively rapid changes in growth, both positively and negatively. When these changes occur, again it may be difficult to appropriately modify the interior so as to permit the occupant to expand beyond its original interior or, alternatively, be reduced in size such that unused space can then be occupied by another tenant.

Other problems also exist with respect to the layout and organization of today's interiors. For example, accessories such as switches and lights may be relatively “set” with regard to locations and particular controlling relationships among such switches and lights. That is, one or more particular switches may control one or more particular lights. To modify these control relationships in most interiors requires significant efforts. In this regard, an interior can be characterized as being “delivered” to original occupants in a particular “initial state.” This initial state is defined by not only the physical locations of functional accessories, but also the control relationships among switches, lights and the like. It would be advantageous to provide means for essentially “changing” the interior in a relatively rapid manner, without requiring physical rewiring or similar activities. In addition, it would also be advantageous to have the capability of modifying physical locations of various application devices, without requiring additional electrical wiring, substantial assembly or disassembly of component parts, or the like. Also, and of primary importance, it would be advantageous to provide a commercial interior which permits not only physical relocation or reconfiguration of functional application devices, but also permits and facilitates reconfiguring control among devices. Still further, it would be advantageous if users of a particular commercial interior could effect control relationships among devices and other utilitarian elements at the location of the commercial interior itself.

Numerous types of commercial interiors would benefit from the capability of relatively rapid reconfiguration of physical location of mechanical and electrical elements, as well as the capability of reconfiguring the “logical” relationship to switches or other controlling devices among controlling/controlled devices associated with the system. As one example, it would be advantageous for a retail establishment to reconfigure shelving, cabinetry and other system elements, based on seasonal requirements. Further, a retail establishment may require different locations and different numbers of point-of-sale systems, based on seasons, currently existing advertised sales and other factors. Also a retail establishment may wish to physically and logically reconfigure other mechanical and electrical structure and applications, for purposes of controlling traffic flow through lighting configurations, varying acoustical parameters through sound management and undertaking similar activities. Current systems do not provide for any relatively easy “reconfiguration,” either with respect to electrical or “logical” relationships (e.g. the control of a particular bank of lights by a particular set of switches), or mechanical structure.

A significant amount of work is currently being performed in technologies associated with control of what can be characterized as “environmental” systems. The systems may be utilized in commercial and industrial buildings, residential facilities, and other environments. Control functions may vary from relatively conventional thermostat/temperature control to extremely sophisticated systems. Development is also being undertaken in the field of network technologies for controlling environmental systems. References are often currently made to “smart” buildings or rooms having automated functionality. This technology provides for networks controlling a number of separate and independent functions, including temperature, lighting and the like.

In this regard, it would be advantageous for certain functions associated with environmental control to be readily usable by the occupants, without requiring technical expertise or any substantial training. Also, as previously described, it would be advantageous for the capability of initial configuration or reconfiguration of environmental control to occur within the proximity of the controlled and controlling apparatus, rather than at a centralized or other remote location.

When developing systems for use in commercial interiors for providing electrical power and the like, other considerations are also relevant. For example, strict guidelines exist in the form of governmental and institutional regulations and standards associated with electrical power, mechanical support of overhead structures and the like. These regulations and standards come from various codes and organizations. Among these organizations and standards are the following: NEC (National Electric Code); ANSI (American National Standards Institute); UL (Underwriters Laboratories) and others. This often results in difficulty with respect to providing power and communications distribution throughout interior locations. For example, structural elements carrying power or other electrical signals are strictly regulated as to mechanical load-bearing parameters. It may therefore be difficult to establish a “mechanically efficient” system for carrying electrical power, and yet still meet appropriate codes and regulations. Other regulations exist with respect to separation and electrical isolation of cables carrying power and other electrical signals from different sources. Regulations and standards directed to these and similar issues have made it substantially difficult to develop efficient power and communications distribution systems.

Other difficulties also exist. As a further example, if applications are to be “hung” from an overhead structure, and extend below a threshold distance above floor level, such applications must be supported in a “breakaway” structure. That is, if substantial forces are exerted on the applications, they must be capable of breaking away from the supporting structure, without causing the supporting structure to fall or otherwise be severely damaged. This is particularly important where the supporting structure is correspondingly carrying electrical power. With respect to other issues associated with providing a distributed power structure, the carrying of high voltage lines are subject to a number of relatively restrictive codes and regulations. For example, electrical codes usually include stringent requirements regarding isolation and shielding of high voltage lines.

Still further, to provide for a distributed power and communication system for reconfigurable applications, physically realizable limitations exist with respect to system size. For example, and particularly with respect to DC communication signals, limitations exist on the transmission length of such signals, regarding attenuation, S/N ratio, etc. Such limitations may correspondingly limit the physical size of the structure carrying power and communications signals.

Other difficulties may also arise with respect to overhead systems for distributing power. For example, in certain instances, it may be desirable to have the capability of lifting or lowering the height of the entirety of the overhead structure above floor level. Also, when considering an overhead structure, it is advantageous for certain elements to have the capability of extending downwardly from a building structure through the overhead supporting structure. For example, such a configuration may be required for fire sprinkling systems and the like.

Other issues and concerns must also be taken into account. For example, when considering a power distribution structure, it is particularly advantageous to provide not only for distribution of AC power, but also generation of DC power (for operating processor configurations and other components of the communications system and network, and for potentially providing DC power for various application devices interconnected to the network) and distribution of digital communications signals. However, extremely strict building codes exist with respect to any type of overhead structures carrying AC electrical power, particularly high voltage power. Further, although it would be advantageous to carry AC power, DC power and digital communication signals in relatively close proximity within an overhead structure, again building codes and electrical codes forbid many types of configurations where there is significant potential of AC power carrying elements coming into contact with components carrying DC signals, either in the form of power or communication signals. In accordance with the foregoing, it would be advantageous to provide for power distribution, and distribution of communication signals throughout a mechanical “grid.” For such a grid to be practical, it would be necessary for the mechanical grid to accommodate distribution of communication signals and power of appropriate strength (both in terms of amplitude and density) while still meeting requisite building, electrical and other governmental codes and regulations. Still further, however, although such a mechanical grid may be capable of physical realization in particular structures, the grid should advantageously be relatively light weight, inexpensive and capable of permitting reconfiguration of associated application devices. Also, it would be advantageous for such a mechanical grid to be capable of reconfiguration (in addition to reconfiguration of control/controlling relationships of application devices), without requiring assembly, disassembly or any significant modifications to the building infrastructure. Still further, it would be advantageous for such a mechanical grid, along with the power and communications distribution network, to be in the form of an “open” system, thereby permitting additional growth.

Although an overhead grid is one form of creating a power and communications network, it is by no means the only approach to providing such functionality. Being an “open” system, such functionality would ideally be available and accessible for use in wall and floor applications as well. Ideally, any electrical receptacle connected to the network could be powered with its “logical” relationship to switches or other controlling devices re-associated at will, regardless of being in the ceiling, wall or floor.

As with commercial interiors, many of the same issues are common to residential interiors. That is, residential interiors also face issues regarding dedicated interior structures, increasing needs for power and ready access for power, and a proliferation of electronic devices and control means. In residential construction, the functions of many of the spaces or rooms, like family rooms, living rooms, etc. need to be pre-determined prior to beginning construction. However, the needs of the occupants and how to use the spaces can and do change. For example, a homeowner may wish to convert a spare bedroom into a home office. The placement of switches, the accessibility of receptacles etc. may be inadequate or inappropriately located to provide optimum location of home office furnishings and equipment.

Similar to commercial interiors, residential interiors have experienced an explosion of new information technologies and associated support equipment. Computer and computer related technologies have become ubiquitous, with many households having multiple desktop or laptop computers, monitors, printers and the like. In addition, other electronic devices have increasingly become more prevalent, including home copying machines, high definition television screens, digital audio equipment, cell phones and charging units, etc. Each of these devices requires its own power source, type of power (i.e., AC or DC) and “on or off” power switches. In most residential applications, the AC duplex receptacles are located in the walls, and are wired to be always “powered.” To later change the receptacle to be controlled by a switch (i.e., on, off, dimmed) involves reconstruction and rewiring, frequently by skilled tradespersons, creating a disruption in the space while undertaking the remodeling, as well as creating additional expense.

Alternatively, overhead lighting typically is controlled by a pre-determined “light switch” located at a fixed location in a wall and enabled to only turn off and on the specific lighting fixture(s) to which it was initially electrically wired. Any addition or elimination of fixtures controlled by the switch usually involve rewiring by a skilled electrician and may require reconstruction by other skilled trades. Moreover, the fixed location of the “light switch” provides no flexibility in changing its location as needs or occupant preferences change.

Similar to commercial and residential interiors, temporary structures, such as trade show pavilions, contend with many of the same issues. That is, temporary structures also face issues associated with dedicated design and structure, needs for power and ready access to power, and the proliferation of electronic devices and control means. Frequently, such temporary structures are intended for use in varying settings (e.g., exhibition centers, convention halls, etc.), at varying locales and/or use with multiple or differing audiences. Often, “on site” modifications such as additional lights, changing the location of receptacles and switches, etc. are difficult to implement “as needed” and frequently require extensive re-planning of the structure's design to implement the desired changes. In addition, the evolution of electronic technologies, particularly those associated with communications such as flat screen monitors, etc. are becoming more and more prevalent. Managing and controlling the various switches (e.g., on/off light switch, etc.) which control the powering and operation of the multiple devices (e.g., dimming lights, turning on audio, turning on flat screen video, etc.) can be a complex and cumbersome process, with switches not conveniently located and each switch devoted to only its particular device. This is compounded by the many differing types and brands of devices (e.g., lighting fixtures, motion sensors, etc.) in the marketplace today.

“Interior environments,” be they commercial, residential or temporary, need to adapt more quickly to meet the needs of the users. Many common problems exist in all these settings, limiting the responsiveness of the environment to address these changing needs and increasing the cost and downtime associated with making these environments more responsive.

Many of the foregoing problems and other issues associated with interiors have been addressed and overcome through substantial advancements in the technical arts with the development of a distributed power and communications network, using certain designation protocols, as disclosed in the commonly assigned International PCT Application Serial No. PCT/US05/30932, titled DESIGNATION BASED PROTOCOL SYSTEMS FOR RECONFIGURING CONTROL RELATIONSHIPS AMONG DEVICES and filed Aug. 31, 2005, of which this patent application is a continuation-in-part thereof. This PCT Patent Application will be referred to herein as the “Designation Protocol Application.” Other commonly assigned applications having disclosures relating to the subject matter of the current application include the following: U.S. patent application Ser. No. 10/500,734, titled SWITCHING/LIGHTING CORRELATION SYSTEM and filed Nov. 12, 2004; U.S. patent application Ser. No. 10/526,506, titled GENERAL OPERATION SYSTEM and filed Mar. 4, 2005; and International PCT Application Serial No. PCT/US05/28022, titled POWER AND COMMUNICATION DISTRIBUTION SYSTEM USING A STRUCTURAL CHANNEL SYSTEM and filed Aug. 5, 2005.

The Designation Protocol Application describes a system whereby an interior environment can be quickly and easily reconfigured, as well as being “reprogrammed and transformed.” The system includes a low voltage communication network and protocol, enabling any electrical device connected to the network to be controlled as the user desires. It comprises a distributed network, using modular plug assemblies which distribute not only communication signals, but also deliver 120-volt power, which can be distributed through an overhead rail grid, as well as beneath raised floors, or modular or traditional wall construction.

The modular plug assembly provides multiple power access points within its base. The system also includes devices identified as connector modules, which can be mechanically and electrically attached to the modular plug assemblies through the power access points. These connector modules can be characterized as “smart” connectors, and provide power to attached devices, such as lights, fans, occupancy sensors and the like. Switches and power devices can be added, removed or rearranged within the network by a user, without requiring reconstruction or use of any specialized skilled trade. Through the use of the communications portion of the network, and certain designation protocols, application devices connected to a connector module on the network can be “logically” associated with any switch as desired by the user, utilizing a 2-button device identified as a wand. The wand enables the user to reconfigure the association between various electrical devices and the switches that control the devices, meaning that such electrical devices and switches can be “reprogrammed” at will.

The Designation Protocol System and the associated structure can work with various traditional building construction materials and approaches, such as modular walls, underfloor, raised floor, etc. In addition, applications specific to the Designation Protocol System can also be employed. These applications include lightweight flexible wall structures, LED overhead lighting elements, ceiling panels and other applications. These applications facilitate reconfiguration of the physical space within which the system is located, in addition to reconfiguration of the electrical and communications network itself.

To illustrate some of the advantages of the system disclosed in the Designated Protocol Application, and to also illustrate some of the issues to which the specific invention disclosed herein is related, reference can be made to known systems which implore what can be characterized as “hard wired” switches. In the construction of most interior environments, hard wired switches are utilized to control the switch state, in that the switch is typically in either a “power on” or “power off” state. Also, in many interior environments, such switches are often mounted at a pre-determined height (often, 42″) and fixed position immediately adjacent to a door entering into the interior environment. Power for the switch is often provided through flexible (or conduit) electrical cabling brought from a circuit breaker, with the electrical cabling then proceeding to the particular electrical junction boxes to which lighting fixtures will be attached, or to duplex receptacles, etc., for which the building owner wishes to have “on” or “off” power control.

With these conventional interior environments, predetermination of the placement of the switches is required during the construction phase of a building, well prior to occupancy by a tenant or owner. If the intended use of the interior environment changes, or the tenant's/owner's needs change following occupancy, expensive reconstruction and electrical rewiring is incurred. For example, a commercial office space interior, originally intended for occupancy by one group, is now to be occupied by two separate departments. To provide such group with independent control of its overhead lighting (e.g., one group works later than the other) would require expensive reconstruction to perforate the wallboard, so as to mount a new switch assembly and an addition of a new electrical power line to the switch, so as to control the desired overhead electrical fixtures. Moreover, the destruction from changing the existing interior switch configuration could be quite considerable to the activities of the occupants. If the rewiring should be extensive, it could actually result in periods when the space could not be occupied (i.e., unrentable, etc.).

In addition, legislation has been passed in various countries, providing for reasonable accommodation for disabled individuals (e.g., in the United States, the Americans with Disabilities Act). In certain circumstances, the placement of conventional switches may be in locations difficult to access by disabled individuals (e.g., reach height, counter between aisle and switch, etc.).

For purposes of description, and for a better understanding of the significant advantages provided by systems disclosed in the designation protocol application and in accordance with this invention, a switch can be characterized as a “sensor,” in that the device senses some type of change in the environment. For example, a power switch can be characterized as a sensor which senses the action of the user and enabling the switch to be in a “power on” state or a “power off” state. It has been found that with respect to the distributed network systems disclosed in the Designation Protocol Application, (or switches) may be advantageously provided in a “wireless” mode. For example, for an interior environment using a distributed network such as those disclosed in the Designation Protocol Application, the wireless switch precludes a necessity of predetermining, prior to construction of a space, where and how many switches are needed. That is, such a determination can be made at the time of occupancy, so as to match the occupant's requirements. Still further, rather than incurring the additional expense and potential space down time to add a new switch (or switches), systems utilizing sensors as described in the Designation Protocol Application can be associated with connector modules. With the switches having a wireless configuration, the connector modules to which the switches may be associated can be characterized as “coordinators.” That is, such coordinators may receive wireless signals from a number of different sensors or switches, and operate so as to control the distribution of power and communication signals on to the distributed network, in a manner so as to appropriately control the application devices to which the switches are associated. In this regard, wireless switches can be placed at locations considered most convenient to the users of the space. Also, the switches can be removably positioned on a wall, table or the like through various means (e.g., “Velcro™”). Accordingly, rather than being in a fixed location, the user or occupant can take a switch with them, and secure (if needed) the switch where desired, thus providing mobility that does not exist with conventional systems.

Still further, there may be times when it is desired that a sensor or actuator trigger a response by several devices as a “group.” For example, it may be desirable for a motion detector to trigger multiple light banks to be enabled within a given area, rather than just one light bank to which it was initially directly connected. In many current, conventional interior environment settings, incorporating such functionality to enable multiple light banks would require direct wiring by skilled trades to each of the desired light banks in the group, thereby again requiring additional time and cost.

It has been found that it may be advantageous to provide various types of wiring configurations when wiring connector modules to application devices. More specifically, it has been found that it may be advantageous for sensors and actuators requiring low voltage power to be utilized with a connector module which is expressly designed for providing low voltage power, but also provides for direct wiring between the smart connector and the low voltage sensor or actuator device. Such a device may be a motion sensor or internet camera as the case may be. The connector module may be, for example, a 24VDC connector module. Further in this regard, it has been found that it may be advantageous to incorporate a wiring closet for facilitating field wiring of the sensor or actuator devices to the connector module. The wiring closet may include a door which can be selectably opened, and wires from the application device can be fed into the wiring closet and secured thereto with components such as locknuts or the like. Wiring from the device can be attached to the connector module through components such as a terminal block. With this configuration, the connector module can then be “plugged into” a modular plug assembly, which provides for communication with all other active devices on the network.

With this type of configuration between the connector module and a low voltage application device, no separate transformers, plugs or other similar components are needed to convert AC power to DC power. The terminal block provides appropriate electrical connections so as to provide the DC power to the actuator or sensor device, as well as providing lines for communication signals. The previously described wiring closet provides ready access so as to attach the device to the connector module.

With this type of configuration, and in accordance with disclosure in the Designation Protocol Application and other commonly assigned applications, the user may use a wand so as to associate other application devices within a group with the low voltage connector module. Such devices may include, for example, a subset of lights in an interior environment, with the lights triggered so as to “turn on” when a motion detector detects movement. Accordingly, the connector module and the network provide for an association between the motion detector and the light group. With this type of capability, the association between the sensor and the light group can be performed at will by the user, with no additional cost. That is, a skilled trades person is unnecessary for purposes of rewiring the group of devices.

Still further, it has been found that it is an advantage for the application devices to be moved at will, when attached to a low voltage or similar connector module by the user. For example, if the interior space needs change and the motion detector is better located elsewhere in the space, the motion detector and associated connector module can simply be unplugged from the existing modular plug assembly and plugged into a modular plug assembly at the desired location. These advantages therefore clearly provide for much faster change and a much lower cost than would exist if it would be required to install a new hard wired power receptacle at the desired location. In addition, from an environmental and sustainability concept, these connector modules capable of field wiring can be reused in new systems, without requiring any substantive modifications.

A number of systems have been developed which are directed particularly to power systems for use with particular mechanical structures within interior environments.

A number of systems have been developed which are directed particularly to power systems for use with particular mechanical structures within interior environments.

For example, Csenky, U.S. Pat. No. 4,074,092 issued Feb. 14, 1978, discloses a power track system for carrying light fixtures and a light source. The system includes a U-shaped supporting rail, with the limbs of the same being inwardly bent. An insulating lining fits into the rail, and includes at least one current conductor. A grounding member is connected to the ends of the rail limbs, and a second current conductor is mounted on an externally inaccessible portion of the lining that faces inwardly of the rail.

Botty, U.S. Pat. No. 4,533,190 issued Aug. 6, 1985, describes an electrical power track system having an elongated track with a series of longitudinal slots opening outwardly. The slots provide access to a series of offset electrical conductors or bus bars. The slots are shaped in a manner so as to prevent straight-in access to the conductors carried by the track.

There are a number of issued patents directed to various aspects of control of environmental systems. For example, Callahan, U.S. Pat. No. 6,211,627 B1 issued Apr. 3, 2001 discloses lighting systems specifically directed to entertainment and architectural applications. The Callahan lighting systems include apparatus which provide for distribution of electrical power to a series of branch circuits, with the apparatus being reconfigurable so as to place the circuits in a dimmed or “not-dimmed” state, as well as a single or multi-phase state. Callahan further discloses the concept of encoding data in a formed detectable in electrical load wiring and at the load. The data may include dimmer identification, assigned control channels, descriptive load information and remote control functionality. For certain functions, Callahan also discloses the use of a handheld decoder.

D'Aleo et al., U.S. Pat. No. 5,191,265 issued Mar. 2, 1993 disclose a wall-mounted lighting control system. The system may include a master control module, slave modules and remote control units. The system is programmable and modular so that a number of different lighting zones may be accommodated. D'Aleo et al. also disclose system capability of communicating with a remote “power booster” for purposes of controlling heavy loads.

Dushane et al., U.S. Pat. No. 6,196,467 B1 issued Mar. 6, 2001 disclose a wireless programmable thermostat mobile unit for controlling heating and cooling devices for separate occupation zones. Wireless transmission of program instructions is disclosed as occurring by sonic or IR communication.

Other patent references disclose various other concepts and apparatus associated with control systems in general, including use of handheld or other remote control devices. For example, Zook et al., U.S. Pat. No. 4,850,009 issued Jul. 18, 1989 disclose the use of a portable handheld terminal having optical barcode reader apparatus utilizing binary imaging sensing and an RF transceiver. Sheffer et al., U.S. Pat. No. 5,131,019 issued Jul. 14, 1992 disclose a system for interfacing an alarm reporting device with a cellular radio transceiver. Circuitry is provided for matching the format of the radio transceiver to that of the alarm reporting unit. Dolin, Jr. et al., U.S. Pat. No. 6,182,130 B1 issued Jan. 30, 2001 disclose specific apparatus and methods for communicating information in a network system. Network variables are employed for accomplishing the communication, and allow for standardized communication of data between programmable nodes. Connections are defined between nodes for facilitating communication, and for determining addressing information to allow for addressing of messages, including updates to values of network variables. Dolin, Jr. et al., U.S. Pat. No. 6,353,861 B1 issued Mar. 5, 2002 disclose apparatus and methods for a programming interface providing for events scheduling, variable declarations allowing for configuration of declaration parameters and handling of I/O objects.

### SUMMARY OF THE INVENTION

In accordance with the invention, a distributed network is used within an interior environment for selectively energizing one or more controlled application devices. The network includes power distribution means connected to a source of electrical power, for distributing the power through the network. Communication distribution means are provided for distributing communication signals through the network. A first sensor is also provided, having at least first and second space and comprising means for generating spatial state signals indicative of the first sensor being in the first state or the second state. Designation means are also provided, for a user to designate the first sensor and a first set of controlled application devices. The first set includes one or more of the controlled application devices. Means are provided for implementing a control relationship between the first sensor and the first set of application devices, and response to designation by the user. Signal receiving means are responsive to the spatial signals being generated by the first sensor, while receiving the spatial signals. Means are also provided which are responsive to receipt of the spatial signals by the signal receiving means, for generating a first set of communication signals on the network. The means to respond ______ receipt of the spatial signals also selectively control application of electrical signals to the first set of controlled application devices, based upon the spatial state signals.

The signal receiving means includes a first wireless coordinator electrically connectable to the source of electrical power through the power distribution means. The signal receiving means is selectively relocatable at desired positions on the network. The spatial state signals comprise sensor identification signals, identifying the first sensor. The wireless coordinator comprises channel means for receiving the sensor identification signals from the first sensor, and for selectively responding to the spatial state signals from the first sensor, based on the sensor identification signals.

The distributive network includes a series of sensors, each of the sensors having at least first and second states, and further having signal generating means for generating further spatial state signals and further sensor identification signals. The wireless coordinator includes channel selection means for selecting a channel through which said wireless coordinator receives the spatial state signals and the sensor identification signals from one or more of the series of sensors. The channel selection means can include a series of manually operable dipswitches.

The wireless coordinator can include means for generating signals indicative of sensor proxies, so as to generate communication signals enabling the distributed network to communicate with a series of wireless connectors. The first sensor can include means for selectively generating spatial state signals indicative of a user wishing to apply an on, off, increase or decrease command to the first set of controlled application devices. The first sensor can also include channel selection means selectably operable by a user, so as to select a communication channel for association between the first sensor and the signal receiving means. The first sensor can include visual means for indicating whether the first sensor is communicatably coupled to the distributed network, so that the signal receiving means will recognize spatial state signals generated by the first sensor.

### BRIEF DESCRIPTION OF THE SEVERAL VIEWS OF THE DRAWING

The invention will now be described with reference to the drawings, in which:

FIG. 1 is a perspective view, showing an exemplary embodiment of a structural channel system which may be used with wireless sensors and coordinators which form the basis of the invention, with FIG. 1 illustrating support of the system from a building structure;

FIG. 2 is a cross-sectional view of the structural channel system shown in FIG. 1, taken along section lines 2-2 of FIG. 1 and expressly illustrating the connection of the system to a threaded support rod;

FIG. 3 is an orthogonal, exploded view in two dimensions of certain of the elements of the structural channel system shown in FIG. 1;

FIG. 4 is a plan view of one section of a main perforated structural channel rail in accordance with the invention;

FIG. 5 is a side elevation view of the main perforated structural channel rail illustrated in FIG. 4;

FIG. 6 is an underside view of the main structural channel rail illustrated in FIGS. 4 and 5;

FIG. 7 is an enlarged, plan view of a portion of one end of the main structural channel rail illustrated in FIG. 5;

FIG. 8 is an enlarged, side elevation view of a portion of one end of the main structural channel rail illustrated in FIG. 5;

FIG. 9 is a perspective view of the main structural channel rail illustrated in FIG. 4;

FIG. 10 is an enlarged, perspective view of one end of the main structural channel rail illustrated in FIG. 9;

FIG. 11 is an enlarged, sectional end view of the main structural channel rail illustrated in FIG. 9, taken along section lines 11-11 of FIG. 9;

FIG. 12 is a perspective and stand-alone view of a suspension bracket in accordance with the invention, in a fully assembled state;

FIG. 13 is a perspective and partially exploded view of the suspension bracket illustrated in FIG. 12;

FIG. 14 is a plan view of a section half of the suspension bracket illustrated in FIG. 12;

FIG. 15 is a plan view of the entirety of the suspension bracket illustrated in FIG. 12;

FIG. 16 is a perspective view of a portion of a main structural channel rail, with the suspension bracket attached thereto and further attached to a support rod;

FIG. 17 is a perspective view of one end of a main structural channel rail showing various uses of a universal suspension plate assembly at upper and lower portions of the main structural channel rail, and at an end of the main structural channel rail;

FIG. 18 is a perspective view of one end of a main structural channel rail, showing the use of a suspension bracket for purposes of perpendicularly securing a pair of opposing perforated structural cross-channels;

FIG. 19 is a side elevation view of an example embodiment of one of the perforated structural cross-channels illustrated in FIG. 18;

FIG. 20 is a plan view of the perforated structural cross channel illustrated in FIG. 18;

FIG. 21 is a perspective and stand-alone view of a modular plug assembly (showing one length thereof) which is adapted to be interconnected to main structural channel rails;

FIG. 22 is an enlarged view of one end of the modular plug assembly illustrated in FIG. 21;

FIG. 23 is a side elevation view of one side of the modular plug assembly illustrated in FIG. 21;

FIG. 24 is a plan view of the modular plug assembly illustrated in FIG. 21;

FIG. 25 is a side elevation view, showing the side opposing the side shown in FIG. 23, of the modular plug assembly illustrated in FIG. 21;

FIG. 26 is a side elevation and enlarged view of one end of the modular plug assembly shown in FIG. 21, with FIG. 26 illustrating the same side as shown in FIG. 25;

FIG. 27 is an end view of the modular plug assembly shown in FIG. 40, taken along lines 27-21 of FIG. 26;

FIG. 28 is a sectional, end view of the modular plug assembly shown in FIG. 40, taken along section lines 28-28 of FIG. 26;

FIG. 28A is a perspective and exploded view of one of the modular plugs of the modular plug assembly shown in FIG. 21;

FIG. 28B is a perspective and exploded view of one of the distribution plugs of the modular plug assembly shown in FIG. 21, with one of the distribution plugs being associated with each section of the modular plug assembly;

FIG. 29 is a perspective and partially exploded view of a portion of a main structural channel rail, a portion of a modular plug assembly, and a connector module, showing the relative locations of the various components when the modular plug assembly is secured to the main structural channel rail;

FIG. 30 is a perspective view of the main structural channel rail, modular plug assembly and connector module shown in FIG. 29, shown in a fully assembled state;

FIG. 31 is a perspective view of one embodiment of a power entry box coupled to a main structural channel rail through one embodiment of a power box connector;

FIG. 32 is a perspective view of the power entry box shown in FIG. 31, in substantially enlarged and stand-alone state, and further showing power being received from above the box;

FIG. 33 is a perspective and partially exploded view showing an end of the power entry box illustrated in FIG. 32, and further showing details relating to a power entry box clamp for securing the box to one of the threaded support rods;

FIG. 34 is a rear elevation view of the power entry box shown in FIG. 32, illustrating available wire knockouts;

FIG. 35 is a perspective view of one embodiment of a power box connector which may be utilized in accordance with the invention;

FIG. 36 is a perspective and stand-alone view of a flexible connector assembly which may be utilized in accordance with the invention, for purposes of electrically interconnecting together a pair of sections of the modular plug assembly;

FIG. 36A is an exploded view of the flexible connector assembly shown in FIG. 36;

FIG. 36B is a side elevation view of the flexible connector assembly shown in FIG. 36;

FIG. 36C illustrates the positioning of the flexible connector assembly as it is being used to connect adjacent sections of the modular plug assembly, and further showing the concept that such connection of the flexible connector assembly is unidirectional;

FIG. 37 is a perspective and stand-alone view of a receptacle connector module in accordance with the invention;

FIG. 37A illustrates a side elevation and stand-alone view of the receptacle connector module shown in FIG. 37;

FIG. 37B is an end view of the receptacle connector module shown in FIG. 37;

FIG. 37C is a further end view of the receptacle connector module shown in FIG. 37, and expressly showing the end opposing the end shown in FIG. 37B;

FIG. 37D is a plan view of the receptacle connector module shown in FIG. 37;

FIG. 38 is an exploded view of a portion of the receptacle connector module identified within circle 38 of FIG. 37A, and expressly showing a ferrule coupler;

FIG. 39 is a sectional end view of the receptacle connector module shown in FIG. 37, and illustrating details of the ferrule coupler, as taken along section lines 39-39 of FIG. 38;

FIG. 40 is a side elevation view of the receptacle connector module shown in FIG. 37, and expressly showing an initial positioning of the receptacle connector module as it is being mechanically and electrically coupled to a section of the module plug assembly;

FIG. 41 is a view similar to FIG. 40, but showing the receptacle connector module in its uppermost position as it is being coupled to the length of the modular plug assembly;

FIG. 42 is a view similar to FIGS. 40 and 41, and showing a user exerting forces on the end of the receptacle connector module, so as to mechanically and electrically secure the receptacle connector module in its final position as coupled to the modular plug assembly;

FIG. 43 is an enlarged view of a portion of the receptacle connector module as shown in FIG. 42, as expressly identified by circle 43 in FIG. 42, and showing details relating to use and operation of a connector latch assembly utilized for purposes of more rigidly coupling the receptacle connector module to the modular plug assembly;

FIG. 44 is a perspective view of the receptacle connector module illustrated in FIG. 37, and showing the connector module coupled to a modular plug assembly and main structural channel rail, and energizing an application device comprising a fan;

FIG. 44A is a partially schematic and partially diagrammatic block diagram of various circuit elements of the receptacle connector module shown in FIG. 37;

FIG. 45 is a perspective and exploded view of a dimmer connector module in accordance with the invention, and illustrating the internal configuration of the same;

FIG. 45A is a perspective view of the dimmer connector module shown in FIG. 45, and illustrating the pivotable coupling of a dimmer light track to the dimmer connector module;

FIG. 46 is a perspective view showing a partial length of a main structural channel rail, dimmer connector module and dimmer light track in a fully assembled state;

FIG. 46A is a partially schematic and partially diagrammatic block diagram showing, in simplified format, the internal circuitry associated with the dimmer connector module;

FIG. 47 is perspective and stand-alone view of a power drop connector module in accordance with the invention;

FIG. 48 is a perspective and exploded view of the power drop connector module shown in FIG. 47;

FIG. 48A is a partially schematic and partially diagrammatic block diagram showing, in simplified format, the internal circuitry associated with the power drop connector module;

FIG. 49 is a perspective view of the power drop connector module shown in FIG. 47, and further showing the power drop connector module connected to a section of the modular plug assembly within a main structural channel rail, and with the power drop connector module energizing an electrically interconnected exemplary embodiment of a power pole;

FIG. 50 is a perspective view of a power pole which may be utilized in accordance with the invention;

FIG. 51 is a sectional, plan view of a portion of the power pole shown in FIG. 50, taken along section lines 51-51 of FIG. 60;

FIG. 52 is another sectional, plan view of a part of the power pole shown in FIG. 50, taken along section lines 52-52 of FIG. 50;

FIG. 53 is a side, elevation view of an alternative embodiment of a receptacle connector module which may be utilized in accordance with the invention, and where the connector module provides for a lateral electrical interconnection to a modular plug of the module plug assembly, with the electrical connection occurring through selectively movable contacts;

FIG. 54 is a partial, side elevation view of an alternative embodiment of a modular plug compatible with use with the receptacle connector module shown in FIG. 53, and where the modular plug includes a configuration permitting lateral access to a series of buses or other components carrying electrical power and communications;

FIG. 55 is a sectional, end view showing the configuration for electrical interconnection of the movable contacts on the connector module shown in FIG. 53, with the buses or similar components of the module plug shown in FIG. 54;

FIG. 56 is a plan and diagrammatic view of a power and communications signal distribution system, illustrating how AC power and communication signals may be distributed among lengths of the main structural channel rails and modular plug assembly of the structural channel system;

FIG. 57 is a plan and diagrammatic view of an embodiment of the structural channel system, absent illustrations of incoming building power, but showing coupling of a power and communication signals among lengths of the main structural channel rails, modular plug assembly and application devices located at various positions within the layout of the structural channel system, and with the application devices and connector modules essentially forming individual subnetworks of their own as a distributed intelligence system;

FIG. 58 is a perspective view of a receptacle connector module illustrating its position within a main structural channel rail and interconnected to a modular plug assembly, and its interconnection to a wall switch;

FIG. 58A is a front elevation view of a pressure switch which may be utilized in accordance with the invention;

FIG. 58B is a front elevation view of a pull chain switch which may be utilized in accordance with the invention;

FIG. 58C is a front elevation view of a motion sensing switch which may be utilized in accordance with the invention;

FIG. 58D is a front elevation view of a dimmer switch assembly which may be utilized in accordance with the invention;

FIG. 58E is a perspective and exploded view of the dimmer switch assembly shown in FIG. 58D;

FIG. 58F is a perspective view of the dimmer switch assembly shown in FIG. 58D, in a fully assembled state;

FIG. 59 is a perspective view of a control wand which may be utilized with the structural channel system in accordance with the invention;

FIG. 60 is a plan view of the wand shown in FIG. 59;

FIG. 61 is a front, elevation view of the wand shown in FIG. 59;

FIG. 62 is a perspective view of one configuration of a structural channel system in accordance with the invention, and illustrating a user pointing the wand to an IR receiver on a receptacle connector module, to which a light fixture is electrically engaged;

FIG. 63 illustrates the user shown in FIG. 62, pointing the wand to the switch to be associated with the light, for purposes of programming the control relationship between the switch and the light;

FIG. 64 illustrates the use of a junction box assembly with the structural channel system;

FIG. 65 is a partially schematic and partially diagrammatic block diagram, in simplified format, showing internal circuitry of the junction box assembly, and further showing interconnection through a knock-out with high voltage cables carried in the wireway;

FIG. 66 is a perspective and exploded view of the junction box assembly shown in FIG. 65;

FIG. 67 is a perspective view of the junction box assembly shown in FIG. 65, in a fully assembled state;

FIG. 68 is a perspective and exploded view of alternative and possibly preferred embodiments for the power entry box and power box connector;

FIG. 69 is a perspective view of the alternative embodiments shown in FIG. 68, showing the power entry box and power box connector in a fully assembled state;

FIG. 70 is a perspective and exploded view of the alternative embodiment of the power box connector shown in FIG. 82;

FIG. 71 is a partially perspective and partially diagrammatic view illustrating the use of the power entry boxes in a daisy chain configuration for the communications network;

FIG. 72 is a perspective view of one embodiment of a connector module;

FIG. 73 is a perspective, underside view of the connector module illustrated in FIG. 1;

FIG. 74 is an exploded view of the connector module illustrated in FIG. 72;

FIG. 75 is a perspective view of an embodiment of a section of a modular plug assembly which may be utilized with connector modules, such as the connector module illustrated in FIG. 72;

FIG. 75A is a perspective and enlarged view of one end of the section of a modular plug assembly illustrated in FIG. 75;

FIG. 76 is a perspective and exploded view of the section of the modular plug assembly illustrated in FIG. 75, showing a modular plug wire assembly, rail cover and rail divider;

FIG. 76A is a perspective and exploded view of one end of the modular plug assembly components illustrated in FIG. 75, showing the modular plug wire assembly, rail cover and rail divider, along with a modular plug cover and an end cover for the rail divider;

FIG. 77 is a perspective and exploded view of a portion of the section of the modular plug assembly illustrated in FIG. 75, and showing an exploded view of the manner in which components of the modular plug are assembled onto the modular plug assembly;

FIG. 78 is a perspective and partially exploded view showing how certain components of a modular plug are connected together;

FIG. 79A is a plan view of the rail cover illustrated in FIG. 76;

FIG. 79B is a side, elevation view of the rail cover illustrated in FIG. 79A;

FIG. 79C is an end view of the rail cover illustrated in FIG. 79A;

FIG. 80A is a plan view of the rail divider illustrated in FIG. 76;

FIG. 80B is a side, elevation view of the rail divider illustrated in FIG. 80A;

FIG. 80C is an end view of the rail cover illustrated in FIG. 80A;

FIG. 80D is an end view of the relative positions of the rail cover and rail divider when the modular plug assembly is fully assembled;

FIG. 81 is a perspective view of a connector module as interconnected to the modular plug assembly, and as positioned within a structural channel system rail;

FIG. 82 is a perspective and exploded view showing the relative positioning and interconnections of the modular plug assembly, connector module and structural channel rail illustrated in FIG. 81, in an exploded format;

FIG. 83 is an end view of the modular plug assembly illustrated in FIG. 75, as positioned and connected to a structural channel rail;

FIG. 84 is a perspective view of a circuit board assembly which may be utilized with a connector module;

FIG. 85 is a side, elevation view of the circuit board assembly illustrated in FIG. 84;

FIG. 86 is a perspective and stand alone view of a module connector set utilized with the circuit board assembly illustrated in FIG. 84;

FIG. 87 is a plan view of the module connector set illustrated in FIG. 15;

FIG. 88 is a front view of the module connector set illustrated in FIG. 86;

FIG. 89 is an enlarged view of a section of the module connector set illustrated in FIG. 86, illustrating the interconnection of the module connector set to the circuit board assembly;

FIG. 90 is a perspective, exploded view of a portion of the connector module, illustrating how the module connector plug is formed with the module connector set and the molded cover housings of the connector module;

FIG. 91 is a top, sectional view of the housing and module connector set of the module connector plug, when the connector module is fully assembled;

FIG. 92 is a perspective view of a low voltage power connector module, as connected to an application device comprising an occupancy detector;

FIG. 93 is a perspective, underside view of the low voltage power connector module and occupancy sensor as illustrated in FIG. 92;

FIG. 94 is a perspective and exploded view of the low voltage power connector module and associated occupancy sensor illustrated in FIG. 92, with the exploded view showing the wiring compartment of the connector module;

FIG. 95 is a perspective view of a partial section of the connector module illustrated in FIG. 92, showing the positioning of the wiring compartment;

FIG. 96 is a side, elevation view of the interior of the wiring compartment of the connector module, with the wiring compartment door being removed;

FIG. 97 is an elevation view of a dimmer connector module, showing, in partial view, the interior of the wiring compartment and the interconnection of the connector module to the dimmer arm;

FIG. 98 is a partial, perspective and exploded view of the connector module and occupancy sensor illustrated in FIG. 21, showing how the occupancy sensor is mechanically coupled to the connector module through the use of an electrical conduit nipple and locknuts;

FIG. 99 is a perspective and partial view of the connector module and occupancy sensor, similar to the view of FIG. 98 but showing the occupancy sensor fully assembled and connected to the connector module;

FIG. 100 is a perspective and partially exploded view of the connector module illustrated in FIG. 97, showing a track light end and its spatial positioning for mechanical interconnection to the dimmer connector module;

FIG. 101 is a partially schematic and partially diagrammatic block diagram of various circuit elements of the low voltage power connector module illustrated in FIG. 72;

FIG. 102 is a perspective view of a remote duplex receptacle which may be utilized with a power pole in accordance with the invention;

FIG. 103 is a further remote duplex receptacle in accordance with the invention, which may be utilized with a wall or the like;

FIG. 104 is a perspective view of a remote duplex receptacle as installed within a power pole FIG. 105 illustrates the remote duplex receptacle and power pole of FIG. 104, which further shows the connection to a power drop connector module;

FIG. 106 is a perspective view of a duplex receptacle assembly in accordance with the invention;

FIG. 107 is a front, elevation view of the duplex receptacle show in FIG. 106;

FIG. 108 illustrates a user programming a remote duplex receptacle in accordance with the invention, through the use of a wand;

FIG. 109 illustrates a user programming a switch so as to establish a control relationship between the switch the remote duplex receptacle;

FIG. 110 is similar to FIG. 108, but shows an appliance energized through the use of the remote duplex receptacle; and

FIG. 111 is similar to FIG. 110, but shows the user programming the switch so as establish the control relationship between the switch and the remote duplex receptacle.

### DETAILED DESCRIPTION OF THE INVENTION

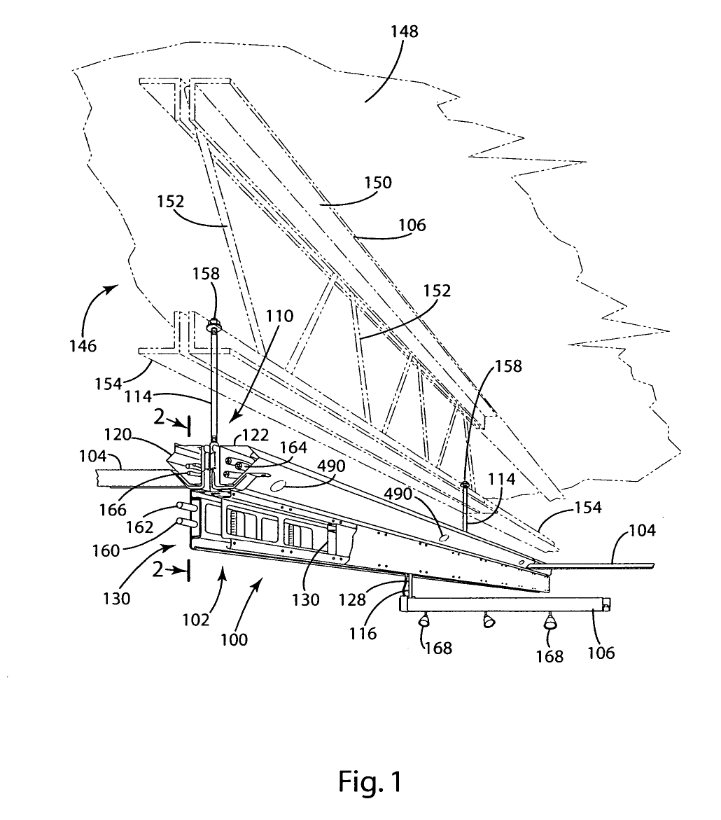

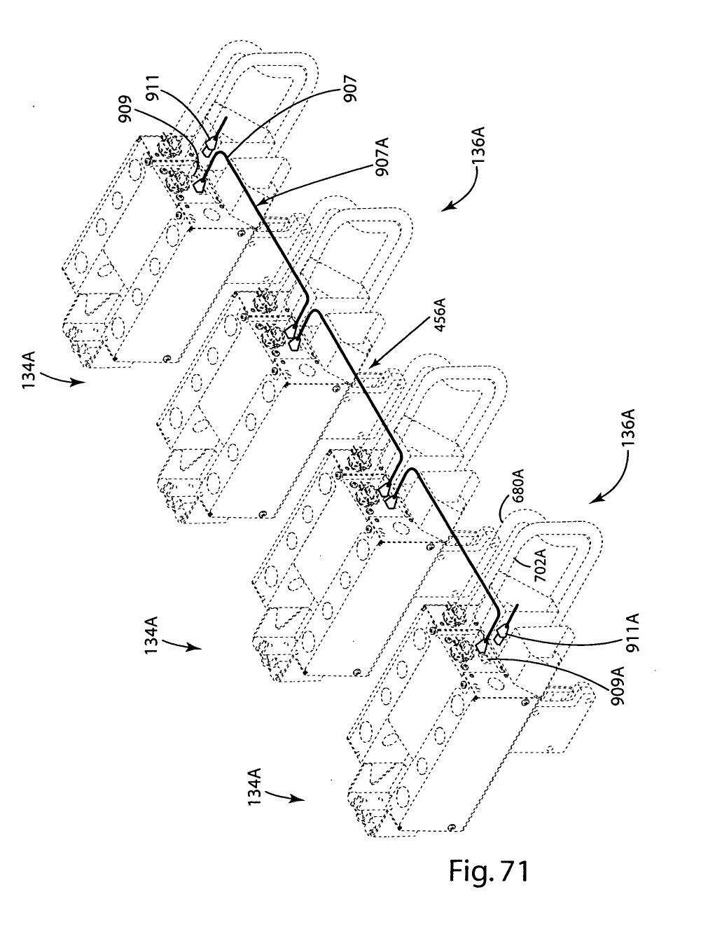

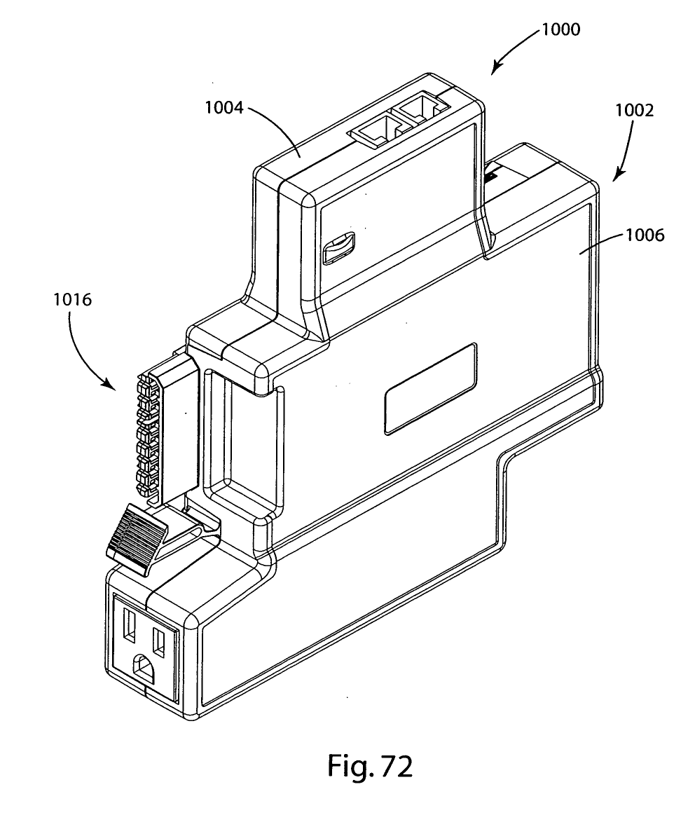

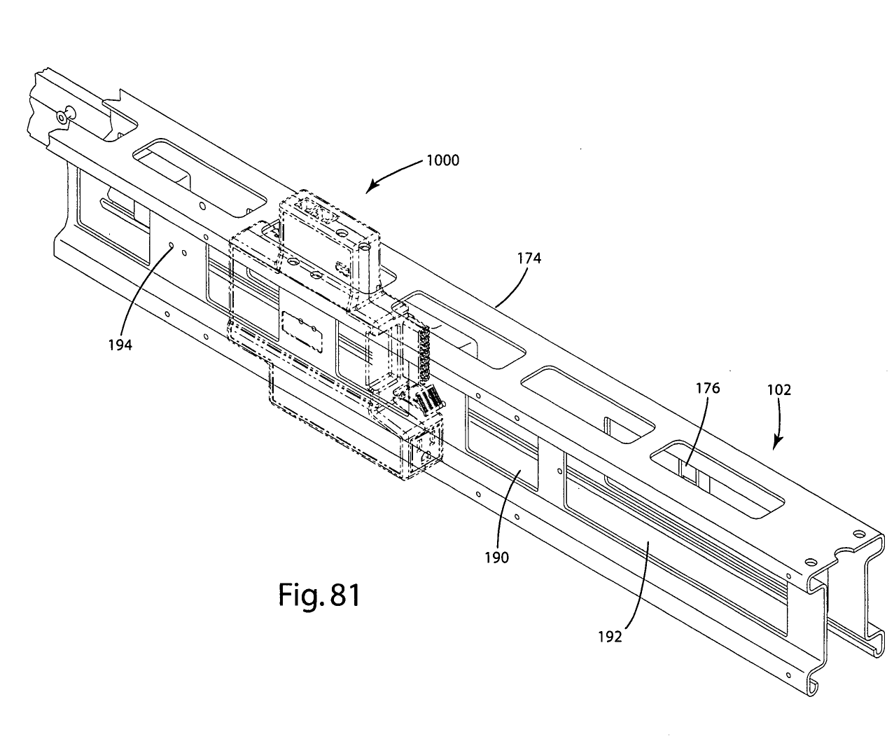

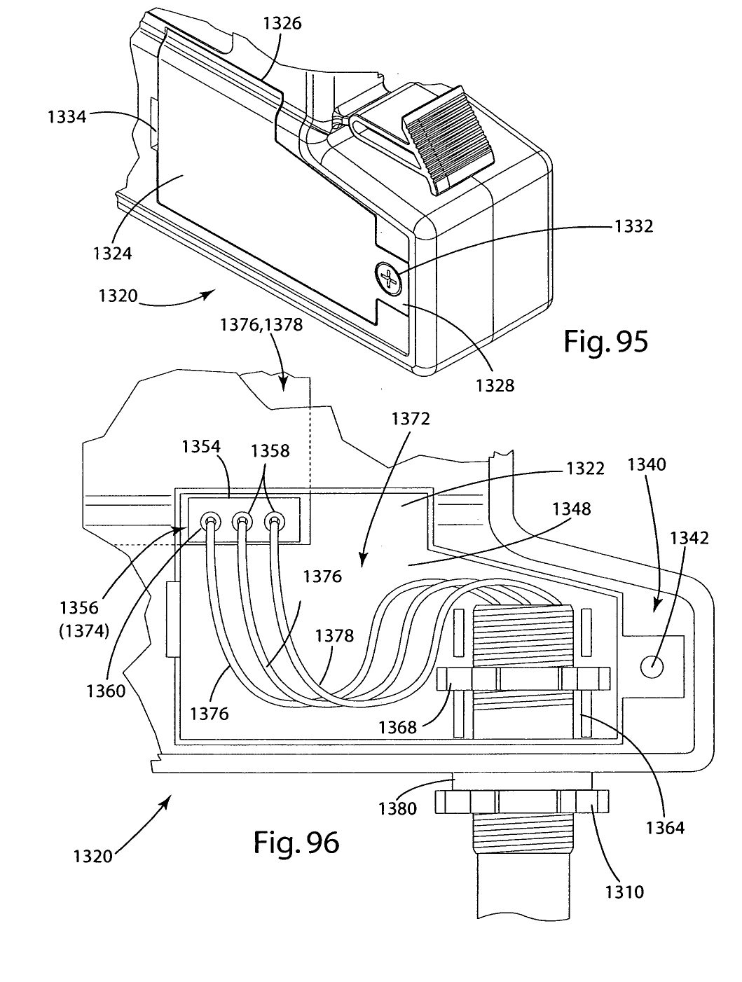

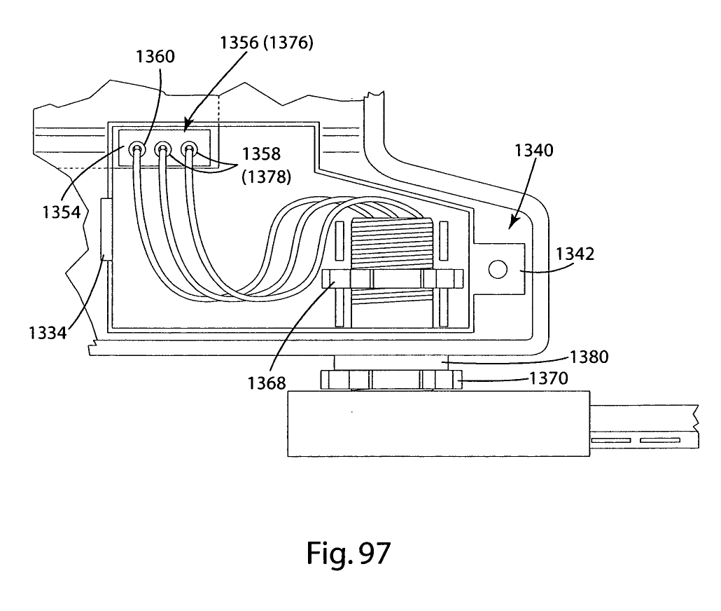

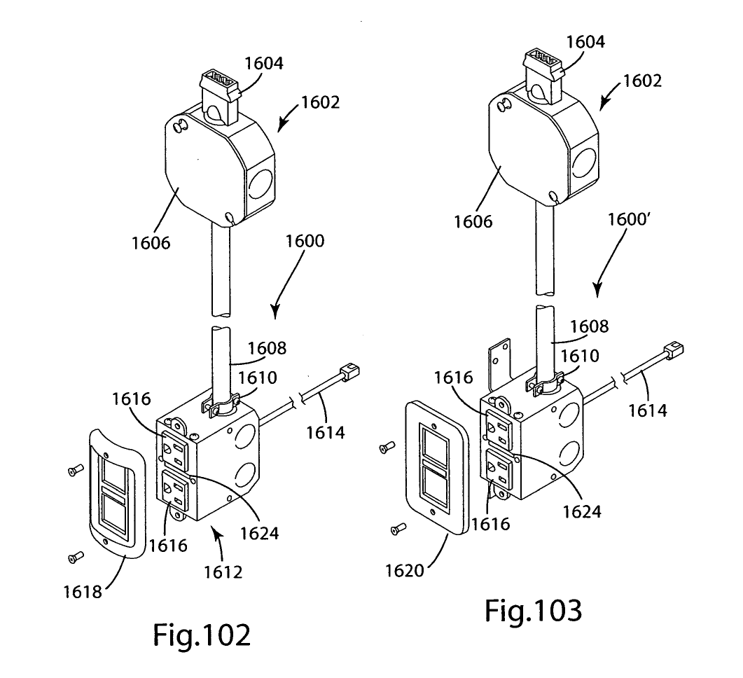

The principles of the invention are disclosed, by way of example, within a remote duplex receptacle 1600 as illustrated in FIG. 102-111. For purposes of background associated with the remote duplex receptacle 1600 and associated elements, a structural channel system 100 is illustrated in FIGS. 1-71, and will first be described. Also, various advances associated with connector modules and associated elements will be described with respect to FIGS. 72-101. As earlier stated, many issues associated with interior environments have been addressed and overcome through substantial advancements in the technical arts, with the development of a distributed power and communications network using certain designation protocols. This network and the protocols are described in the previously referenced Designation Protocol Application, of which this application is a continuation-in-part thereof. Also previously referenced were two other applications having disclosure relating to the subject matter of the current application. These applications include U.S. patent application Ser. No. 10/500,734, titled SWITCHING/LIGHTING CORRELATION SYSTEM and filed Nov. 12, 2004 (and referred to herein as the “Correlation System Application”); and International PCT Application Serial No. PCT/US05/28022, titled POWER AND COMMUNICATION DISTRIBUTION SYSTEM USING A STRUCTURAL CHANNEL SYSTEM and filed Aug. 5, 2005 (referred herein as the “Structural Channel System Application”). The disclosure herein of the structural channel system 100 in FIGS. 1-71 substantially corresponds to a part of the disclosure of the Structural Channel System Application. Further, the Designation Protocol Application describes a system whereby an interior environment can be quickly and easily reconfigured, as well as being “reprogrammed and transformed.” The system includes a low voltage communication network and protocols, enabling electrical devices connected to the network to be controlled as the user desires. It comprises a distributed network, using modular plug assemblies which distribute not only communication signals, but also deliver electrical power, which can be distributed through a grid. The grid itself may be overhead, but electrical power can also be distributed through grids located elsewhere in the interior environment, or even independent of a structural grid. For example, the electrical power can be distributed beneath raised floors, or modular or other traditional wall construction. The connector modules described herein and illustrated in FIGS. 72-101 may be utilized with the system described in the Designation Protocol Application and with the structural channel system 100. In accordance with the foregoing, the structural channel system 100 will first be described with respect to FIGS. 1-71. Following this description, the connector modules in accordance with the present invention will be described with respect to FIGS. 72-101. However, it should be emphasized that the connector modules described herein, along with associated elements, may be utilized with systems independent of the structural channel system 100, and with systems utilizing program structures independent of those disclosed in the Designation Protocol Application.

A perspective view of major components of the structural channel system 100, as installed within a building structure which may comprise a reconfigurable commercial interior, is illustrated in FIG. 1. The structural channel system 100 comprises an overhead structure providing significant advantages in environmental workspaces. As examples, the structural channel system 100 facilitates access to locations where a commercial interior designer may wish to locate various functional elements, including lighting, sound equipment, projection equipment (both screens and projectors), power poles, other means for energizing and providing data to and from electrical and communication devices, and other utilitarian elements.

As will be described in greater detail in subsequent paragraphs herein, the structural channel system 100 includes what may be characterized as a “grid” which essentially forms a base structure for various implementations of the structural channel system. The utilitarian elements referred to herein, for purposes of definition, are characterized as “devices.” Such devices, which may be programmed to establish control relationships (such as a series of switches and a series of light fixtures), are referenced herein as “applications.” In addition, the structural channel system 100 facilitates flexibility and reconfiguration in the location of various devices, which may be supported and mounted in a releasable and reconfigurable manner within the structural channel system 100. Still further, the structural channel system 100 may carry not only AC electrical power (of varying voltages), but also may carry DC power and communication signals.

The structural channel system 100 may also include a communication structure which permits “programming” of control relationships among various commercial devices. For example, “control relationships” may be “programmed” among devices, such as switches, lights, and the like. More specifically, with the structural channel system 100, reconfiguration is facilitated with respect to expense, time and functionality. Essentially, the commercial interior can be reconfigured in “real time.” In this regard, not only is it important that various functional devices can be quickly relocated from a “physical” sense, but logical relationships among the functional devices can also be altered. In part, it is the “totality” of the differing aspects of a commercial interior which are readily reconfigurable, and which provide some of the inventive concepts of the structural channel system 100.

Still further, the structural channel system 100 overcomes certain other issues, particularly related to governmental and institutional codes, regulations and standards associated with electrical power, mechanical support of overhead structures and the like. For example, it is advantageous to have power availability throughout a number of locations within a commercial interior. The structural channel system 100 provides the advantages of an overhead structure for distributing power and communication signals. However, structural elements carrying electrical signals (either in the form of power or communications) are regulated as to mechanical load-bearing thresholds. As described in subsequent paragraphs herein, the structural channel system 100 employs suspension brackets 110 for supporting elements such as cross-channels 104 and the like throughout the overhead structure. With the use of suspension brackets 110 the load resulting from these cross-channels 104 is directly supported through elements coupled to the building structure of the commercial interior. Accordingly, rail elements carrying power and communication signals do not support the mechanical loads resulting from use of the cross-channels 104.

As will be further described in subsequent paragraphs herein, the structural channel system 100 provides other advantages. For example, the structural channel system 100 permits carrying of relatively high voltage cables, such as 277 volt AC power cables. With the use of wireways 122 as described subsequently herein, such cabling can be appropriately isolated and shielded, and meet requisite codes and regulations. Still further, the structural channel system 100 can carry DC “network” power, along with DC communications. The DC power advantageously may be generated from building power, through AC/DC converters associated with power entry boxes. Alternatively, DC power may be generated by power supplies within connector modules throughout the network. With the DC network power essentially separate from other DC building power, overload potential is reduced.

Still other advantages exist relating to the carrying of both AC and DC power. Again, governmental and institutional codes and regulations include some relatively severe restrictions on mechanical structures incorporating buses, cables or other conductive elements carrying both AC and DC power. These restrictions, for example, include regulations limiting the use of AC and DC cables on a single mechanical structure. The structural channel system 100 comprises a mechanical and electrical structure which provides for distribution of AC and DC power (in addition to distribution of communication signals through an electrical network) through corresponding cables that utilize a mechanical structure which should meet most codes and regulations.

Still further, the structural channel system 100 includes the concept of providing for both wireways and cableways for carrying AC and DC power cables. In the particular embodiment of the structural channel system 100 described herein, the cableways (subsequently identified as cableways 120) are utilized for carrying components and signals such as low voltage DC power or other signals which do not necessarily require any substantial isolation or shielding. In contrast, the wireways (identified as wireways 122 subsequently herein) include an isolation and shielding structure which is suitable for carrying signals and power such as 277 volt AC power. Further, the structural channel system 100 includes not only the capability of providing for a single set of such cableways and wireways, but also provides for the “stacking” of the same. Still further, other governmental and intuitional codes and regulations include restrictions relating to objects which extend below a certain minimum distance above ground level, with respect to support of such objects. The structural channel system 100 provides for breakaway hanger assemblies, again meeting these restrictive codes and regulations. Still further, with a distributed power system as provided by the structural channel system 100, it is necessary to transmit power between various types of structural elements, such as adjacent lengths of main channels. With the particular mechanical and electrical structure of the structural channel system 100, flexible connector assemblies (such as the flexible connector assemblies 138 subsequently described herein) can be utilized to transmit power from one main channel length to another. Additionally, the structural channel system 100 may include various lengths of main channels which are coupled to components providing building power individually for each of the main channel lengths. However, in such event, it is still necessary to electrically couple together these main channel lengths in a manner so that communications signals can readily be transmitted and received among the various lengths. Accordingly, the structural channel system 100 includes means for “daisy chaining” components of the system together in a manner so that the distributed network is maintained with respect to communication signals.

Still further, the structural channel system 100 can be characterized as not only a distributed power network, but also a distributed “intelligence” network. That is, when various types of application devices are connected into the network of the structural channel system 100, “smart” connectors may be utilized. It is this intelligence associated with the application devices and their connectivity to the network which permits a user to “configure” the structural channel system 100 and associated devices as desired. This is achieved without requiring physical rewiring, or any type of centralized computer or control systems.

The structural channel system 100 may also be characterized as an “open” system. In this regard, infrastructure elements (such as main channels and the like) and application devices can be readily added onto the system 100, without any severe restrictions. Other advantageous concepts include, for example, the use of mechanical elements for supporting the structural channel system 100 from the building structure itself, so as to permit the “height” of the structural channel system 100 from the floor to be varied.

With reference first to FIG. 1, the structural channel system 100 may be employed within a commercial interior 146. The commercial interior 146 may be in the form of any type of commercial, industrial or office interior, including facilities such as religious, health care and similar types of structures. For purposes of description, FIG. 1 illustrates only certain overhead elements of commercial interior 146. These elements of the commercial interior 146 are illustrated in FIG. 1 in “phantom line” format. As shown in FIG. 1, the commercial interior structure 146 may include a ceiling 148, with sets of upper L-beams 150 welded or otherwise secured to the ceiling 148 by any appropriate and well-known means. Angled supports 152 extend downwardly from the upper L-beams 150, and attach to sets of lower L-beams 154. Secured to the lower L-beams 154 are sets of threaded support rods 114. The threaded support rods 114 extend downwardly from the lower L-beams 154 and may be secured to the lower L-beams 154 by any appropriate means. As an example, and as shown somewhat in diagrammatic format in FIG. 1, the threaded support rods 114 may have nut/washer combinations 158 at their upper ends for securing the support rods 114 to the L-beams 154.

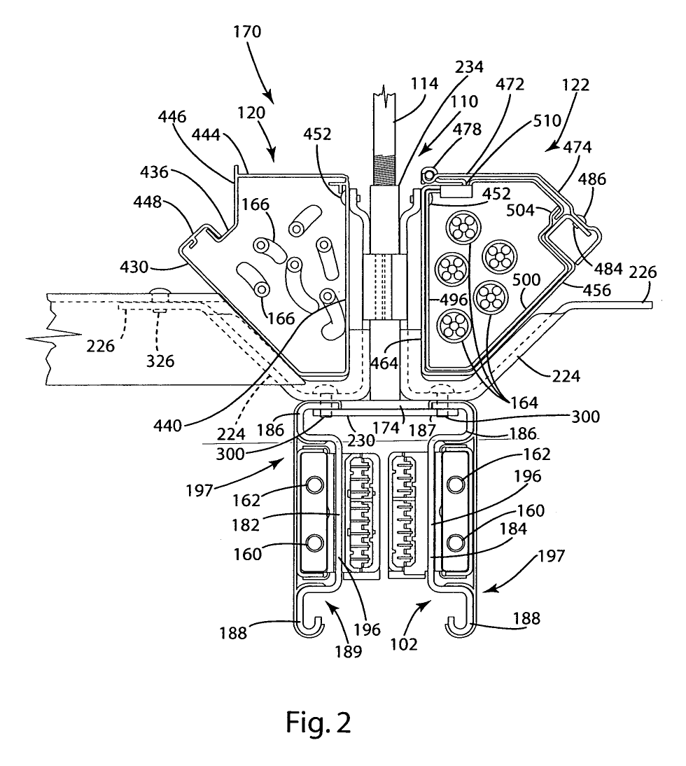

The structural channel system 100 includes a number of other principal components, many of which are shown at least in partial format in FIG. 1. More specifically, FIG. 1 illustrates a length of a main perforated structural channel rail 102 (sometimes referred to herein as the “main structural channel 102”) having an elongated configuration as shown in FIG. 1. As will be described in detail in subsequent paragraphs herein, the main perforated structural channel rail 102 may carry, on opposing sides of the structural channel 102, modular plug assemblies 130. As described in subsequent paragraphs herein, each of the modular plug assemblies 130 may carry, within its interior, an AC power cable assembly 160 and a DC power/communications cable assembly 162. As also described in subsequent paragraphs herein, the AC power cable assembly 160 may carry, for example, 120 volt AC power, other voltages, or electrical power other than AC. Correspondingly, the DC power/communications cable assembly 162 may carry communication signals and other low voltage DC power. Above the main structural channel 102 are a cableway 120 and a wireway 122. The cableway 120 and wireway 122 may be utilized for various functions associated with the structural channel system 100. For example, the wireway 122 may be utilized to carry 277 volt AC power cables 164, as illustrated in FIGS. 1 and 2. Correspondingly, the cableway 120 may be utilized to carry elements such as low voltage DC power cables 166, as also illustrated in FIGS. 1 and 2.

Also associated with the structural channel system 100 are suspension brackets 110. One of these suspension brackets 110 is illustrated in part in FIG. 1, and will be illustrated and described in greater detail in subsequent drawings and paragraphs herein. The suspension brackets 110 are utilized in part to support the main structural channel rails 102 from the ceiling 148 through the threaded support rods 114. Also, and of primary importance, the suspension brackets 110 include elements which permit cross-channels, such as the cross-channels 104 illustrated in FIG. 1, to be mechanically supported directly through the threaded support rods 114 from the ceiling 148. Accordingly, the cross-channels 104 do not exert any significant mechanical load on the main structural channels 102, which carry the modular plug assemblies 130 having AC power cable assemblies 160 and DC cable assemblies 162. If mechanical loads were exerted on the main structural channels 102 by elements such as the cross-channels 104, governmental and institutional regulations would not permit the main structural channels 102 to carry the modular plug assemblies 130.

The structural channel system 100 as illustrated in FIG. 1 may comprise cross-rails 106. Each of the cross-rails 106 utilized with the structural channel system 100, as described in subsequent paragraphs herein, is releasably interconnected to one of the main structural channel rails 102. Further, cross-rails 106 may extend in perpendicular configurations relative to the main structural channel rails 102, as illustrated in FIG. 1. However, as also described in subsequent paragraphs herein, a cross rail 106 may be interconnected to an adjacent main structural channel 102 at an angular configuration, relative to the longitudinal configuration of the main structural channel 102. Each cross rail 106 may be releasably coupled to an associated main structural channel 102 through a universal suspension plate assembly 116: The cross-rails 106 may be utilized for purposes of distributing electrical power and communication signals from an interconnected main structural channel rail 102 having a modular plug assembly 130. This power and communications signal distribution may be utilized with various devices, such as the three lights 168 illustrated in FIG. 1.

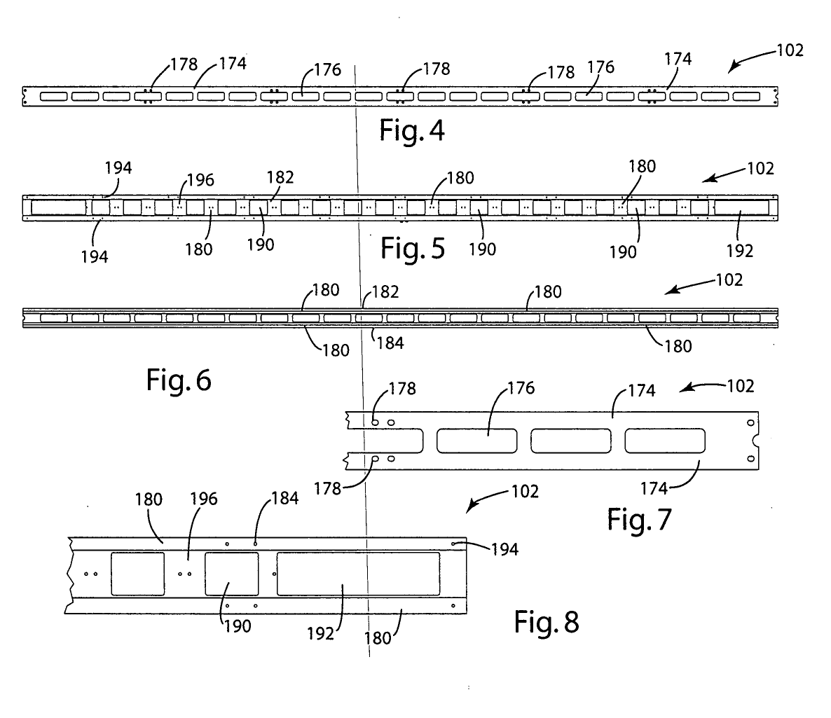

One advantage associated with the structural channel system 100 (and other structural channel systems in accordance with the invention) may not be immediately apparent. As described in previous paragraphs herein, the structural channel system 100 includes the threaded support rods 114, suspension brackets 110, and cross-channels 104. As will be explained in greater detail in subsequent paragraphs herein, the cross-channels 104 are supported through the suspension brackets 110 solely by threaded support rods 114. With reference to FIGS. 1 and 4, the threaded support rods 114 can each be characterized as forming a suspension point 170. That is, where each of the threaded support rods 114 is secured to a lower L-beam 154 or similar building structure position, the combination of the building structure position and the threaded support rod 114 may be characterized as a suspension point 170. Accordingly, the main structural channel rails 102, suspension points 170, suspension brackets 110 and cross-channels 104 may be characterized as forming a structural or mechanical network or “grid” 172. For purposes of designing the entirety of a structural channel system in accordance with the invention for any particular structure and set of applications, the structural grid 172 formed by the suspension points 170, suspension brackets 110, cross-channels 104 and main structural channels 102 may be characterized as a common “base” for building a particular implementation of a structural channel system in accordance with the invention. That is, a common configuration of the structural grid 172 can be designed and would not significantly change across various implementations of structural channel systems in accordance with the invention, except with respect to size. This concept of a common structural grid which may be utilized with a structural channel system having the capability of various configurations for power and communications distribution, for configuring and reconfiguring structural positioning of application devices (such as lights, fans and the like), and for configuration and reconfiguration of functional control relationships among devices (through programmability) provides a significant advantage to architects and designers. This principle should be kept in mind in reading the subsequent paragraphs herein describing the various components of the structural channel system 100.

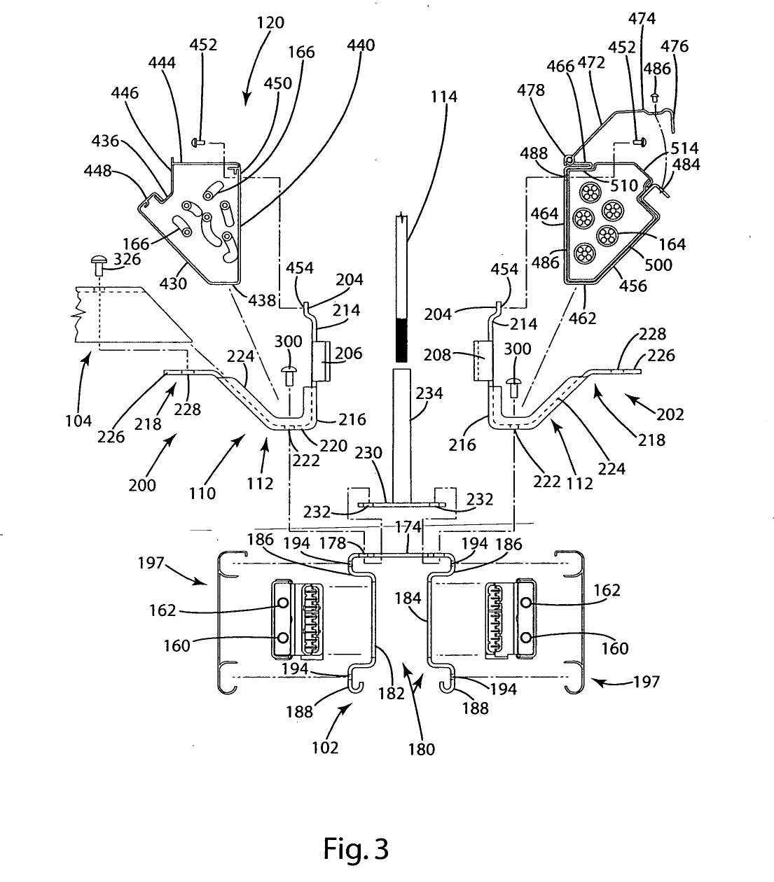

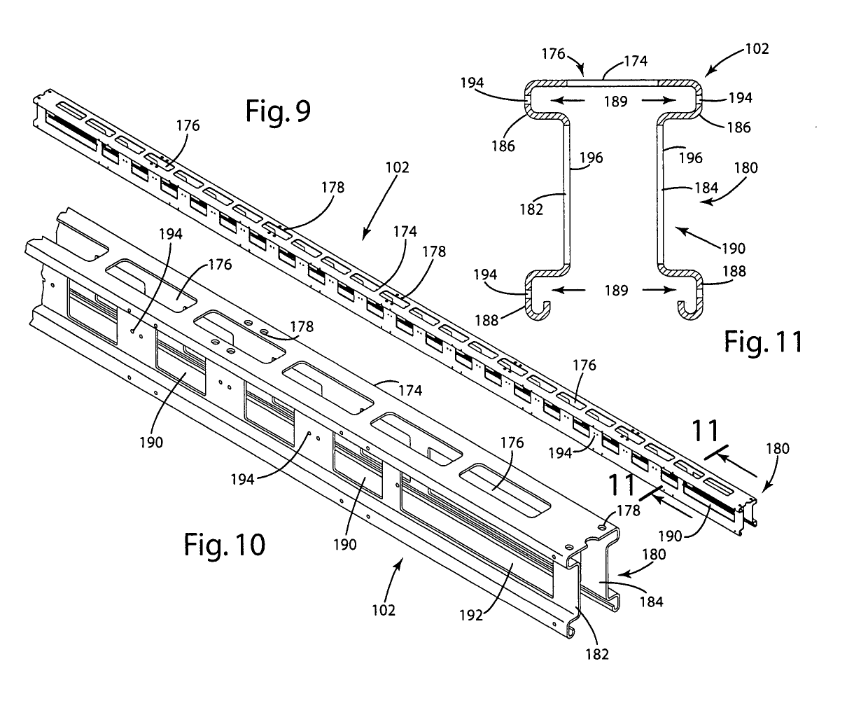

Turning more specifically to the details of the system 100, a main perforated structural channel rail 102 will now be described with respect to FIGS. 1, 2 and 5-12. Turning specifically to FIG. 2, which illustrates an assembled one of the main structural channel rails 102, each of the main structural channel rails 102 may be supported by associated threaded support rods 114. The support occurs at various suspension points 170, through associated suspension brackets 110. Each of the threaded support rods 114 may be in the form of a co-threaded rod. Only a lower end of the rod 114 is illustrated in FIGS. 2 and 3. As previously shown and described with respect to FIG. 1, each of the threaded support rods 114 may be secured at one end to one of the lower L-beams 154, through an aperture (not shown) extending through a flange of the L-beam 154. The co-threaded support rod 114 is threaded adjacent its upper end and is secured at a desired vertical disposition through its threading at both lower and upper ends. The co-threaded support rod 114 is threadably secured to one of the suspension brackets 110 at the lower end thereof. With the interconnections described herein, a main structural channel 102 may be secured to the lower L-beams 154 of the commercial interior 146 in a manner which provides for rigidity, yet also provides for adjustability with respect to vertical positioning relative to the L-beam 154. Also, in addition to the particular example of an overhead supporting arrangement as described herein, it is possible to interconnect the main structural channels 102 of the structural channel system 100 to other structure of the commercial interior 146, such as concrete structures above the channel system 100, and with connections other than support rods. For example, in place of the co-threaded support rod 114 and L-beam 154 configuration, the support rod 114 could be used with a threaded hanger or similar means, with the hanger threadably received at an upper end of the threaded rod 114. The hanger may then be hung on or otherwise releasably interconnected to other overhead supporting elements. In any event, it is advantageous to utilize a supporting arrangement which facilitates vertical adjustability of the interconnected main structural channel 102. As described in subsequent paragraphs herein, the lower end of the threaded support rod 114 illustrated in FIGS. 2 and 3 is threaded into and extends downwardly through a tube of the suspension bracket 110, also as shown in FIGS. 2 and 3.

Each of the main structural channel rails 102 is of a unitary design. Turning primarily to FIGS. 4-11, the length of main perforated structural channel rail 102 shown therein includes a longitudinally extending upper portion 174 formed in a single plane, which would commonly be positioned in a horizontal configuration. Extending through the upper portion 174 are a series of spaced apart upper rectangular apertures 176. The apertures 176 can be characterized as surface perforations which are utilized to permit passage of cables above and below the ceiling plane formed by the structural channel rail 102. Also extending through the upper portion 174 at spaced apart positions are a series of predrilled mounting holes 178. As described in subsequent paragraphs herein, these predrilled mounting holes 178 will be utilized for purposes of providing interconnection to suspension brackets 110 at various locations along the length of the structural channel rail 102. For example, such mounting holes 178 (as shown in pairs in the drawings) could be spaced at 20-inch intervals.

Integral with the upper portion 174 and extending downwardly from opposing lateral sides thereof are a pair of side panels 180. As shown in the drawings, the side panels 180 comprise a left side panel 182 and a right side panel 184, with the left and right designations being arbitrary. As shown primarily, for example, in FIG. 11, each of the side panels 180 forms, at the upper portion thereof, an upper U-shaped section 186, with the base of each U-shaped section 186 being positioned outwardly. Extended downwardly from and integral with each of the upper U-shaped sections 186 is a recessed side portion 196. The recessed side portions 196 will have a vertical orientation when the main structural channel rail 102 is positioned within the structural channel system 100. At the lower ends of each of the recessed side portions 196, and preferably integral therewith, are lower hook-shaped sections 188. The hook-shaped sections 188 have a configuration as primarily shown in the sectional end view of FIG. 11. The hook-shaped sections 188 are utilized for various functions, including positioning of joiners for alignment of adjacent structural channel rails 102.

Extending through each of the recessed side portions 196, and positioned at spaced apart intervals therein, are perforations in the form of side plug assembly apertures 190. As will be described in subsequent paragraphs herein, the side plug assembly apertures 190 will be utilized to couple together the main structural channel rails 102 with the modular plug assemblies 130. As further shown in FIGS. 4-11, a series of predrilled through holes 194 extend through the side panels 180.

In addition to the foregoing elements, the main perforated structural channel rails 102 can also include covers, such as the covers 197 illustrated primarily in FIGS. 2 and 3. The covers 197 are utilized in pairs, so as to provide for aesthetics and general closure of the sides of the structural channel rails 102, when the sections 500 of the modular plug assembly 130 are secured within the structural channel rails 102. Each of the structural channel rails 102 includes an upper channel 199. Each of the upper channels 199 is shaped and has sufficient resiliency so as to be “snap fitted” around a corresponding one of the upper U-shaped sections 186 above the side panels 180. Correspondingly, the covers 197 also include lower channels 201, having the cross sectional configuration shown in FIG. 3. Like the upper channels 199, the lower channels 201 are shaped and have a resiliency so as to be “snap fitted” around corresponding lower hook-shaped sections 188 below the side panels 180. Alternatively, if desired, the covers 197 can be more rigidly secured to the upper U-shaped sections 186 and lower hook-shaped sections 188 through the use of connecting screws or the like received through the covers 197 and the main bodies of the structural channel rails 102. Again, the covers 197 are primarily designed for appearance. The upper channels 199 and channels 201 are integral with cover side panels 203 having a vertical disposition when secured to the structural channel rails 102.

One other concept should also be mentioned. Specifically, when connecting the individual sections of the covers 197 to the individual lengths of the main rails 102, the ends of the individual sections of the covers 197 may be “staggered” relative to the location of the ends of the individual lengths of the main rails 102. The staggering may assist in minimizing misalignments. In this regard, if such staggering results in sections of the main rails 102 which are partially uncovered, the covers 197 can be constructed of materials which would allow the individual sections of the covers 197 to be cut at the assembly site, so that partial cover lengths can be provided.

In brief summary, the main perforated structural channel rails 102 form primary components of the structural channel system 100. The structural channel rails 102 may be constructed and used in various lengths. For example, structural channel rails 102 may be formed in lengths of 60 inches or 120 inches. For purposes of providing appropriate support, suspension brackets 110 should be utilized to support the main structural channel rails 102 at designated intervals. The smaller the supporting intervals, the greater will be the load rating for the structural channel rails 102. For example, a specific load rating may be obtained with the main structural channel rails 102 supported by suspension brackets 110 at 60-inch intervals. Further, the main structural channel rails 102 may be constructed of various types of materials. For example, rails 102 may be formed as steel with a thickness of 0.105 inches, and may have a galvanized finish.

As earlier described, the structural channel system 100 also includes a series of suspension brackets 110. Specifically, each of the suspension brackets 110 is adapted to perform two functions. First, the suspension bracket 110 comprises means for providing mechanical support for the main perforated structural channel rails 102, through the threaded support rods 114. Also, each suspension bracket 110 is adapted to interconnect to one or a pair of cross-channels 104. The cross-channels 104 are relatively well known construction elements, commercially available in the industry. Of primary importance, however, is the means for supporting the cross-channels 104 through the suspension brackets 110. More specifically, the suspension brackets 110 comprise means for coupling the cross-channels 104 and supporting the same in a manner such that the weight of the coupled cross-channels 104 is carried only by the associated threaded support rod 114 and not by the main structural channel rail 102. This aspect of the structural channel system 100 in accordance with the invention is of importance with respect to governmental and institutional regulations regarding load-bearing structures carrying electrical and communications signals and equipment. As will be described in subsequent paragraphs herein, the main structural channel rails 102 carry modular plug assemblies 130 which, in turn, carry AC power, low voltage DC power (possibly) and communication signals. Because of the power carried by the main structural channel rails 102 through the modular plug assemblies 130, regulatory limitations exist with respect to mechanical loads supported by the main structural channel rails 102. With the configuration of each suspension bracket 110 as described in subsequent paragraphs herein, and although the cross-channels 104 act as crossing rails for the entirety of the structural channel system 100, and are “coupled” to the main structural channel rails 102, the weight of the cross-channels 104 (and any application devices supported therefrom) is carried solely by the threaded support rods 114 through the suspension brackets 110, rather than by the main structural channel rails 102 themselves.

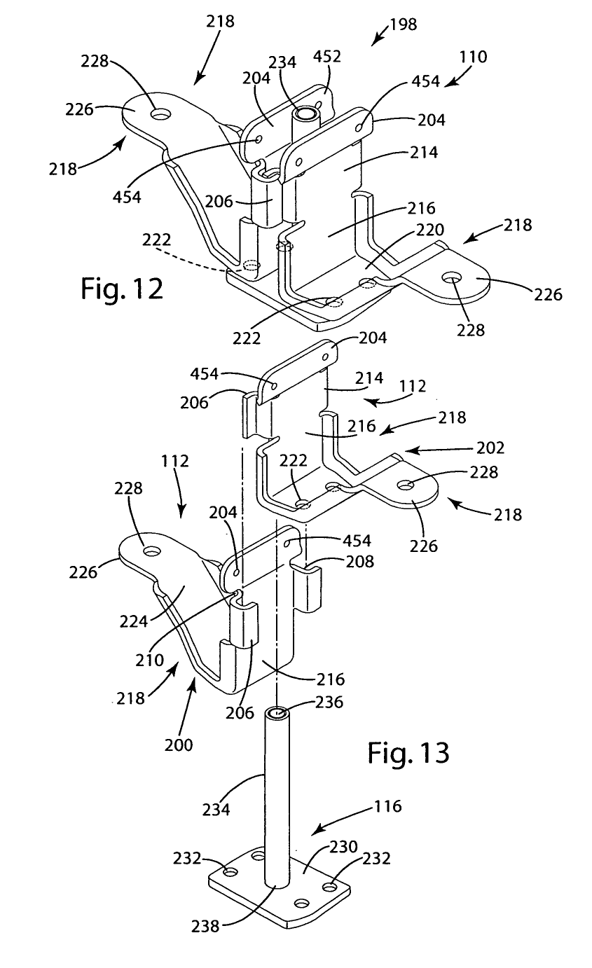

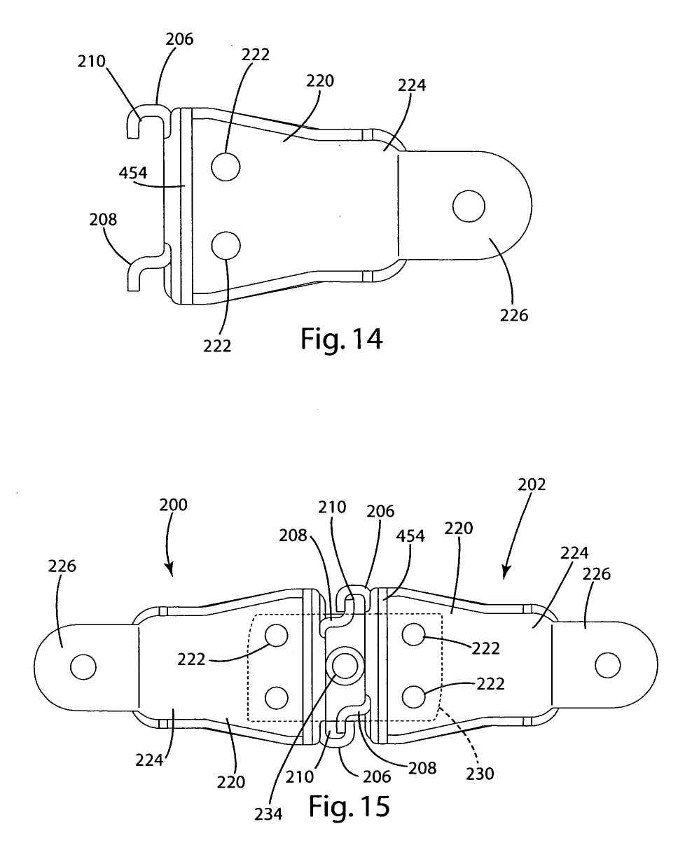

A suspension bracket 110 will now be described with respect to FIGS. 12-16. Turning first to FIGS. 12-15, the suspension bracket 110 includes a main rail hanger 198. The main rail hanger 198 comprises a pair of suspension bracket section halves 112. The section halves 112 include a first suspension bracket section half 200 and a second suspension bracket section half 202. Although numbered differently, it will be apparent from the description herein that the first section bracket section half 200 may be constructed identical to the second suspension bracket section half 202. With reference to each of the section bracket section halves 112, each half includes an upper flange 204 extending across the width of the section half 112. A pair of spaced apart, and preferably threaded, holes 454 extend through each of the upper flanges 204. The holes 454 will be utilized for purposes of mounting cableways 120 or wireways 122 as described in subsequent paragraphs herein.

Integral with each upper flange 204 is a central portion 214. On one side of each central portion 214, and preferably integrally formed therewith, is a U-shaped leg 206. The leg 206 has a configuration as primarily shown in FIGS. 13, 14 and 15. The U-shaped leg 206 forms an inwardly projecting “capturing” slot 210. Correspondingly, and extending outwardly from an opposing side of the central portion 214 (and preferably integral therewith) is an arcuate arm 208. The vertical cross section of the arm 208, as with the U-shaped leg 206, is primarily shown in FIGS. 13, 14 and 15. Extending downwardly from the central portion 214 and integral therewith for each section half 112, is a vertically disposed lower section 216. Extending outwardly from the lower edge (and preferably integral therewith) of the lower section 216 for each section half 112 is a cross channel bracket 218. The cross channel bracket 218 includes a horizontally disposed base 220 which is preferably integral with the lower edge of the lower section 216 of the section half 112. A pair of screw holes 222 are spaced apart and extend through the horizontally disposed base 220 of each section half 112. The screw holes 222 will be utilized to receive screws for purposes of securing that particular section half 112 to the corresponding main structural channel rail 102. Extending laterally outwardly and angled upwardly from the horizontally disposed base 220 is a lateral angled portion 224. The angled portion 224 is upwardly angled and preferably integral with the horizontally disposed base 220. Integral with the terminal end of each lateral angled portion 224 is a horizontally disposed foot 226. The foot 226 has the size and configuration as primarily shown in FIGS. 12 and 13. A through hole 228 extends downwardly through each foot 226. As described in subsequent paragraphs herein, each foot 226 will be utilized to interconnect the suspension bracket 110 to a cross channel 104.

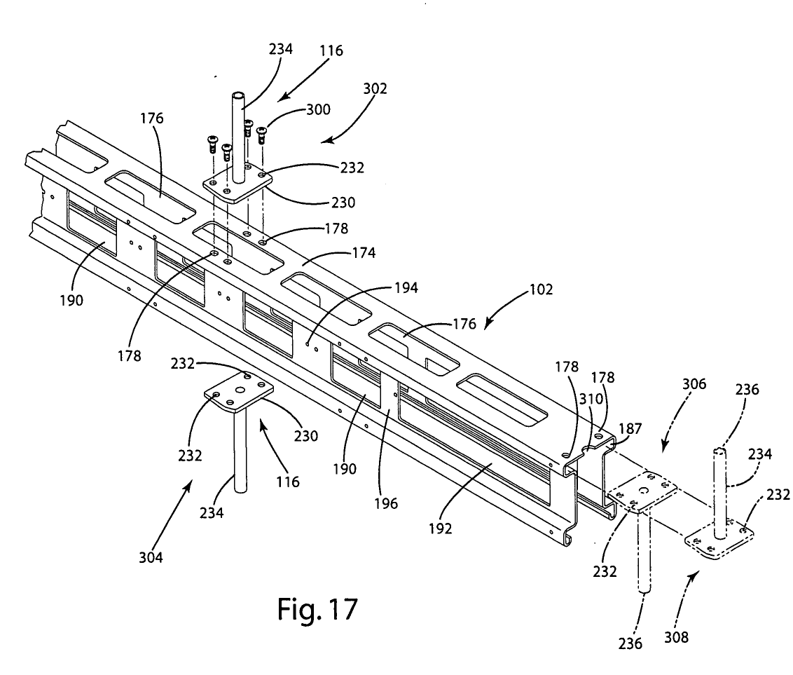

The suspension bracket 110 further includes a universal suspension plate assembly 116, as primarily illustrated in FIG. 13. The universal suspension plate assembly 116 can also be used separate and apart from the suspension bracket 110, as will be described in subsequent paragraphs herein with respect to FIG. 17. More specifically, the universal suspension plate assembly 116 includes a suspension plate 230 having a substantially rectangular configuration as shown in FIGS. 13 and 15. When used with the entirety of the suspension bracket 110, the suspension plate 230 will be in a horizontally disposed configuration. Extending downwardly through the suspension plate 230 are a set of four spaced apart threaded holes 232. The threaded holes 232 will be utilized to receive screws which will also pass through the through holes 222, for purposes of securing the suspension bracket 110 to the main structural channel rail 102. The universal suspension plate assembly 116 further includes a vertically disposed and upwardly extending tube 234. The tube 234 preferably includes a series of internal threads extending downwardly for at least a partial length of the tube 234 from the upper end 236 of the tube 234. The threaded tube 234 also includes a lower end 238, which is preferably welded or otherwise secured to an upper surface of the suspension plate 230.

The assembly of the suspension bracket 110 will now be described, both with respect to the assembly of its individual components and with respect to assembly to a main structural channel rail 102. The first suspension bracket section half 200 and the second suspension bracket section half 202 of the suspension bracket section halves 112 can first be brought together in a manner as shown in FIGS. 12 and 15. With reference specifically to FIG. 15, it is noted that the U-shaped leg 206 of the first suspension bracket section half 200 captures the arcuate arm 208 of the second suspension bracket section half 202 within the capturing slot 210 of the U-shaped leg 206. Correspondingly, the U-shaped leg 206 of the second suspension bracket section half 202 captures the arcuate arm 208 of the first suspension bracket section half 200 within the capturing slot 210 of the leg 206 of the second suspension bracket section half 202. In this manner, the section halves 200, 202 are essentially “locked” together, with respect to any laterally directed forces attempting to separate the section halves. The universal suspension plate assembly 116 is then brought into proximity with the main rail hanger 198, such that the threaded tube 234 extends upwardly between the opposing section halves 200, 202. This configuration is primarily shown in FIGS. 12 and 15. With this configuration, the suspension plate 230 will then be positioned immediately beneath the horizontally disposed bases 220 of each of the section halves 200, 202. As previously mentioned, screws (not shown in FIG. 12 or 15, but illustrated as screws 300 in FIG. 2) can be inserted through the two pairs of screw holes 222 in the horizontally disposed bases 220, and further through the threaded holes 232 of the suspension plate 230. This configuration, with the screws 300 extending through the bases 220 and the suspension plate 230, is shown in FIG. 2. Also, it should be understood that the threaded tube 234 is utilized, when the universal suspension plate assembly 116 is used with the suspension bracket 110, to threadably receive one of the threaded support rods 114, for purposes of securing the suspension bracket 110 to the building structure.

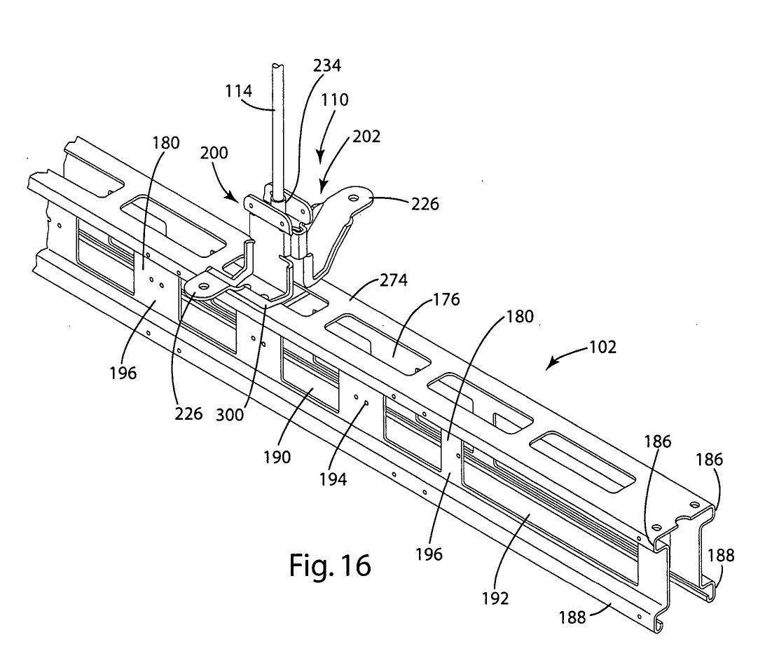

For purposes of fully assembling the suspension bracket 110 to a main structural channel rail 102, and with reference to FIGS. 2, 3, 11, 13 and 16, the universal suspension plate assembly 116, with the threaded tube 234 connected thereto, can be inserted within one of the upper rectangular apertures 176, so as to be configured as shown in FIG. 16. Connecting screws 300 (shown in FIG. 2) can then be inserted through the pairs of screw holes 222 located in the horizontally disposed bases 220 of each of the section halves 200, 202. The screws 300 can be inserted through the screw holes 222, through the predrilled mounting holes 178 within the upper portion 174 of the structural channel rail 102, and further through the threaded holes 232 within the suspension plate 230. With this configuration, the universal suspension plate assembly 116 and suspension bracket section halves 200, 202 can be secured to a length of the main structural channel rails 102. As further shown in FIG. 16, one of the threaded support rods 114 (shown in partial length in FIG. 16) can be threadably received, at its lower end, within the upper end 236 of the threaded tube 234. As previously described, the threaded support rod 114 will be connected at its upper end to part of the building structure, such as the lower L-beam 154 as illustrated in FIG. 1.

As described in foregoing paragraphs, the suspension bracket 110 utilizes a universal suspension plate assembly 116. As also previously described herein, the universal suspension plate assembly 116 includes a suspension plate 230, threaded holes 232 and threaded tube 234. The threaded tube 234 includes a threaded upper end 236 and a lower end 238, with the lower end 238 being welded or otherwise secured to a surface of the suspension plate 230. In accordance with the invention, the universal suspension plate assembly 116 is adapted not only to be utilized with the suspension bracket section halves 200, 202, but also in other configurations for supporting the main structural channel rail 102 and for supporting various other components of the structural channel system 100 and application devices which may be interconnected thereto.

Certain of the various connection configurations between the universal suspension plate assembly 116 and a length of the main structural channel rail 102 are illustrated in FIG. 17. As shown therein, the universal suspension plate assembly 116 can be used in various configurations, in interconnections to main structural channel rail 102. FIG. 17 illustrates four example configurations, identified as a first configuration 302, second configuration 304, third configuration 306 and fourth configuration 308. With reference to the first configuration 302, configuration 302 illustrates a universal suspension plate assembly 116 positioned so that the suspension plate 230 is mounted to an upper surface of the upper portion 174 of the structural channel rail 102. In this configuration, threaded screws 300 extend downwardly through the threaded holes 232 of the suspension plate 230 and the predrilled mounting holes 178 and the upper portion 174. The threaded tube 234 extends upwardly above the structural channel rail 102. In the second configuration 304, the suspension plate 230 is received within the upper grid 187 of the structural channel rail 102, formed below the upper portion 174. In this configuration, connecting screws would first be received through the predrilled mounting holes 178 and then, therebelow, the threaded holes 232 and the suspension plate 230.

In a third configuration 306, the suspension plate 230 is again positioned within the upper grid 187, but at the end of a length of structural channel rail 102. Two of the threaded holes 232 and the suspension plate 230 are aligned with the two predrilled mounting holes 178 at the end of the rail 102. Although not expressly shown in FIG. 17, the other two threaded holes 232 of the suspension plate 230 can be coupled through connecting screws received through predrilled mounting holes (not shown) within another length of the structural channel rail 102 (not shown). Also in this configuration, the threaded tube 234 is extended downwardly, so that the upper end 236 is actually positioned at the lower-most position of the suspension plate assembly 116. A still further fourth configuration 308 can be utilized at an end of the structural channel rail 102. In this configuration, the suspension plate assembly 116 for the fourth configuration 308 is positioned in a directionally opposing configuration relative to the third configuration 306. Again, the suspension plate 230 is received within the upper grid 187. However, the threaded tube 234 is extended upwardly, so that the upper end 236 is at the uppermost plane of the suspension plate assembly 116. Also with the fourth configuration 308, two of the threaded holes 232 are aligned with the two holes 178 at the end of the structural channel length 102, for purposes of securing the suspension plate 230 to the one length of the structural channel rail 102. Connecting screws (not shown) are received within the other pair of threaded holes 232 of the suspension plate 230, with the holes 232 being aligned with predrilled mounting holes (not shown) in an adjacent length of the main structural channel rail 102. For purposes of securing the structural channel rail 102 lengths to be coupled together so that their ends are in close proximity, a slot 310 is formed at the end of the length of main structural channel rail 102 shown in FIG. 17. A corresponding slot (not shown) would exist within the end of an adjacent length of the main structural channel rail 102 (not shown). In this manner, the universal suspension plate assembly 116 for the fourth configuration 308, like the third configuration 306, would be secured to adjacent lengths of the main structural channel rail 102.

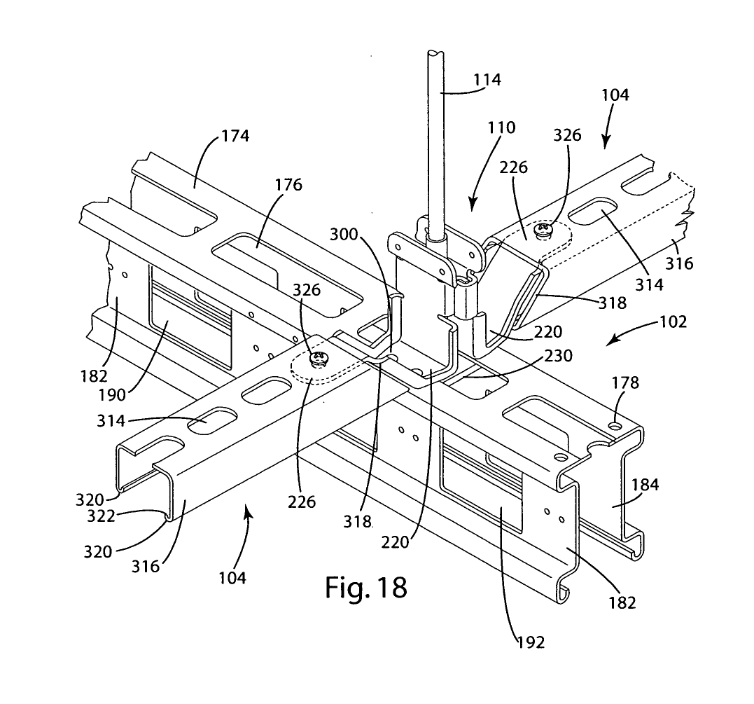

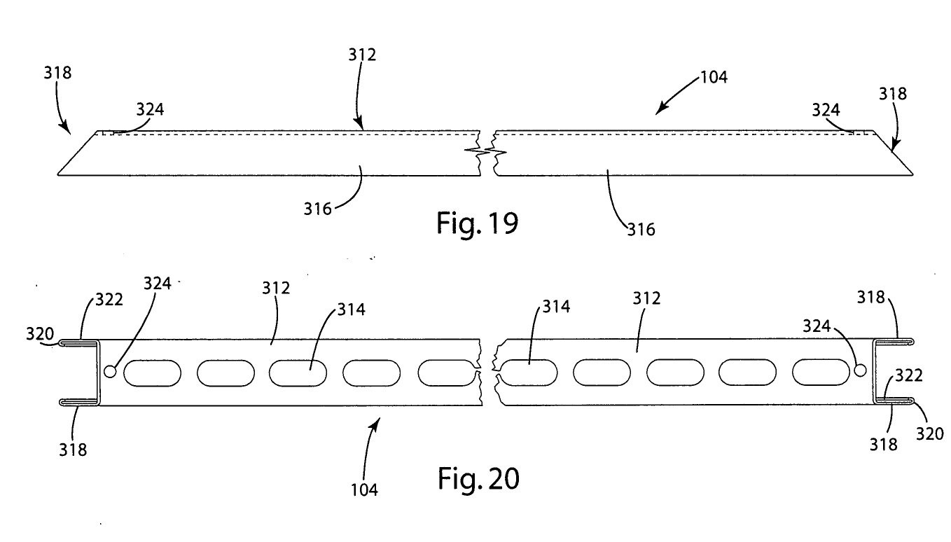

As earlier described herein, the structural channel system 100 includes a series of cross-channels 104, which form in part the structural network grid 172. The cross-channels 104, including their interconnection to the commercial interior and building structure through the suspension brackets 110, will now be described with respect to FIGS. 18, 19 and 20. The cross-channels 104 (originally shown in FIG. 1) provide cross bracing for the mechanical structure of the structural channel system 100 and form part of the structural grid 172. FIG. 18 illustrates a pair of the cross-channels 104, with the channels 104 being in a coaxial alignment and both coupled to a common suspension bracket 110. FIGS. 19 and 20 illustrate side elevation and plan views, respectively, of one of the cross-channels 104. Turning specifically to FIG. 18, the drawing illustrates one of the suspension brackets 110 previously described herein, coupled to one of the threaded support rods 114. Horizontally disposed bases 220 of the suspension bracket 110 are connected through screws 300 or similarly connecting means to a suspension plate 230 and to the main structural channel rail 102 as previously described herein. FIG. 18 further illustrates one cross channel 104 connected to the suspension bracket 110 and extending perpendicular to the main structural channel 102. A second cross channel 104 is also illustrated in FIG. 18, extending perpendicular to the main structural channel 102 in an opposing direction to the first cross channel 104. Referring now primarily to FIGS. 19 and 20, each cross channel 104 includes an upper flange 312. A series of oval or elliptical apertures 314 extend through the surface of the upper flange 312. Integral with the upper flange 312 are a pair of opposing sides 316. At the end of each of the cross-channels 104, the sides 316 terminate in tapered or angled ends 318, as primarily shown in FIG. 19. At the lower portion of each tapered end 318, the sides 316 turn upwardly in curls 320. The curled portions of the sides 316 thereby form small troughs 322. Each of the cross-channels 104 may also include threaded or unthreaded holes 324 extending through the upper flange 312 adjacent the opposing tapered ends 318. Referring back to FIG. 18, and for purposes of connection of the cross-channels 104 to the suspension bracket 110, screws 362 may be threadably received within the threaded holes 324 of the cross-channels 104, and then also through apertures or through holes 228 of the horizontally disposed feet 226 of the suspension bracket 110. In this manner, each of the cross-channels 104 as illustrated in FIG. 18 is rigidly secured to the suspension bracket 110.

With the cross-channels 104 secured to the horizontally disposed feet 226, the entirety of the mechanical load of the cross-channels 104 is carried by the associated threaded support rod 114 through the suspension bracket 110. Accordingly, the support of the cross-channels 104 as shown in FIG. 18 does not subject the associated main structural channel rail 102 to any additional mechanical load. This is important in that, as described in subsequent paragraphs herein, the main structural channel rail 102 will be carrying AC power, communication signals and possibly DC power. Governmental and institutional regulations may not permit electrical load-carrying elements, such as the structural channel rail 102, to correspondingly support any substantial weight-bearing elements. It is the configuration of the suspension bracket 110, and the cooperative interconnection of the bracket 110 with the cross-channels 104 which provide this feature of permitting cross bracing (with the cross-channels 104), without subjecting the main structural rails 102 to significant mechanical loads.

Another primary aspect of the structural interconnections among the main structural channel rails 102, cross-channels 104 and suspension brackets 110 should also be emphasized. As previously described herein, and as particularly illustrated in FIG. 15, the first suspension bracket section half 200 is coupled to the second suspension bracket section half 202 through the releasable interconnection of the U-shaped legs 206 and arcuate arms 208 associated with each of the section halves 200, 202. With this type of coupling configuration, any mechanical loads which would be placed downwardly on the horizontally disposed feet 226, or otherwise be exerted on the suspension bracket section halves 200, 202 in a downward or laterally outward direction, will actually cause the section halves 200, 202 to exert opposing forces on each other, at least partially through the coupling of the U-shaped legs 206 and arcuate arms 208. That is, for example, reference can be made to the view of the suspension bracket section halves 200, 202 in FIG. 15. If downwardly or outwardly directed forces are exerted on the horizontally disposed foot 226 of the first suspension bracket section half 200, the section half 200 will exert, through the coupling of its arcuate arm 208 with the U-shaped leg 206 of the section half 202, and the coupling of the U-shaped leg 206 of the section half 200 with the arcuate arm 208 of the section half 202, forces which will be “pulling” the section half 202 to the left as viewed in FIG. 15. Correspondingly, if downwardly or outwardly directed forces are exerted on the horizontally disposed foot 226 of the suspension bracket section half 202, forces would be exerted on the suspension bracket section half 200, again through the U-shaped legs 206 and arcuate arms 208 of the section halves 200, 202, which would correspond to “pulling” forces on the section half 200 to the right as viewed in FIG. 15. Accordingly, loads exerted on the section halves 200, 202 of the suspension bracket 110, either directly or through loads associated with cross-channels 104 and application devices supported therefrom, will act so as to “increase” the “coupling forces” between the two section halves 200, 202. This is particularly advantageous if substantial loads are exerted on the feet 226 of the suspension bracket 110.

The cross-channels 104 can take the form of any of a number of well known and commercially available structural building and framing components. For example, one product which may be utilized for the cross-channels 104 is marketed under the trademark UNISTRUT®, and is manufactured by Unistrut Corporation of Wayne, Mich. Whatever components are utilized for the cross-channels 104, they must meet certain governmental and institutional regulations regarding structural bracing parameters.

The foregoing describes a substantial number of the primarily mechanical components associated with the structural channel system 100. The structural channel system 100 includes means for distributing power (both AC and DC) and communication signals throughout a network which is enmeshed with the mechanical components, or structural grid 172, of the structural channel system 100. For purposes of describing the structural channel system 100, another term will be utilized. Specifically, reference will be made to the “electrical network 530” or “network 530.” The network 530 can be characterized as all of the electrical components of the structural channel system 100 as described in subsequent paragraphs herein. As will be apparent from subsequent description herein, the electrical network 530, like the structural grid 172, can be characterized as an “open” network, in that additional components (including modular plug assemblies, power entry boxes, connector modules, application devices, and other components as subsequently described herein) can be added to the entirety of the electrical network 530.

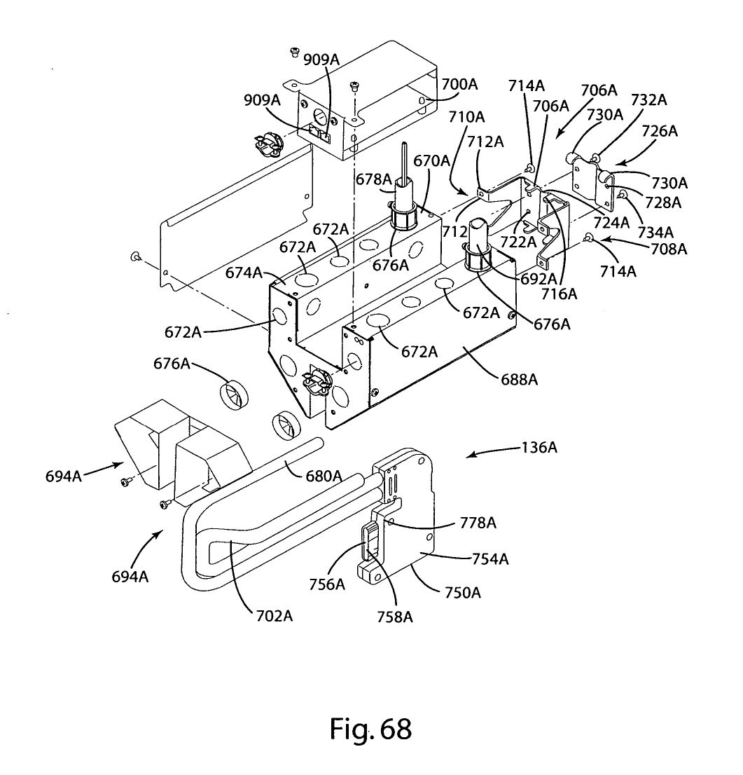

To provide the electrical network 530, the structural channel system 100 includes means for receiving incoming building power and distributing the power across the structural grid 172. Also, so as to provide for programmability and reconfiguration of control/controlling relationships among application devices, the structural channel system 100 also includes means for generating and receiving communication signals throughout the grid 172. To provide these features, the structural channel system 100, as will be described in subsequent paragraphs herein, comprises power entry boxes 134, power feed connectors 136, modular plug assemblies 130 having modular plugs 576, receptacle connector modules 144, dimmer connector modules 142, power drop connector modules 140, flexible connector assemblies 138 and various patch cords and other cabling. In addition, the components also include, for example, a number of different types of switches. These include, but are not limited to, dimmer switch 839, pull chain switch 917, motion sensing switch 921 and several other types of switches. Still further, components associated with the structural channel system 100 can include junction boxes 855. These components are in addition to the cableways 120 and wireways 122, previously described herein, which carry power cables 166 and 164, respectively. In addition to the foregoing, a somewhat preferred embodiment of a power entry box and power box connector will also be subsequently described herein, and identified as power entry box 134A and power box connector 136A, as illustrated in FIGS. 68-71.

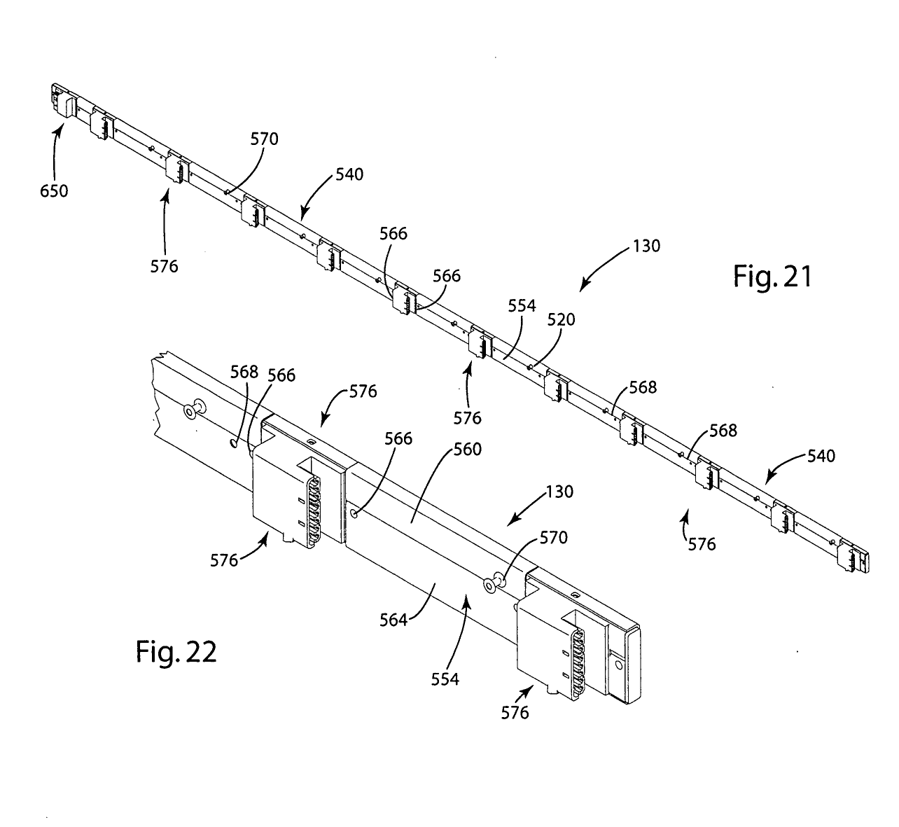

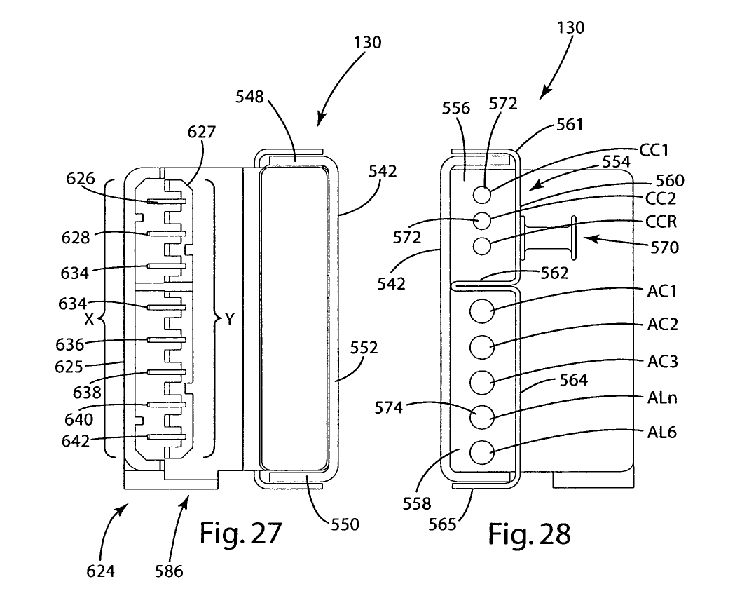

Turning more specifically to the components of the electrical network 530, these components include one or more modular plug assemblies 130, a length of which is illustrated and described herein with respect to FIGS. 21-30. Each length of the modular plug assembly 130 will be mechanically interconnected to a main structural channel rail 102, so as to be mechanically distributed throughout the structural grid 172. The modular plug assembly 130 provides means for distributing power and communication signals throughout the electrical network 530, and for providing network distribution for communication signals in the form of programming and data signals applied among connector modules associated with application devices. In addition to the use of the modular plug assemblies 130 with the main structural channel rails 102, it is also possible to couple the modular plug assemblies 130 to other building structures, such as walls, vertical partitions or the like. That is, as will be apparent from further description herein, the concepts associated with use of the modular plug assemblies 130 are not limited to use with the structural grid 172, but instead can be used in what can be characterized as a “stand alone” configuration or “stand alone” base. With reference first primarily to FIGS. 23 and 27, the modular plug assembly 130 includes elongated modular plug assembly sections 540, one of which is illustrated in FIG. 23. As described in subsequent paragraphs herein, individual plug assembly sections 540 may be mechanically connected to lengths of the main structural channel rails 102, and electrically interconnected together through the use of flexible connector assemblies. With reference primarily to FIGS. 23 and 27, the elongated power assembly section 540 includes an elongated power assembly cover 542. The cover 542 has a cross sectional configuration as primarily shown in FIG. 27. The cover 542 includes a cover side panel 552 which will be vertically disposed when the modular plug assembly section 540 is secured within the structural channel system 100. Integral with the cover side panel 552 and curved inwardly therefrom is an upper section 548, having a horizontally disposed configuration relative to the side panel 552. Extending inwardly from the lower portion of the side panel 552 and integral therewith is a lower section 550, again as shown in FIG. 27. As shown primarily in FIG. 23, a first set of through holes 544 are spaced apart and extend through the cover side panel 552. Correspondingly, a second set of through holes 546 are also spaced apart and extend through the cover side panel 552. The power assembly cover 542 is utilized to provide an outer cover for individual lengths of the elongated modular power assembly sections 540, when the modular power assembly 130 is coupled to the main structural channel rails 102.

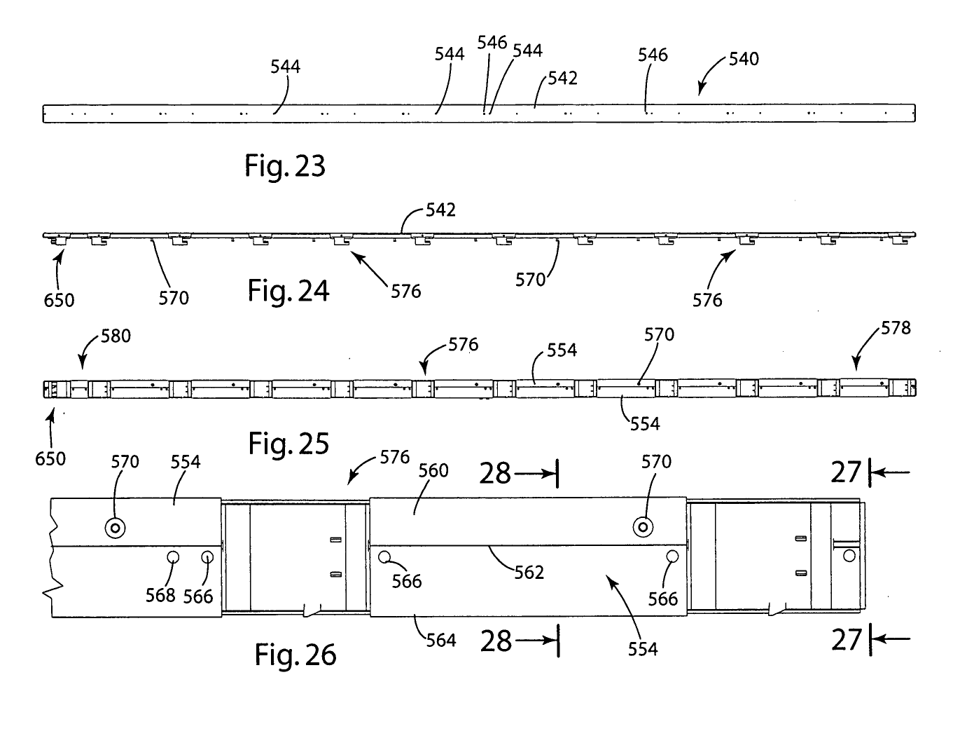

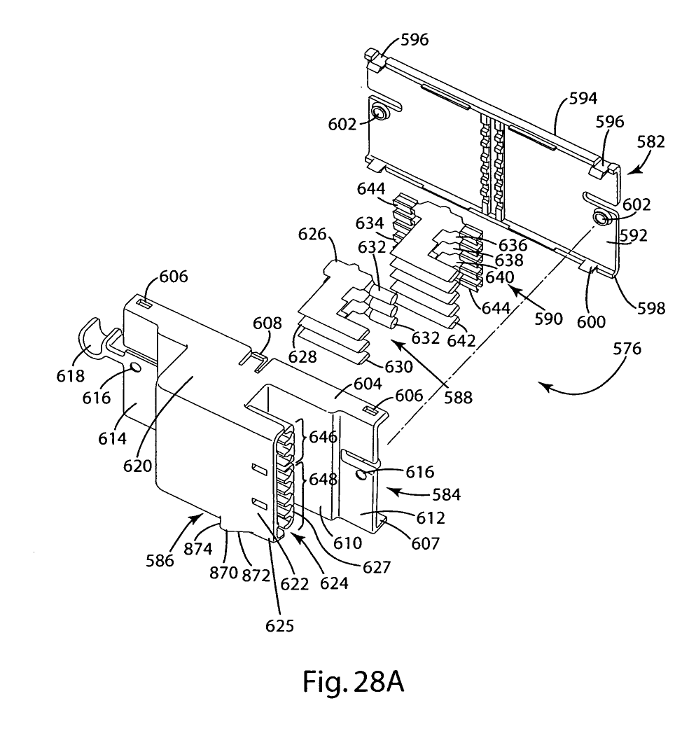

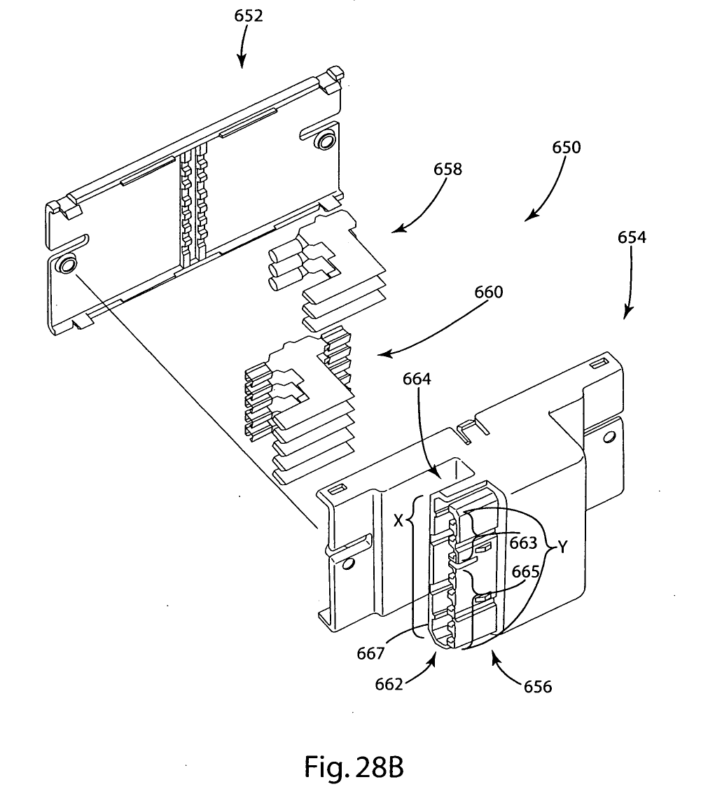

The sections 540 of the modular plug assembly 130 also include what are characterized as principal electrical dividers 554. FIG. 28 illustrates a cross sectional view of the divider 554. With reference primarily to FIGS. 22, 26 and 28, the principal electrical dividers 554 are utilized to provide an inner side of the modular plug assembly sections 540, and to also form channels for carrying communication cables and AC power cables, with electrical isolation therebetween. With reference to the drawings, each principal electrical divider 554 includes an upper communications channel 556. The purpose of the channel 556 is to carry communications cables 572, described in subsequent paragraphs herein. The upper communications channel 556 is formed by an upper inner side panel 560 integral with an upper section 561 which is horizontally disposed and curves outwardly from the side panel 560. Also integral with and extending perpendicularly and outwardly from the upper inner side panel 560 at the lower portion thereof (see FIG. 28) is an inwardly directed divider tongue 562. The inwardly directed divider tongue 562 separates the upper communications channel 556 and the lower AC power channel 558. The divider tongue 562 curves outwardly on itself. Integral with and extending downwardly from the divider tongue 562 is a lower inner side panel 564. The lower inner side panel 564 terminates at its lower portion with an integrally formed and perpendicularly curved lower section 565. For purposes of connection of the principal electrical divider 554 with the power assembly cover 542, screw holes 568 extend through the lower inner side panel 564. These holes align with a second set of through holes 546 in the plug assembly cover 542. Pan head or similar screws (with locking nuts) may be utilized for interconnection. Also extending through the lower inner side panel 564 are a set of through holes 566. These holes 566 are aligned with the first set of through holes 544 in the plug assembly cover 542. Rivets or similar connecting means may be utilized with these holes, for purposes of interconnecting the electrical dividers 554, plug assembly cover 542 and modular plugs 576 as described in subsequent paragraphs herein.

In addition to the foregoing components of the principal electrical dividers 554, the dividers 554 also include a series of spaced apart ferrules 570. The ferrules 570 are best viewed in FIGS. 22 and 28. As described in subsequent paragraphs herein, the ferrules 570, which may be secured to the upper inner side panels 560 of the electrical dividers 554 in any suitable manner, function so as to provide for coupling of connector modules (described in subsequent paragraphs herein) to the modular plug assembly sections 540. The ferrules 570 have a stool or mushroom-shaped configuration, as principally shown in FIG. 28.

The electrical dividers 554 have been referred to herein as the “principal” electrical dividers. The reason for this designation is that electrical dividers having a substantially similar configuration as the electrical dividers 554, but differing in length, are utilized at opposing ends of the modular plug assembly sections 540. As illustrated in FIG. 25, the modular plug assembly section 540 includes what can be characterized as a right-hand electrical divider 578. The right-hand electrical divider 578 has somewhat of a shorter length than each of the principal electrical dividers 554. In this regard, the principal electrical dividers 554 are preferably each of equal length. The modular plug assembly section 540 also includes what can be characterized as a left-hand electrical divider 580. This divider is of a still shorter length, relative to the right-hand electrical divider 578 and the principal electrical dividers 554. Each of the electrical dividers 578, 580 has a structural configuration substantially similar to the principal electrical dividers 554.

As earlier stated, the modular plug assembly sections 540 will carry a set of communications cables 572, and a set of AC power cables 574, as shown in cross section in FIG. 28. The structural channel system 100, in its entirety, is adapted to distribute at least AC power and communication signals throughout the electrical network 530, which is enmeshed with the mechanical components of the structural channel system 100. As will be described in subsequent paragraphs herein, the electrical network 530 includes means for receiving building power, distributing power and communication signals throughout the structural grid 172 and the electrical network 530, and providing power, reconfiguration and programmability to application devices interconnected into the electrical network 530. To provide for the distribution of power and communication signals, and as also earlier mentioned herein, the modular power assembly 130 includes a series of communication cables 572 which are carried in the upper communications channel 556 along the length of each of the elongated modular plug assembly sections 540. These communication cables 572 are utilized to carry digital communication signals throughout the electrical network 530, for purposes of providing programmability of connector modules associated with application devices, and reconfiguration of control and controlling relationships among the application devices.

Also, in a somewhat modified embodiment of the structural channel system 100, the communication cables 572 can be utilized to carry not only communication signals, but also low voltage DC power. This concept of utilizing the communication cables 572 for DC power as well as communication signals, will be described subsequently herein. It may be mentioned at this time that the signals carried on the communication cables 572 will operate so as to provide for a distributed, programmable network, where modifications to the control relationships among various application devices can be reconfigured and reprogrammed at the physical locations of the application devices themselves, as attached to the network 530. In this regard, and as also subsequently described herein, the network 530 includes not only the communication cables 572, but also connector module means having processor circuitry responsive to the communication signals, so as to control application devices coupled to the connector module means. Also, means will be described herein with respect to connecting communication cables 572 associated with one section 540 of the modular plug assembly 130, to an adjoining or otherwise adjacent section 540 of the plug assembly 130.

At this point in the description, it is worthwhile to more specifically describe one configuration which may be utilized with the communication cables 572, along with nomenclature for the same. It should be emphasized that this particular cable configuration and nomenclature is only one embodiment which may be utilized with the structural channel system 100. Other communications cable configurations may be utilized. Also, as described subsequently herein, the communications cables 572 and network 530 may be modified so as to carry not only communication signals, but also DC power.

Specifically, reference is made to FIG. 28, which illustrates three communication cables 572. For purposes of identification and description, the communications cables 572 as illustrated in FIG. 28 are referenced in FIG. 28 (and elsewhere in the specification) as communication cables CC1, CC2 and CCR. In the particular embodiment described herein, the communication cables CC1 and CC2 may be utilized to carry communications signals in what is commonly referred to as a “differential configuration.” Such a signal carrying arrangement may be contrasted with what is often characterized as “single ended configuration.” With differential configurations for electrical signals, wire or cable pairs are utilized for each electrical signal. In this case, the cable pair CC1 and CC2 will be utilized for the communications signals applied through the network 530. The concept of differential configurations is relatively well known in the electrical arts. The use of cable pairs for carrying communication signals, as opposed to single-ended configurations, provides for relatively high immunity to noise and cross-talk. With this configuration, the “value” of the signal at any given time is the instantaneous algebraic difference between the two signals. In this regard, the communication signals carried on CC1 and CC2 may be distinguishable from the single-ended configuration, where the signals are represented by one active conductor and signal ground. The communications cable 572 which is identified as cable CCR is characterized as the “return” cable. The return cable CCR essentially provides for a return line for communications associated with the network 530. This return line cable CCR provides for appropriate grounding of the entirety of the DC portion of the network 530.

It should be stated that if a configuration is utilized which employed the communication cables 572 not only to carry communication signals, but also to carry DC power, one of the three communication cables 572 would be made to carry the communication signals for the network 530. Correspondingly, another one of the cables 572 would be made to carry DC power for various network components associated with the distributed network 103. Such DC power transmitted along one of the communication cables could be used, for example, to power microprocessor elements and the like within various connector modules as described subsequently herein. Further, even if DC power is carried by the communication cables 572, one of the communication cables 572 would still preferably be utilized as a “return” cable. This cable would be utilized to provide a return line not only for the communication signals associated with the network 530, but also for the DC power carried along the communication cables 572.

As will be made apparent herein, the communication cables CC1 and CC2 are of primary importance with respect to the distributed network 530. The communication cables CC1 and CC2 will carry data, protocol information and communication signals (collectively referred to herein as “communications signals”) throughout the network 530 of the structural channel system 100, including transmission to and from connector modules. For example, and as described subsequently herein, the communication cables CC1 and CC2 may carry data or other information signals to electronic components within a connector module, so as to control the application within the connector module of AC power to an electrical receptacle. Again, it should be noted that signals on communication cables CC1 and CC2 may be in the form of data, protocol, control or other types of digital signals.

In addition to the communication cables 572, the sections 540 of the modular plug assembly 130 carry the AC power cables 574 within the lower AC power channel 558 of each section 540 of the plug assembly 130. For purposes of description, it is worthwhile to more specifically describe one configuration which may be utilized for the AC power cables 574, along with nomenclature for the same. It should be emphasized that this particular AC power cable configuration and nomenclature is only one embodiment which may be utilized with the structural channel system 100 in accordance with the invention. Other AC cable configurations may be utilized. More specifically, reference is made to FIG. 28, which illustrates the AC power cables 574. In the example embodiment shown in FIG. 28, the AC power cables 574 are five in number, and are identified as AC cables AC1, AC2, AC3, ACN and ACG. With a five cable (or as commonly referred to, “five wire”) configuration for AC power, it is known that such a configuration can provide three separate circuits, with the circuits utilizing a common neutral and common ground. In this particular AC power cable configuration utilized with the structural channel system 100, AC1, AC2 and AC3 are designated as the “hot” cables. ACN is neutral cable, and ACG is a common ground cable. In accordance with the foregoing, if a user wished to “tap off” the AC power cables 574, so as to provide a single AC circuit with three wires, the user would connect to ACN and ACG, and then also connect to one of the hot cables AC1, AC2 or AC3. By advantageously providing the capability of selecting one of three AC circuits, the distributed network 530 associated with the structural channel system 100 can be effectively “balanced.”

In addition to the foregoing elements, the modular plug assembly 130 includes a series of modular plugs 576 coupled to each plug assembly section 540 and spaced apart on the same side of each section 540 as the side of the electrical dividers 554. The modular plugs 576 are actually spaced intermediate adjacent lengths of the electrical dividers 554. The modular plugs 576 function so as to electrically interconnect the communication cables 572 to connector modules (to be described herein). In this manner, communication signals can be transmitted and received between the connector modules and the communication cables 572. In addition, the modular plugs 576 also function to couple AC power from the AC power cables 574 to those connector modules which have the capability of applying power to various application devices.

One embodiment of a modular plug 576 is primarily illustrated in FIGS. 22, 26, 27 and 28A. With reference thereto, the modular plug includes a lid 582, inner panel 584, plug connector 586, communications male blade set assembly 588 and AC power male blade set 590. With reference first to the modular plug lid 582, and primarily referring to FIG. 28A, the plug lid 582 includes an outer and vertically disposed panel 592. The panel 592 includes a top edge 594, with a pair of upper tabs 596 located at opposing ends of the edge 594. A lower edge 598 extends along the bottom of the outer panel 592. A pair of downwardly projecting lower tabs 600 are located at opposing ends of the lower edge 598. A pair of rivet holes 602 are located at opposing sides of the outer panel 592. With reference to the inner panel 584, and again with reference to FIG. 28A, the inner panel 584 includes a side panel 610, with a top edge 604 running therealong. On opposing sides of the top edge 604 are a pair of slots 606. When assembled, the upwardly projecting tabs 596 of the lid 582 will snap into place within the slots 606. Although not shown in the drawings, slots similar to slots 606 are located at opposing sides of a lower edge 607 projecting inwardly from the bottom of the side panel 610. A tab 608 is located near the center portion of the top edge 604. When assembled, the upwardly projecting tab 608 will be captured under the top edge 594 of the outer panel 592 of lid 582.

Extending laterally outward from opposing sides of the side panel 610 are a pair of recessed panels, identified as right hand recessed panel 612 and left hand recessed panel 614. The references to “right hand” and “left hand” are arbitrary. Extending through both the right hand recessed panel 612 and left hand recessed panel 614 are a pair of rivet holes 616. Extending outwardly from the left hand recessed panel 614 is a screw bail 618.

Referring now to the plug connector 586, and again primarily with reference to FIG. 28A, the plug connector 586 includes a lateral portion 620 in the form of a housing extending outwardly from the side panel 610. Integral with and extending perpendicularly to the lateral portion 620 is a right angled section 622. Correspondingly, extending outwardly from a terminating end of the right angled section 622 is a modular plug male terminal set housing 624. The housing 624 has a cross sectional configuration as shown primarily in FIGS. 27 and 28A. As further shown in these drawings, the housing 624 includes a first side wall 625 and an opposing second side wall 627. The first side wall 625 has an elongated C-shaped configuration, with a height X as shown in FIG. 27. Correspondingly, the second side wall 627 has a “reversed C-shaped” (as viewed in FIG. 27) configuration, with a height Y, which is less than height X. The side walls 635, 627 are sized and configured so that the housing of a connector with a “reversed” configuration of the side walls 625, 627 would “mate” with the housing 624 shown in FIG. 27.

In addition to the lid 582, inner panel 584 and plug connector 586, the modular plug 576 further includes a series of three male communication blade terminals, identified as blade terminals 626, 628 and 630. Attached to each of the three blade terminals 626, 628 and 630 is a crimp connector 632. Each crimp connector 632 is coupled to a different one of the communications cables 572 (not shown in FIG. 28A). The crimp connectors 632 are typically referred to as “insulation displacement crimps.” Typically, for various types of electrical components, one or two insulation displacement crimps may be utilized. With this coupling connection, the crimp connectors 632 will cause the communication cables 572 to each be conductively connected to one of the communications blade terminals 626, 628 or 630. For example, the communications blade terminal 626 may be conductively connected to the communications cable 572 previously designated as CC1. Correspondingly, male blade terminal 628 may be conductively connected to cable CC2. Male blade terminal 630 may be connected to cable CCR. The communications male blade set 588 may then be appropriately positioned within the modular plug 576 so that the terminating ends of the communications blades 626, 628 and 630 extend outwardly and into the modular plug male terminal set housing 624. With this assembly, the portion of the housing 624 which is identified as communications terminal set 646 will have the blades extending therefrom and connected to differing ones of the communications cables 572.

In addition to the communications cable male blade set 588, the modular plug 576 also includes the AC power male blade set 590. As shown primarily in FIG. 28A, the AC power male blade set 590 has a configuration substantially similar to that of the communications male blade set 588. The male blade set 590 includes a series of terminal blades, identified as blades 634, 636, 638, 640 and 642. Extending laterally outward from opposing sides of the base of each blade is a pair of crimp connectors 644. The crimp connectors 644 will be utilized to electrically and conductively interconnect each of the individual blades of the male blade set 590 to different ones of the AC power cables 574. For purposes of clarity, neither the communication cables 572 nor the AC power cables 574 are illustrated in FIG. 28A. More specifically, the male blade terminal 634 will be conductively connected through its pair of crimp connectors 644 to AC power cable AC1. Correspondingly, blade 636 will be conductively connected to AC power cable AC2. Blade 638 will be conductively connected to AC power cable AC3. Blade 640 will be connected to AC power cable ACN, while blade 642 will be connected to AC power cable ACG.

For assembly of the modular plug 576, the communications male blade set 588 can be inserted and secured by any suitable means to the inner panel 584. This assembly occurs so that the individual blades 626, 628 and 630 of the communication male blade set 588 extend into the right-angled section 622 of the plug connector 586. These blades extend into the upper three terminal openings of the plug connector 586, identified in FIG. 28A as the communications terminal set 646. Correspondingly, the AC power male blade set 590 is assembled with the inner panel 584 so that the individual blades of the set 590 extend outwardly into the lower five terminal openings of the modular plug male terminal set housing 624, identified as AC power terminal set 648, again illustrated in FIG. 28A. As shown primarily in FIG. 27, the male terminal set housing 624 can include a terminal set divider 649 extending therethrough, for purposes of isolation of the communication male blade set 588 from the AC power male blade set 590 when assembled into the housing 624. The lid 582 can then be coupled to the inner panel 584, with the blade sets 588 and 590 secured to the inside of the lid 582 by any suitable means. To secure the lid 582 to the inner panel 584, the upper tabs 596 of the lid 582 are secured within the slots 606 of the inner panel 584. Correspondingly, the tabs 608 at the upper portion of the inner panel 584 are secured under the top edge 594 of the lid 582. Lower tabs 600 of the lid 582 are secured within slots (not shown) on the lower edge 607 of the inner panel 584.

As illustrated primarily in FIGS. 21, 22, 26 and 28, the right hand recessed panel 612 of the inner panel 584 and the left hand recessed panel 614 of the panel 584 are positioned so that they are received “behind” adjacent ones of the principal electrical dividers 554. With this positioning, rivets can be secured through the through holes 566 (of the electrical divider 554), 616 (of the inner panel 584), 602 (of the lid 582), and holes 544 in the power assembly cover 542. As also earlier stated, during assembly, the AC power cables 574 will be extended through crimp connectors 644 of the AC power male blade set 590. Correspondingly, communication cables 572 will be extended through the crimp connectors 632 of the communications male blade set 588. In accordance with the foregoing, the individual modular plugs 576 can be assembled into the modular plug assembly 130.

In addition to the modular plugs 576 which are spaced apart and used along the sections 540 of the modular plug assembly 130, a somewhat modified plug is utilized at one end of each elongated modular plug assembly section 540. This plug is identified as a distribution plug 650, and is illustrated in an exploded view in FIG. 28B. The distribution plug 650 is also illustrated in an assembled format within a section 540 of the modular plug assembly 130 in FIGS. 21, 24 and 25. As described subsequently herein, the distribution plug 650 will be utilized, in combination with the flexible connector assembly 138, to electrically couple together adjacent sections 540 of the modular plug assembly 130. As earlier stated, the distribution plug 650 is substantially similar to the previously described modular plug 576. Accordingly, the distribution plug 650 will not be described in substantial detail. Instead, with reference to FIG. 28B, only the main components of the plug 650 will be described. Assembly of these components occurs in the same manner as assembly of similar components for the modular plugs 576.

The distribution plug 650 includes a lid 652 (substantially corresponding to the lid 582 of the plug 576). For purposes of interconnection of terminal components to communications cables 572 and AC power cables 574, the distribution plug 650 also includes a communications male blade set 658, and an AC power male blade set 660. Connected to or otherwise integral with the inner panel 654 is a plug connector 656, substantially corresponding to the plug connector 586 of the modular plug 576. An angled section 662 extends in a substantially parallel alignment with the inner panel 654. Correspondingly, extending outwardly from a terminating end of the angled section 662 is a distribution plug male terminal set housing 664.

For assembly of the distribution plug 650, the communications male blade set 658 can be inserted and secured by any suitable means to an inner panel 654 (corresponding to the inner panel 584 of modular plug 576). This assembly occurs so that the individual blades of the communication male blade set 658 extend into the angled section 662 of the plug connector 656. These blades extend into the upper three terminal openings of the plug connector 656, identified in FIG. 28B as the communications terminal set 663. Correspondingly, the AC power male blade set 660 which again comprises five blades, each connected to a different one of the AC power cables 574, is assembled within the inner panel 654 so that the individual blades of the set 660 extend outwardly into the lower five terminal openings of the distribution plug male terminal set housing 664. These lower five terminal openings are identified in FIG. 28B as the AC power terminal set 665. The lid 652 can then be coupled to the inner panel 654, with the blade sets 658 and 660 secured to the inside of the lid 652 by any suitable means. The lid 652 can then be secured to the inner panel 654, in a manner similar to the connection of the lid 582 to the inner panel 584 of the modular plug 576. The distribution plug 650 can then be secured to the end of a section 540 of the modular plug assembly 130, adjacent and attached to the left hand electrical divider 580 associated with the particular section 540.

As described in subsequent paragraphs herein, the distribution plug 650 will be utilized to secure the corresponding section 540 of the modular plug assembly 130 to one end of a flexible connector assembly 138. For this purpose, the distribution plug male terminal housing 664 has the configuration shown primarily in FIG. 28B. More specifically, the distribution housing 664 includes, like the modular plug housing 624, a first side wall 667, and an opposing second side wall 669. The first side wall 667 has an elongated C-shaped configuration, with a height X as shown in FIG. 28B. It should be noted that this configuration and height corresponds to the first side wall 625 of the plug connector 586 of the modular plug 576 as shown in FIGS. 27 and 28A. Correspondingly, the second side wall 669 has a “reversed C-shaped” (as viewed in FIG. 28B) configuration, with a height Y, which is less than height X. It should be noted that the second side wall 669 corresponds in structure and size to the second side wall 627 of the modular plug 576. With the entirety of the aforedescribed sizing and configuration of the side walls 667, 669 of the housing 664, if the modular plug housing 624 of the modular plug 576 (as shown in FIG. 28A) is brought into engagement with the distribution plug housing 664 of the distribution plug 650 (as viewed in FIG. 28B), the housings will, in fact, “mate.” Of course, both plugs 576 and 650 are carrying male terminals. In effect, the distribution plug housing 664 is essentially identical to a “reversal” of the modular plug housing 624. This concept becomes relevant in the use of the flexible connector assembly 138 in connecting together adjacent sections 540 of the modular plug assembly 130, in a manner such that the flexible connector assembly 138 is “unidirectional” and cannot be electrically engaged with the sections 540 in an incorrect manner. This concept is advantageous in providing for safety, proper assembly and conformance with governmental and institutional codes and regulations.

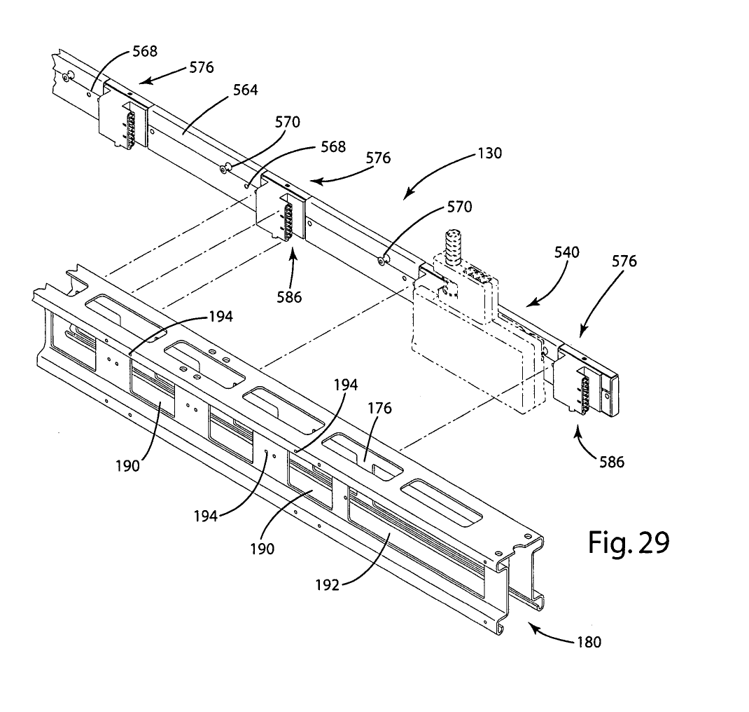

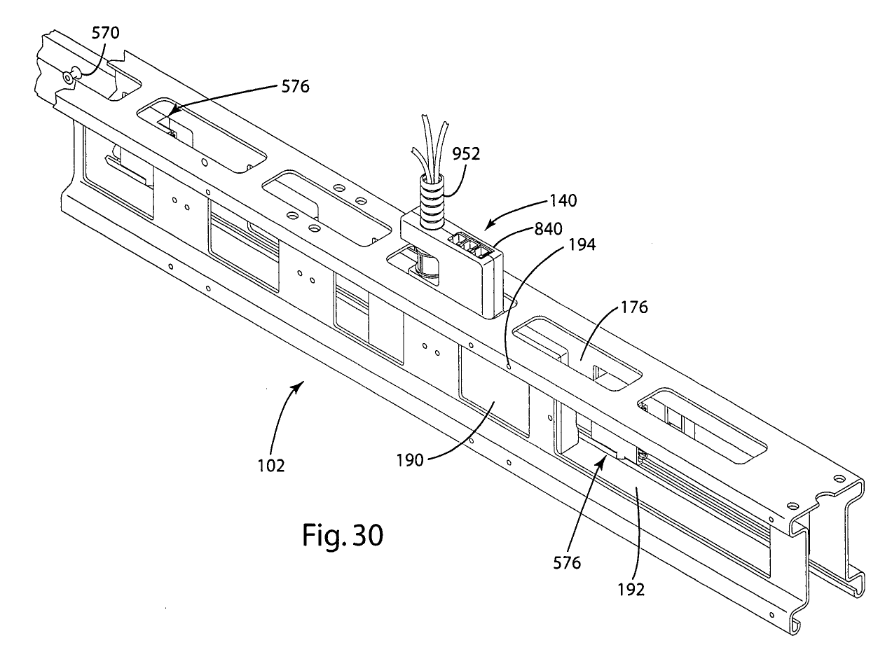

The modular plug assembly 130, comprising the individual sections 540, is secured to the main perforated structural channel rails 102, as primarily illustrated in FIGS. 29 and 30. With reference to these drawings, and also with reference to FIGS. 2 and 3, a section 540 of the modular plug assembly 130 is moved toward the side of a main perforated structural channel rail 102. The section 540 is assembled by positioning the plug assembly section 540 into the recessed areas of one of the side panels 180 of the structural channel rail 102. The modular plugs 576 are appropriately spaced apart so that they are aligned with the side plug assembly apertures 190 in the structural channel rail 102. With this alignment, the plug connectors 586 will be assembled through the side plug assembly apertures 190, so that they are secured within the spatial area formed between opposing side panels 180 (i.e. the left side panel 182 and the right side panel 184 as shown in FIGS. 2 and 3). The first modular plug 576 along a section 540 of the modular plug assembly 130 will be fitted into one of the elongated side-end apertures 192 of the rail 102. This elongated configuration of the aperture 192 permits sufficient room for coupling of this end modular plug 576 to a power box connector 136 as described in subsequent paragraphs herein. With this positioning of the section 540 of the modular plug assembly 130 relative to the corresponding section of the main structural channel rail 102, the two components can be secured together through self tapping screws (not shown) or similar means extending through holes 568 of the plug assembly 130 and holes 194 within the structural channel rail 102. It will be apparent that other types of connecting means may also be utilized for coupling the section 540 of the modular plug assembly 130 to the structural channel rail 102.

With the foregoing configuration, the modular plugs 586 are positioned so that the plug connectors 586 of the modular plugs 576 are positioned within the inner spatial area of the structural channel rail 102. Also, it is apparent that sections 540 of the modular plug assembly 130 can be positioned with in the inner spatial area of the structural channel rail 102 through both side panels 180 of the structural channel rail 102. In this manner, a pair of sections 540 of the modular plug assembly 130 can be within the spatial interior of the structural channel rail 102. Also, although not shown in FIG. 29 or 30, a distribution plug 650 (previously described with respect to FIG. 28B) will be positioned at the opposing end (not shown) of the end of the section 540 of the plug assembly 130 shown in FIG. 29. In accordance with the foregoing, this assembly now provides for a length of the structural channel rail 102 to have electrical terminals accessible at various positions along the structural channel rail 102, with these terminals electrically interconnected to the communication cables 572 and the AC power cables 574. Communication signals and AC power can therefore be distributed throughout the entirety of the electrical network 530, and the associated structural grid 172. With respect to both the modular plugs 576 and the distribution plugs 650, it may be appropriate to include “end caps” (not shown) so as to cover the housing ends of these plugs when not in use. Also, for purposes of aesthetics and safety, it may be worthwhile to include end caps at the ends of the sections 540 of the modular plug assembly 130.

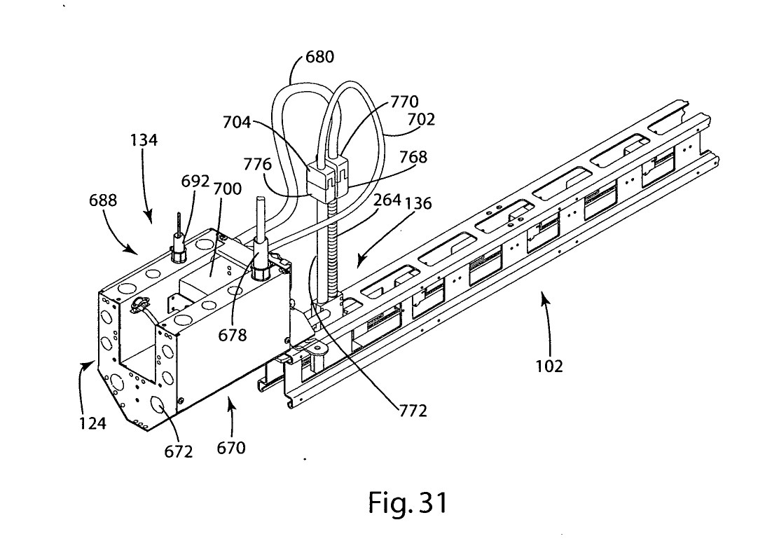

To this point in the description, various mechanical and electrical aspects of the structural channel system 100 have been described, including the modular plug assembly 130, carrying communication cables 572 and AC power cables 574. References were previously made to the AC power cables 574 and having the capability of carrying three separate AC circuits. References have also been made to components such as wireways 122, through which other AC power cables (such as 277 volt AC cables) may be carried. Cableways 120 have also been described, with the capability of carrying other types of electrical cables, such as low voltage DC power cables. In addition, reference has been made to the concept that the communications cables 572 may also have the capability of carrying low voltage DC power. Although the previously described components of the structural channel system 100 function to carry and transfer AC and DC power, and communications, throughout the entirety of the channel system 100, means have not yet been described as to how power is initially applied to the AC power cables 574, and may be applied to the communications cables 572. For this purpose, the components of the structural channel system 100 include means for receiving building electrical power from the building structure and, potentially, generating DC power from building power. This means for receiving, generating and distributing power may include a power entry box, such as the power entry box 134 primarily illustrated in FIGS. 31-34.

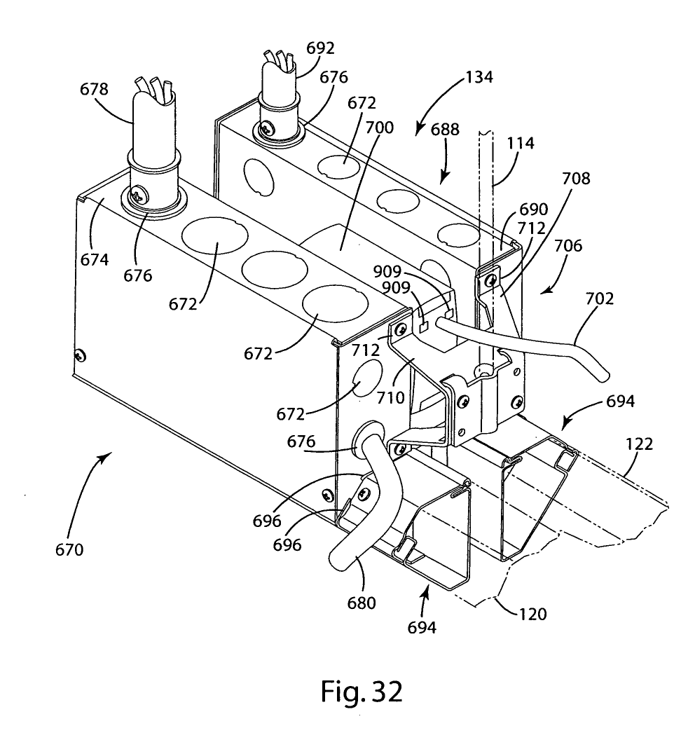

Prior to describing the power entry box 134, it should be noted that the inventors have determined that a potentially preferable structure of a power entry box may be utilized. For this reason, a second power entry box 134A (and associated power box connector 136A) is described in subsequent paragraphs herein with respect to FIGS. 68-71. However, it should be emphasized that either of the power entry boxes 134 or 134A, or other means for receiving, generating and distributing power throughout the network 530, may be utilized. Referring first to the power entry box 134, and with reference to FIG. 32, the power entry box 134 is adapted to receive AC power from sources external to the structural channel system 100. These sources may be in the form of conventional building power or, alternatively, any other type of power source sufficient to meet the power requirements of the structural channel system 100 and application devices interconnected thereto. Further, power sources of various amplitudes and wattage may be utilized. As an example, the power entry box 134 is illustrated as receiving both 120 volt AC power and 277 volt AC power from the building.

More specifically, the power entry box 134 shown in FIG. 32 comprises a 120 volt AC side block 670 having a substantially rectangular cross section. Knockouts 672 are provided in an upper surface 674. In the particular embodiment shown in FIG. 32, a cable nut 676 is secured to one of the knockouts 672 and to an incoming 120 volt AC cable 678. The cable nut 676 or other components associated therewith may provide strain relief for the incoming cable 678 and other power cables associated with the power entry box 134. Although not specifically shown in any of the drawings, the wires of the incoming 120 volt AC cable 678 may be directly or indirectly connected and received through an outgoing AC cable 680. Connected at the terminal end of the AC cable 680 is a standard 120 volt AC universal connector 682. The AC connector 682 is adapted to transmit power to a power box connector, such as the power box connector 136 illustrated in FIG. 31. Power box connector 136 will be described in subsequent paragraphs herein. In the configuration shown in FIG. 31, the power entry box 134 is mounted above the main structural channel rail 102, as also described in subsequent paragraphs herein. The 120 volt AC connector 682 is coupled to a corresponding AC connector 684. Connector 684 is connected to the terminating end of the AC power entry conduit 686 which, in turn, is coupled to the power box connector 136.

Referring back to FIG. 32, the power entry box 134 may also include a 277 volt AC side block 688, having a substantially rectangular cross sectional configuration. An upper surface 690 of the side block 688 includes a series of knockouts 672. Connected to one of the knockouts 672 is a cable nut 676. Also coupled to the cable nut 676 and extending into the side block 688 is a 277 volt AC cable 692. These conduit or cables 164 may carry relatively high voltage, such as 277 volt power, and thus may be connected, directly or indirectly, to the wires within the 277 volt AC cables 692.

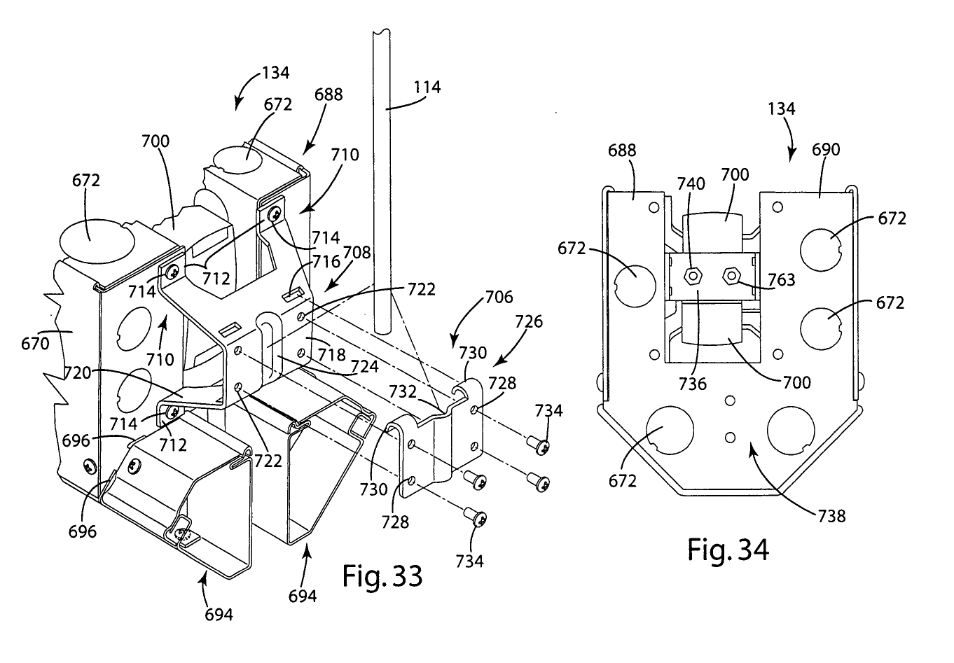

For purposes of maintaining shielding adjacent the power entry box 134, the power entry box 134 can include a pair of interconnected wireway segments 694. The wireway segments 694 can be formed with the same peripheral or cross sectional configuration as the wireways 122 previously described herein. In fact, each of the wireway segments 694 can be characterized as an extremely short length of a wireway 122. Accordingly, the individual parts of the wireway segments 694 will not be described herein, since they substantially conform to individual parts of wireways 122 previously described herein. However, for purposes of connecting the wireway segments 694 to the front portion of the power entry box 134, brackets 696 (partially shown in FIGS. 32 and 33) can be integrally formed at one end of each of the wireway segments 694. Screws or other similar connecting means (not shown) may then be utilized to connect the brackets 696 to the front cover of the power entry module 134, for purposes of securing the wireway segments 694 to the power entry box 134. To then connect one of the wireway segments 694 to a wireway 122 (depending upon the particular direction the power entry box 134 is facing along the main structural channel rail 102), a joiner 492 as previously described herein can be utilized. Further, it should be noted that the power entry box 134 includes a substantial number of knockouts 672. These knockouts 672 can be utilized not only for conduit or cables connected to incoming power through cables 678 and 692, but they can also be utilized to permit cables (such as cables 164) to extend completely through the power entry box 134. For example, cables associated with the cableways 120 may not be interconnected to any wiring or cabling associated with the power entry box 134, and may merely need to extend through the lower portion of the power entry box 134.

In addition to the foregoing, the power entry box 134 may also include a network circuit 700, situated between the 120 volt AC power side block 582 and the 277 volt AC power side block 688. The network circuit 700 may be utilized to provide various functions associated with operation of the communications portion of the electrical network 530. The network circuit 700 may include a number of components associated with the electrical network 530 and features associated with generation and transmission of communication signals. For example, each network circuit 700 may include transformer components, for purposes of utilizing AC power to generate relatively low voltage DC power. Also, the network circuit 700 can include repeater components for purposes of performing signal enhancement and other related functions. Corresponding transformer and repeater functions will be describe din greater detail herein, with respect to the board assemblies 826 associated with the connector modules 140, 142 and 144. Extending out of the housing which encloses the network circuit 700 is a pair of connector ports 909. The connector ports 909 may be in the form of conventional RJ11 ports. As will be explained subsequently herein with respect to the alternative power entry box 134A (and FIG. 71), the connector ports 909, in combination with patch cords (not shown), may be utilized to provide for daisy chaining of the electrical communications network 530 through the power entry boxes. Also, and again as subsequently described herein with respect to the alternative power entry box 134A, patch cords in the form of “bus end” patch cords may be used with the connector ports 909 of first and last power entry boxes within a chain.

As earlier mentioned, the communications portion of the network 530 utilizes communication signals on cables CC1, CC2 and CCR. Further, in one embodiment, the communication signals can be carried on cables CC1 and CC2 in a “differential” configuration, while cable CCR carries a return signal. With the use of differential signal configurations, and as subsequently described herein, individual low voltage DC power supplies or transformers will be associated with connector modules and other elements associated with the network 530, where DC power is required.

However, as an alternative to having these individual DC power supplies associated with the connector modules, the network circuit 700 could include conventional AC/DC converter circuitry. Such converter circuitry could be adapted to receive AC power tapped off the 120 volt AC cables 678. The AC power could then be converted to low voltage DC power and applied as an output of the converter to a conventional DC cable 702. The DC cable 702 could be conventionally designed and terminate in a conventional DC connector 704. Such an alternative is still within the principal concepts of the invention as embodied within the structural channel system 100. A configuration utilizing AC/DC converters within power entry boxes is disclosed in U.S. Provisional Patent Application entitled “POWER AND COMMUNICATIONS DISTRIBUTION SYSTEM USING SPLIT BUS RAIL STRUCTURE” filed Jul. 30, 2004, and incorporated by reference herein.

In the configuration of the power entry box 134 illustrated in FIGS. 31-34, the cable 702 is shown as extending out of the housing comprising the network circuit 700, and will be characterized herein as the power box communications cable 702. As shown in FIG. 31, the power box communications cables 702 terminates in a conventional DC or digital connector 704.

The conventional connector 704 is directly connected to a connector 776 and connector cable 772 associated with the power box connector 136. These components will be described in subsequent paragraphs herein. As earlier described, the power entry box 134 is adapted to be positioned above a length of the main structural channel rail 102, as primarily illustrated in FIG. 31. The power entry box 134 essentially “rests” on the upper portion of the main rail 102. To secure the power entry box 134 in an appropriate position, the box 134 is connected to the grid 172 through a connector 706, as primarily shown in FIGS. 32 and 33. In these illustrations, FIG. 33 is somewhat of an exploded view of the connector 706. With reference thereto, the connector 706 includes a support brace 708 having a size and configuration as illustrated in the drawings. The support brace 708 includes a pair of spaced apart upper legs 710 which angle upwardly and terminate in feet 712. The support brace 708 is connected at its upper end to the side blocks 670 and 688 through screws 714 extending through holes in the feet 712 and in the side blocks 670, 688. As also shown primarily in FIG. 33, the upper legs 710 include a pair of spaced apart slots 716. Integral with the upper legs 710 and extending downwardly therefrom is a central portion 718. Integral with the lower edge of the central portion 718 are a pair of spaced apart lower legs 720, only one of which is illustrated in FIG. 33. As with the upper legs 710, the lower legs 720 also include feet 712. Screws 714 extend through threaded holes (not shown) in the feet 712 of the lower legs 720, and connect to the front walls of the side blocks 670 and 688.

Returning to the central portion 718, a series of four threaded holes 722 extend therethrough in a spaced apart relationship. The central portion 718 also includes a vertically disposed groove 724 extending down the center of the central portion 718. The connector 706 also includes a bracket 726, primarily shown in FIG. 33. The bracket 726 has a series of four threaded holes 728. A pair of spaced apart upper lips 730, having a downwardly curved configuration, extend upwardly from the bracket 726. The bracket 726 also includes a vertically disposed groove 732 positioned in the center portion of the bracket 726.

To couple the power entry box 134 to the structural grid 172, the power entry box 134 can be positioned above a corresponding main structural channel rail 102 as primarily shown in FIG. 31. With reference to FIG. 33, the power entry box 134 can be positioned so that one of the threaded support rods 114 is partially “captured” within the groove 724 of the support brace 708. When the appropriate positioning is achieved, the bracket 726 can be moved into alignment with the central portion 718 of the support brace 708. In this aligned position, the threaded support rod 114 is also captured by the groove 732 and the bracket 726. Also with this position, the threaded holes 722 in the central portion 718 will be in alignment with the threaded holes 728 in the bracket 726. Also, to readily secure the bracket 726 to the support brace 708, the upper lips 730 of the bracket 726 are captured within the slots 716 of the brace 708. Correspondingly, screws 734 are threadably received within the through holes 728 and through holes 722 of the bracket 726 and support brace 708, respectively. In this manner, the threaded support rod 114 is securely captured within the grooves 724 and 732. The supported positioning of the power entry box 134 is illustrated in FIG. 31.

With respect to interconnections of other elements of the power entry box 134, attention is directed to FIG. 34, which illustrates a rear view of the power entry box 134. A rear wall 738 of the power entry box 134 may include knockouts 672, for purposes of extending cables and conduit therethrough. Also, for purposes of securing the network circuit 700, a rear mounted cross bracket 736 can be integral with or otherwise connected to sides of the side blocks 670 and 688. This cross bracket 736 can then be secured to the rear portion of the network circuit 700, through the use of bolt and hex nut combinations 740 or similar connecting means.

In accordance with the foregoing, a component of the structural channel system 100 has been described which serves to receive power from sources external to the structural channel system 100, and apply AC power to the AC power cables 574. Correspondingly, the power entry box 134 can include circuitry for communication signals applied through the electrical network 530 on communication cables CC1, CC2 and CCR. Also, as described subsequently herein with respect to an alternative embodiment of a power entry box 134A, the power entry boxes can be utilized for purposes of “daisy chaining” so as to provide for interconnection of communication signal paths throughout the network 530. In the particular embodiment of the structural channel system 100 described herein, the AC power and communication signals from the power entry box 134 are applied to the appropriate cabling through a power box connector 136, as subsequently described herein.

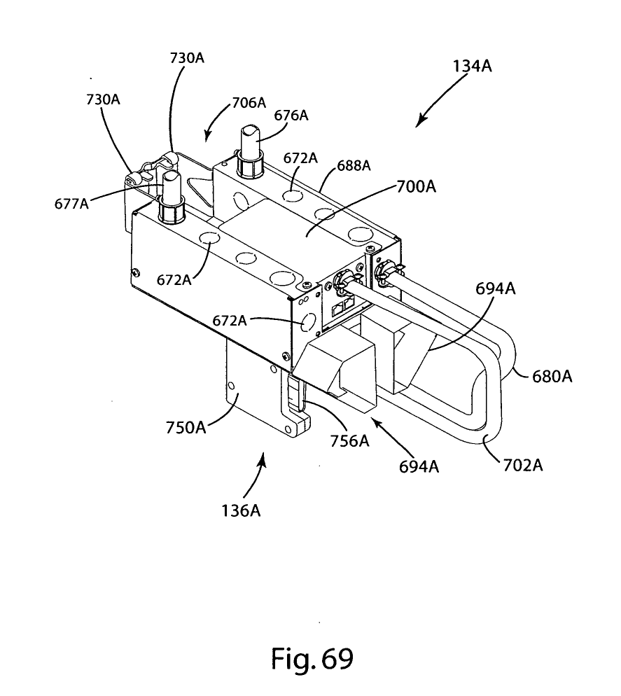

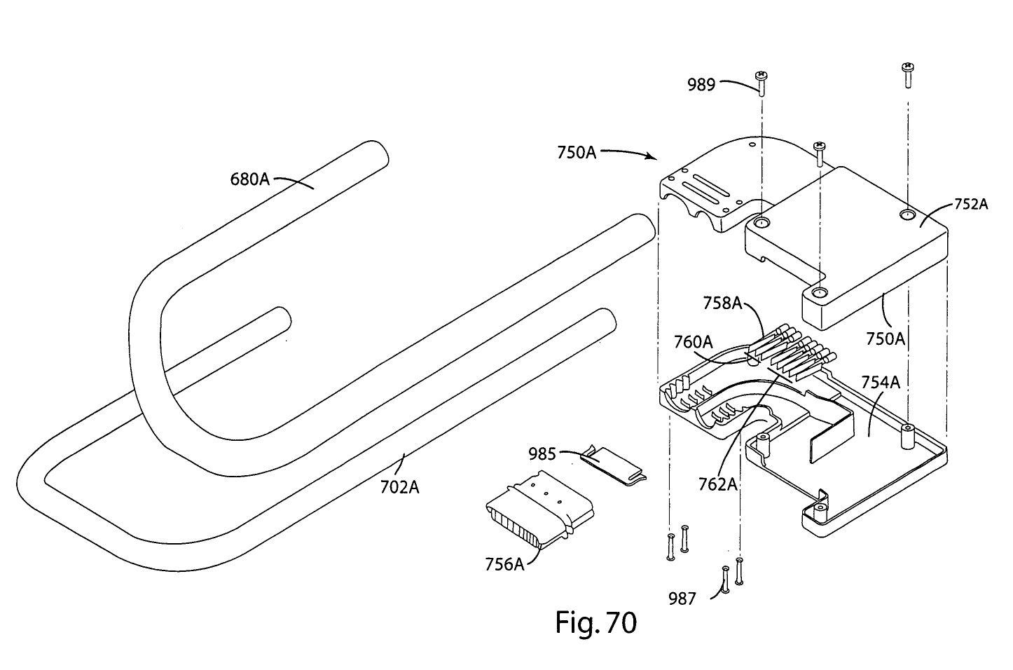

More specifically, the power entry box 134 is electrically coupled to the power box connector 136. The power box connector 136 provides a means for receiving AC power from the building through the power entry box 134, and applying the AC power to an elongated plug assembly section 540 of the modular power assembly 130. The power box connector 136 also provides means for connecting the network circuit 700 from the power entry box 134 to the communication cables CC1, CC2 and CCR associated with an elongated plug assembly section 540 of the modular power assembly 130. Although the power box connector 136 represents one embodiment of a means for providing the foregoing functions, it will be apparent that other types of power box connectors may be utilized, without departing from the principal novel concepts of the invention. In fact, an alternative and somewhat preferred embodiment of a power box connector which may be utilized is subsequently described herein and illustrated as power box connector 134A in FIGS. 69 and 70.

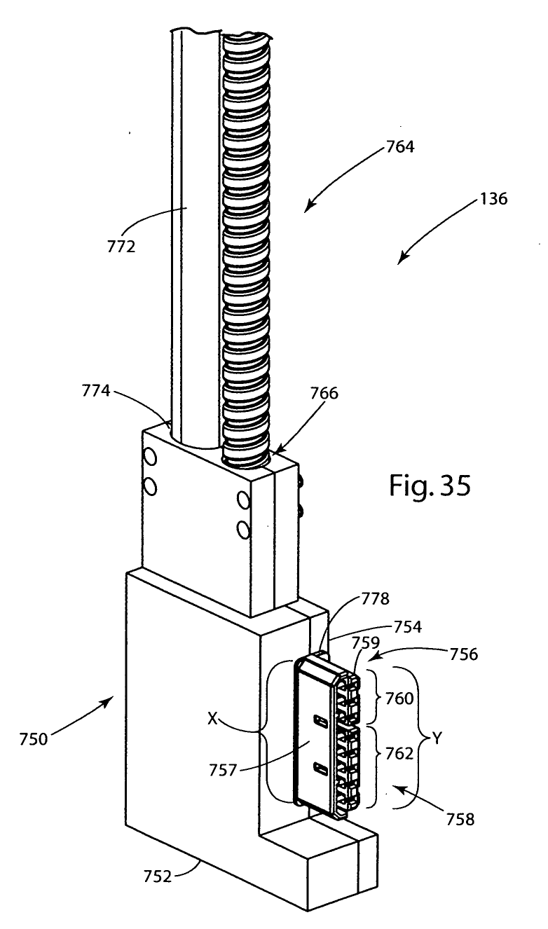

Turning primarily to FIGS. 31 and 35, and first with reference to FIG. 35, the power box connector 136 comprises a base housing 750, which will be located within a main structural rail 102 and adjacent a plug assembly section 540 when installed. The base housing 750 includes a relatively conventional main body 752, secured to an outer cover 754. Extending outwardly from a slot 778 formed within one end of the main body 752 is a connector housing 756, again as primarily shown in FIG. 35. The connector housing 756 is formed such that it includes a first side wall 757 and a second side wall 759. The first side wall 757, as viewed in FIG. 35, has an elongated C-shaped cross-sectional configuration, with a height X. The second side wall 759, also as viewed in FIG. 35, has a “reverse” elongated C-shaped configuration, with a shorter height Y. The heights X and Y of the first and second side walls 757, 759, respectively, correspond to the heights of the first side wall 625 and second side wall 627 previously described herein with respect to the modular plugs 576 of the sections 540 of the modular plug assembly 130. Accordingly, with these side walls 757, 759, the connector housing 756 is adapted to mate with a corresponding modular plug male terminal set housing 624 (FIG. 28A) of a modular plug 576. Extending into the connector housing 756 from the interior of the base housing 750 are a set of eight female terminals 758. The female terminals 758 include a set of three terminals, identified as a communications cable female terminal set 760. The remaining five of the female terminals 758 are identified as AC power female terminal set 762. When the power box connector 136 is connected to a modular plug 576, the individual female terminals 758 of the female terminal set 760 will be electrically connected to individual terminals of the communications cable terminal set 646 of a modular plug 576. Therefore, the individual terminals 758 of the terminal set 760 will be electrically connected to communication cables CC1, CC2 and CCR within the modular plug assembly 130. The terminals 758 of the female terminal set 760 are connected, by any simple means, to individual wires or cables (not shown) extending into the interior of the power box connector 136 from the communications conduit 772. The communications conduit 772 is coupled, at aperture 774, to the base housing 750 of the connector 136. The wires or cables extending through communications conduit 772, as shown in FIG. 31, extend upwardly through a conventional communications connector 776. The connector 776 is connected, in turn, to the mating communications connector 704. The communications connector 704 is connected to the power box communications cable 702 which, in turn, is connected to the network circuit 700. In this manner, signals from the network circuit 700 may be transferred to and received from the communications cables CC1, CC2 and CCR.

With respect to AC power, the AC power female terminal set 762 will, when the power box connector 136 is coupled to a modular plug 576, provide for electrical connection from the power box connector 136 to the individual AC power cables AC1, AC2, AC3, and ACG. This AC power female terminal set 762 is connected, within the interior of the base housing 750, to electrical wires or cables extending out of the base housing 750 through the AC power entry conduit 686. The AC power entry conduit 686 is coupled to the base housing 750 through the aperture 766. As shown in FIG. 31, the AC power entry conduit 686 is connected, at a terminating end, to a conventional AC connector 684. The AC connector 684 mates with the corresponding AC power entry box connector 682. The AC power entry box connector 682 is coupled to a terminating end of the outgoing AC cable 680 from the power entry box 134. As earlier described, the AC cable 680 carries, in this particular embodiment, three AC circuits from the building power. With the AC power female terminal set 762 appropriately connected to a corresponding AC power male terminal set 648 associated with a modular plug 576 of the modular plug assembly 130, the three-circuit AC building power is then applied to AC power cables AC1, AC2, AC3, ACN and ACG through the power entry box 134 and power box connector 136.

With respect to connection to a specific end of a section of the main structural channel rail 102 where the power entry box 134 will be connected to the modular plug assembly 130 through the power box connector 136, the interconnections should be such that the power box connector 136 is inserted upwardly from the bottom of a section of the structural channel rail 102 at the end where the elongated side-end apertures 192 exist within the side panels 180 of the rail 102 (see FIG. 29 for the relative location of the apertures 192 in the structural channel rail 102). Also, with respect to the assembly of a section 540 of the modular plug assembly 130 to the structural channel rail 102, this will be the end of the section 540 where the particular plug connector 586 at the end of the section 540 is in the same directional alignment as the plug connectors 586 of the other modular plugs 576 of section 540. That is, the interconnection would typically not be at the end of a section 540 of the modular plug assembly 130 having the distribution plug 650 (as shown, for example, in FIGS. 24 and 25).

The foregoing has explained functions and components associated with the structural channel system 100 which provide for transmitting building power to AC power cables 574 associated with the modular plug assemblies 130, and for providing means to couple communications signals through power entry boxes 134, power box connectors 136, modular plugs 576 and communication cables 572. Still further, as an alternative, the foregoing components could utilize an AC/DC converter with the power entry box 134, for purposes of applying DC power through certain of the communication cables 572.

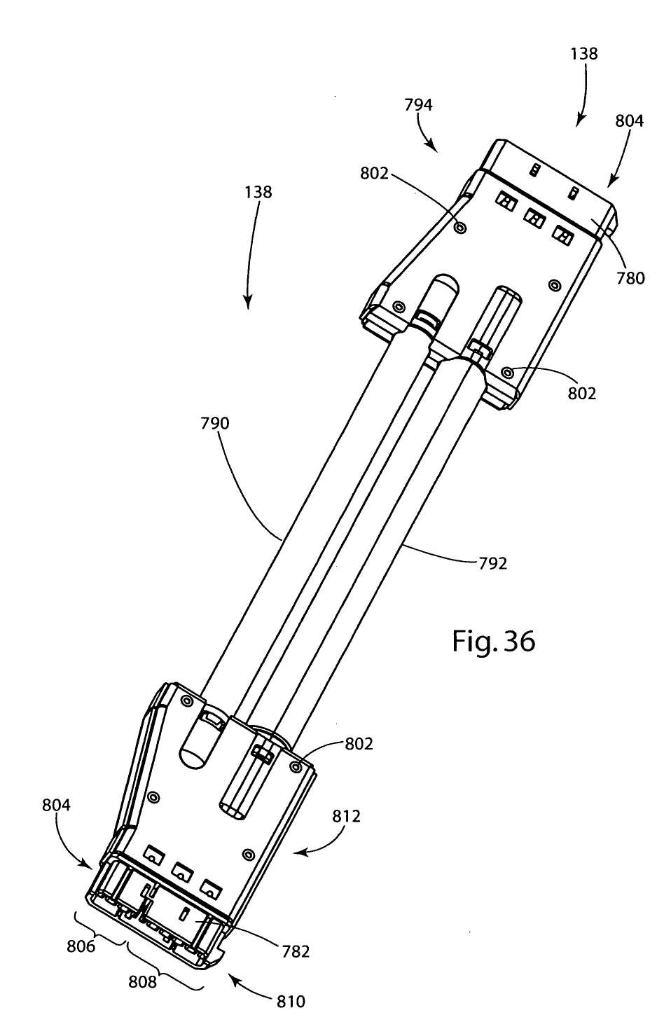

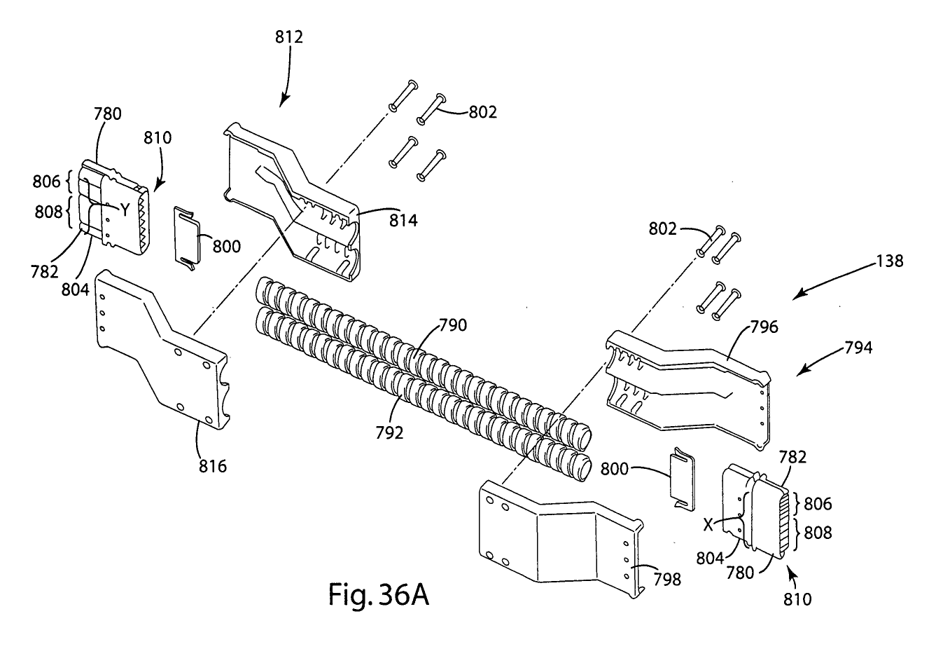

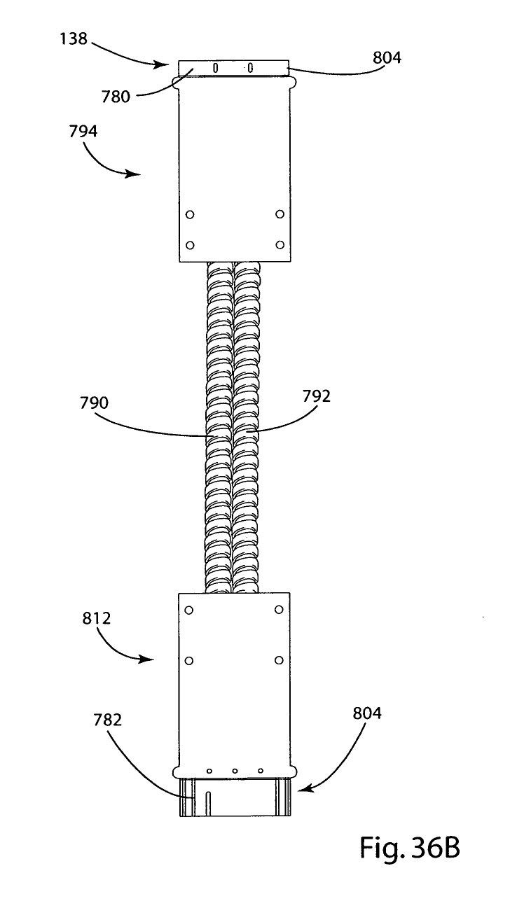

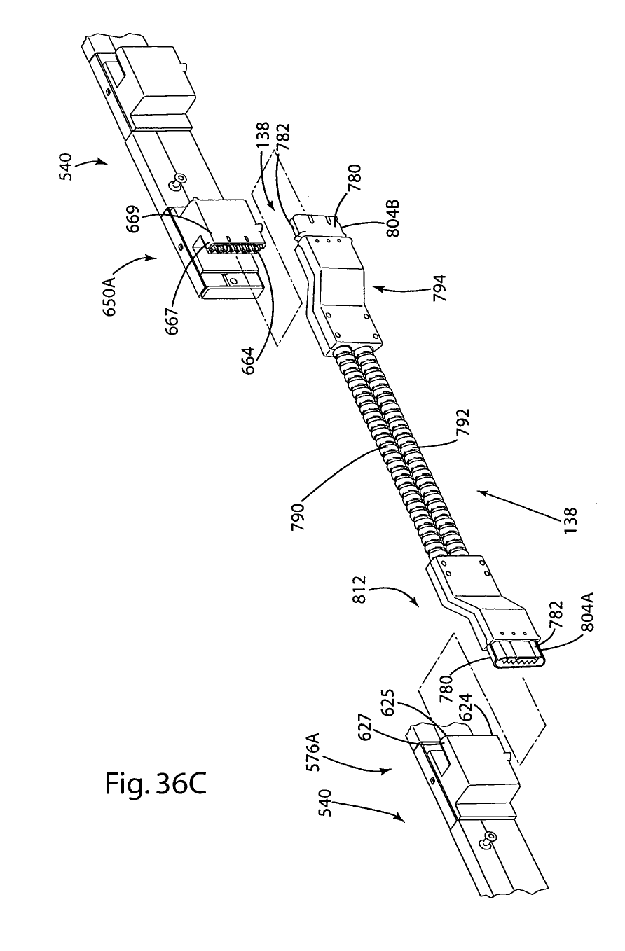

In accordance with the foregoing, the components described herein function so as to provide power and communication signals to and through one section 540 of the modular plug assembly 130. In addition, through the use of daisy chaining of the power entry boxes (which will be described in further detail herein with respect to power entry boxes 134A), communication signals can be transmitted from one section 540 of the modular plug assembly 130 to another section 540. Further, however, and in accordance with the invention, the structural channel system 100 includes means for electrically coupling AC power cables 574 from one section 540 to a relatively adjacent section 540 of the modular plug assembly 130. Still further, this means for electrically coupling of the AC power cables 574 also includes means for electrically coupling the communication cables 572 of adjacent sections 540. For this purpose, the structural channel system in accordance with the invention includes flexible connector assemblies 138, one of which is illustrated in FIGS. 36, 36A, 36B and 36C. Turning to these drawings, the flexible connector assembly 138 includes an elongated AC power flexible conduit 790. The flexible conduit 790 is conventional in structure and is utilized to carry AC power cables (not shown) between the two ends of the connector 138. Also provided is an elongated communications flexible conduit 792. The communications flexible conduit 792 may, for example, have an oval configuration. Each of the conduits is relatively well known in the industry.

One end of the AC power flexible conduit 790 and one end of the communications flexible conduit 792 are connected to what is characterized as a right-hand jumper housing 794 of the flexible connector assembly 138. References herein to right hand and left hand are arbitrary. The right hand jumper housing 794 includes a right hand jumper offset 796, having the offset construction as illustrated primarily in FIG. 36A. A right hand jumper cover 798 is also included, with the offset 796 and cover 798 forming the housing 794. The conduits 790 and 792 extend into one end of the housing 794, and are secured therein by any suitable means. Rivets 802 may be utilized to secure together the offset 796 and cover 798.

As further shown in FIG. 36A, the right hand jumper housing 794 encloses a spacer clip 800 utilized for maintaining spacing and positioning of components of the flexible connector assembly 138 within the interior of the housing 794. Coupled to one end of the housing 794 is a female terminal housing 804. The female terminal housing 804 houses a set of eight female terminals 810. The female terminals 810 comprise a communications female terminal set 806, having three of the female terminals 810. The remaining five female terminals 810 comprise the AC power female terminal set 808. The female terminals 810 extend toward the outer end of the terminal housing 804. As with other connector housings previously described herein, the terminal housing 804 also comprises a pair of side walls. Specifically, the terminal housing 804 associated with the housing 794 includes a first side wall 780 and a second side wall 782, shown in FIGS. 36A and 36C. The first side wall 780 is in the form of an elongated C-shaped cross-sectional configuration, having a height X (FIG. 36A). Correspondingly, the second side wall 782, opposing the first side wall 780, as a “reverse” C-shaped cross-sectional configuration. The second side wall 782 has a relatively shorter height identified as height Y. These references to heights X and Y correspond to the same heights identified as heights X and Y in the prior description associated with the modular plugs 576 and the distribution plugs 650. As will be described in subsequent paragraphs herein, the sizing and configuration of the various connector housings ensures that the interconnection of a flexible connector assembly 138 between two sections 540 of the modular plug assembly 130 is “unidirectional.”

On the opposing end of the flexible connector 138, the AC power flexible conduit 790 and communications flexible conduit 792 are secured to a left hand jumper housing 812. As further shown in FIG. 36A, the left hand jumper housing 812 is similar in configuration to the right hand jumper housing 794, but with a “reverse” offset. The left hand jumper housing 812 comprises a left hand jumper offset 814 and a left hand jumper cover 816. The offset 814 and cover 816 are secured together by means of rivets 802. Secured within the left hand jumper housing 812 is an additional spacer clip 800, utilized for maintaining spacing and positioning of components of the flexible connector assembly 138 within the interior of the housing 812. Coupled to a terminating end of the left hand jumper housing 812 is a second female terminal housing 804, having the same structure and configuration as the female terminal housing 804 previously described with respect to use within the right hand jumper housing 794. The conduits 790 and 792 extend into an opposing end of the jumper housing 812, and are secured therein by any suitable means. As with the female terminal housing 804 associated with the right hand jumper housing 794, the female terminal housing 804 associated with the left hand jumper housing 812 also houses a set of eight female terminals 810, comprising a communications female terminal set 806 and an AC power female terminal set 808. The communications female terminal set 806 includes three female terminals 810, while the AC power female terminal set 808 comprises five female terminals 810. The female terminals 810 extend toward the outer end of this terminal housing 804. As shown primarily in FIG. 36A, the spatial positioning of the female terminal housing 804 associated with the left hand jumper housing 812 corresponds to the spatial positioning of the female terminal housing 804 associated with the right hand jumper housing 794, but rotated 180°. To make clear this configuration, when the flexible connector assembly 138 is viewed in the side elevation view of FIG. 36B, the first side wall 780 associated with the housing 804 for the right hand jumper housing 794 is visible. On the opposing end of the flexible connector assembly 138 as viewed in FIG. 36B, the second side wall 782 of the housing 804 associated with the left hand jumper housing 812 is visible. Accordingly, the 180° rotation of one of the female terminal housings 804 relative to the other occurs within a horizontal plane, so that the vertical orientations of the female terminals 810 are identical for each of the female housings 804. This positional orientation of the female housings 804 and the use of the jumper offsets will be made apparent in subsequent discussions relating to the interconnection of the flexible connector assembly 138 to adjacent sections 540 of the modular plug assembly 130.

Although not specifically shown in the drawings, cables or wires are attached to the female terminals 810 associated with each terminal housing 804 (by any suitable means), and extended through the AC power flexible power conduit 790 and communications flexible conduit 792. Three of these wires or cables are connected to the communications female terminal sets 806, and extend through the communications flexible conduit 792. These cables or wires will be utilized to couple together the communications cables CC1, CC2 and CCR associated with adjacent sections 540 of the modular plug assembly 130. Correspondingly, a set of five wires or cables are extended through the AC power flexible conduit 790 and conductively interconnected to the female terminals 810 associated with each terminal housing 804 which form the AC power female terminal sets 808. These wires or cables and the AC power female terminal sets 808 are utilized to couple together the AC cables AC1, AC2, AC3, ACN, and ACG associated with adjoining sections 540 of the modular plug assembly 130.

More specifically, the female terminals 810 of one of the terminal housings 804 will be electrically coupled to the male blade sets 658, 660 associated with a distribution plug 650 (see FIG. 28B) at one end of one section 540 of the modular plug assembly 130. The other terminal housing 804 of the flexible connector assembly 138 will be electrically coupled to the male blade sets 588, 590 associated with a modular plug 576 (see FIG. 28A) at one end of another, or a second, section 540 of the modular plug assembly 130, thereby electrically coupling the second section 540 to the first section 540. Typically, for purposes of interconnection, these first and second adjacent sections 540 of the modular plug assembly 130 will be positioned so that the end of the second section 540 which is nearest to the distribution plug 650 of the first section 540 will be the end of the second section 540 which does not have a distribution plug 650. That is, in a typical configuration, the female terminals 810 of one of the terminal housings 804 will be electrically connected to the distribution plug 650 of one section 540, and to an endmost modular plug 576 associated with the adjacent, or second, section 540.

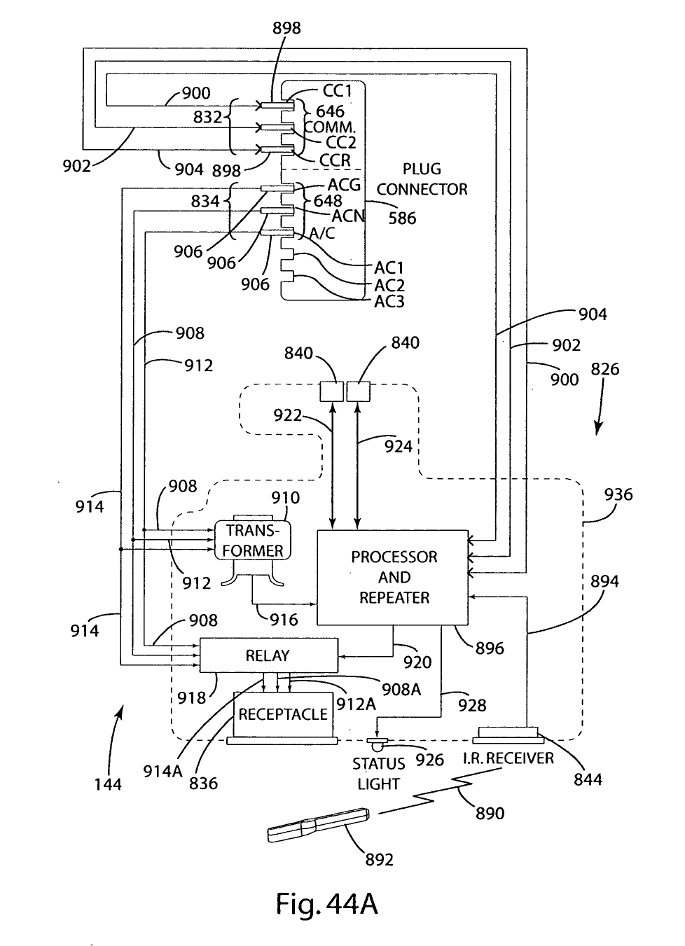

As earlier referenced, one particular advantage of the flexible connector assembly 138 comprises its capability of being “plugged into” adjoining sections 540 of the modular plug assembly 130 only in one direction. With this feature, the flexible conduit assembly 138 is referred to herein as being “unidirectional.” This unidirectional property is a significant safety feature. More specifically, and as earlier referenced, each of the terminal housings 804 of the flexible connector assembly includes a first side wall 780 and a second side wall 782. These sidewalls correspond in size and configuration to the first and second side walls 625, 627 of the modular plugs 576 and first and second side walls 667, 669 of the distribution plug 650. As also earlier referenced, the positioning of one of the terminal housings 804 in the flexible connector assembly 138 corresponds to a two-dimensional, 180° rotation in a horizontal plane of the other terminal housing 804 of the assembly 138. Accordingly, as shown in FIG. 44, one of the terminal housings 804 includes its first side wall 780 on one side of the connector assembly 138, while the other terminal housing 804 is positioned so that its first side wall 780 is on the opposing side. Interconnection of one of the flexible connector assemblies 138 to adjacent sections 540 of the modular plug assembly 130 is shown in FIG. 36C. For purposes of description and understanding, the sections 540 are shown independent of any interconnections to main rails 102 or similar components. Also, and again for purposes of description, the two terminal housings 804 associated with the flexible connector assembly 138 in FIG. 36C are identified as terminal housing 804A and terminal housing 804B. With the connector assembly 138 positioned as shown in FIG. 36C relative to the section 540, the terminal housing 804A has its first side wall 780 facing the sections 540. The second side wall 782 of the terminal housing 804A faces in an opposing direction. In contrast, with reference to terminal housing 804B, its first side wall 780 faces outwardly from the sections 540, while its second side wall 782 faces toward the sections 540.

In assembling the flexible connector assembly 138 to the two sections 540 shown in FIG. 36C, the terminal housing 804A will be coupled to the modular plug male terminal set housing 624 of a modular plug 576 located at the end of one of the sections 540. For purposes of description, this modular plug 576 is expressly identified by reference numeral 576A. As further shown in FIG. 36C, the first side wall 625 of the modular plug 576A is to the outside of the housing 654, while the second side wall 627 is toward the inside of the housing 624. With this configuration, relative to the configuration of the side walls 780, 782 of housing 804A, the housing 804A can readily “mate” with the housing 624 of modular plug 576A. It should be noted that if the side walls 780, 782 of housing 804A or the side walls 625, 627 of modular plug 576A were “reversed,” it would not be possible to interconnect housing 804A with housing 624 of plug 576A.

Correspondingly, the terminal housing 804B is adapted to mate with a distribution plug 650, identified specifically as distribution plug 650A in FIG. 36C. As further shown in FIG. 36C, the first side wall 667 of the distribution plug male terminal housing 664 is located toward the inside of the housing 664. Correspondingly, the second sidewall 669 of distribution plug 650A is located outwardly of the plug 650A. With this configuration, and with the positional configuration of terminal housing 804B as shown in FIG. 36C, the terminal housing 804B can readily “mate” with the housing 664 of the distribution plug 650A. As previously noted with respect to housing 804A and housing 674 of plug 576A, if either of the side walls 780, 782 of housing 804B or the side walls 667, 669 of distribution plug 650A were reversed, mating of the housing 804B, in the position shown in FIG. 36C, would not be possible. With the foregoing configurations of the terminal housings associated with the module plugs 576, distribution plug 650 and flexible connector assembly 138, in combination with the offsets provided by the structural configuration of the right hand jumper housing 794 and left hand jumper housing 812, a proper mating configuration of the flexible connector assembly 138 with the adjacent sections 540 can only occur in one direction. That is, the flexible housing assembly 138 will be capable of being “plugged into” adjoining sections 540 of the modular plug assembly 130 only in a “unidirectional” manner. As previously stated, it is believed that this provide a significant safety feature. Also, with this feature and the general structural configuration of the interconnection of the connector assembly to the adjoining sections 540, it is believed that the use of the flexible connector assembly 138 will meet most governmental and institutional codes and regulations relating to electrical apparatus.

One other concept associated with the flexible connector assembly 138 should be mentioned. FIG. 36C illustrates the use of the flexible connector assembly 138 to electrically couple together a pair of sections 540 of the modular plug assembly 138 which are essentially in an alignment which could be characterized as a “straight line” configuration. However, if for some reason it would be desirable to electrically couple together a pair of sections 540 which are, for example, angled relative to each other, the connector assembly 138, having flexibility with respect to its conduits 790, 792, can be utilized for such electrical interconnection. Still further, the flexible connector assembly 138 is not necessarily limited to any particular length, with the exception that electrical and code requirements may limit the connector assembly length. Except for these possible limitations, the flexible connector assembly 138 can be of any desired lengths, and a user may incorporate a number of connector assemblies 138 having varying lengths within a structural channel system 100.

In accordance with the foregoing, the flexible connector assembly 138 provides a means for essentially electrically coupling together sections 540 of the modular plug assembly 130. Power from the building therefore does not have to be directly applied through a power entry box 134 for each section 540 of the modular plug assembly 130. It will be apparent, however, that the number of sections 540 of the modular plug assembly 130 which may be coupled together through the use of the flexible connector assemblies 138 may be limited in a physically realizable implementation, by electrical load and “density” requirements, and code restrictions.

In accordance with all of the foregoing, the structural channel system 100 may be employed to provide high voltage electrical power (or other power voltages) through AC power cables 164 extending through sections of the wireways 122. Correspondingly, DC or other low voltage power may be provided throughout the network grid 172 through cables 166 extending through the cableways 120. Power from the cables 164 or cables 166 can be “tapped off” anywhere along the grid 172 as desired, for purposes of energizing various types of application devices. Still further, the structural channel system 100 includes components such as the power entry boxes 134, power box connectors 136, modular plug assembly 130 and flexible connector assemblies 138 for purposes of distributing both AC power (with multi-circuit capability) and communication signals throughout the grid 172 and electrical network 530. Also, if desired, the communication cables 572 can be utilized for purposes of distributing low voltage DC power throughout the electrical network 530, as well as communication signals.

With the components of the electrical network 530 as previously described herein, not only electrical power can be provided to conventional, electrically energized devices, such as lights and the like, but communication signals may also be provided on the electrical network 530 and utilized to control and reconfigure control among various application devices. As an example, and as described in the commonly assigned International Patent Application No. PCT/US03/12210, entitled “SWITCHING/LIGHTING CORRELATION SYSTEM,” filed Apr. 18, 2003, control relationships between switches and lights may be reconfigured in a “real time” fashion. In this regard, and as described in subsequent paragraphs herein, connector modules can be associated with application devices, such as lighting fixtures and the like. These connector modules can include DC power, processor means and associated circuitry, responsive to communication signals carried on the communication cables 572, so as to appropriately control the lighting fixtures, in response to communication signals received from other application devices, such as switches. The structural channel system 100 provides means for distributing requisite power and for providing a distributed intelligence system for transmitting and receiving these communication signals from application devices which may be physically located throughout the entirety of the structural grid 172.

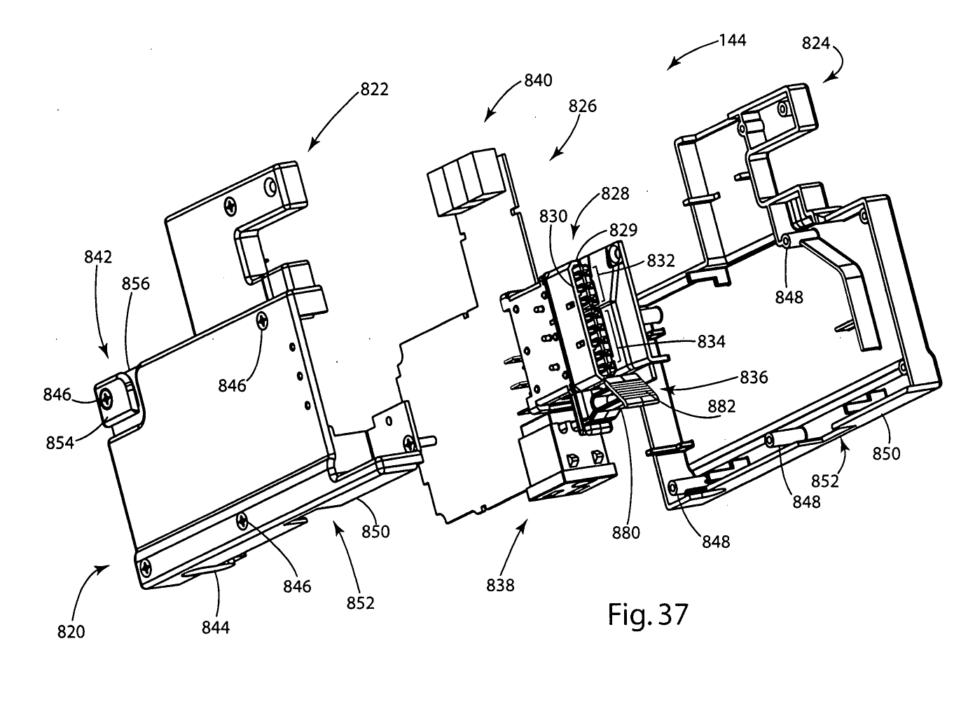

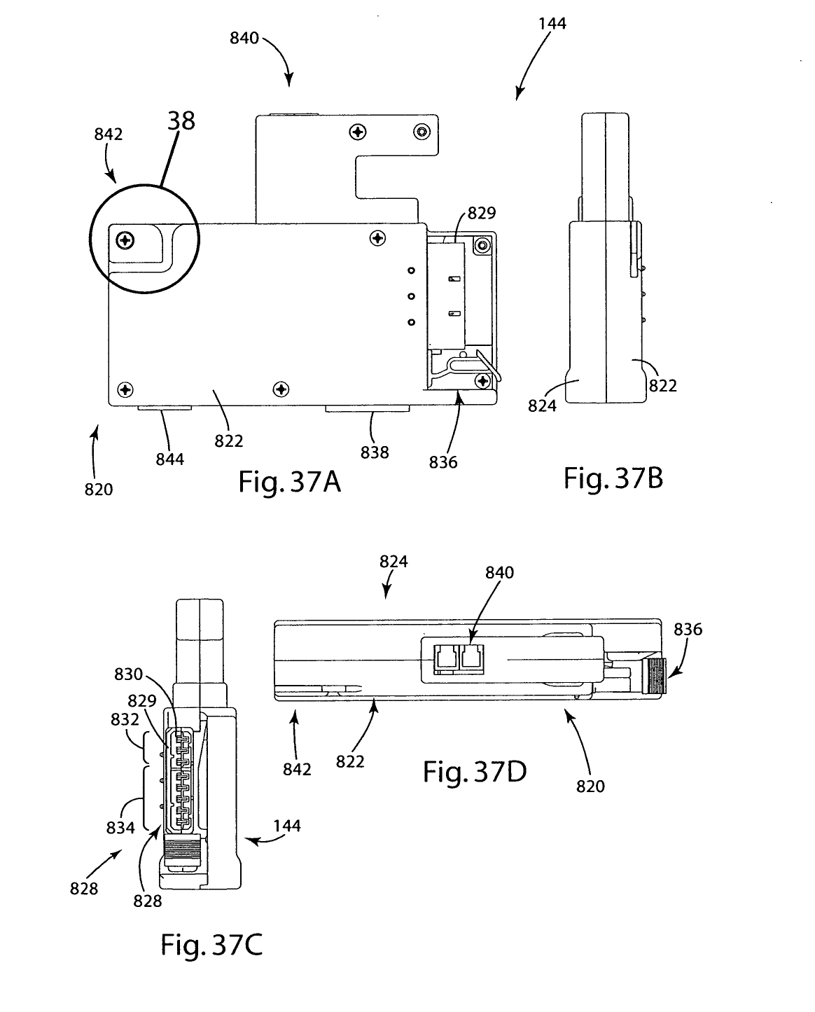

Once such connector module which may be utilized in the structural channel system 100 is referred to herein as a receptacle connector module 144. The receptacle connector module 144 is illustrated in FIGS. 37-44A. With the exception of FIG. 44, the receptacle connector module 144 is illustrated in a stand-alone configuration in FIGS. 37-44A. In FIG. 44, the receptacle connector module 144 is illustrated as electrically and mechanically interconnected to a section 540 of the modular plug assembly 130, and energizing an electrical device. For purposes evident from subsequent description herein, the receptacle connector module 144 can be referred to as a “smart” connector module, in that it includes certain logic which permits the connector module 144 to be programmed by a user (through remote means) so as to initiate or otherwise modify a control/controlling relationship between devices energized through the receptacle connector module 144 and controlling devices, such as switches or the like.

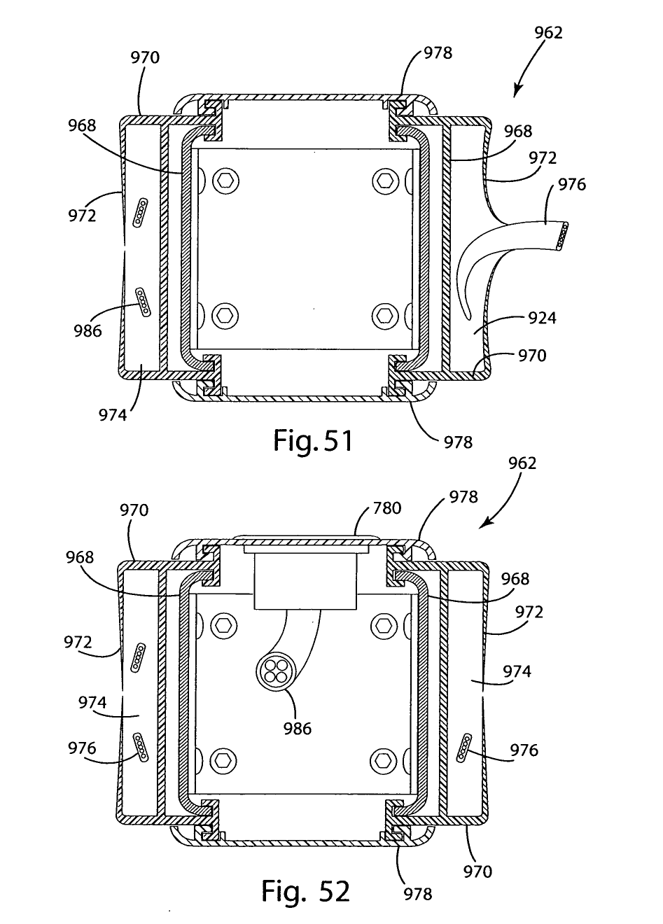

With reference initially to FIGS. 37-37D, the receptacle connector module 144 includes a connector housing 820. The connector housing 820 includes a front housing cover 822 and a rear housing cover 824. Fasteners 846 can be extended through apertures in the front housing cover 822 and secured within threaded couplers 848 in the rear housing cover 824, for purposes of securing the covers 822 and 824 together. Secured within the connector housing 820 is a board assembly 826, as primarily shown in FIG. 51. The board assembly 826 includes various circuit components for purposes of functional operation of the receptacle connector module 144. The principal components are illustrated in FIG. 44A and will be described in subsequent paragraphs herein. The board assembly 826 includes a connector plug 828. The connector plug 828 comprises a connector plug housing 829. The connector plug housing 829, as will be apparent from subsequent description herein, is adapted to mate with the male terminal set housing 624 of each of the modular plugs 576 associated with sections 540 of the modular plug assembly 130. A set of eight female terminals 830 extend toward the end of the connector plug 828 to the opening of the connector plug housing 829. The female terminals 830 include a set of three female terminals forming a communications female terminal set 832. When the receptacle connector module 144 is electrically and mechanically coupled to a section 540 of the modular plug assembly 130, the communications female terminal set 832 will be electrically connected to the communications male terminal set 646 previously described with respect to FIG. 28A. Correspondingly, five of the female terminals 830 will form an AC power female terminal set 834. When coupled to a modular plug 576 of a section 540 of the modular plug assembly 130, the AC power female terminal set 834 will be electrically engaged with the AC power male terminal set 648 of the modular plug 576, as also shown in FIG. 28A.

For purposes of securing the connector plug 828 of the connector module 144 to a modular plug 576, a connector latch assembly 836 is provided below the connector plug housing 829. Operation of the connector latch assembly 836 will be described in subsequent paragraphs herein. In addition to the foregoing, the receptacle connector module 144 includes a lower surface 850 formed by the lower portions of the front housing cover 822 and rear housing cover 824. Extending through a slot 852 also formed by the covers 822, 824, is an electrical receptacle 838, operation of which will be described in subsequent paragraphs herein. The connector module 144 includes a set of two connector ports 840. Each of the connector ports 840 may be a standard RJ45 port. Such ports are conventionally used as telephone plugs and also as programmable connections. The connector ports 840, as described in greater detail subsequently herein, provide a means for transferring and receiving communication signals to and from various application devices (including switches and the like), in addition to providing a means for transmitting DC power to certain application devices for functional operation. The communication signals may then be carried to and from the communication cables 572 associated with the modular plug assembly 130.

The receptacle connector module 144 also includes an IR (infrared) conventional receiver 844 which is located as shown in FIG. 37 on the lower surface 850 of the connector housing 820. As also described in subsequent paragraphs herein, the IR receiver 844 provides a means for receiving spatial signals from a user for purposes of “programming” the functional operation of the receptacle connector module 844 in response to communication signals received through the connector ports 840 and through the communications female terminal set 832.

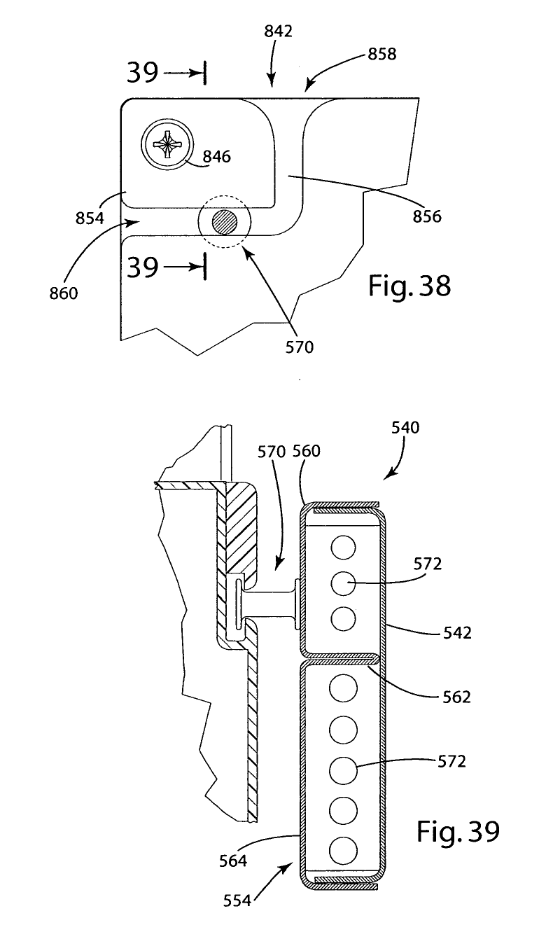

As earlier described, the receptacle connector module 144 is electrically coupled to communication cables 572 and AC power cables 574 of the modular plug assembly 130, through a mating connection of the female terminals 830 within the connector plug 828 to the male blade sets 588, 590 of one of the modular plugs 576 associated with the modular plug assembly 130. Further, the receptacle connector module 144 (and other connector modules as described in subsequent paragraphs herein) preferably includes additional means for mechanically securing the connector module 144 to a section 540 of the modular plug assembly 130. For this purpose, a subdevice referred to herein as a ferrule coupler 842 is utilized, in combination with one of the spaced apart ferrules 570 which is secured to one of the electrical dividers 554 of a section 540 of the modular plug assembly 130. Reference will be made primarily to FIGS. 37, 37A, 38 and 39, in describing the ferrule coupler 842. As shown first primarily in FIGS. 37 and 38, the front housing cover 822 includes a pin insert 854 which is coupled to the housing cover 822 at its upper left hand corner (as viewed in FIG. 37A). The pin insert 854 is secured to the front housing cover 822 by one of the fasteners 846. As shown in an enlarged view in FIG. 38, the positioning of the pin insert 854 and the structural configuration thereof forms a slot 856. The slot 856 includes a vertical slot section 858 which opens outwardly at the upper portion of the connector housing 820. The slot 856 then continues downward and turns at substantially a right angle so as to form a horizontal slot section 860. The horizontal slot section 860 opens outwardly at one end of the connector housing 820.

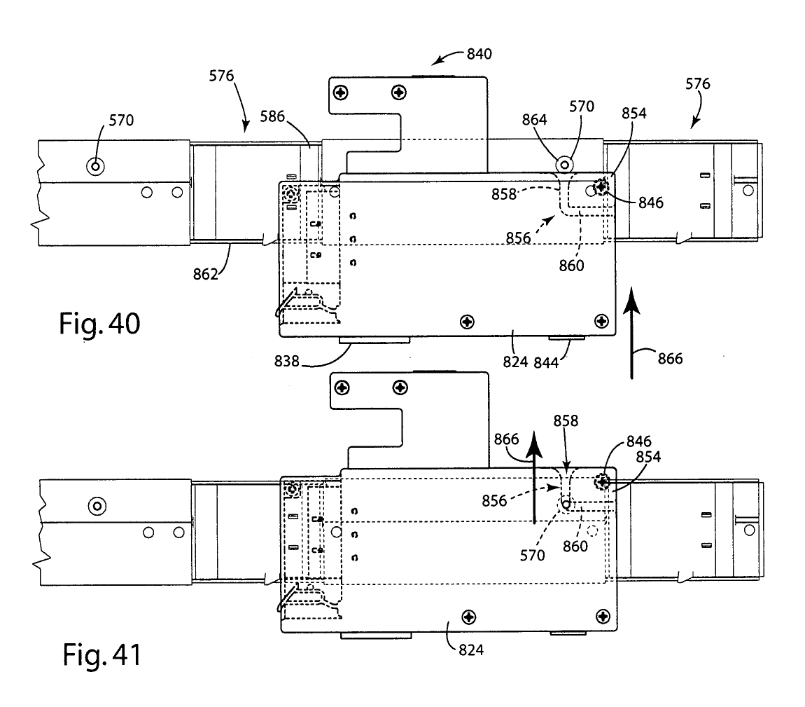

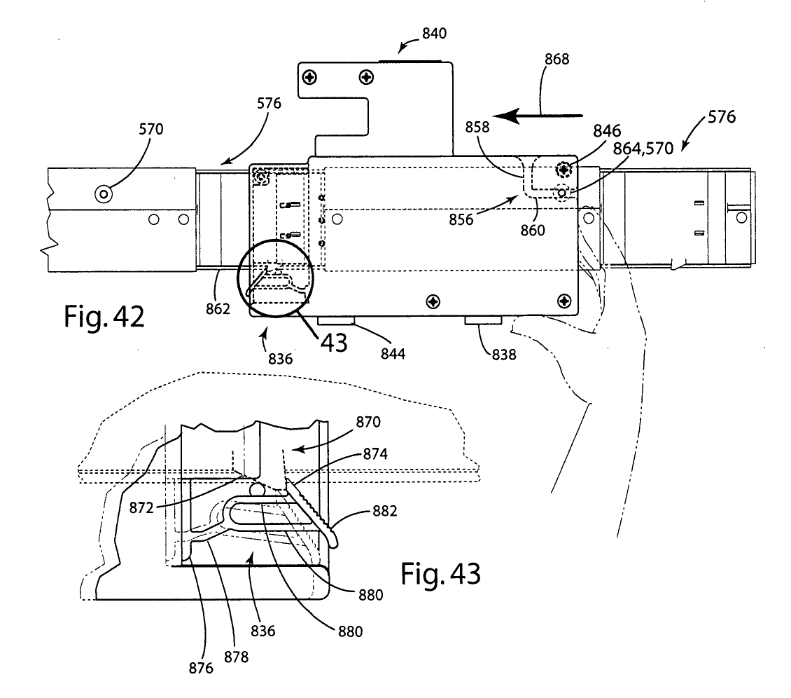

With reference primarily to FIGS. 38, 39, 40 and 41, the connector module 144 is positioned relative to one of the modular plugs 576 to which it is to be connected by moving the connector module 144 upward through the central spatial area of a structural channel rail 102 until the connector module 144 is essentially in a position as shown in FIG. 40. In this position, the particular modular plug 576 to which the connector module 144 will be electrically connected is identified as modular plug 862. The connector module 144 is positioned so that its upper surface is immediately below a ferrule 570, with the ferrule 570 in alignment with the vertical slot section 858. This position is also shown in FIG. 40. The particular ferrule 570 of interest is identified as ferrule 864. The connector module 144 is then raised upwardly in the direction shown by arrows 866 in FIGS. 40 and 41. As the connector module 144 is moved upwardly, the ferrule 864 moves downwardly into the slot 856 through the vertical slot section 858. This upward movement continues until the ferrule 864 rests against the bottom of the vertical slot section 858 of the slot 856. This position is illustrated in FIG. 41. To then engage the connector plug 828 of the connector module 144 with the plug connector 586 of the modular plug 862, the connector module 144 is moved toward the modular plug 862. This movement would correspond to movement of the connector module 144 to the left as viewed in FIG. 41. The sizing and relative structure of the section 540 of the modular plug assembly 130 and the various components of the connector module 144 should be such that when the connector plug 828 is fully engaged with the plug connector 586, the ferrule 864 will be located within the horizontal slot section 860 of the slot 856. This relative positioning and configuration is illustrated in FIG. 42. In this manner, the ferrule coupler 842 assists in preventing vertical movement of the connector module 144 relative to the section 540 of the modular plug assembly 130.

In accordance with the foregoing, any substantially vertical movement of the connector module 144 relative to the section 540 of the modular plug assembly 130 is prevented through the ferrule coupler 842. However, the ferrule coupler 842, when the connector module 144 is fully electrically coupled to the plug connector 586, will not prevent initial movement of the connector module 144 to the right (i.e. opposite the direction of the arrow 868) relative to the section 540, as viewed in FIG. 42. Any such unintentional movement (through earthquake movements, “bumping” against the connector module 144, etc.) could present a substantially unsafe situation, in that the connector plug 828 could become partially dislodged from the plug connector 586. To prevent such unintentional movement, the connector module 144 further includes a connector latch assembly 836.

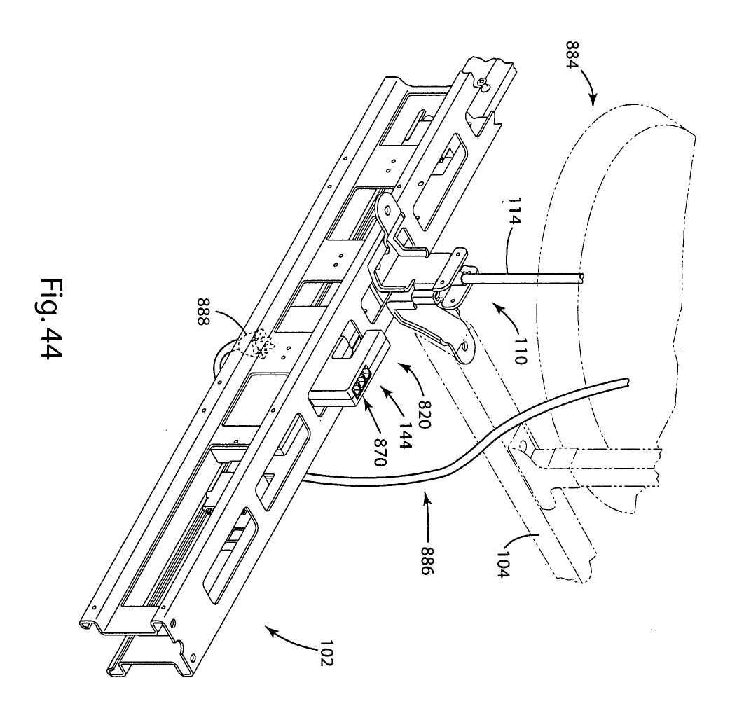

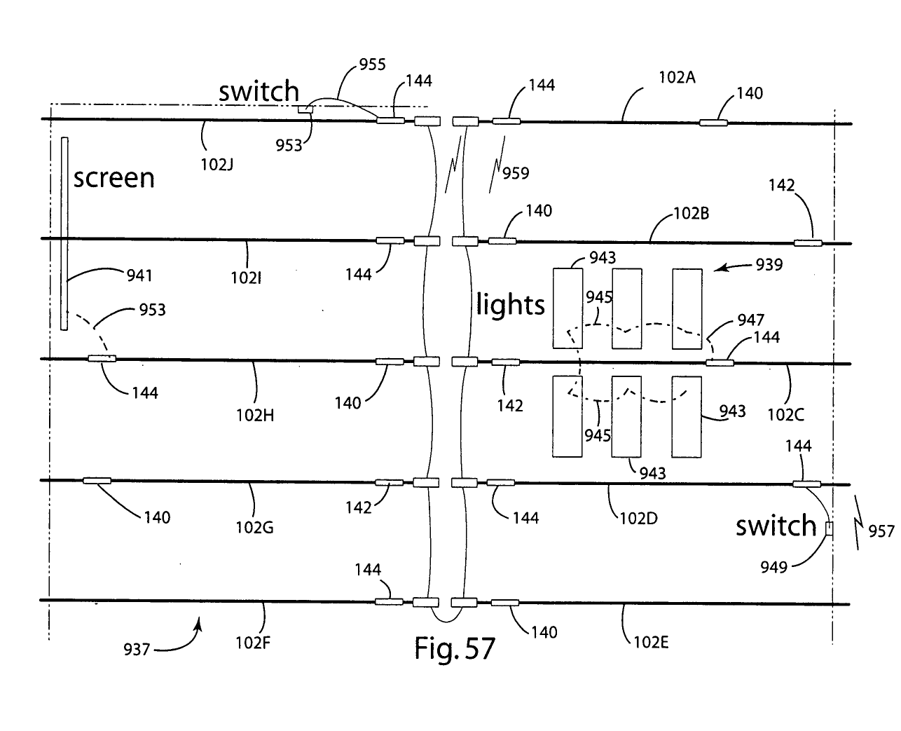

Functional operation of the connector latch assembly 836 will now be described primarily with respect to FIGS. 32A, 42 and 43. With reference first to FIGS. 42A and 57, the plug connector 586 includes, at the lower portion thereof, a mating ramp 870. The mating ramp 870, as shown in FIG. 43, has an inclined ramp surface 872. The lower end of the inclined ramp surface 872 terminates in a ramp edge 874. The connector latch assembly 836 also comprises a brace 876 which is integral with or otherwise coupled to a lower portion of the connector plug 828 of the connector module 144. Projecting outwardly from the brace 176 is a resilient arm 878, as also shown in FIG. 43. The distal end of the resilient arm 878 terminates in a pair of fingers 880. The fingers 880 are integral with or otherwise connected to an inclined latch shoe 882. The connector latch assembly 836 is sized and configured so that it has a “normal” position as illustrated in solid line format in FIG. 43. However, the resilient arm 878 and fingers 880 are sufficiently flexible so that the latch shoe 882 can be flexed downwardly, as illustrated in phantom line format in FIG. 43. When the receptacle connector module 144 is first positioned relative to the section 540 of the modular plug assembly 130 as illustrated in FIG. 40, the latch shoe 832 is in the position shown in FIG. 40. As the connector module 144 is raised upwardly to the position shown in FIG. 41, the latch shoe 882 is located to the “right” of the mating ramp 870 of the modular plug 862, as viewed in FIG. 41. As the connector module 144 is moved to the left as viewed in FIG. 41 relative to the modular plug 862, for purposes of electrically connecting the module 144 to the modular plug 862, the latch shoe 882 will contact the ramp edge 874. This configuration is illustrated in phantom line format in FIG. 43. As the connector module 144 is moved to the left as viewed in FIG. 42 (corresponding to movement of the latch shoe 882 to the right as viewed in FIG. 43), the latch shoe 882 contacts the ramp surface 872 and is flexed downwardly, as shown by the phantom line format of FIG. 43.

When the connector module 144 is moved a sufficient distance, as shown in FIGS. 42 and 43, the latch shoe 882 passes the ramp edge 874 of the mating ramp 870. When the latch shoe 882 is completely past the ramp edge 874, the latch shoe 882 is free to flex upwardly to its normal position, as shown in solid line format in FIG. 43. This configuration is also illustrated in FIG. 42. With this positioning of the latch shoe 882 relative to the mating ramp 870, the connector module 144 is essentially “locked” into appropriate position, relative to the modular plug 862. To thereafter disengage the connector module 144 from the modular plug 862, a user must manually press downward on the latch shoe 882, until the upper end of latch shoe 882 is positioned below the ramp edge 874 of the mating ramp 870. With the latch shoe 882 below the ramp edge 874, the connector module 144 can be disconnected from the modular plug 862. That is, the connector module 144 can be moved to the right as viewed in FIG. 42, relative to the modular plug 862. This movement can continue until the ferrule 864 has moved to the end of the horizontal slot section 860. This would correspond to the position of the connector module 144 as shown in FIG. 41. The connector module 144 has been sized and configured so that it is then completely disconnected from the modular plug 862. The connector module 144 can be pulled downwardly, so that the ferrule 570 moves upward within the vertical slot section 858. This would correspond to movement of the connector module 144 from the position shown in FIG. 41 to the position shown in FIG. 40.

In accordance with all of the foregoing, the connector latch assembly 836, in combination with the mating ramp 870, and the ferrule coupler 842, in combination with a ferrule 570, serve to provide for mechanical interconnection of the connector module 144 to the section 540 of the modular plug assembly 130. With this interconnection, as shown in FIG. 42, external forces must be manually exerted on the latch shoe 882, for purposes of disconnecting the connector module 144 from the modular plug 862. These components provide means for preventing inadvertent vertical or horizontal movement of the connector module 144, relative to the section 540 of the modular plug assembly 130.

As earlier described, the receptacle connector module 144 includes an IR receiver 844 and an electrical receptacle 838 extending through a lower surface 850 of the module 144 (FIG. 37). In this particular instance, the receptacle 838 is illustrated in the drawings as a conventional three-prong receptacle, having a ground wire connection. For purposes of providing AC power to an electrical application device through the receptacle 838, the receptacle 838 will be coupled to AC power from the AC power cables 574, in a manner as subsequently described herein. As an example of use, and as shown in FIG. 44, the receptacle connector module 144 can be utilized to energize an electrical application device, such as an overhead fan 884 shown in phantom line format in FIG. 44. The overhead fan 884 may be energized through an electrical cord 886 having a plug 888. The plug 888 may be electrically connected to the receptacle 838 of the connector module 144.

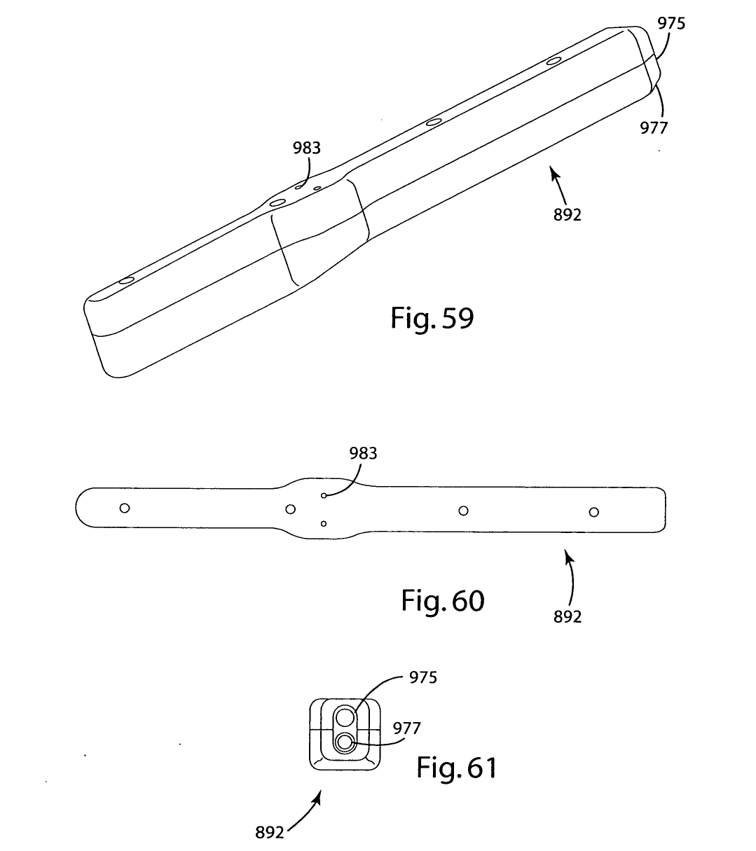

The internal circuitry of the receptacle connector module 144, represented by the board assembly 826 illustrated in FIG. 37, will now be described, primarily with respect to FIG. 44A. As shown therein, the receptacle connector module 144 includes the IR receiver 844. The receiver 844 is a conventional and commercially available IR receiver, which is adapted to receive spatial IR signals 890 from a manually operable and hand-held device, illustrated as a wand 892 in FIG. 44A. The wand 892 is operated by a user, and will be described in subsequent paragraphs herein with respect to FIGS. 59, 60 and 61. Incoming spatial IR signals 890 are received by the IR receiver 844, and converted to electrical signals which are applied as output signals on line 894. The output signals on line 894 (which is a “symbolic” line and may comprise a plurality of wires or cables) are applied as input signals to a processor and associated repeater circuitry 896.

In addition to the signals received by the processor and associated repeater circuitry 896 from the IR receiver 844 through line 894, the processor and associated repeater circuitry 896 also receives communication signals from communication cables CC1, CC2 and CCR running through sections 540 of the modular plug assembly 130. These signals are “tapped off” the plug connector 586 (symbolically shown in FIG. 44A) of one of the modular plugs 576 spaced along a section 540 of the modular plug assembly 130. More specifically, signals from the communication cables CC1, CC2 and CCR are received through the communications cable terminal set 646 (see FIG. 28A) of the plug connector 586. The three terminals of the communications cable terminal set 646 are electrically coupled to the communications female terminal set 832 of the connector module 144. This connection is illustrated in FIG. 44A through what is shown as “symbolic” contacts 898. Although shown as symbolic contacts 898, they represent an electrical interconnection of the modular plug 576 and associated plug connector 586, comprising communications cable terminal set 646, to a communications female terminal set 832 associated with the connector module 144. For purposes of simplifying description of the board assembly 826 and circuits of other connector modules as subsequently described herein, the elements shown as symbolic contacts 898 will be utilized to represent these electrical interconnections. Further, it should be noted that FIG. 44A represents the receptacle connector module 144 when the module 144 is completely mechanically and electrically engaged with a section 540 of the modular plug assembly 130, and an associated modular plug 576.

As further shown in FIG. 44A, reference is made to each of the symbolic contacts 898 as being representative of an electrical interconnection to one of the communication cables CC1, CC2 and CCR. Communication signals from the communication cables CC1 and CC2 are applied through the symbolic contacts 898 and lines 900 and 902 as input signals to the processor and associated repeater circuitry 896. Correspondingly, the return communication cable CCR is also connected through a symbolic contact 898 and its signal is applied to the processor and associate repeater circuitry 896 on line 904. Also, although communication signals from cables CC1 and CC2 can be received by the processor and associated repeater circuitry 896, the lines 900, 902 and 904 are bidirectional, and the processor and associated repeater circuitry 896 is also adapted to generate output signals and apply the same as communication signals to the communication cables CC1, CC2 and CCR through the symbolic contacts 898.

Turning to the AC power portion of the receptacle connector module 144, and the AC/DC conversion features so as to provide DC power for functional operation of the connector module 144, the modular plug 576, as previously described herein, includes an AC power terminal set 648 mounted on the plug connector 586 and connected to the AC power cables 574 (see, e.g., FIG. 28) which run through each section 540 of the modular plug assembly 130. The AC power terminal set 648 is electrically interconnected to the AC power female terminal set 834 associated with the connector module 144 (see prior description with respect to FIG. 37). This electrical interconnection is illustrated through the use of “symbolic” contacts 906 as shown in FIG. 44A. Symbolic contacts 906 correspond to symbolic electrical connections in the same manner as the previously described symbolic contacts 898.

In this particular embodiment of the receptacle connector module 144 and associated board assembly 826 as shown in FIG. 44A, the symbolic contacts 906 are illustrated so as to correspond to electrical interconnection to AC power cables AC1, ACN and ACG. AC1 corresponds to a “hot” cable. As previously described herein, the particular embodiment of the AC power cables 574 comprises three hot circuits, utilizing AC power cables AC1, AC2 and AC3. FIG. 44, and other diagrammatic circuit configurations of other connector modules as shown herein, illustrate the use only of the hot AC power cable AC1, and not the AC power cables AC2 or AC3. However, as previously described herein, for purposes of “balancing” and the like, AC power could be received by the connector module 144 utilizing AC power cable AC2 or AC3.

In FIG. 44A, for purposes of clarity and description, no connections are shown to the terminals of the AC terminal set 648 of plug connector 586 corresponding to AC power cables AC2 and AC3. However, in a physical realization of the receptacle connector module 144, the AC power female terminal set 834 of the connector module 144 may, in fact, include female terminals corresponding to the slots for power cables AC2 and AC3. Also, lines may exist from the proximity of all of these female terminals, which are connected to a transformer 910 and relay 918 as subsequently described herein. With such a “five wire” connection arrangement, various means could be utilized to insure that only one of the lines connected to the “hot” wires for power cables AC1, AC2 and AC3 is enabled at any given time. As somewhat of an alternative, the symbolic contacts 906 could be provided for each of the slots associated with the AC power cables AC1, AC2, AC3, ACN, and ACG. These contacts 906 could be in the form of spade terminals or the like. Correspondingly, the line shown as line 908, connected to the transformer 910, relay 918 and symbolic contact 906 associated with AC power cable AC1, may be used to selectively couple the transformer 910 and relay 918 to any one of the contacts 906 associated with the power cables AC1, AC2 or AC3. For example, line 908 may be in the form of a “pigtail,” having one end substantially permanently coupled to the transformer 910 and relay 918. The other end of the pigtail line 908 may be assembled so that it is capable of being selectively coupled to any one of the symbolic contacts 906 associated with “hot” cables AC1, AC2, or AC3. The selective coupling will be dependent upon which circuit is to be used. The selectively coupled end of the line 908 may be in the form of any suitable terminal which could be electrically coupled to the spade of the symbolic contact 906. Such a selective interconnection can be done on-site or, and likely preferably, at the manufacturing site when the connector module 144 is assembled. In any event, such a pigtail configuration may provide a convenient means for using connector modules 144 of substantially the same configurations with any of the three circuits AC1, AC2 or AC3. Of course, and as apparent from the description herein, the structural channel system 100 is not, in any manner, limited to the use of three AC circuits. Any number of AC power circuits may be employed. Also, it should be kept in mind that various configurations may be utilized for the electrical interconnections of the communication female terminal set 832 and AC power female terminal set 834 of the connector module 144 to the communications cable terminal set 646 and AC power terminal set 648 of the modular plug 576, without departing from the principal concepts of the invention.

As illustrated in FIG. 44A, the AC “hot” cable AC1 is electrically connected through one of the symbolic contacts 906 and applied through line 908 as an input to a conventional and commercially available transformer 910. Correspondingly, the neutral AC power cable ACN also is electrically connected through one of the symbolic contacts 906 and applied to the transformer 910 through line 912. Further, ground AC power cable ACG may be electrically connected to a further one of the symbolic contacts 906, through the plug connector 586 of the module plug 576, and applied to the transformer 910 and relay through line 914.

The transformer 910 can be any of a number of conventional and commercially available transformers, which provide for receiving AC input power on lines 908, 912 and 914, and converting the AC power to an appropriate DC power level for functional operation of components of the board assembly 826. For example, one type of transformer which may be utilized is manufactured and sold by Renco Electronics, Inc. of Rockledge, Fla. The transformer is identified under Renco's part number RL-2230. The transformer 910 may convert 120 volt AC power from the power cables AC1, ACN and ACG to an appropriate level of DC power for operation of components on the board assembly 826. The DC power generated by the transformer 910 is applied as output power signals on symbolic line 916 (which may consist of several wires or cables). The DC power on line 916 is applied as input power signals to the processor and repeater circuitry 896.

In addition to the connection to the transformer 910, the AC power signals on lines 908, 912 and 914 are also applied as input signals to a receptacle relay 918, as illustrated in FIG. 44A. The receptacle relay 918, like the transformer 910, can also be a relatively conventional and commercially available component. The receptacle relay 918 includes three output lines, namely lines 908A, 912A and 914A. The receptacle relay 918 can be characterized as having two states, namely an “on” state and an “off” state. When the receptacle relay 918 is in an on state, the electrical signals on lines 908, 912 and 914 are switched through to lines 908A, 912A and 914A, respectively. Accordingly, line 908A is a hot line (corresponding to AC power cable AC1) which is applied as an input line to the receptacle 838. Correspondingly, lines 912A and 914A are neutral and ground lines, respectively, which are also applied as input lines to the receptacle 838. Still further, control signals for controlling the particular state of the receptacle relay 918 are applied as input control signals from the processor and repeater circuitry 896 through control line 920.

In operation, the receptacle connector module 144 may be “programmed” by a user through the use of the wand 892. The wand 892 may, for example, be utilized to transmit spatial signals 890 to the receptacle connector module 144, which essentially “announces” to the network 530 that the connector module 144 is available to be controlled. The wand 892 may then be utilized to transmit other spatial IR signals to an application device, such as a “switch,” which would then be “assigned” as a control for the connector module 144. The use of switches is subsequently described herein with respect to FIGS. 88A-88D. The switch will thereafter control application devices which may be “plugged into” the connector module 144 through the electrical receptacle 838. For example, it may be assumed that the receptacle 838 is electrically connected to the overhead fan 884 illustrated in FIG. 44. This connection can be made through the electrical cord 886 and plug 888 also illustrated in FIG. 44. The plug 888 is electrically engaged with the receptacle 838. With appropriate spatial signals 890 transmitted to the IR receiver 844 of the receptacle connector module 144, and to an IR receiver on the controlling application device (i.e., the switch) which is to control whether electrical power is applied through the receptacle 838, IR receiver circuitry will, in turn, transmit electrical signals on line 894 to the processor and repeater circuitry 896. The signals received by the processor and repeater circuitry 896 may, for example, be signals which would cause the processor and repeater circuitry 896 to program itself so as to essentially “look” for specific communication signal sequences from the communication cables CC1 and CC2. To undertake these functions, it is clear that the controlling application device (not shown in FIG. 44) also requires logic circuitry which may be “programmed.” Also, this logic circuitry must be capable of transmitting signals (either by wire or wireless) to the communications cables CC1 and CC2.

Assuming that programming has been completed, and assuming that the relay 918 is in an “off” state, meaning that electrical power is not being applied through receptacle 838, the user may activate the switch or other controlling device. Activation of this switch may then cause transmission of appropriate communication signal sequences on communication cables CC1 and CC2. The processor and repeater circuitry 896 will have been programmed to interrogate signal sequences received from the communication cables CC1 and CC2, and respond to particular sequences generated by the controlling switch, which indicate that power should be applied through the receptacle 838. In response to receipt of these signals on lines 900 and 902 from the communication cables CC1 and CC2, the processor and repeater circuitry 896 will cause appropriate control signals to be applied on line 920 as input signals to the receptacle relay 918. The receptacle relay 918 will be responsive to these signals so as to change states, meaning that the receptacle relay 918 will move from an off state to an on state. With this movement to an on state, power from the AC power cables AC1, ACN and ACG will be applied through the receptacle relay 918 to the receptacle 838. In this manner, the overhead fan 884 will be energized.

In addition to the foregoing components, the receptacle connector module 144 also includes other components and features. For example, for purposes of providing a visual indication to a user of the current status of the receptacle connector module 144, the connector module 144 can include a status light or indicator 926. The status light can be secured to the structural components of the connector module 144 in any suitable manner, so as to be readily visible to the user. For this reason, it is preferable that the status light 926 extend outwardly from the lower surface 850 (see FIG. 37) of the outer structure of the connector module 144. The status light 926 can be controlled by status signals from the processor and repeater circuitry 896, as applied through line 928. The status light or indicator 926, as will be described in subsequent sections herein, can be utilized to indicate whether a particular connector module or actuator has been designated by a user as being part of the electrical network 530. Also, the status light or indicator 926 can be utilized to provide an indication as to whether the particular sensor or actuator has been associated with other sensors or actuators will respect to control relationships. In this regard, when the connector module 144 is “powered,” the processor and repeater circuitry 896 will be “aware” of the status, and can apply appropriate signals to the status light 926, indicating the same. The status light 926 can be any of a number of conventional lights, and may comprise an LED.

As subsequently described in greater detail, various types of connector modules can be utilized for various functions associated with the structural channel system 100. These functions are associated with AC power, DC power and network communications. As also previously described, network communications occur through communication signals on communication cables CC1 and CC2 of the communication cables 572 associated with the sections 540 of the modular plug assembly 130. Devices which are to act as controlling or control devices must therefore be coupled into the network 530. The prior description explained how an application device, such as the overhead fan 884 (FIG. 44), could be coupled into a programmable connector module comprising the receptacle connector module 144. As also described, controlling devices, such as switches and the like, may also be coupled into the network 530. These devices, which are also “smart” devices (in that they may include processors and associated electronic elements), have the capability of transmitting and receiving communication signals from connector modules through the communication cables 572, and are also powered. Accordingly, the structural channel system 100 provides means for supplying DC power to application devices, and for transmitting and receiving communication signals from and to these application devices and the communication cables 572.

This capability of providing communications to “smart” devices is provided in substantial part through the connector ports 840, which were previously described from a structural format with respect to FIG. 37. The ports 840 are symbolically shown as being part of the board assembly 826 in FIG. 44A. The connector ports 840 can be relatively conventional and commercially available communication ports, such as RJ45 ports, with a selected number of circuit wires being utilized with the ports. The connector ports 840 have bidirectional communications with the processor and repeater circuitry 896 through symbolic lines 922 and 924. The connector ports 840 provide a means for interconnecting switches and the like to the network 530. Specifically, through the processor and repeater circuitry 896, communication signals can be transmitted and received through the connector ports 840 to and from controlling devices with the use of patch cords (not shown in FIG. 44A) connecting the connector ports 840 to the controlling application devices. Still further, DC power can be applied from the processor and repeater circuit 896 through lines 922 and 924 and the connector ports 840 to interconnected controlling application devices, for purposes of powering circuit boards and other components within the switches or other application devices. In this regard, if necessary, the transformer 910 may generate a certain level of DC power on line 916, while the processor and repeater circuitry 896 may cause a different level of DC power to be generated on lines 922 and 924, and applied to various application devices through connector ports 840.

With the configuration shown for the connector ports 840 of the receptacle connector module 144, not only can communication signals and DC power be transmitted to interconnected application devices through lines 922 and 924, but such interconnected application devices can also transmit communication signals back to the processor and repeater circuitry 896 through the ports 840 and lines 922, 924. Such communication signals can then be processed by the processor and repeater circuitry 896, and/or the same or different communication signals (in response to the communication signals received on lines 922,924) can be transmitted to the communication cables CC1 and CC2 through lines 900 and 902. These lines 900 and 902 are then being utilized as lines for output signals from the processor and repeater circuitry 896, which are applied to the communication cables CC1 and CC2 through the symbolic contacts 898 and plug connector 586 of a modular plug 574. In this regard, FIG. 88 illustrates the coupling of connector ports 840 of a receptacle connector module 144 to a section 540 of the modular plug assembly 130. FIG. 88 further illustrates a patch cord 932 connected at one end to one of the connector ports 840, and connected at its other end to a connector port of a switch 934. It is in this manner that communication signals can be transmitted from the switch 934 to the connector module 144 and to communication cables CC1 and CC2 associated with the communication cables 572. These communication signals from the switch 934 may be utilized for various control purposes, including control of devices electrically interconnected to the receptacle 838 of the receptacle control module 144, such as through plug 888 and cord 886 shown, in part, in FIG. 88.

A further feature of the receptacle connector module 144, which is also associated with other connector modules subsequently described herein, relates to “repeater” functions. The connector module 144 includes repeater features associated with the processor and repeater circuitry 896. The repeater circuitry 896 is provided for purposes of maintaining signal and power strength. Such functions are relatively well known in the electronic arts. Repeater circuitry can take various forms, but may typically be characterized as circuitry which is used to extend the length, topology or interconnectivity of physical media beyond that imposed by individual segments. This is a relatively “complex” way to define the conventional activities of repeaters, which are to perform basic functions of restoring signal amplitudes, wave forms and timing to normal data and collision signals. Repeaters are also known to arbitrate access to a network from connected nodes, and optionally collect statistics regarding network operations.

In the receptacle connector module 144 as illustrated in FIG. 44A, the processor and repeater circuitry 896 utilizes DC power generated as output from the transformer 910 to operate its own internal circuitry, and to provide signal enhancement and apply output DC power to each of the connector ports 840 through the lines 922, 924. Also, as earlier described, communication signals can be transmitted to and received from the communication cables 572 through the symbolic contacts 898 and lines 900 and 902. The processor and repeater circuitry 896 is adapted to enhance these communication signals. Such communication signals may be transmitted to and received from application devices connected to the connector ports 840.

In accordance with the foregoing, the connector module 144 includes not only features associated with control of power applied to the receptacle 838, but also provides for distributing power to interconnected application devices through the connector ports 840 connected to the processor and repeater circuitry 896, and for transmitting and receiving communication signals to and from interconnected application devices and the communication cables 572. Still further, the receptacle connector module 144 (and other connector modules as subsequently described herein) operate so as to provide repeater functions, which may be in the form of signal amplifications, wave shaping, collision priorities and the like. It should also be noted that in the example embodiment of the structural channel system 100, functions such as signal amplification and the like can be performed solely with DC power provided through the transformer 910, and do not require any AC power directly provided from AC power cables 574. Further, these repeater functions also do not require any DC power received from outside of the corresponding connector module 144, such as from external transformers or the like.

As a primary feature of the receptacle module 144, the module 144 comprises means responsive to programming signals received from a user (utilizing the wand 892) to configure itself so as to be responsive to selectively control the application of AC power to the receptacle 838 from appropriate ones of the AC power cables 574. In this regard, and as earlier explained, although FIG. 44A illustrates AC power cable AC1 as being utilized, it is clear that cables AC2 or AC3 could also be utilized, with appropriate interconnections.

With respect to functions of the receptacle connector module 144, the combination of the IR receiver 844, processor and repeater circuitry 896, receptacle relay 918 and associated incoming and outgoing lines, may be characterized as an “actuator” 936. The actuator 936 is shown in FIG. 44A as consisting of the components captured within the phantom line boundary of the actuator 936. An actuator 936 may be found in all of the connector modules described herein, and each includes an IR receiver 844 and processor and associated repeater circuitry 896. Elements other than the receptacle relay 918 may be incorporated within the actuators 936 utilized with other connector modules. In this regard, an actuator 936 can be defined as a component of the electrical network 530 which controls the application of AC or DC power to devices such as light fixtures, projection screen motors, power poles and similar devices. Although this specification describes only a certain number of connector modules, for utilization with a certain number of application devices, it will be apparent that various other types of connector modules and application devices having functions differing from those described herein may be utilized with a structural channel system in accordance with the invention, without departing from the principal novel concepts of the invention.

With the use of the receptacle connector module 144, the module 144 and the application device to which the module is connected (in this instance, overhead fan 884) actually become part of the distributed electrical network 530. It should also be noted that this interconnection or addition of an application device (i.e., the overhead fan 884) to the structural channel system 100 has occurred, through use of the connector module 144, without requiring any physical rewiring or programming of any centralized computers or any other centralized control systems. The receptacle connector module 144 and other connector modules as subsequently described herein, in combination with the capability of being coupled to AC and DC power, and communication signals through communication cables 572, provide for a true distributed network. Also, it will be apparent to those of ordinary skill in the art that the processor and repeater circuitry 896 may include a number of elements, such as memory, microcode, instruction registers and the like for purposes of logically controlling the receptacle relay 918, in response to communication signals received by the processor and repeater circuitry 896. Concepts associated with “programming” a control switch electrically connected to the network 503, so that activation of the control switch will transmit communication signals which may be received by appropriate logic in the receptacle connector module 144, will be explained in somewhat greater detail in subsequent paragraphs relating to FIGS. 59-63. Other examples associated with the use of a manually operated and hand-held device for transmitting appropriate signals to program a “control/controlling” relationship between and among devices, including those associated directly with connector modules, are described in International Patent Application No. PCT/US03/12210, filed Apr. 18, 2003.

Still further, it will also be apparent to those skilled in the art that the board assembly 826 of the receptacle connector module 144, and board assemblies of other connector modules subsequently described herein, may include a number of other electronic components. For example, the board assembly 826 may include line surge protection components, for purposes of component protection and safety. Also, the processor and repeater circuitry 896 may include various interface logic for purposes of communications with the status light 926 and IR receiver 844. In addition to the processor and repeater circuitry 896 including components such as those previously described herein, and components such as a microcontroller and oscillator, support components may be included. Such support components may include, for example, a micro debug interface circuit. Still further, for purposes of communications between the circuitry 896 and other components associated with the receptacle module 144 and the structural channel system 100, communications control logic may be included, and may also include logic associated with transceivers, signal arbitrations, “short to power” detection, and other functional components and features. Communications circuitry and software associated with communications from and to the processor and repeater circuitry 896 may also include various relays, relay control logic and other functional components and software such as zero crossing detectors.

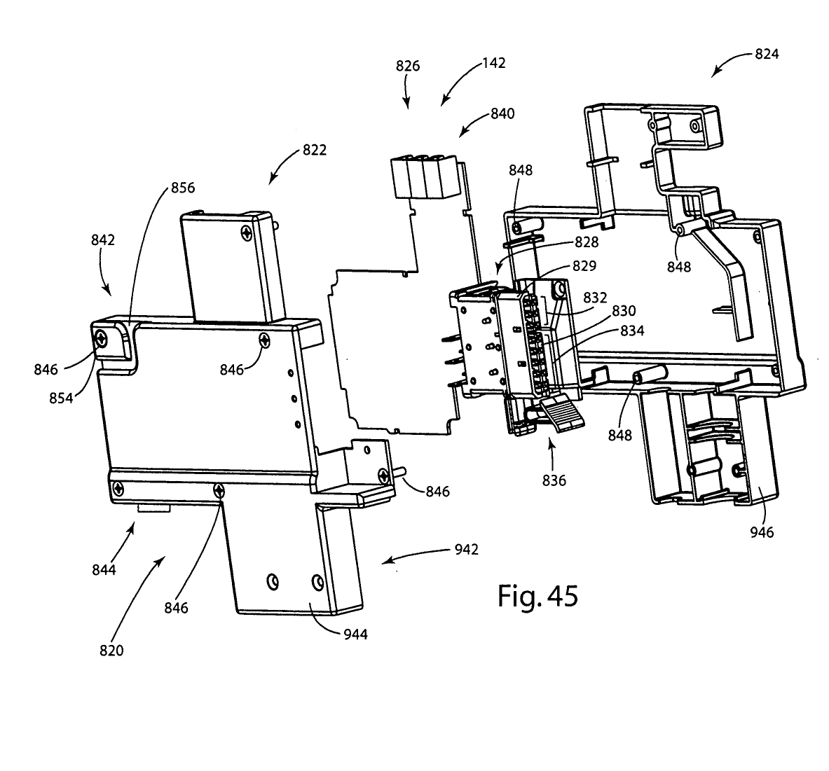

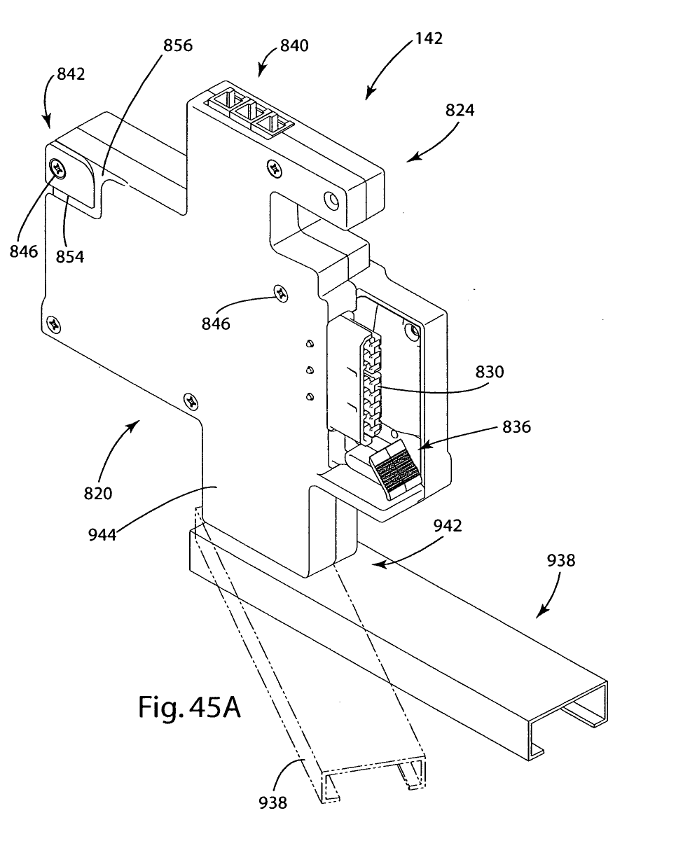

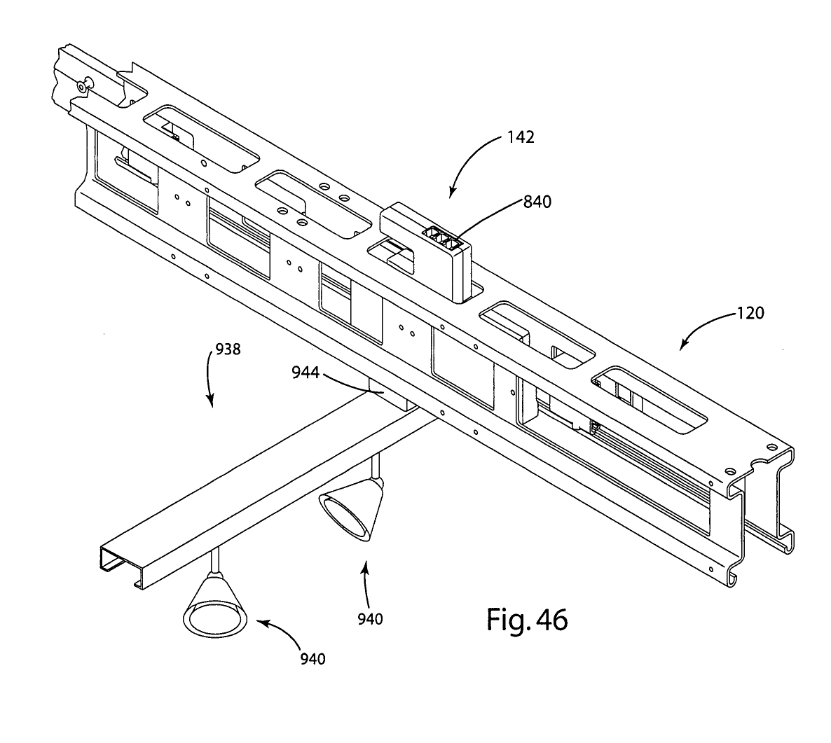

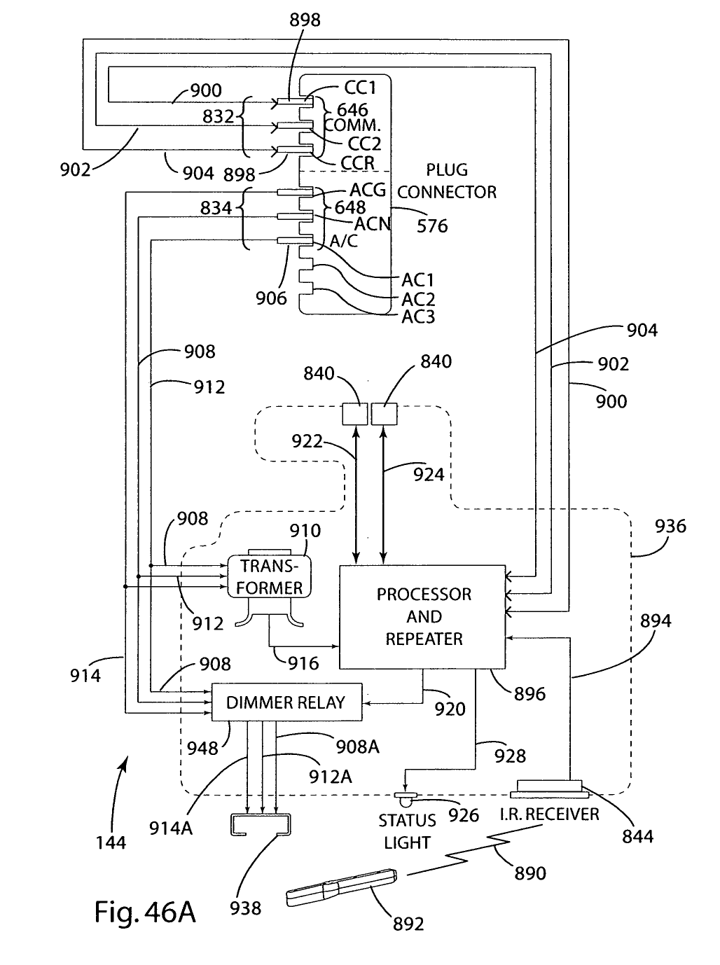

A number of differing connector modules may be utilized in accordance with the invention. As a further example, a connector module referred to as a dimmer connector module 142 is illustrated in FIGS. 45, 45A, 46 and 46A. The dimmer connector module 142 is similar in mechanical and electrical structure to the previously described receptacle module 144. However, the dimmer connector module 142 is adapted to interconnect to conventional dimmer lights, such as those that may be found on a track light rail 938 illustrated in FIGS. 45A and 46. Well known and commercially available lights, light rails and track lighting which may be utilized with the dimmer connector module 142 are adapted to receive electrical power input signals of varying voltages. The track light rail 938 is electrically and mechanically coupled to a series of lights 940, two of which are shown as an example embodiment in FIG. 46. The lights 940 are adapted to receive electrical power input signals of varying voltages, so as to vary their intensity. That is, when relatively lower voltages are applied as input power to the lights 940, the intensity of the emanating light is relatively low. Correspondingly, higher voltages will cause the lights 940 to emanate a higher intensity of light. In addition to using the concept of varying voltages for purposes of varying light intensity, other uses may also be employed in accordance with the invention. For example, the concept of utilizing connector modules for purposes of applying varying voltage signals may be utilized for sound intensity, acoustical management, fan speed and many other applications. In fact, the dimmer connector module 142 and similar connector modules which provide for varying output voltages may be utilized with any type of application device which will accept power signals of varying amplitudes.

Turning specifically to the dimmer connector module 142, and as earlier stated, the module 142 is somewhat similar to the receptacle connector module 144. Accordingly, like structure of the connector module 142 will be numbered with like reference numerals corresponding to the receptacle connector module 144. In FIG. 45, the dimmer connector module 142 is illustrated in a stand-alone configuration. As with the receptacle connector module 144, the dimmer connector module 142 can be referred to as a “smart” connector module, in that it includes certain logic which permits the connector module 142 to be programmed by a user (through a remote means) so as to initiate or otherwise modify a control/controlling relationship between devices energized through the dimmer connector module 142 and controlling devices, such as switches or the like. As with the receptacle connector module 144, the dimmer connector module 142 includes a connector housing 820. The connector housing 820 includes a front housing cover 822 and rear housing cover 824. Fasteners 846 extend through apertures in the front housing cover 822 and are secured with threaded couplers 848 within the rear housing cover 824 for purposes of securing the covers 822, 824 together. Secured within the connector housing 820 is a board assembly 826. The internal circuitry of the board assembly 826 will be described with respect to FIG. 46A. The board assembly 826 includes a connector plug 828, surrounded by a connector plug housing 829. A set of eight female terminals 830 extend toward the end of the connector plug 828 to the opening of the plug housing 829. The female terminals 830 include the communications female terminal set 832. The communications female terminal set 832 will be electrically connected to the communications male terminal set 646 previously described with respect to FIG. 28A. Correspondingly, an AC power female terminal set 834 is also provided as part of the connector plug 828. When coupled to a modular plug 576 of a section 540 of the modular plug assembly 130, the AC power female terminal set 834 will be engaged with the AC power male terminal set 648 of the modular plug 576, as also shown in FIG. 28A.

Also in a manner substantially corresponding to that of the receptacle connector module 144, the dimmer connector module 142 includes a connector latch assembly 836, for purposes of securing the connector plug 828 of the connector module 142 to a modular plug 576. The operation of the connector latch assembly 836 corresponds to the previously described operation of the connector latch assembly 836 associated with the receptacle connector module 144.

In addition to the foregoing, and like the receptacle connector module 144, the dimmer connector module 142 includes a set of two connector ports 840 at the top portion thereof. The connector ports 840 provide a means for transmitting communication signals to and from various application devices (including switches and the like). The communication signals may then be carried to and from the communication cables 572 associated with the modular plug assembly 130.

The dimmer connector module 142 also includes an IR receiver 844, located as shown in FIG. 45A at the lower portion of the connector housing 820. As with the receptacle connector module 144, the module 142 is electrically coupled to communication cables 572 and AC power cables 574 of the modular plug assembly 130 through a mating connection of the female terminals 830 within the connector plug 828 to the male blade sets or terminals 588, 590 of one of the modular plugs 576 associated with the plug assembly 130. Further, the dimmer connector module 142 also includes a ferrule coupler 842, used in combination with one of the spaced apart ferrules 570 which is secured to one of the electrical dividers 554 of a section 540 of the modular plug assembly 130. The structure and functional operation of the ferrule coupler 842 corresponds to that described with respect to the receptacle connector module 144 and illustrated in FIGS. 37A, 38 and 39. Accordingly, the functional operation of the ferrule coupler 842 for the dimmer connector module 142 will not be repeated herein.

To prevent any unintentional movement of the dimmer connector module 142, the connector module 142 further includes a connector latch assembly 836 corresponding in structure and function to the connector latch assembly 836 previously described with respect to the receptacle connector module 144. The structure and functional operation of the connector latch assembly 836 was previously described with respect to FIGS. 28A, 42 and 43. Accordingly, this description will not be repeated in detail herein for the dimmer connector module 142. As with the receptacle connector module 144, the connector latch assembly 836, in combination with a mating ramp 870 of a modular plug 576, and the ferrule coupler 842, in combination with a ferrule 570, serve to provide for mechanical interconnection of the dimmer connector module 142 to a section 540 of the modular plug assembly 130. With this interconnection, external forces must be manually exerted on a latch shoe 882 of the connector latch assembly 836, for purposes of disconnecting the dimmer connector module 142 from a modular plug 576. These components provide means for preventing inadvertent vertical or horizontal movement of the dimmer connector module 142, relative to the section 540 of the modular plug assembly 130.

In addition to the foregoing components, and unlike the receptacle connector module 144, the dimmer connector module 142 includes a lower dimmer housing 942 formed within the front dimmer housing 944 and rear dimmer housing 946 as shown in FIG. 45: The lower dimmer housing 942 will house electrical components interconnected to the board assembly 826 which are specifically adapted for interconnection to track lighting, conventional dimmer lights or other application devices which have are responsive to variations in voltage amplitudes applied to application device components. For purposes of providing AC power of varying voltages to an application device through dimmer circuitry within the lower dimmer housing 942, a dimmer relay 948 as subsequently described herein will be coupled to AC power from the AC power cables 574. As an example of use, and as shown in FIG. 46, the dimmer connector module 142 can be utilized to energize an electrical application device such as the track lighting 938. The track lighting 938 will be energized through appropriate electrical wires or cables (not shown) interconnected to dimmer circuitry within the dimmer connector module 142.

The internal circuitry on the board assembly 826 of the dimmer connector module 142 includes a number of components substantially corresponding to components of the receptacle connector module 144 previously described with respect to FIG. 44A. The internal circuitry of the dimmer connector module 142 is illustrated in FIG. 46A. Like numbers have been utilized as reference numerals for components corresponding to numbered components of the receptacle connector module 144. Accordingly, the dimmer connector module 142 includes the IR receiver 844, adapted to receive spatial IR signals 890 from the manually operable and hand-held wand 892. As earlier mentioned, the wand 892 is operated by a user, and will be described in greater detail with respect to FIGS. 59, 60 and 61. The IR receiver 844 converts incoming spatial IR signals 890 to electrical signals applied as output signals on line 894. These output signals are applied as input signals to the processor and associated repeater circuitry 896.

In addition to signals received by the processor and associated repeater circuitry 896 from the IR receiver 844 through line 894, the circuitry 896 also receives communication signals from cables CC1, CC2 and CCR of the modular plug assembly 130. The signals are tapped off the plug connector 586 of the modular plug 576. Signals from the communication cables CC1, CC2 and CCR are then received through the communications cable terminal set 646 (see FIG. 28A) of the plug connector 586. These terminals are coupled through the communications female terminal set 832 of the module 142. This connection is illustrated in FIG. 46A, through “symbolic” contacts 898. It should be noted that FIG. 46A represents the dimmer connector module 142 when the module 142 is mechanically and electrically engaged with a section 540 of the modular plug assembly 130, and an associated modular plug 576.

As further shown in FIG. 46A, communication signals are applied through the symbolic contacts 898 and lines 900 and 902 as input signals to the processor and associated repeater circuitry 896. Return communication cable CCR is also connected through a contact 898, with its signal applied to the circuitry 896 on line 904. The lines 900, 902 and 904 are bidirectional, and the circuitry 896 is adapted to generate output signals as communication signals to the cables CC1, CC2 and CCR through the contacts 898.

Turning to the AC power portion of the dimmer connector module 142, an AC power terminal set 648 is mounted on the plug connector 586 and connected to the AC power cables 574 (see FIG. 28) which run through the modular plug assembly 130. The terminal set 648 is interconnected to the AC power female terminal set 834 associated with the dimmer connector module 142 (see prior description with respect to FIG. 45). This interconnection is illustrated through the use of symbolic contacts 906.

In this particular embodiment of the dimmer connector module 142, the symbolic contacts 906 are illustrated as corresponding to electrical interconnection of AC power cables AC1, ACN and ACG. AC1 corresponds to the “hot” cable. However, as previously described herein, and for purposes of balancing and the like, AC power could be received by the connector module 142 utilizing AC power cables AC2 or AC3. Also as previously described, the line 908 and the symbolic contact 906 associated with AC power cable AC1 could actually be in the form of a pigtail secured to the transformer 910, and capable of being selectively interconnected to any of the terminals corresponding to the AC power cables AC1, AC2 or AC3. Of course, other types of configurations could be utilized for providing selective interconnection to one of the “hot” circuits made available for use with the dimmer connector module 142.

As with the receptacle connector module 144, the interconnections to the AC cables AC1, ACN and ACG can be applied as input through lines 908, 912 and 914, respectively, to the transformer 910. The transformer 910 for the dimmer connector module 142 may correspond in structure and function to the transformer 910 utilized with the receptacle connector module 144. The transformer 910 may convert AC power from the power cables AC1, ACN and ACG to DC power, applied as output power signals on symbolic line 916. The DC power on line 916 is applied as input power to the processor and repeater circuitry 896.

In addition to the connections to the transformer 910, the AC power signals on lines 908, 912 and 914 are also applied as input signals to what is illustrated in FIG. 46A as a dimmer relay 948. The dimmer relay 948 as illustrated in FIG. 46A includes output lines 908A, 912A and 914A. Control signals for the dimmer relay 948 are applied as output signals from the processor and associated repeater circuitry 896 on control line 920. With respect to operation of the dimmer relay 948, the AC power which is applied as input on lines 908, 912 and 914 will be relatively constant in amplitude. The control signals on line 920 applied to the dimmer relay 948 from the processor and associated repeater circuitry 896 will act so as to modify the AC output voltage amplitudes applied to the light track 938 through lines 908A, 912A and 914A. Various types of dimmer relays are well known and commercially available.

In operation, the dimmer connector module 142 may be “programmed” by a user through use of the wand 892. The wand 892 may, for example, be utilized to transmit spatial signals 890 to the dimmer connector module 142, which essentially “announces” to the network 530 that the connector module 142 is available to be controlled. The wand 892 may then be utilized to transmit other spatial IR signals to an application device, such as a dimmer switch, which would then be assigned as a control for the connector module 142. The use of switches is subsequently described herein with respect to FIGS. 59A-59F. The dimmer switch will thereafter control track lighting or other similar types of dimming devices which may be interconnected to the track light rail 938 or any other appropriate components for electrically coupling the dimming devices to the dimmer relay 948. For example, it may be assumed that the dimmer relay 948 is electrically connected through appropriate dimmer electronics to a track light rail 938, having the lights 940. With appropriate spatial signals 890 transmitted to the IR receiver 844 of the dimmer connector module 142, and to an IR receiver on the controlling application device (i.e. the dimmer switch) which is to control the amplitude of electrical power applied through the dimmer relay 948, IR receiver circuitry would, in turn, transmit electrical signals on line 894 to the processor and repeater circuitry 896. Signals received by the processor and repeater circuitry 896 may, for example, be signals which would cause the processor and repeater circuitry 896 to program itself so as to essentially “look” for specific communication signal sequences from the communication cables CC1 and CC2. To undertake these functions, it is clear that the controlling application device (not shown in FIG. 45) also requires logic circuitry which may be “programmed.” Such logic circuitry must be capable of transmitting signals (either by wire or wireless) to the communication cables CC1 and CC2.

Assuming that programming has been completed, and assuming that the dimmer relay 948 is essentially in a “zero” state, meaning that no electrical power is being applied through lines 908A, 912A and 914A, the user may activate the dimmer switch or other controlling device. Activation of this switch may then cause transmission of appropriate communication signal sequences on communication cables CC1 and CC2. The processor and repeater circuitry 896 would have been programmed to interrogate signal sequences received from the cables CC1 and CC2, and respond to particular sequences generated by the controlling dimmer switch, which indicate the level of power which should be applied through the dimmer relay 948. In response to receipt of these signals on lines 900 and 902 from the cables CC1 and CC2, respectively, the processor and repeater circuitry 896 will cause appropriate control signals to be applied on control line 920 as input signals to the dimmer relay 948. The dimmer relay 948 will be responsive to these signals so as to vary the amplitude of power or voltage which is permitted to “pass through” the dimmer relay 948 from the lines 908, 912 and 914. Accordingly, the output intensity of the lights 940 may be varied, in accordance with the level of power transmitted through the dimmer relay 948.

In addition to the foregoing components, the dimmer connector module 142 also includes other components and features. As with the receptacle connector module 144, the dimmer connector module 142 can include a status light 926. The light can be controlled by status signals from the processor and repeater circuitry 896, as applied through line 928. In addition, for purposes of coupling various application devices into the network 530, the dimmer connector module 142, like the connector module 144, includes a pair of connector ports 840. The connector ports 840 have bidirectional communications with the processor and repeater circuitry 896 through symbolic lines 922 and 924. Communication signals can be transmitted or received through the connector ports 840 to and from controlling devices with the use of patch cords (not shown in FIG. 46A) connecting the connector ports 840 to the controlling application devices. Also, with the configuration shown for the connector ports 840 of the dimmer connector module 142, not only can communication signals and DC power be transmitted to interconnected application devices through lines 922 and 924, and connector ports 840, but such interconnected application devices can also transmit communication signals back to the processor and repeater circuitry 896 through the ports 840 and lines 922, 924. Such communication signals can then be processed by the circuitry 896, and the same or different communication signals can be transmitted to the communication cables CC1 and CC2 through lines 900 and 902. In this manner, communication signals from the application devices can be applied to the network 530. Still further, and as with the receptacle connector module 144, the dimmer connector module 142 includes the IR receiver 844, processor and repeater circuitry 896 and associated incoming and outgoing lines. These components, along with the dimmer relay 948, may be characterized as an “actuator” 936, as shown in FIG. 46A. Further, with the use of the dimmer connector module 142, the module 142 and the application device to which the module is connected become part of the distributed electrical network 530. In accordance with all of the foregoing, the dimmer connector module 142 comprises a means responsive to programming signals received from a user to configure itself so as to be responsive to selectively control the amplitude of AC voltages applied to application devices connected to the dimmer relay 948.

It should be emphasized that variations in the dimmer connector module 142 and the interconnected track light rail 948 may be implemented. For example, the track light rail 948 may be mechanically coupled to the bottom of the dimmer connector module 142, in a manner so that the rail 948 may be rotated in a horizontal plane. Accordingly, the rail 948 may be “angled” relative to the elongated axis of a section 540 of the modular plug assembly 130. This concept is illustrated in FIG. 45A, with an angled configuration of the rail 948 being shown in phantom line format.

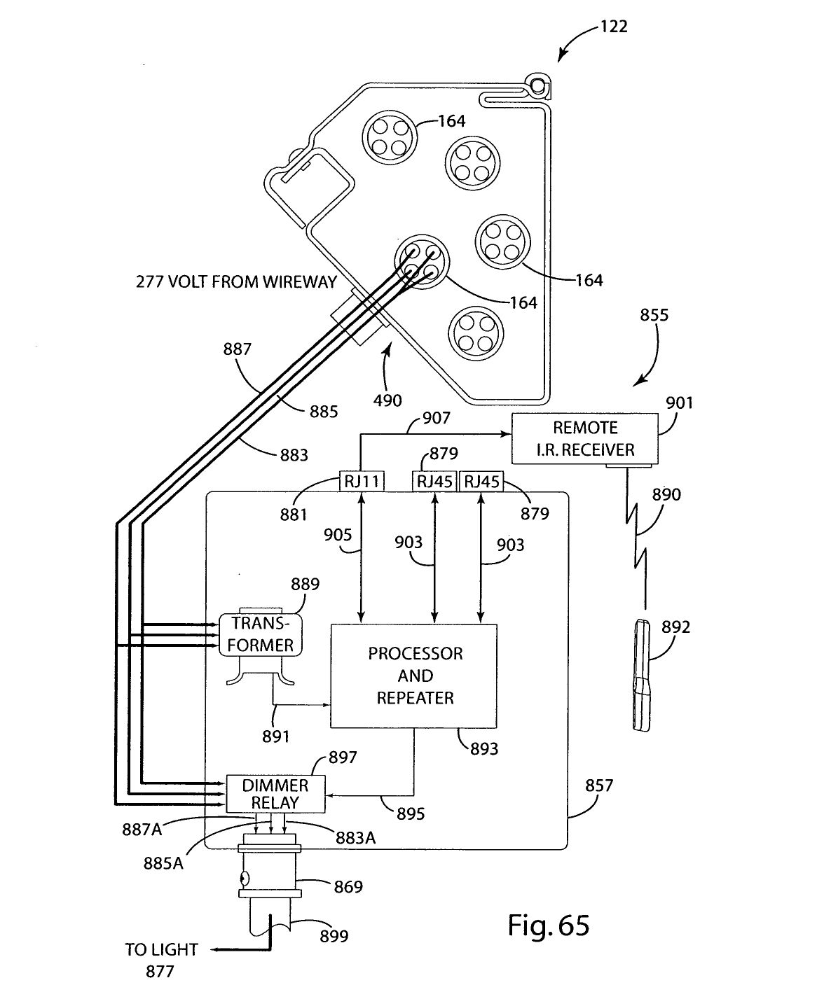

Another aspect of the dimmer connector module 142 and other connector modules which may be utilized should be mentioned. In the embodiment of the dimmer connector module illustrated herein, the IR receiver 844 for programmable control of the connector module 142 is located on the bottom of the connector module 142 itself. If desired, the dimmer connector module 142 could be wired so as to couple the logic and electronics within the connector module 142 to receivers located remotely from the connector module 142. In this manner, when a user wishes to remotely program the control/controlling relationships involving the lights 940, the user can transmit IR or other spatial signals to IR receivers adjacent the actual lights 940 which the user wishes to control. Otherwise, and particularly if the lights 940 may be located a substantial distance form the connector module 142, the user will essentially need to “back track” from the lights 940 so as to determine the location of the connector module 142 associated with the lights 940. This concept of utilizing a remotely positioned IR receiver 844 is described in subsequent paragraphs herein with respect to the dimmer junction box assembly 855 illustrated in FIGS. 65, 66 and 67.

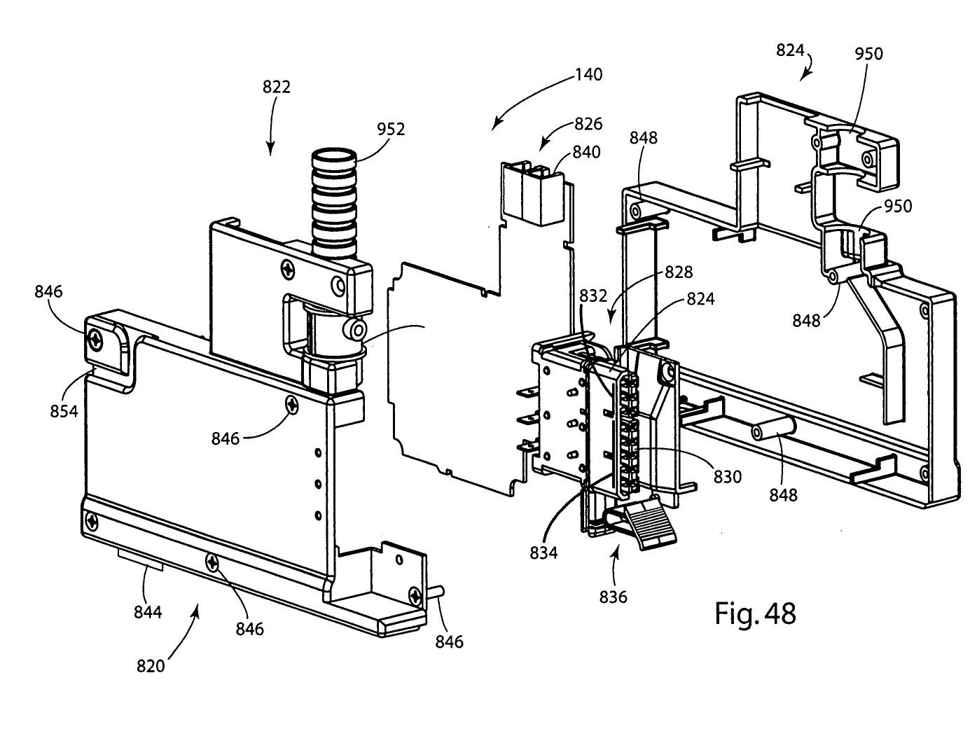

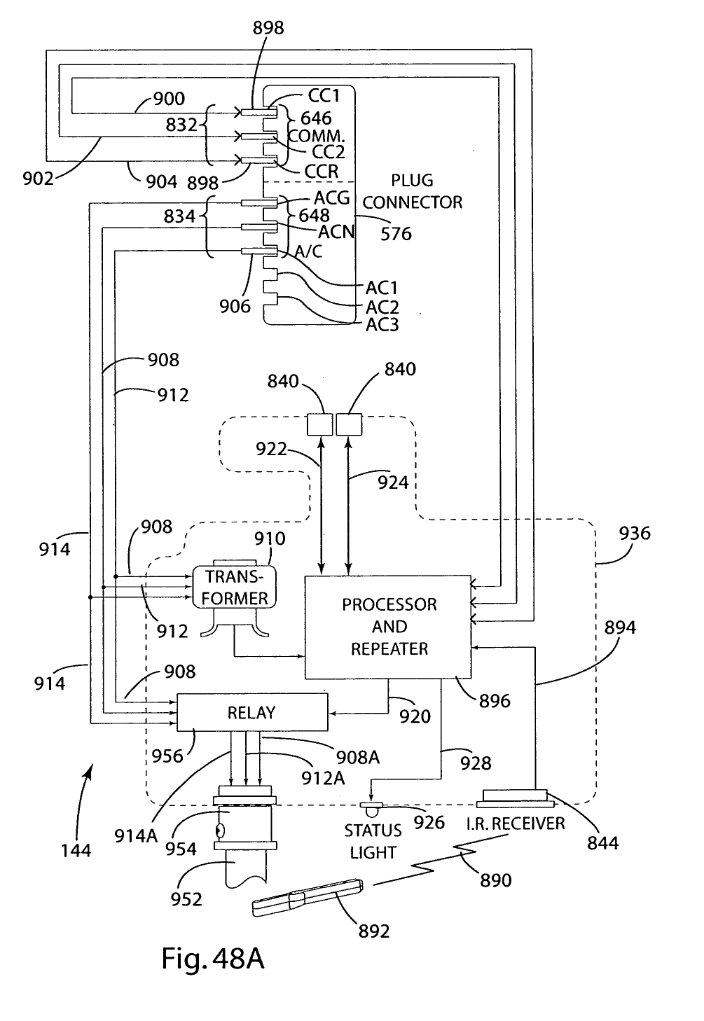

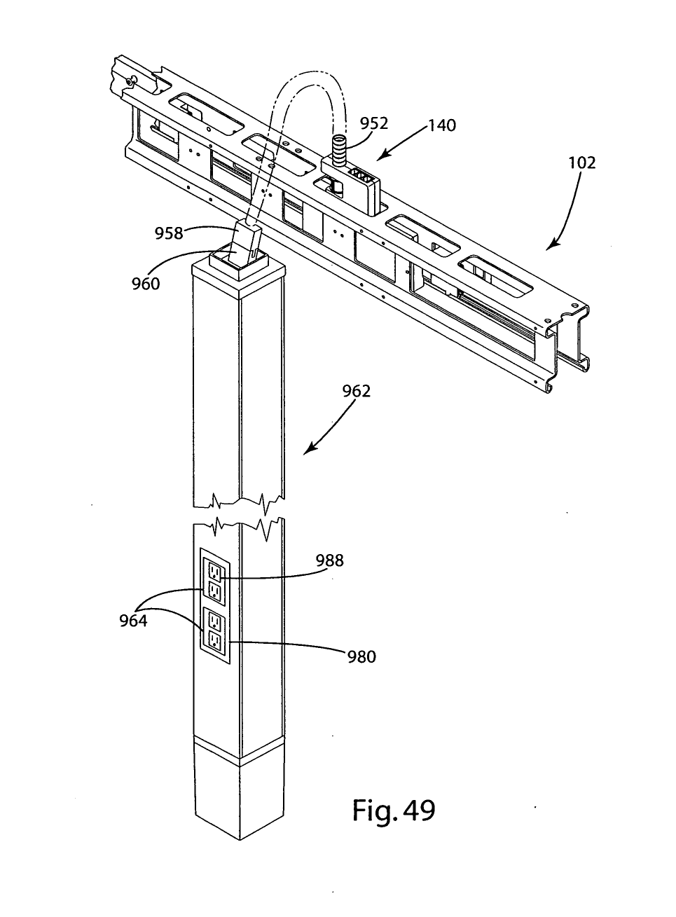

A still further example of a connector module which may be utilized is referred to herein as a power drop connector module 140, and is illustrated in FIGS. 48, 48A and 49. The power drop connector module 140 is substantially similar to the receptacle connector module 144. Accordingly, like structure of the connector module 140 will be numbered with like reference numerals corresponding to the receptacle connector module 144. The power drop connector module 140 is adapted to provide selectable AC power to application devices coupled to the connector module 140, such as the pole 962 described in subsequent paragraphs herein. Turning primarily to FIG. 48, the power drop connector module 140 is illustrated therein in a stand-alone configuration. As with the receptacle connector module 144, the power drop connector module 140 can be referred to as a “smart” connector module, in that it includes certain logic which permits the connector module 140 to be programmed by a user (through remote means) so as to initiate or otherwise modify a control/controlling relationship among devices energized through the power drop connector module 140, and also to control the devices, such as through switches or the like.

As with the receptacle connector module 144, the power drop connector module 140 includes a connector housing 820. The connector housing 820 includes a front housing cover 822 and rear housing cover 824. Fasteners 846 extend through apertures in the front housing cover 822 and are secured with threaded couplers 848 within the rear housing cover 824 for purposes of securing the covers 822, 824 together. Secured within the connector housing 820 is a board assembly 826. The internal circuitry of the board assembly 826 will be described with respect to FIG. 48A. The board assembly 826 includes a connector plug 828, surrounded by a connector plug housing 829. A set of eight female terminals 830 extend toward the end of the connector plug 828 to the opening of the plug housing 829. The female terminals 830 include the communications female terminal set 832. The communications female terminal set 832 will be electrically connected to the communications male terminal set 646 of a modular plug 576, previously described with respect to FIG. 28A. Correspondingly, an AC power female terminal set 834 is also provided as part of the connector plug 828. When coupled to a modular plug 576 of a section 540 of the modular plug assembly 130, the AC power female terminal set 834 will be engaged with the AC power male terminal set 648 of the modular plug 576, as also shown in FIG. 28A.

Also like the receptacle connector module 144, the power drop connector module 140 includes a set of two connector ports 840 at the top portion thereof. The connector ports 840 provide a means for transmitting communication signals to and from various application devices (including switches and the like), as well as a means for transmitting DC power to “smart” devices, such as switches. The communication signals may also be carried to and from the communication cables 572 associated with the modular plug assembly 130. The power drop connector module 140 also includes an IR receiver 844, located as shown in FIG. 48 at the lower portion of the connector housing 820. As with the receptacle connector module 144, the module 140 is electrically coupled to communication cables 572 and AC power cables 574 of the modular plug assembly 130 through a mating connection of the female terminals 830 within the connector plug 828 to the male blade sets or terminals 588, 590 of one of the modular plugs 576 associated with the plug assembly 130.

Further, the power drop connector module 140 also includes a ferrule coupler 842, used in combination with one of the spaced apart ferrules 570 which is secured to one of the electrical dividers 554 of a section 540 of the modular plug assembly 130. The structure and functional operation of the ferrule coupler 842 corresponds to that described with respect to the receptacle connector module 144 and illustrated in FIGS. 37A, 38 and 39. Accordingly, the functional operation of the ferrule coupler 842 for the power drop connector module 140 will not be repeated herein. The connector module 140 also includes a connector latch assembly 836 corresponding in structure and function to the connector latch assembly 836 previously described with respect to the receptacle connector module 144 and FIGS. 28A, 42 and 43. Accordingly, this description will not be repeated herein for the power drop connector module 140. As with the receptacle connector module 144, the connector latch assembly 836, in combination with a mating ramp 870 of a modular plug 576, and the ferrule coupler 842, in combination with a ferrule 570, provide mechanical interconnection of the power drop connector module 140 to a section 540 of the modular plug assembly 130. With this interconnection, external forces must be manually exerted on a latch shoe 882 of the connector latch assembly 836, for purposes of disconnecting the power drop connector module 140 from a modular plug 576. These components provide means for preventing inadvertent vertical or horizontal movement of the power drop connector module 140, relative to the section 540 of the modular plug assembly 130.

In addition to the foregoing components, and unlike the receptacle connector module 144, the power drop connector module 140 includes a pair of conduit slots 950 formed within the front housing cover 822 and rear housing cover 824, as illustrated in FIG. 48. A flexible conduit 952 extends upwardly from an upper portion of the front housing cover 822. The flexible conduit 952 is secured to the entirety of the housing cover 820 through a bushing 954, preferably having strain relief properties. As will be described with respect to FIG. 48A, AC power lines will extend through the flexible conduit 952, which are connected through a switching relay to the AC power cables 574 in the modular plug assembly 130. The flexible conduit 952 can include a universal connector at its terminating end, such as the connector 958 illustrated in FIG. 49. In this manner, AC power from the AC power cables 574 can be selectively applied to application devices connected to the flexible conduit 952. As an example, and as shown in FIG. 49, the power drop connector module 140 can be utilized to selectively energize an application device such as the power pole 962.

The internal circuitry on the board assembly 826 of the power drop connector module 140 includes a number of components substantially corresponding to components of the receptacle connector module 144 previously described with respect to FIG. 44A. This circuitry is illustrated in FIG. 48A. Like numbers have been utilized as reference numerals for components corresponding to numbered components of the receptacle connector module 144. Accordingly, the power drop connector module 142 includes the IR receiver 844, adapted to receive spatial IR signals 890 from the manually operable and hand-held wand 892. As earlier mentioned, the wand 892 is operated by a user, and will be described in greater detail with respect to FIGS. 59, 60 and 61. The IR receiver 844 converts incoming spatial IR signals 890 to electrical signals applied as output signals on line 894. These output signals are applied as input signals to the processor and associated repeater circuitry 896.

In addition to signals received by the processor and associated repeater circuitry 896 from the IR receiver 844 through line 894, the circuitry 896 also receives communication signals from cables CC1, CC2 and CCR of the modular plug assembly 130. These signals are received through the communications cable terminal set 646 (see FIG. 28A) of the plug connector 586. These terminals are coupled through the communications female terminal set 832 of the module 140. This connection is illustrated in FIG. 48A, through “symbolic” contacts 898. It should be noted that FIG. 48A represents the power drop connector module 140 when the module 140 is mechanically and electrically engaged with a section 540 of the modular plug assembly 130, and an associated modular plug 576.

As further shown in FIG. 48A, communication signals are applied through the symbolic contacts 898 and lines 900 and 902 as input signals to the processor and associated repeater circuitry 896. Return communications cable CCR is also connected through a contact 898, with its signal applied to the circuitry 896 on line 904. The lines 900, 902 and 904 are bidirectional, and the circuitry 896 is adapted to generate output signals as communication signals applied to the cables CC1, CC2 and CCR through the contacts 898.

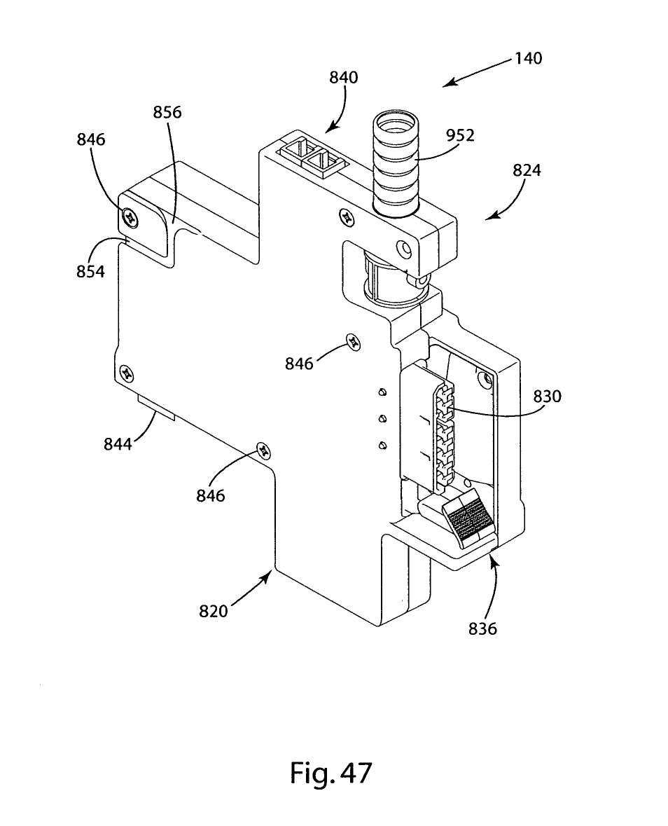

Turning to the AC power portion of the power drop connector module 140, an AC power terminal set 648 is mounted on the plug connector 586 and connected to the AC power cables 574 (see FIG. 28) which run through the modular plug assembly 130. The terminal set 648 is interconnected to the AC power female terminal set 834 associated with the power drop connector module 142 (see prior description with respect to FIGS. 47 and 48). This interconnection is illustrated through the use of symbolic contacts 906.

In this particular embodiment of the power drop connector module 140, the symbolic contacts 906 are illustrated as corresponding to electrical interconnection of AC power cables AC1, ACN and ACG. AC1 corresponds to the “hot” cable. However, as previously described herein, and for purposes of balancing and the like, AC power could be received by the connector module 142 utilizing AC power cables AC2 or AC3. Also, as previously described, the line 908 and the symbolic contact 906 associated with AC power cable AC1 could actually be in the form of a pigtail and selectively secured to the transformer 910, and capable of being interconnected to any of the terminals corresponding to the AC power cables AC1, AC2 or AC3. Also, of course, other types of configurations could be utilized for providing selective interconnection to one of the “hot” circuits made available for use with the power drop connector module 140.

As with the receptacle connector module 144, the power from the AC cables AC1, ACN and ACG can be applied as input through lines 914, 912 and 908, respectively, to the transformer 910. The transformer 910 for the power drop connector module 140 may correspond in structure and function to the transformer 910 utilized with the receptacle connector module 144. The transformer 910 may convert AC power from the power cables AC1, ACN and ACG to DC power, applied as output power signals on symbolic line 916. The DC power on line 916 is applied as input power to the processor and repeater circuitry 896.

In addition to the connections to the transformer 910, the AC power signals on lines 908, 912 and 914 are also applied as input signals to what is illustrated in FIG. 48A as a relay 956. The relay 956, like the transformer 910, can be a relatively conventional and commercially available device. The replay 956 includes three output lines, namely lines 908A, 912A and 914A. Further, the relay 956 can be characterized as having two states, namely an “on” state and an “off” state. When the relay 956 is in an on state, the electrical AC power signals on lines 908, 912 and 914 are switched through to lines 908A, 912A and 914A, respectively. Accordingly, line 908A is a hot line (corresponding to AC power cable AC1) which is applied as an input line to the flexible conduit 952. Correspondingly, lines 912A and 914A are neutral and ground lines, respectively, which are also applied as input lines to the conduit 952. Still further, control signals for controlling the particular state of the relay 956 are applied as input control signals from the processor and repeater circuitry through control line 920.

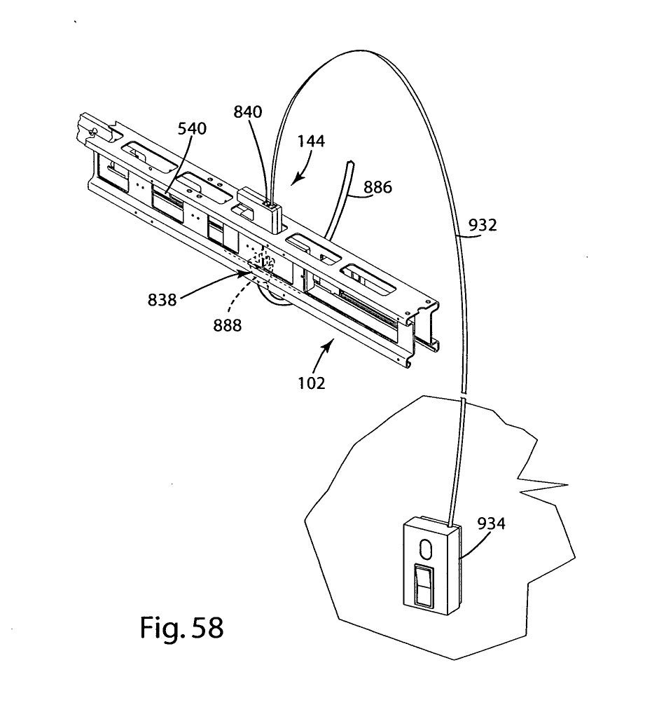

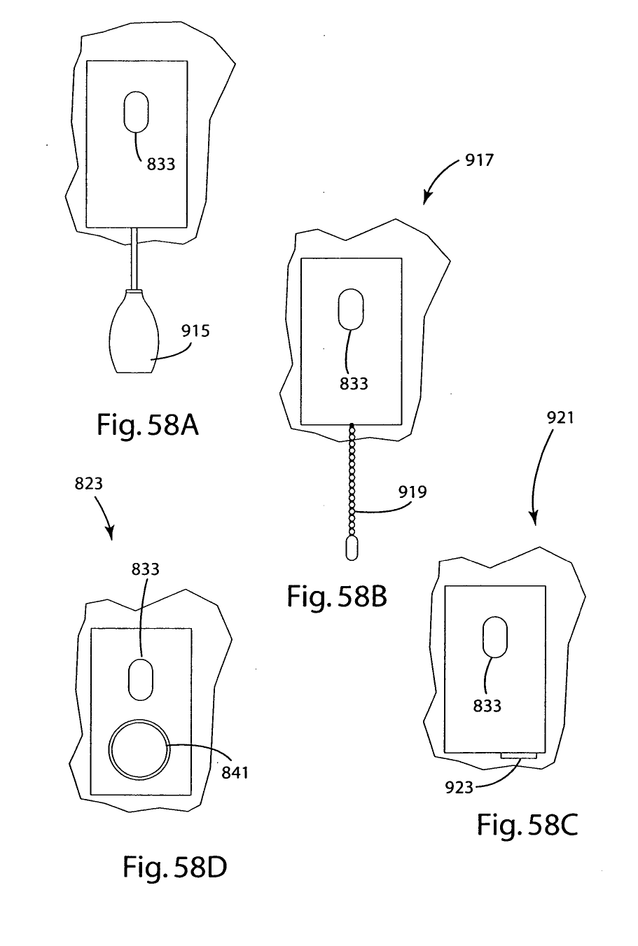

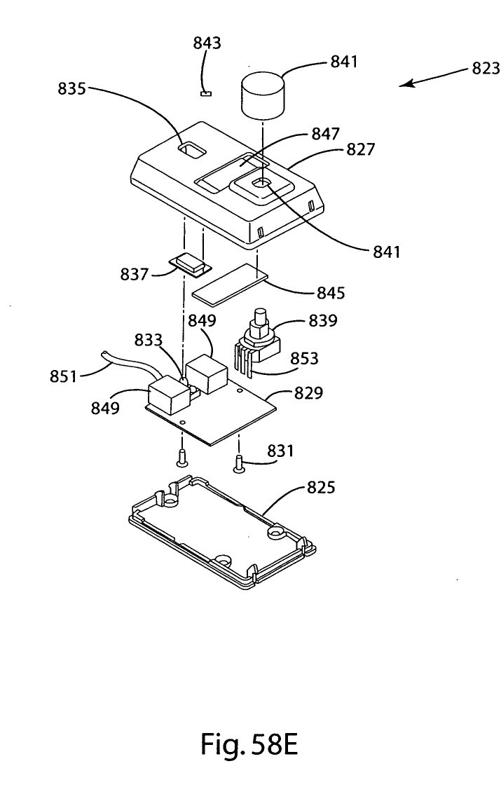

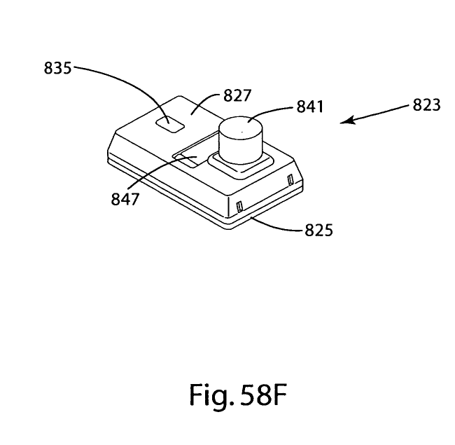

In operation, the power drop connector module 140 may be “programmed” by a user through the use of the wand 892. The wand 892 may, for example, be utilized to transmit spatial signals 890 to the power drop connector module 140, which essentially “announces” to the network 530 that the connector module 140 is available to be controlled. The wand 892 may then be utilized to transmit other spatial IR signals to an application device, such as a “switch,” which would then be “assigned” as a control for the connector module 140. The use of switches is subsequently described herein with respect to FIGS. 58A-58F. The switch will thereafter control application devices which may be connected to a terminating end of the flexible conduit 952. For example, it may be assumed that the flexible conduit 952, with its universal connector 958, is electrically connected to the power pole 962 illustrated in FIG. 49. With appropriate spatial signals 890 transmitted to the IR receiver 844 of the power drop connector module 140, and to an IR receiver on the controlling application device (i.e., the switch) which is to control whether electrical power is applied through the flexible conduit 952, IR receiver circuitry will, in turn, transmit electrical signals on line 894 to the processor and repeater circuitry 896. The signals received by the processor and repeater circuitry 896 may, for example, be signals which would cause the processor and repeater circuitry 896 to program itself so as to essentially “look” for specific communications signals sequences from the communication cables CC1 and CC2. To undertake these functions, it is clear that the controlling application device (not shown in FIG. 48A or FIG. 49) also requires logic circuitry which may be “programmed.” In addition, the logic circuitry should be capable of transmitting signals (either by wire or wireless) to the communication cables CC1 and CC2.

Assuming that programming has been completed, and assuming that the relay 956 is in an “off” state, meaning that electrical power is not being applied through the flexible conduit 952, the user may activate the switch or other controlling device. Activation of this switch may then cause transmission of appropriate communication sequences on communication cables CC1 and CC2. The processor and repeater circuitry 896 will have been programmed to interrogate signal sequences received from the cables CC1 and CC2, and respond to particular sequences generated by the controlling switch, which indicate that power should be applied to the flexible conduit 952 through the relay 956. In response to receipt of these signals on lines 900 and 902 from the communication cables CC1 and CC2, the processor and repeater circuitry 896 will cause appropriate control signals to be applied on line 920 as input signals to the relay 956. The relay 956 will be responsive to these signals so as to change states, meaning that the relay 956 will move from an off state to an on state. With this movement to an on state, power from the AC power cables AC1, ACN and ACG will be applied through the relay 956 to the flexible conduit 952. In this manner, the power pole 962 may be energized.

In addition to the foregoing components, the power drop connector module 140 also includes other components and features. As with the receptacle connector module 144, the power drop connector module 140 can include a status light 926. The light can be controlled by status signals from the processor and repeater circuitry 896, as applied through line 928. In addition, for purposes of coupling various application devices into the network 530, the power drop connector module 140, like the connector module 144, includes the connector ports 840. The connector ports 840 have bidirectional communications with the processor and repeater circuitry 896 through symbolic lines 922 and 924. Communication signals can be transmitted or received through the connector ports 840 to and from controlling devices with the use of patch cords (not shown in FIG. 48A) connecting the connector ports 840 to the controlling application devices. Also, with the configuration shown for the connector ports 840 of the power drop connector module 140, not only can communication signals and DC power be transmitted to interconnected application devices through lines 922 and 924, and connector ports 840, but such interconnected application devices can also transmit communication signals back to the processor and repeater circuitry 896 through the ports 840 and lines 922, 924. Such communication signals can then be processed by the circuitry 896, and the same or different communication signals can be transmitted to the communication cables CC1 and CC2 through lines 900 and 902. In this manner, communication signals from the application devices can be applied to the network 530. Still further, and as with the receptacle connector module 144, the power drop connector module 140 includes the IR receiver 844, processor and repeater circuitry 896 and associated incoming and outgoing lines. These components, along with the relay 956, may be characterized as an “actuator” 936, as shown in FIG. 48A. Further, with the use of the power drop connector module 140, the module 140 and the application device to which the module is connected become part of the distributed electrical network 530. In accordance with all of the foregoing, the power drop connector module 140 comprises a means responsive to programming signals received from a user to configure itself so as to be responsive to selectively control the application of AC power through the relay 956 to wires or cables within the flexible conduit 952, and therefore to interconnected application devices.

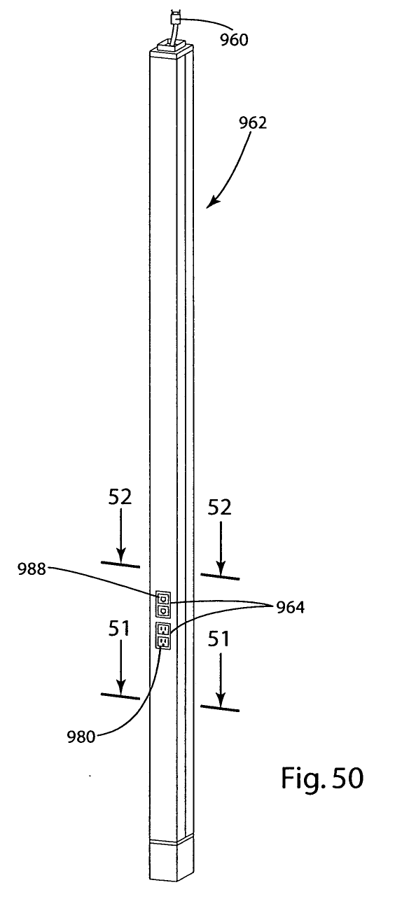

In accordance with the foregoing, the power drop connector module 140 is adapted to provide AC power from the AC power cables 574 associated with the modular plug assembly 130, to application devices such as the power pole 962 illustrated in FIGS. 49 and 50. The power pole 962 will now be described in greater detail, with respect to FIGS. 49-52. Referring thereto, the power pole 962 is adapted to be electrically coupled to AC power from the overhead structure of the structural channel system 100. Structurally, the power pole 962 is further adapted to be secured at its lower portion to a floor or other ground level structure. With reference primarily to FIGS. 50, 51 and 52, the power pole 962 includes a base 966, with a base cover surrounding the base 966. Extending upwardly from the base 966 are a pair of metallic and opposing side frames 968, in the form of metal extrusions. The side frames 968 are illustrated in FIGS. 51 and 52. Preferably, the side frames 968 are welded or otherwise connected to the base 966, and extend upwardly so as to form the basic frame of the power pole 962. For purposes of stability, the side frames 968 can be welded or otherwise connected through braces (not shown) at various intervals along the vertical length of the power pole 962.

The power pole 962 further includes a pair of opposing plastic pole extrusions 970. The pole extrusions 970 have the cross sectional configurations illustrated in FIGS. 51 and 52. These pole extrusions 970 include flexible covers 972, which form spaces 974 through which components, such as DC cables 976, may enter and extend. In addition to the opposing plastic pole extrusions 970, the power pole 962 further includes plastic extrusion side covers 978. The cross sectional configurations of the covers 978 are illustrated in FIGS. 51 and 52. These side covers 978, at least at their lower portions, are constructed of plastic materials which can be relatively easily cut, for purposes of providing openings through which electrical components may be coupled to the power pole 962. For example, FIG. 49 illustrates the use of a plastic outlet cover 980 secured to the power pole 962 for purposes of coupling two electrical receptacle pairs 964 to the power pole 962. In an alternative configuration, FIG. 50 illustrates the use of a plastic outlet cover 980 with one electrical receptacle pair 964 and a pair of DC jacks 988.

At the top of the power pole 962, a top cap 984 can be secured to the pole 962. The top cap 984 includes a central aperture through which an AC cable 986 may extend. The AC cable 986 is adapted to extend through the center of the power pole 962, and can be utilized to provide AC power to components such as the electrical outlet receptacle pair 964. At its terminating end at the top, the AC cable 986 is connected to a conventional AC connector 960. The AC connector 960 is adapted to connect, for example, to the AC connector 958 and the flexible conduit 952 of the power drop connector module 140, as illustrated in FIG. 49. In the particular embodiment of the power pole 962 as illustrated herein, DC power is not provided from any transformers associated with the connector modules. Instead, if DC power is required, the same could be provided through sources external to the structural channel system 100. On the other hand, however, there is nothing to prevent DC power or communication signals from being applied to the power pole 962 from the modular plug assembly 130. In general, the power pole 962 provides means for applying power (and communications and data, if desired) downwardly from the overhead structure of the structural channel system 100. The power pole 962 is adapted to permit selectivity in providing multiple outlets, data jacks or other electrical components to a user in a manner so as to facilitate accessibility.

The connector modules 140, 142 and 144 as described herein all utilize, in some manner, AC power from the AC power cables 574, through connections with modular plugs 576 of the modular plug assembly 130. Also with use of the modular plugs 576, the previously described connector modules directly receive communication signals from the communication cables 572 of the modular plug assembly 130. Power on the modular plug assembly 130 may typically be 120 volt AC power. In certain instances, it is also advantageous if application of power from the power cables 164 to interconnected application devices is controlled. For example, certain dimmer lights are adapted for use with 277 volt maximum input. Accordingly, it would be worthwhile to have the capability of connecting such application devices to power cables 164, if the power cables 164 are carrying 277 volt AC. Although such connections could be made directly, it would also be advantageous if control of the light intensity for such application devices could be maintained as part of the electrical network 530. For this reason, the structural channel system 100 may include means for providing a “smart” connection of the power cables 164 to interconnected application devices through the network 530.

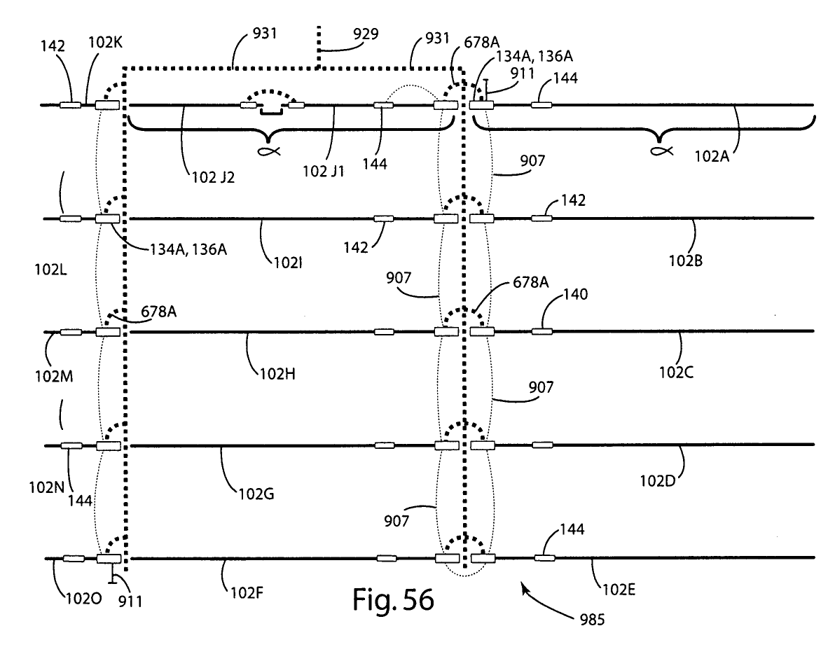

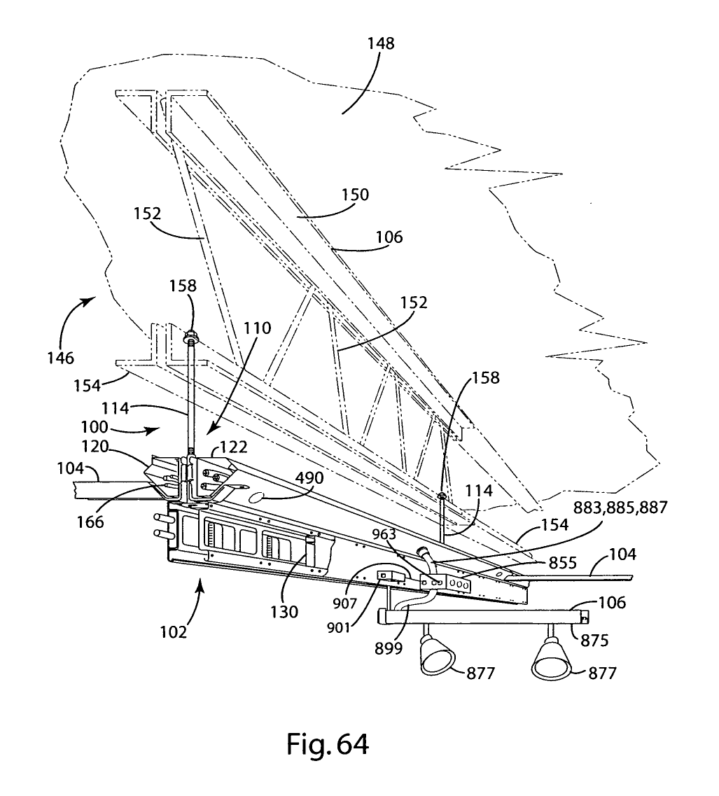

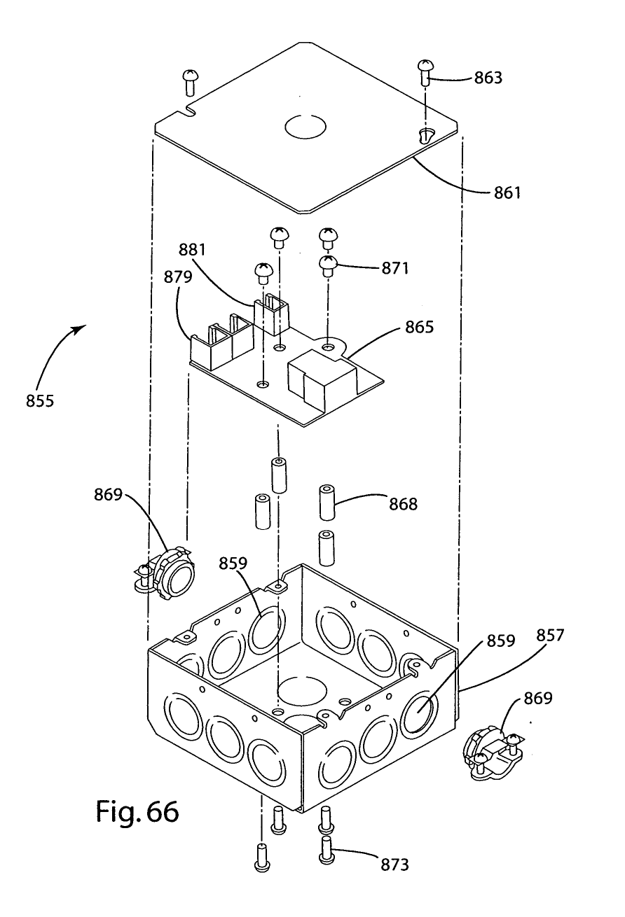

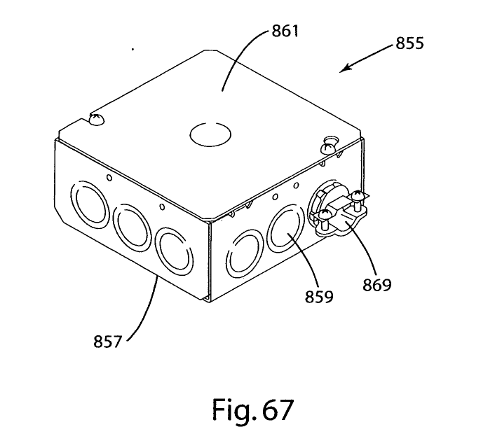

To this end, the structural channel system 100 includes a junction box assembly 855. The junction box assembly 855 is illustrated in FIGS. 64-67. With reference first to FIGS. 66 and 67, the junction box assembly 855 may be utilized with a light rail (such as light rail 875 illustrated in FIG. 64) having a series of dimmer lights 877 attached thereto. The light rail 875 and dimming lights 877 can be conventionally wired to the junction box assembly 855 and also mechanically secured to a length of the structural channel rail 102. This configuration is illustrated in FIG. 56A, which is substantially similar to the configuration illustrated in FIG. 1. The light rail 875 and dimming lights 877 may be in the form of a 277 volt light dimmer configuration. The junction box assembly 855 may be attached by any suitable means to the rail 102 or other components of the structural channel system 100, in a manner so that the 277 volt AC power cables 164 within the wireway 122 may be tapped into for 277 volt AC power. This configuration is illustrated in the diagrammatic view of FIG. 65. The junction box assembly 855 can be characterized as a smart junction box, and includes several of the components of the dimmer connector module 142. The junction box assembly 855 can be appropriately connected to the light rail 875 and programmed so as to control the amplitude of voltages applied to the dimming lights 877.

Turning specifically to FIGS. 66 and 67, the junction box assembly 855 includes an electrical box 857 having a conventional configuration, with a top cover 861 attached thereto through pan head screws 863. Knockouts 859 are provided at various locations around the perimeter of the electrical box 857. A board assembly 865 is included, having various electronic components and processor circuitry associated with the “smart” box assembly 855. Positioned below the board assembly 865 is a series of spacers 867. Pan head screws 873 are received from the bottom of the electrical box 857 for purposes of securing the positioning of the board assembly 865, and are received through the spacers 867. Pan head screws 871 are also provided for purposes of securing the board assembly 865 to the spacers 867. As further shown in FIG. 66, the board assembly 865 includes a pair of connector ports 879, and a remote IR receiver connector port 881. As subsequently described herein, the connector ports 879 may preferably be RJ45 ports, while the remote receiver connector port 881 may preferably be an RJ11 port. For purposes of safety and appropriately securing cabling with the junction box assembly 855, strain reliefs 869 can be provided as required.

Turning to the diagrammatic view of FIG. 65, a flexible conduit or other cabling may be coupled to one or more of the AC power cables 164 within the wireway 122. Such conduit may be connected through a knockout 490 within the wireway 122. This cabling or conduit may include three AC wires, comprising wires 883, 885 and 887. These wires may carry, for example, hot, neutral and ground for a specific circuit within the power cables 164. As with the incoming AC power associated with the previously described connector modules 140, 142 and 144, the AC power from wires 883, 885 and 887 are applied as input power to a transformer 889. The transformer 889 is adapted to receive the AC power and convert the same to an appropriate level of DC power, which is applied as input power on line 891 to the processor and associated repeater circuitry 893. The transformer 889 and processor and associated repeater circuitry 893 can operate in a manner substantially similar to that of the transformers 910 and processors 896 previously described with respect to the connector modules 140, 142 and 144. The processor and repeater circuitry 893 includes a control line 895 through which output signals can be applied for purposes of controlling a dimmer relay 897. The dimmer relay 897 also accepts, as input signals, the AC power from the wires 883, 885 and 887. The dimmer relay 897 will operate in response to control signals from control line 895 so as to vary the amplitude of voltages applied as output on lines 883A, 885A and 887A. This varying voltage amplitude is then applied through the strain relief 869 to flexible conduit or other cable 899, connected to the dimming lights 877.

Also similar to the previously described connector modules, the junction box assembly 855, as previously stated, includes a pair of RJ45 connector ports 879. The connector ports 879 are similar to the connector ports 840 previously described with respect to the connector modules 140, 142 and 144. Patch cords may be connected to the connector ports 879, and attached from these connector ports to application devices and to one of the connector modules currently on the network 530. It should be noted that for purposes of interconnecting the junction box assembly 855 to the network 530, one of the RJ45 connector ports 879 will need to be connected through a patch cord to a connector module or other device currently on the network 530. The RJ45 connector ports 879 are connected to the processor and associated repeater circuitry 893 through bidirectional lines 903.

In addition to the foregoing, the junction box assembly 855 also includes the RJ11 connector port 881, connected to the processor and associated repeater circuitry 893 through line 905. The remote IR receiver RJ11 connector port 881 is adapted to connect to a remote IR receiver 901 through patch cord or connector line 907. It should be emphasized that the remote IR receiver 901 is physically remote from the junction box assembly 855. Also, when remote IR receivers 901 are utilized with connector modules or other types of sensors or actuators, the remote IR receivers will, again, be physically remote from the devices to which they are connected. As previously described herein, it may be advantageous to provide the user with one or more remote IR receivers, such as receiver 901 which can be spaced apart and located in a more visually accessible location on the structural channel system 100. As with the IR receivers 844 previously described herein, the receiver 901 is adapted to receive spatial IR signals 890 from the wand 892.

In accordance with all of the foregoing, the junction box assembly 855 comprises a means for using high voltage power running through the wireways 122 for various application devices, and has also provided means for coupling such application devices to the network 530. In this regard, it should be noted that power is being applied to the dimmer lights 877, without requiring the use of AC power from the AC power cables 574. A configuration for the junction box assembly 855, as connected to dimmer lights 877 on the structural channel system 100, is illustrated in FIG. 64. Further, it should be emphasized that the junction box assembly 855 can receive high voltage power not only from the wireways 122, but also from a number of other locations, including directly from building power.

Previously, a specific means for receiving and distributing power throughout the network 530 was described with respect to the power entry box 134. The power entry box 134 was described in detail with respect to FIGS. 31-34. Also, a power box connector 136 for use with the power entry box 134 was described with respect to FIG. 35. Second embodiments of a power entry box and a power box connector are described in the following paragraphs, primarily with respect to FIGS. 68-70. The power entry box illustrated in FIGS. 68 and 69 will be referred to herein as the power entry box 134A, and the power box connector illustrated primarily in FIGS. 68, 69 and 70 will be referred to herein as the power box connector 136A. It is believed by the inventors that the power entry box 134A and the power box connector 136A may be somewhat of preferred embodiments relative to the previously described power entry box 134 and power box connector 136. However, it is also believed that the structure and functional operation of the power entry box 134 and power box connector 136 are fully acceptable for implementation of the structural channel system 100.

As apparent from FIG. 68, the power entry box 134A is substantially similar to the power entry box 134. For purposes of description, like components of the power entry box 134A and the power box connector 136A to the power entry box 134 and power box connector 136 will be numbered substantially the same, with the letter A designating components for power entry box 134A and power box connector 136A. More specifically, and with reference to FIGS. 68 and 69, the power entry box 134A includes an AC side block 670A, knockouts 672A and upper surface 674A. A cable nut 676A is secured to one of the knockouts 672A and to an incoming 120 volt AC cable 678A. Although not specifically shown in the drawings, wires of the incoming 120 volt AC cable 678A may be directly or indirectly connected and received through the outgoing AC cables 680A. Unlike the flexible cable 680 associated with the power entry box 134, the cable 680A may be more rigid in structure. The AC cable 680A, as shown in FIG. 68, is coupled directly into the power box connector 136A.

The power entry box 134A may also include a 277 volt AC side block 688A. An upper surface 690A of the side block 688A includes a series of knockouts 672A. Connected to one of the knockouts 672A is a cable nut 676A. Also coupled to the cable nut 676A and extending into the side block 688A is a 277 volt AC cable 692A. Power from the cable 692A may be applied to power cables 674 within wireways 122. The power entry box 130A can include wireway segments 694A corresponding in structure and function to the previously describe wireway segments 694. For purposes of connecting the wireway segments 694A to the front portion of the power entry box 134A, brackets, as previously described herein with respect to FIGS. 32 and 33, may be integrally formed at one end of the wireway segments 694A. Also, joiners 492 as previously described herein can be utilized, for purposes of connecting one of the wireway segments 694A to a wireway 122. Further, the knockouts 672A can be utilized not only for conduits or cables connected to the incoming power through cables 678A and 692A, but can also be utilized to permit cables to extend completely through the power entry box 134. For example, cables associated with the cableways 120 may need to extend through the lower portion of the power entry box 134A.

In addition to the foregoing, the power entry box 134A also includes a network circuit 700A, situated between the side block 670A and the side block 688A. In addition, the power entry box 134A also includes a pair of connector ports 909A, preferably having an RJ11 port configuration. As will be described in subsequent paragraphs herein, the connector ports 909A can be utilized, with corresponding patch cords (not shown) to “daisy chain” multiple power entry boxes 134A and provide interconnection of communications and associated cabling throughout the electrical network 530.

One distinction may be mentioned at this time, relative to the structural configurations of the power entry box 134 and power entry box 134A. With the previously described power entry box 134, a connector 706 was provided as shown in FIGS. 32 and 33. The connector 706 is located on the same side of the power box communications cable 702 as the outgoing AC cable 680. In contrast, and the embodiment of the power entry box 134A, a connector 706A is provided at the rear portion of the power entry box connector 134A. However, like the connector 706, the connector 706A includes a support brace 708A with a pair of spaced apart upper legs 710A. The upper legs 710A angle upwardly and terminate in feet 712A. The support brace 708A is connected at its upper end to the side blocks 670A and 688A through screws 714A extending through holes in the feet 712A and in the side blocks 670A and 688A. As also shown primarily in FIG. 68, the upper legs 710A include a pair of spaced apart slots 716A. Integral with the upper legs 710A and extending downwardly therefrom is a central portion 718A. Integral with the lower edge of the central portion 718A are a pair of spaced apart lower legs 720A. As with the upper legs 710A, the lower legs 720A include feet 712A. Screws 714A extend through threaded holes in the feet 712A of the lower leg 720A, and connect to the rear walls of the side blocks 670A and 688A.

Returning to the central portion 718A, a series of four threaded holes 722A extend therethrough in a spaced apart relationship. The central portion 718A also includes a vertically disposed groove 724A extending down the center of the central portion 718A. The connector 706A also includes a bracket 726A, also shown in FIG. 68. The bracket 726A has a series of four threaded holes 728A. A pair of spaced apart upper lips 730A, having a downwardly curved configuration, extend upwardly from the bracket 726A. The bracket 726A also includes a vertically disposed groove 732A positioned in the center portion of this bracket 726A.

To couple the power entry box 134A to the structural grid 172, the power entry box 134A can be positioned above a corresponding main structural channel rail 102. The power entry box 134A can be positioned so that one of the threaded support rods 114 is partially “captured” within the groove 724A of the support brace 708A. When the appropriate positioning is achieved, the bracket 726 can be moved into alignment with the central portions 718A of the support brace 708A. In this aligned position, the threaded support rod 114 is also captured by the groove 732A and the bracket 726A. Also, to readily secure the bracket 726A to the support brace 708A, the upper lips 730A of the bracket 726A are captured within the slots 716A of the brace 708A. Correspondingly, screws 734A are threadably received within the through holes 728A and through holes 722A of the bracket 726A and support brace 708A, respectively. In this manner, the threaded support rod 114 is securely captured within the grooves 724A and 732A.

The power entry box 134A is mechanically and electrically coupled to the power box connector 136A, as primarily shown in FIGS. 68, 69 and 71. The power box connector 136A provides a means for receiving AC power from the building through the power entry box 134A, and applying the AC power to an elongated power assembly section 540 of the modular power assembly 130. The power box connector 136A also provides means for connecting the network circuit 700 from the power entry box 134A to the communication cables CC1, CC2 and CCR associated with an elongated power assembly section 540 of the modular power assembly 130. The power box connector 136A, in combination with the power entry box 134A, performs the same functions as the previously described power box connector 136 and power entry box 134.

Turning to the drawings, the power box connector 136A includes a base housing 750A, which will be located within a main structural rail 102 and adjacent a power assembly section 540 when installed. The base housing 750A includes a main body 752A and a cover 754A. The main body 752A and cover 754A are connected together by means of rivets 987 or similar connecting means. Internal to the base housing 750A formed by the main body 752A and cover 754A is a spacer clip 985. Extending outwardly from a slot 778A formed within the housing 750A is a connector housing 756A. The connector housing 756A is adapted to mate with a modular plug male terminal set housing 624 (FIG. 28A) of a modular plug 576. Extending into the connector housing 756A from the interior of the base housing 750A are a set of eight power entry female terminals 758A. The power entry female terminals 758A include a set of three terminals, identified as a communications cable female terminal set 760A. The remaining five of the female terminal set 758A are identified as AC power female terminal set 762A. When the elements 756A and 758A are appropriately located within the interior of the housing 750A, the main body 752A and cover 754A can be tightly secured together through the use of plastic screws 989. When the power box connector 136A is connected to a modular plug 576, the individual female terminals 758A of the female terminal set 760A will be electrically connected to individual terminals of the communications cables terminal set 646 of a modular plug 576. Correspondingly, the terminals 758A of the female terminal set 760A are connected to individual wires or cables (not shown) extending into the interior of the power box connector 136A from the communications conduit 702A. The wires or cables extending through the communications conduit 702A are connected to appropriate communication connections on the network circuit 700 in the power box connector 134A.

Correspondingly, when the power box connector 136A is connected to the modular plug 576, the individual female terminals 758A of the AC power female terminal set 762A will be electrically interconnected to individual terminals of the AC power terminal set 648 of the modular plug 576. Correspondingly, the terminals 758A of the AC power female terminal set 762A can be connected to individual wires or cables (not shown) extending into the interior of the power box connector 136A from the outgoing AC cable or conduit 680A. The wires or cables extending through the outgoing AC cable or conduit 680A are connected to incoming AC building power within the power box connector 134A, as previously described herein. A configuration of the power entry box 134A as electrically coupled to the power box connector 136A is illustrated in FIG. 69.

With respect to the use of the power entry boxes 134A and power box connectors 136A with the network 530, greater details of the network 530 will be described in subsequent paragraphs herein. However, at this time, reference can be made to the manner in which individual lengths of the main structural channel rails 102 and associated modular plug sections 540 can be coupled together so as to form the network 530. As earlier described, one component of the structural channel system 100 in accordance with the invention which can be utilized to electrically interconnect adjacent or adjoining sections 540 of the modular plug assembly 130 is the flexible connector assembly 138. With the flexible connector assembly 138, the adjacent or adjoining sections 540 of the modular plug assembly 130 are electrically coupled together both with respect to AC power on AC power cables 574 and communication signals on communication cables 572. In some instances, however, limitations with respect to power loads and government and institutional codes and regulations may result in the necessity of utilizing multiple power entry boxes 134A and associated power box connectors 136A. When this is required, it is inappropriate to “transfer” power signals from one section 540 to another section 540 of a modular plug assembly 130 using a flexible connector assembly or similar device. On the other hand, however, in order to provide for a complete and distributed electrical network 530, it is desirable to have the capability of readily coupling together communication cables 572 from sections 540 of the modular plug assembly 130, regardless of the relative spatial positioning of the sections 540, and regardless of whether multiple power entry boxes 136A are being utilized.

In this regard, reference is made to FIG. 71, which illustrates in diagrammatic form a series of four power entry boxes 134A and associated power box connectors 136A. For purposes of description and simplicity, mechanical and structural elements other than the power entry boxes 134A and power box connectors 136A are not shown. It can be assumed that each of the power entry boxes 134A shown in FIG. 71 is supported on a separate one of lengths of main structural channel rails 102. Further, it can be assumed that each of the power box connectors 136A is plugged into separate modular plugs 576 of separate sections 540 of the modular plug assembly 130. FIG. 71 essentially shows the concept of daisy chaining the power entry boxes 134A. This is performed by the use of patch cords 907A which connect adjacent ones of the power entry boxes 134A through connector ports 909A within the power entry boxes 134A. The connector ports 909A are connected to the network circuitry 700 within each of the power entry boxes 134A. These connector ports 909A may be in the form of RJ11 ports for purposes of daisy chaining the network 530 through the power entry boxes 134A. The patch cords 907A may be in the form of CAT5 cable. In terms of operation, the network circuit 700 acts so as to essentially cause the communication signals associated with communication cables CC1, CC2 and CCR, and transmitted to the power entry boxes 134A through communications conduit 702A, to be “passed through” an interconnected patch cord 907A to the network circuit 700 associated with the particular power box connector 134A to which that particular patch cord 907A is interconnected. Transmission can be bidirectional and the network circuit 700 may have transformer, repeater or similar circuitry for purposes of enhancing received and transmitted communication signals. It is in this manner that communication signals can be transmitted to and from spaced apart sections 540 of the modular plug assembly 130. Also, as earlier described, this is a means for transmitting such communication signals among different sections 540, without using a flexible connector assembly 138. For purposes of appropriate interconnections and functional operation, patch cords which are typically characterized as termination resistors should be inserted into connector ports 909A of the first and last power entry boxes 134A within the chain. These termination resistors are illustrated as patch cords 911A in FIG. 71.

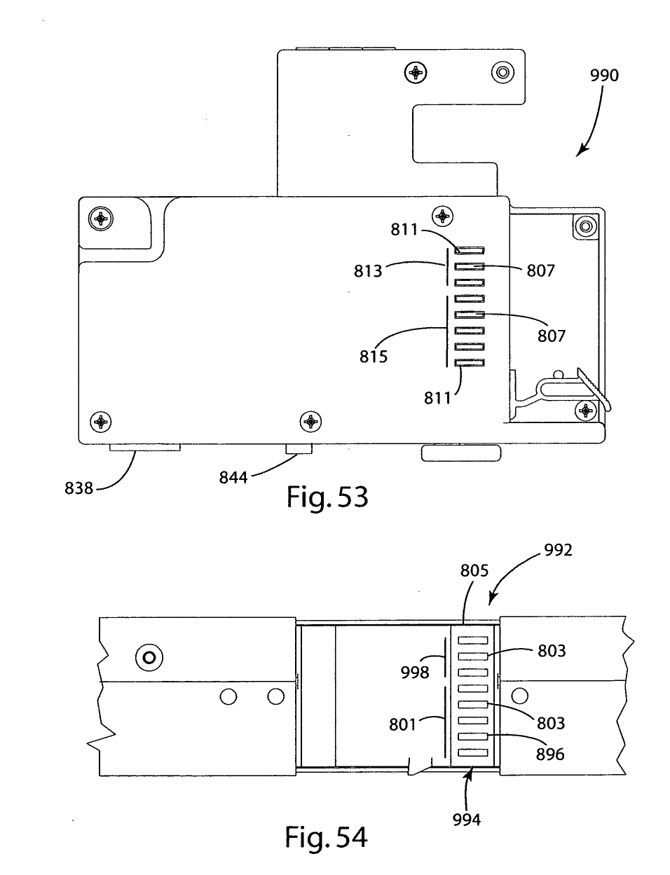

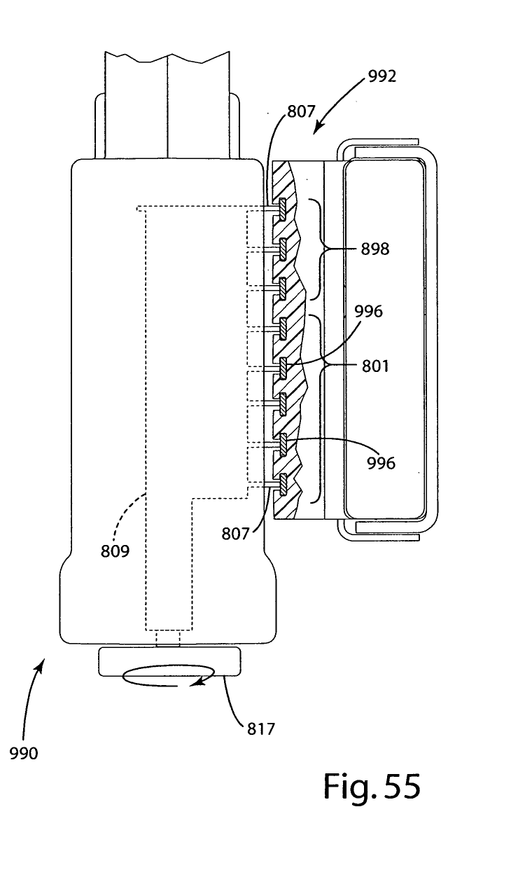

The prior description herein has been directed primarily to connector modules (such as the receptacle connector module 144) which are electrically interconnected to the modular plugs 576 on an “inline” basis. In some instances, it may be preferable to provide for a variation in the electrical connections between the connector modules and the modular plugs 576. An example embodiment of such a variation is illustrated with the modified receptacle connector module 990 shown in FIGS. 53, 54 and 55. This configuration also includes a modified modular plug 992, utilized in place of the modular plug 576 previously described herein. With this particular configuration, the modified modular plug 992 may include a modified plug connector 994 (replacing the plug connector 586 of the modular plug 576 shown in FIG. 28A) as primarily shown in FIGS. 54 and 55. The modified plug connector 994 can include a series of buses 996 comprising three communications buses 998 and five AC power buses 801. These buses can be connected to the communications cables 572 and AC power cables 574 within the modular plug assembly 130 in any suitable manner, so as to provide for complete conductivity between the same. Also, the communications cables 572 and AC power cables 574 could be replaced by a series of buses, carrying the same signals as the cables 572, 574. In any event, the buses 996 can be configured so as to project laterally outward from the plug connector 994 through a series of terminal openings 803 of a plug connector bus housing 805. The concept of the employment of buses within a power and communications distribution system is disclosed in copending U.S. Provisional Patent Application entitled POWER AND COMMUNICATIONS DISTRIBUTION SYSTEM USING SPLIT BUS RAIL STRUCTURE filed Jul. 30, 2004.

Turning to the modified receptacle connector module 990, it can be assumed that the principal structural and electrical components of the connector module 990 correspond to those previously described herein with respect to the receptacle connector module 144. However, as shown in FIGS. 53 and 55, the modified receptacle connector module 990 includes a series of movable electrical contacts 807. The movable electrical contacts 807 are adjustable through what is shown in diagrammatic form in FIG. 55 as an extender control module 809. The extender control module 809 may include relatively conventional components, which provide for the capability of the movable electrical contacts 807 to be moved from a retracted position within the housing of the receptacle connector module 990, to an extended position so that they are in conductive connectivity with the buses 996. This conductive configuration is illustrated in FIG. 55. Referring back to FIG. 53, the electrical contacts 807 may move between the extended and retracted positions within terminal slots 811 which extend laterally outwardly from one side of the receptacle connector module 990. The moveable electrical contacts 807 include a series of three communications contacts 813 and five AC power contacts 815.

Referring again to FIG. 55, the extender control module 809, which can be appropriately housed and secured within the receptacle connector module 990, can include a manually rotatable control knob 817. The control knob 817 can be structurally connected to the extender control module 809, so that rotation of the knob 817 will cause the moveable electrical contacts 807 to move between a retracted position and an extended position. Again, in the retracted position, the electrical contacts 807 would not be in contact with any of the buses 996. In the extended position shown in FIG. 55, the three communication contacts 813 would be electrically connected to the three communication buses 998, and the five AC power contacts 815 would be electrically connected to the AC power buses 801. It should be emphasized, at this point, that although the five AC power buses 801 can provide for up to three electrical circuits, only one circuit will be selected for use with the receptacle connector module 990 at any given time. With respect to further operation of the modified receptacle connector module 990, reference can be made to the prior description with respect to the receptacle connector module 144 and FIG. 44A. With reference to FIG. 44A, the moveable electrical contacts 807 can be characterized as substantially conforming to the symbolic contacts 898 previously described with respect to the receptacle connector module 144. The foregoing is a brief description of a modified receptacle connector module 990, which may utilize a different type of connection between a connector module and a modular plug.

Turning to other aspects of the structural channel system 100, the system 100 has been described with respect to use of various types of applications and application devices. For example, the use of a receptacle connector module 144, with a switch 934 interconnected through a patch cord 932 was previously described with respect to FIG. 58. It should be emphasized that there is no necessity for the structural channel system 100 to be configured so that the switch 934 is directly controlling the receptacle control module 144. That is, the patch cord 932, in combination with its connection to a connector port 840 of the receptacle connector module 144, provides a means for supplying DC power to the switch 934, and also for coupling the switch 934 to the electrical network 530. In this regard, although the switch 934 is coupled into the network 530 through the connector module 144, the switch 934 may be operating so as to control either one or several other connector modules which are coupled into the network 530. The connector ports 840 can be characterized as providing a network tap for the interconnection of switch 934 into network 530. Also, because it is unnecessary for the switch 934 to be directly coupled (through a patch cord) to a connector module for which the switch has been programmed to control, this feature again illustrates one of the advantageous of the structural channel system 100, in that the switch 934 can be reprogrammed any number of times so as to control any of a various set of connector modules, without requiring any physical rewiring or any modifications to the patch cord connections. That is, it is only necessary for the switch 934 to be connected “somewhere” into the electrical network 530.

It should be noted that various types of switches may be utilized as part of the applications or application devices associated with the structural channel system 100 in accordance with the invention. One type of switch which may be utilized with the structural channel system 100 is characterized as a rotary dimmer switch 823, as illustrated in FIGS. 58E and 58F. With reference thereto, the rotary dimmer switch assembly 823 includes a back plate or rear housing 825, having a structural configuration as primarily shown in FIG. 58E. The rear housing 825 can be secured by connecting means or by a snapfit arrangement with a front dimmer switch housing 827. Secured within the interior formed by the front housing 827 and rear housing 825 is a sensor board 821. The sensor board 821 can, for example, be secured to the front housing 827 by means of pan head screws 831 or other similar connecting means. Secured to the sensor board 821 is an IR receiver 833. The IR receiver 833 functions in a manner similar to the IR receivers 844 previously described with respect to the connector modules, such as the receptacle connector module 144. The IR receiver 833 is adapted to receive spatial IR signals from a wand, such as the wand 892 previously described herein. The IR receiver 833 is made accessible to the wand 892 through a cover slot 835 within the front housing 827. A lens 837 is positioned within the slot 835, and covers the IR receiver 833. Structurally and electrically connected to the sensor board 821 is a dimmer switch 839. The dimmer switch 839 projects outwardly through a switch slot 841 positioned within the front housing 827 as shown in FIGS. 58E and 58F. For purposes of manual rotation of the dimmer switch 839, a switch knob 841 is secured to the end of the dimmer switch 839 by means such as a set screw 843 as illustrated in FIG. 58E. For purposes of identification of the particular switch assembly 823, a switch label 845 can be included, and secured within a label slot 847 of the front housing 827. The dimmer switch 839 also includes a set of pins 853 adapted to electrically interconnect to appropriate lines and circuitry of the sensor board 821. These pins 853 essentially provide a means of communicating, by electrical signals, the rotational position of the dimmer switch 839.

Secured to the sensor board 821 and accessible to a user are a pair of connector ports 849, as shown from the rear in FIG. 58E. The connector ports 849 are adapted to receive patch cords 851. The patch cords 851 may be utilized in two ways. First, the other end of a patch cord 851 connected to a connector port 849 may be directly connected to one of the connector ports 840 associated with any of the connector modules 140, 142 or 144. In this manner, the rotary dimmer switch assembly 823 may be electrically connected into the network 530. DC power may be received through a patch cord 851 from an interconnected connector module, for purposes of functional operation of circuitry of the sensor board 821. Also, the patch cord 851, once connected to one of the connector modules 140, 142 or 144, is utilized to transmit and receive communication signals to and from the electrical network 530 through the interconnected connector module. In this regard, it should be noted that the rotary dimmer switch assembly 823 can be characterized as a smart switch, in that it includes processor and associated control circuitry within the sensor board 821. The electronics and processor elements of the sensor board 821 perform several features. First, the sensor board 821 includes components which will be responsive to spatial signals received from the IR receiver 833, for purposes of associating the rotary dimmer switch assembly 823 with control of dimming lights (such as the lights 940 previously described herein with respect to FIG. 46). Further, the electronics and processor elements of the sensor board 821 will be responsive to manual rotation of the switch knob 841 and the dimmer switch 839, so as to cause appropriate communication signals to be applied through a connector port 849 and interconnected patch cord 851. These communication signals from patch cord 851 will then be applied through the network 530 to one or more appropriate dimmer connector modules 142 and interconnected dimming light elements associated with the network 530. In addition, for purposes of programming the rotary dimmer switch assembly 823, signals will also be transmitted on patch cord 851 in response to certain spatial signals received by the IR receiver 833. The connector ports 849, like the connector ports 840, may be relatively standard RJ 45 ports. Patch cords, such as the patch cords 851, are adapted to be received within RJ 45 connector ports and are commercially available.

In addition to the feature of electrically interconnecting the rotary dimmer switch assembly 823 to the electrical network 530 through interconnection of the patch cord 851 directly to a connector module, switch assemblies such as the dimmer switch assembly 823 may also be daisy chained within the network 530. That is, one of the two connector ports 849 may include a patch cord 851 which, as previously described herein, is directly connected to one of the connector modules 140, 142 or 144. Further, however, a second patch cord 851 may be connected at one end to the other connector port 849 of the rotary dimmer switch assembly 823, with its terminating end coupled to a connector port 849 of another rotary dimmer switch assembly 823. In this manner, two or more rotary dimmer switch assemblies 823 may be daisy chained together for purposes of functional operation. Limitations on the daisy chaining of the switch assemblies 823 may exist based on voltage and power requirements. Also, it should be emphasized that the concept of daisy chaining switch assemblies is not limited to the rotary dimmer switch assembly 823, and will be applicable to other types of switches.

In accordance with the foregoing, the concept has been described of a manually manipulated and hand-held instrument, such as the wand 892 to essentially program a dimmer connector module 142 and associated lighting elements, in a configuration as shown in FIG. 46. The dimmer connector module 142 can be programmed, along with the rotary dimmer switch assembly 823, so that the dimmer switch assembly 823 controls a particular one (or more) of the dimmer connector modules 142. With this program designation, manual manipulation of the switch knob 841 by a user will cause communication signals to be generated by the sensor board 821, and applied as output signals to one of the patch cords 851 connected to one of the connector ports 849. These communication signals on the patch cord 851 will then be applied to the communications cables 572 of the modular plug assembly 130, through connection of the patch cord 851 to a connector port 840 associated with one of the connector modules 140, 142 or 144. With the assumption that the particular rotary dimmer switch assembly 823 is controlling the lights 940 illustrated in FIG. 46, the signals applied on the electrical network 530 through the interconnected patch cord 851 will be recognized as input signals of interest by the appropriate dimmer connector module 142. With reference to FIG. 54, the signals applied to the communication cables 572 may then be applied as input signals to the processor and repeater circuitry 896 associated with the particular dimmer connector module 142. The processor and associated repeater circuitry 896 will be responsive to these input signals to apply control signals on control line 920, so as to control the voltage amplitude through the dimmer relay 948, which is applied to lights 940. In this manner, the intensity of the lights 940 is controlled.

The concepts associated with the foregoing description of the rotary dimmer switch assembly 823, with its interconnection to the electrical network 530 through a connector module represent an important feature of the structural channel system 100. In conventional rotary dimmer switches, 120 volt AC power is typically applied through the switch. Manual rotation of the switch knob and associated dimmer switch with the conventional configuration will cause dimmer control circuitry to vary the voltage output on AC power lines passing through the dimmer switch assembly. These power lines are typically directly connected to dimming lights on a light rail or the like. The variation in voltage amplitude of the AC power lines as they pass through the dimmer switch assembly will thereby cause the track lights to vary in intensity. In contrast, in the configuration previously described herein, there is no AC power applied to or passing through the rotary dimmer switch assembly 823. Instead, manual rotation of the switch knob 841 and associated dimmer switch 839 will cause variations in DC voltages and communication signals, which are applied to processor components associated with the sensor board 821. The processor components will interpret the DC voltage variations in a manner so as to cause corresponding communications or control signals to be applied through the patch cord 851. These control signals will correspondingly be applied to other elements of the network 530 (i.e., eventually to a dimmer connector module 142 programmed to be responsive to signals from the particular rotary dimmer switch 823) so as to cause circuitry within the dimmer connector module 142 to vary the voltage amplitude applied to an interconnected set of lights 940. To provide this feature, the rotary dimmer switch assembly 823 has been “programmed,” along with one or more sets of lights 940 and interconnected dimmer connector modules 142. It should be emphasized that this programming of the control relationship occurs without any need whatsoever of any type of centralized computer control, or any physical change in circuits, wiring or the like.

FIGS. 58A-58C illustrate elevation views of other types of switches which may be utilized in accordance with the invention. Specifically, FIG. 58A illustrates a pressure switch 913. The pressure switch 913 includes, as does the rotary dimmer switch assembly 823, an IR receiver 833, for purposes of programming controlled relationships between the switch 913 and other devices associated with the structural channel system 100. The pressure switch 913 includes an air bulb 915. The pressure switch 913 includes circuitry (not shown) internal to the switch 913, in the form of a pressure transducer which can generate signals in response to forces exerted on the bulb 915 which “squeeze” air from the bulb. The output signals of the transducer can be utilized for purposes of generating appropriate control signals, in a manner having similarity to the control signal generation associated with the rotary dimmer switch assembly 823.

FIG. 58B illustrates an elevation view of a pull chain switch 917 which may be utilized with the structural channel system 100. As with the other switches, the pull chain switch 917 includes an IR receiver 833. In addition, the switch 917 includes a conventional pull chain 919. Forces exerted on the pull chain 919 will cause switching circuitry (not shown) within the switch 917 to operate so as to generate appropriate control signals which can be applied to other devices associated with the network 530.

Still further, FIG. 58C is an elevation view of a motion sensing switch 921 which may be utilized with the structural channel system 100. Again, the motion sensing switch 921 includes an IR receiver 833. The switch 921 would include circuitry which is relatively conventional and commercially available, so as to sense motion in a spatial area surrounding the switch through motion sensor 923. The motion sensing circuitry will sense motion through a lens 923 located in an appropriate position on the switch 921 for purposes of sensing motion within an appropriate spatial area. If motion is sensed, the switch 921 will be caused to generate signals on an interconnected communications line, which may be applied to an interconnected connector module associated with the structural channel system 100. As with the other switches described herein, the network 530 may be “programmed” so that certain devices (such as lights or the like) are responsive to the signals generated by the motion sensing switch 921.

Although the foregoing paragraphs have described four types of switches, numerous other types of switch configurations may be utilized for purposes of controlling various devices or applications associated with the network 530, without departing from the novel concepts of the invention. However, for appropriate operation, each of the aforedescribed switches will include circuitry and components similar to those of the dimmer switch assembly 823, including connector ports and processor circuitry associated with a sensor board. That is, each of the switches described with respect to FIGS. 58A-58B will also be a “smart” switch, and capable of being programmed by a user.

The structural channel system 100 provides a means for facilitating control and reconfiguration of control relationships among various devices associated with applications. An example of a controlling/controlled relationship among devices has been previously described herein for the rotary dimmer switch assembly 823 and dimming lights.

The prior description also focused on the structure of the rails 102, modular power assembly 130 and various types of connector modules. The network 530 of the structural channel system 100 has significant advantages. Namely, it does not require any type of centralized processor or controller elements. That is, the network 530 can be characterized as a distributed network, without requirement of centralized control. Further, it is a programmable network, where controlling/controlled relationships among devices associated with an application are not structurally or functionally “fixed.” In fact, various types of devices can be “reprogrammed” to be part of differing applications. For example, a dimmer light may be programmed to be controlled by a first rotary dimmer switch assembly, and then “reprogrammed” to be controlled by only a second rotary dimmer switch assembly, or both the first and second rotary dimmer switch assemblies. This can occur without any necessity whatsoever of physical rewiring, or programming of any type of centralized controller. Instead, the network 530 utilizes what is referred to as a “programming tool” for effecting the application environment. As an example embodiment of a programming tool which may be utilized with the structural channel system 100, subsequent paragraphs herein will describe the manually manipulable and hand-held “wand” 892.

With the network structure described herein, the network 530 can be characterized not only as a distributed network, but also as an “embedded” network. That is, it is embedded into physical devices (e.g. connector modules, etc.) and linked together through the mechanical structural grid 172 of the structural channel system 100. In this regard, with the connector modules interconnecting various devices (e.g. switches, lights, etc.) to the AC and communications cable structures, the connector modules can be characterized as “nodes” of the network 530.

With the network 530 characterized in this manner, it is worthwhile, for purposes of understanding the power and communications distribution, to illustrate an exemplary structural channel system 100 and network “backbone” associated therewith. In typical communications networks, the backbone is often characterized as a part of the network which handles “major” traffic. In this regard, the backbone typically employs the highest speed transmission paths in the network, and may also run the longest distance. Many communications systems utilize what is often characterized as a “collapsed” backbone. These types of collapsed backbones comprise a network configuration with the backbone in a centralized location, and with “subnetworks” attached thereto. In contrast, the network 530 which is associated with the structural channel system 100 is somewhat in opposition to the concept of a collapsed backbone. In fact, the backbone of the network 530 can better be described as a “distributed” backbone. Further, the network 530 can be characterized as being an “open” system, and even the backbone can be characterized as an “open” backbone. That is, the network 530 and the backbone are not limited in terms of expansion and growth.

For purposes of understanding this concept of the backbone, FIG. 56 illustrates an exemplary structure of the structural channel system 100. The illustration is essentially in a “diagrammatic” format. Specifically, FIG. 56 illustrates a structural channel system 100 configuration having sixteen main rails 102. The sixteen rails are identified as main rails 102A through 102O, with two rails 102J1 and 102J2. In the particular configuration shown, three or four main rails 102 are essentially in a coaxial configuration. For example, main rails 102A, 102J1, 102J2 and 102K form one coaxial configuration. Similarly, main rails 102D, 102G and 102N form another coaxial configuration. FIG. 56 also illustrates incoming 120 volt AC power on line 929. This power can be general building power. The incoming AC power on line 929 is applied to common power distribution cables 931. In the particular embodiment shown in FIG. 56, two power distribution cables 931 are utilized. The power distribution cables 931 are further shown in FIG. 70 as being coupled to either one or a pair of 120 volt AC power cables 678A. These AC power cables 678A were previously described with respect to FIG. 68 and the power entry box 134A. As further shown in FIG. 56, each of the main rails 102, with the exception of rail 102J2, has a power entry box 134A at one end of the associated main rail 102. For example, with respect to main rails 102B and 1021, each rail has a power entry box 134A associated therewith, which may be physically adjacent to each other, as shown in FIG. 56. As previously described herein, the power entry boxes 134A have outgoing AC power cables 680A (not shown) and outgoing communication cables 702A (not shown) extending outwardly from the power entry boxes 134A. Although not specifically shown in FIG. 56, the AC power cables 680A and communication cables 702A, as previously described herein, are connected to power box connectors 136A. In FIG. 56, the power entry boxes 134A and power box connectors 136A are shown as one element, for purposes of simplicity. Also in accordance with prior description herein, the power box connectors 136A are electrically connected (both with respect to AC power and communication signals) through modular plugs 576 to sections 540 of the modular plug assembly 130. With respect to the illustrations in FIGS. 56 and 57, and the description herein, it is being assumed that each of the structural channel rails 102 includes sections 540 of the modular plug assembly 130 running along the entirety of the length of each of the main rails 102. Accordingly, these combinations of the power entry boxes 134A and associated power box connectors 136A are utilized to apply the incoming AC building power to the sections 540 of the modular plug assembly 130 as previously described herein.

Further, as also previously described herein, communication signals are received and transmitted through network circuits 700 associated with each of the power entry boxes 134A. For purposes of description and simplicity, the previously described communication cables 702A are not illustrated in FIG. 56 or FIG. 57. However, what is shown in FIG. 56 are the interconnections using the patch cords 907, for purposes of daisy chaining together the separate power entry boxes 134A. In this manner, each of the main rails 102 and the associated modular power assembly sections 540 are linked together for purposes of forming the network 530, through these interconnections of the patch cords 907. As also earlier described, separate bus ending patch cords 911 are connected to connector ports 909A within the first power entry box 134A in the chain, and the last power entry box 134A in the chain.

As further shown in FIG. 56, each of the main rails 102 has a power entry box 134A associated therewith, with the exception of main rail 102J2. As shown therein, a flexible connector assembly 138 (previously described with respect to FIGS. 36A-36C) is shown connected to the main rail 102J1, at an end of the main rail 102J1 opposing the end associated with the power entry box 134A. The flexible connector 138 is utilized to “jump” power and communication signals from the main rail 102J1 to the main rail 102J2. In accordance with all of the foregoing, including the daisy chaining of the power entry boxes 134A, AC power and communication signals are applied to all of the main rails 102A-102O associated with the structural channel system 100. As further shown in FIG. 56, various ones of the connector modules 140, 142 and 144 can be connected at various positions along the main rails 102 and associated modular plug assembly 130. For purposes of clarity, these connector modules in FIG. 56 are not shown as being interconnected to any application devices.

With the particular configuration illustrated in FIG. 56, a “backbone” 935 of the network 530 associated with the structural channel system 100 can be defined. With the FIG. 56 configuration, the “initiation point” for the back bone 935 begins at the power entry box 134A associated with main rail 102A. The communications path of the backbone 904 then flows from main rail 102A through the patch cords 907 associated with the main rails 102A-102O in alphabetical sequence, with the path of power and communication signals being coupled from main rail 102J1 to main rail 102K, and main rail 102J1 being coupled to main rail 102J2. The “termination” of the particular backbone 935 shown in FIG. 56 occurs at the power entry box 134A associated with main rail 102O. With this backbone 935 in place, it can be seen that the main rails 102 actually function in what can be characterized as a series of “parallel” network branches off of the backbone 935. It can also be seen that the backbone 935 represents a completely open system, in that main rails 102 (and associated power entry boxes and power box connectors) can be readily added to the backbone 935 and network 530.

FIG. 57 is similar to FIG. 56, in that it illustrates an embodiment of the structural channel system 100 in a “diagrammatic” format. More specifically, FIG. 57 illustrates aspects of an embodiment or system layout 937 of the structural channel system 100. The system layout 937 illustrates the network 530, with two programmable applications, namely a light bank 939 and an automated projection screen 941. For purposes of description, and as with FIG. 56, elements such as cross-rails, perforated structural channels, support rods and other support and hanger components (including the building support structure) are not shown in FIG. 57. Further, unlike FIG. 56, and for purposes of clarity of the illustration in FIG. 57, incoming building power is not illustrated in FIG. 57. However, the system layout 937 in FIG. 57 is substantially similar to the system layout in FIG. 56. More specifically, FIG. 57 includes a series of lengths of main rail 102A-102J. Power entry boxes 134A are located at the beginning of each main rail 102, and patch cords 907 connect the power entry boxes 134A in a daisy chain configuration. In this manner, all of the communication cables 572 are linked together, through a “backbone” as previously described with respect to FIG. 56. It should also be emphasized that the backbone is essentially terminated on both ends, with termination resistors.

As earlier stated, the system layout 937 shown in FIG. 57 includes a light bank 939, illustrated as having a series of six lights 943. The lights 943 are all linked together through cables 945, so that all of the lights 943 are either enabled or disabled together. The lights 943 are coupled to a connector module. In this instance, the connector module corresponds to a receptacle connector module 144, which provides conventional three wire AC power through a receptacle to the light bank 939. The power may be provided through a conventional AC power cord 947 which is electrically coupled to a first one of the lights 943 of the light bank 939.

Still further, it can be assumed that the light bank 939 has been “programmed” to be under control of a switch 949. The switch 949 may be any one of a number of different types of switches, such as the pressure switch 913 previously described with respect to FIG. 58A. The switch 913 is connected to the network 530 through a patch cord 932, which is interconnected through module 144 to the communication cables 572 associated with the main rail 102D. As further illustrated in FIG. 57, the connector module 144 to which the switch 949 is directly connected is associated with main rail 102D, while the receptacle connector module 144 directly coupled to the light bank 939 is associated with main rail 102C. However, the communications cables 572 of the main rails 102D and 102C are coupled together through the daisy chaining of the power entry boxes 134A associated with each of the main rails 102D and 102C. Accordingly, following appropriate “programming” of the correlation between the light bank 939 and the switch 949, enablement of the switch 949 will cause communication signals to be applied through the cables 572 associated with both main rails 102D and 102C. The processing components associated with the receptacle connector module 144 directly coupled to the light bank 939 will be responsive to these communication signals, so as to control AC power signals applied to the light bank 939.

Correspondingly, and as previously mentioned, the system layout 937 illustrated in FIG. 57 is further shown as having an automated projection screen 941. It may be assumed that the projection screen 941 is a conventional projection screen, which can be responsive to appropriate AC power signals so as to “unwind” and provide a full projection screen. Such projection screens which may be utilized as screen 941 are well known and commercially available.

The projection screen 941 is shown as being interconnected to a receptacle connector module 144 through an AC power cable 953. The receptacle module 144 is coupled to the main rail 102H. For control of the automated projection screen 941, it may be assumed that the user has “programmed” a controlling/controlled relationship between the screen 941 and a switch 925. The switch 925 may be any of a number of different types of switches, such as a pressure switch 913 as previously described with respect to FIG. 58A. In FIG. 57, the switch 925 is illustrated as being coupled through a patch cord 955 to a module 144 associated with main rail 102J. As further illustrated in FIG. 57, in the event a user activates or otherwise enables switch 925, communications signals can be applied through the patch cord 955 coupling the switch 925 to the module 144 associated with main rail 102J. These communications signals can then be further applied to main rail 102H through the patch cords 907 which couple the cables 572 of main rail 102J and 1021, and the cord 907 which couples the cables 572 of main rail 1021 to those of main rail 102H. The receptacle connector module 144 on main rail 102H will be responsive to these communications signals, so as to apply (or not apply) power to the AC power cable 953 connecting the receptacle connector module 144 to the automated projection screen 941. In accordance with the foregoing, the system layout 937 of the structural channel system 100 provides means for generating and applying communications control signals among various devices associated with applications connected to the structural channel system 100, in addition to selectively applying power to various application devices.

Another aspect of system layout 937 of the structural channel system 100 should be noted. Specifically, the layout 937 has been described with respect to the use of patch cords 907. As further shown in FIG. 57, it would be possible to replace one or more of these with electronics which would provide for wireless signals 959 to be transmitted between various system components, such as power entry boxes 134A on different ones of the main rails 102. Also, wireless signals, such as wireless signals 957 shown in FIG. 57 could replace the patch cords which couple together devices such as the switch 949 to a module 144. Still further, it is apparent that numerous other device and application configurations could be utilized with a layout of the structural channel system 100, other than those illustrated in FIG. 57. In fact, an advantage of the structural channel system 100 in accordance with the invention is that it is an “open” system, and facilitates the addition of application devices, backbone equipment and the like.

To this point, discussion regarding the network portion of the structural channel system 100 has focused around the cables 572 and 574, various types of connector modules, the power entry box 134A and interconnection of various application devices to the network 530. Numerous times, however, reference has also been made to the concept of “programming” the control and reconfiguration of control relationships among various application devices which may be utilized with the structural channel system 100. As an example, the discussion regarding FIG. 57 mentioned the concept of establishing controlling/controlled relationships among switches, lights and automated projection screens.

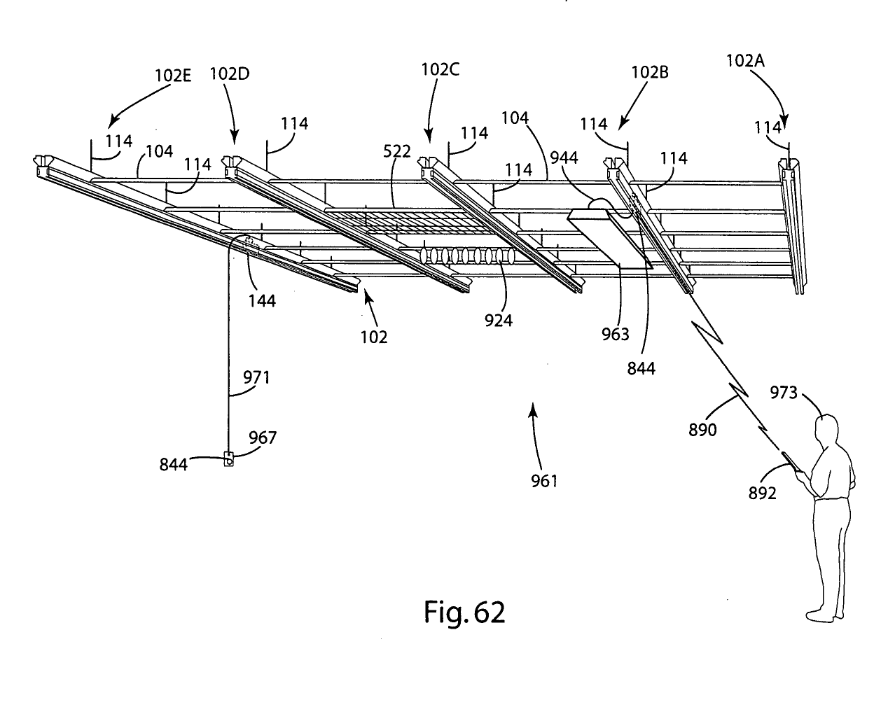

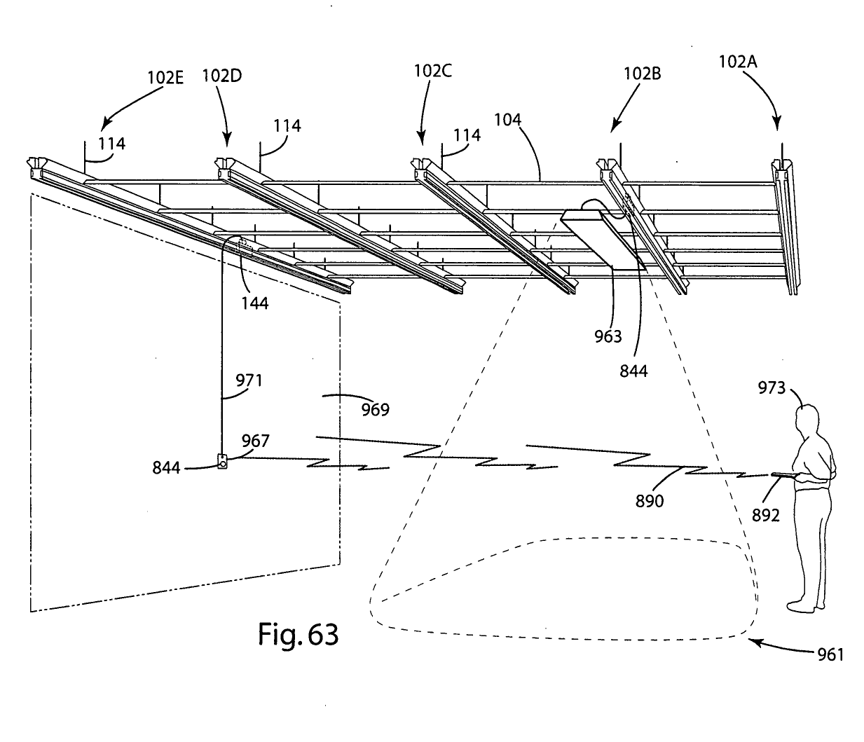

To provide an exemplary embodiment of this concept of programmable control, on a “real time” and “decentralized” basis, reference is made to FIGS. 62 and 63. Specifically, these drawings illustrate a system layout 961, employing a series of five main rails 102A-102E. Cross-channels 104 are also shown interconnecting the main rails 102, and support rods 114 are shown in part as securing the structural rails 102 to the building structure. For purposes of this description, power cables and communication cables extending between main rails 102 and similar elements are not shown. Instead, FIG. 62 also illustrates a conventional light 963. The light 963 is connected through an AC power cable 965 to a receptacle connector module 144 associated with main rail 102B. In addition, a switch 967 (which may be any one of a number of different types of switches) is illustrated as being secured to a wall 969. The switch 967 is coupled to main rail 102E through patch cord 971 and a module 144. As previously described with respect to FIGS. 56 and 57, other communications cables (not shown) and modules (not shown) can be utilized to couple the communications cables 572 associated with any one of the main rails 102 to the communications cables 572 of the other main rails 102 associated with layout 961.

Further, it can be assumed that it is the desire of a user 973 to establish a controlling/controlled relationship between the switch 967 and the light 963. For this purpose, and as shown in FIGS. 62 and 63, the user 973 is employing a “programming tool.” In this particular instance, the programming tool can be characterized as the control wand 892. The control wand 892 is utilized for purposes of transmitting spatial programming signals 890, which are capable of being received through IR receivers 844 associated with the switch 967 and the receptacle connector module 144. An example of the control wand 892 is illustrated in FIGS. 59, 60 and 61. With reference thereto, the control wand may be of an elongated configuration. At one end of the control wand 892 is a light source 975 which, preferably, would generate a substantially collimated beam of light. In addition to the light source 975, the control wand 892 may also include an infrared (IR) emitter 977, for transmitting infrared transmission signals to corresponding IR receivers 844 associated with the structural channel system 100, including the connector modules and the application devices.

The control wand 892 may also include a trigger 979, for purposes of initiating transmission of IR signals. Still further, the control wand 892 may include mode select switches, such as mode select switch 981 and mode select switch 983. These mode select switches would be utilized to allow manual selection of particular commands which may be generated utilizing the control wand 892. The control wand 892 would also utilize a controller (not shown) or similar computerized devices for purposes of providing requisite electronics within the control wand 892 for use with the trigger 979, mode select switches 981, 983, light source 975 and IR emitter 977. An example of the use of such a wand, along with attendant commands which may be generated using the same, is described in the correlation system application.

Referring back to FIG. 62, the user 973 can employ the wand 892 to transmit signals to the IR receiver 844 associated with the receptacle connector module 144. These spatial IR signals are illustrated as signals 890. For purposes of illustrating a relatively simple control sequence, it can be assumed that the user 973 wishes to have the light switch 967 control the particular lighting fixture 963. The user 973 can first configure the mode selector switches 981, 983 associated with the wand 892 so as to enable a “control set” sequence. The wand 892 can then be pointed to the IR receiver 844 associated with the receptacle connector module 144. When the wand 892 is appropriately pointed (indicated by the light source 975), the user 973 may activate the trigger 979 on the wand 892.

The user can than “point” the wand 892 to the IR receiver 844 associated with the switch 967. When the wand 892 again has an appropriate directional configuration, as indicated by the light source 975, the trigger 979 can again be activated, thereby transmitting the appropriate IR signals 890. This concept is illustrated in FIG. 63. Additional signals can then be transmitted through the wand 892, so as to indicate that the control sequence is complete and the lighting fixture 963 is to be controlled by the light switch 967.

In addition to the foregoing, signaling may be used, for purposes of changing the on and off states of various elements. For example, with RF signaling, an individual could possibly turn on all of the elements in an office or other commercial interior with a general signal, rather than with a specific switch.

As described in the foregoing, the structural channel system 100 in accordance with the invention facilitates flexibility and reconfiguration in the location of various devices which may be supported and mounted in a releasable and reconfigurable manner within the structural channel system 100. The structural channel system 100 also facilitates access to locations where a commercial interior designer may wish to locate various application devices, including electrical lights and the like. The structural channel system 100 carries not only AC power (of varying voltages) but also DC power and communication signals. The communication signals are associated with a communications network structure permitting the “programming” of control relationships among various devices. The programming (or reprogramming) may be accomplished at the location of the controlled and controlling elements, and may be accomplished by a layperson without significant training or expertise.

The structural channel system 100 in accordance with the invention facilitates the reconfiguration of a commercial interior in “real time.” Not only may various functional elements be quickly relocated from a “physical” sense, but logical relationships among devices can also be altered, in accordance with the prior description relating to programming of control relationships. The structural channel system 100 in accordance with the invention presents a “totality” of concepts which provide a commercial interior readily adapted for use with various devices, and with the capability of reconfiguration without requiring additional physical wiring or substantial rewiring. With this capability of relatively rapid reconfiguration, change can be provided in a building's infrastructure quickly, ensuring that the attendant commercial interior does not require costly disassembly and reassembly, and is not “down” for any substantial period of time. Further, the structural channel system 100, with attendant devices, permits occupants to allow their needs to “drive” the structure and function of the infrastructure and layout.

In addition to the foregoing, the structural channel system 100 overcomes other issues, particularly related to governmental and institutional codes and regulations associated with electrical power, mechanical support of structures and the like. For example, it is advantageous to provide device availability throughout a number of locations within an interior. The structural channel system 100 provides the advantages of a structure for distributing power (both AC and DC) and communications signals. However, structural elements carrying electrical signals (either in the form of power or communications) are regulated as to mechanical load-bearing parameters. As described herein, the structural channel system 100 utilizes a suspension bracket for supporting elements such as perforated structural channels and the like throughout the overhead structure. With the use of these elements, the load resulting from these support elements is directly supported through elements coupled to the building structure of the commercial interior. Accordingly, rail elements carrying power and communication signals do not support the mechanical loads resulting from various other support and hanger components associated with the structural channel system 100. This provides significant advantages, in that regulations do not permit power and communication distribution systems to carry significant mechanical loads. That is, the structural channel system 100 provides for both power distribution and a distributed communications network, notwithstanding governmental and institutional restrictive codes and regulations.

Still other advantages exist. For example, the structural channel system 100 provides for carrying relatively high voltage cables, such as 277 volt AC power cables. With the use of wireways as previously described herein, such cabling can be appropriately shielded, and meet codes and regulations. Still further, the structural channel system 100 carries both DC “working” power, and a communications network. DC power may be generated from building power, through AC/DC converters associated with the power entry boxes. Alternatively, the electrical network 530 may be structured so that it is unnecessary for the communication cables 572 to carry any DC power, as may be required by connector modules and application devices. Instead, and as described in detail herein, such DC power may be generated through the use of the distributed AC power on cables 574, and the use of transformers within the connector modules. With the removal of the necessity of having any of the communication cables 572 carry DC power, relatively more advantageous configurations may be utilized for carrying communication signals, such as the differential signal configuration previously described herein.

Still further advantages relate to the carrying of both AC and DC power. Again, governmental and institutional codes and regulations include some relatively severe restrictions on mechanical structures incorporating components carrying both AC and DC power. The structural channel system 100 provides for a mechanical and electrical structure which includes distribution of AC and DC power, and which should meet most codes and regulations.

In addition to the foregoing, the structural channel system 100 can be characterized as not only a distributed power network, but also a distributed “intelligence” network. That is, when various types of application devices are connected into the network of the structural channel system 100, “smart” connectors will be utilized. It is this intelligence associated with the application devices and their connectivity to the network which permits a user to “configure” the structural channel system 100 and associated devices as desired. This is achieved without requiring any type of centralized computer or control systems. Still further, the structural channel system 100 may be characterized as an “open” system. That is, the structural channel system 100 can readily be grown or reduced, with respect to both structural elements and functional devices.

Other advantageous concepts also exist with respect to the structural channel system 100. For example, mechanical elements utilized for supporting the structural channel system 100 from the building structure itself permit the “height” of the structural channel system 100 from the floor to be varied. In addition, it should again be emphasized that the flexible connector assembly 138 is unidirectional, and can only be interconnected between a pair of adjacent sections 540 of the modular plug assembly 130 in one way. With respect to this concept, terminal housings are utilized which are “reversed” in structure, as shown by the prior illustrations. Also, use of the angled sections again prohibits certain incorrect interconnections of the flexible connector 138 to the sections 540 of the modular plug assembly 130.

Another concept which may be employed in the system 100 relates to the positioning and configuration of the main rails 102. It would actually be possible to “flip” a length of main rail 102. In this “upside down” configuration, the main rail 102 actually has a shape whereby the rail 102 could “cradle” one or more of the cableways 120.

In general, the individual sections 540 of the modular plug assembly 130 may be utilized in a number of different applications, independent of the main rails 102. For example, a number of sections 540 of the modular plug assembly 130 could be utilized, in combination with the flexible connector assembly 138, in “stand alone” configurations where the sections 540 are secured to walls or other structures. In general, the configurations of the sections 540, including the modular plugs 576 and distribution plugs 650, provide for an advantageous structural and electrical configuration for distributing power and communications signals throughout an interior. Also, other configurations may be contemplated whereby the sections 540 of the modular plug assembly 130 are utilized with somewhat different relative structural configurations with the lengths of main rails 102.

The foregoing has described a substantial number of concepts associated with the structural network grid 172 and the electrical network 530. The electrical network 530 operates with what can be characterized as a protocol for purposes of establishing and reconfiguring control relationships among devices and application devices. In this regard, the network 530 can be characterized as comprising a system composed of electronics and software, with the electronics including the wands 37. In this regard, the programming functions can be characterized as comprising a designation based protocol system for reconfiguring control relationships among devices. Such a system is described in the Designation Protocol Application.

Processor elements have been previously described with respect to connector modules, such as the power drop connector module 140, dimmer connector module 142 and receptacle connector module 144. For example, within the receptacle connector module 144, a processor is incorporated within the processor and associated repeater circuitry 896. These programming functions serve to provide for operative relationships between the user and application devices, connector modules and the like. For the circuitry 896, various types of processors can be realized, without departing from any of the principal concepts of the invention. For example, one such processor which may be utilized and is commercially available is known as an ATmega8 microcontroller manufactured by ATmel, Inc. The microcontroller includes 8 K bytes of in-system soft-programmable flash, boot code section with independent lock bits, 512 bytes of EEPROM, and 1K bytes of internal SRAM. Of course, other types of microcontrollers or microcomputers could also be utilized for the processor and associated repeater circuitry 896.

The prior discussion set forth herein describes the concept of connector modules. As stated, these connector modules can be selectively interconnected to the various types of application devices, such as lighting fixtures and the like. The connector modules previously described herein can include DC power, processor means and associated circuitry, responsive to communication signals carried on a network, so as to appropriately control certain of the application devices, in response to communication signals received from other application devices, such as sensors (e.g., switches). The connector modules therefore, in association with other components of the distributed network, provide means for distributing requisite power and for providing a distributed intelligence system where transmitting and receiving communication signals from application devices which may be physically located throughout an entirety of the network.

Additional advances are also known with respect to various types of connector modules. These advances will be described with respect to connector module improvements, as primarily shown in FIGS. 72-101. First, a receptacle connector module 1000 will be described with respect to FIGS. 72-91. The receptacle connector module 1000 can be used and function in substantially the same manner as the receptacle connector module 144 previously described with respect to FIGS. 37-44. Functions associated with the previously described receptacle connector module are also set forth in the Structural Channel Application and the Designation Protocol Application. However, as described in detail in subsequent paragraphs herein, the receptacle connector module 1000 provides certain advantages with respect to the manner in which electrical contacts are affixed to a connector module circuit board, and the manner in which electrical contacts are otherwise assembled into the connector module 1000.

In view of a number of aspects of the receptacle connector module 1000 being similar in structure and function to the previously described receptacle module 144, a number of the individual components of the receptacle module 1000 will not be described in any detail herein. As with the previously described receptacle connector module 144, the receptacle connector module 1000 can be referred to as a “smart” connector module, in that it includes certain logic permitting the connector module 1000 to be programmed by a user (through remote means) so as to initiate or otherwise modify a control/controlling relationship between devices energized through the receptacle connector module 1000 and controlling devices, such as switches or the like.

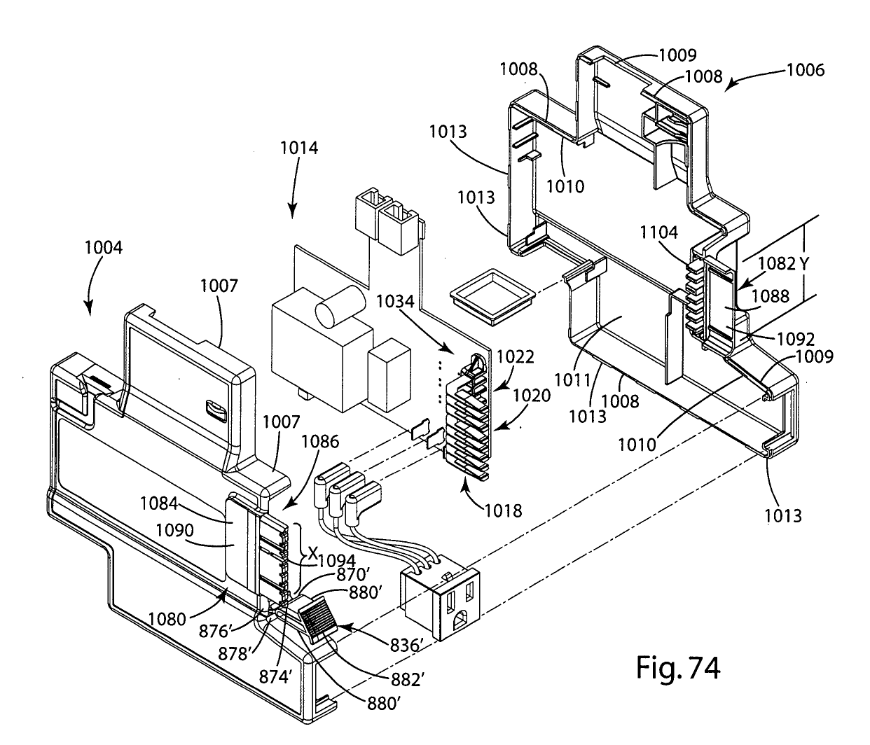

With reference initially to FIGS. 72, 73 and 74, the receptacle connector module 1000 includes a connector housing 1002. The connector housing 1002 includes a front housing cover 1004 and a rear housing 1006. Housing covers 1004 and 1006 of the connector housing 1002 of connector module 1000 may be connected together in a manner slightly different than the connection arrangement previously described with respect to receptacle connector module 144. As an example embodiment, and with respect primarily to FIG. 74, the front housing cover 1004 can include a front cover edge 1007. Although not expressly shown in FIG. 74 or other drawings, the front cover edge may have a first projecting rim (not shown) extending around the periphery of the edge 1007. Inwardly from the first projecting rim, the edge 1007 may also include a second recessed rim (not shown) integral with the first projecting rim but, as shown in FIG. 74, not extending inwardly to the extent of the first projecting rim. Accordingly, the first projecting rim may be characterized as “overlapping” the second recessed rim. To better clarify the concepts of the projecting and recessed rims, FIG. 74 shows the edge and rim configurations associated with the rear housing cover 1006. More specifically, and again with respect to FIG. 74, the rear housing cover 1006 includes a rear cover edge 1008 extending around the periphery of the cover 1006. The uppermost portion of the rear cover edge 1008 includes a first recessed rim 1009, as identified in various locations in FIG. 74. Projecting inwardly form the edge 1008 and essentially positioned “inward” of the first recessed rim 1009 is a second projecting rim 1010. The second projecting rim 1010 can be characterized as essentially “overlapping” the first recessed rim 1009. When the front housing cover 1004 and rear housing cover 1006 are to be coupled together, the respective covers 1004, 1006 can be brought together and the first projecting rim of the front cover edge 1007 will essentially abut the first recessed rim 1009 of the rear housing cover 1006. Correspondingly, the covers 1004, 1006 are sized and configured so that when brought together, the second recessed rim of the front cover edge 1007 abuts the second projecting rim 1010 of the rear cover edge 1008. With this configuration, the front cover edge 1007 and the rear cover edge 1008 can essentially be characterized as “mating” together. For purposes of providing connection between the front and rear housing covers, 1004, 1006, respectively, the housings can also be sonically welded together. In this regard, FIG. 74 illustrates sonic weld locations 1013, as viewed on the rear housing cover 1006. Accordingly, the front connector housing 1004 and rear connector housing 1006 are formed, such that “offsetting” raised rims, molded into each housing cover, provide for mating alignment of the two housing covers. Following mating of the front and rear housings, the mating seam of the two housing covers can be ultrasonically welded at the multiple locations 1013 along the seam.

As also shown in FIG. 74, secured within the connector housing 1002 is a board assembly 1014. The board assembly 1014 substantially functionally corresponds to the board assembly 826 previously described herein with respect to receptacle connector module 144 and illustrated in FIG. 37. Principal components of the board assembly 1014 substantially correspond to the principal components of the board assembly 826 as illustrated in FIG. 44A for the receptacle connector module 144. However, the board assembly 1014 includes certain improvements in accordance with the invention, primarily relating to the module connector plug 1016. These improvements in accordance with the invention will be described in subsequent paragraphs herein, primarily with respect to FIGS. 74 and 84-91.

As previously described herein with respect to FIGS. 21-30 and 37-44A, the receptacle connector module 144 included a connector plug 828 which was adapted to electrically interconnect to modular plugs 576 associated with sections 540 of a module plug assembly 130. Similarly, the receptacle connector module 1000 also includes a module connector plug adapted to electrically interconnect to modular plugs associated with sections of a modular plug assembly. However, the modular plug assembly utilized with the receptacle connector module 1000 comprises some structural modifications relative to the structure of the sections 540 of modular plug assembly 130.

Before going into the description of the modified modular plug assembly utilized with the receptacle connector module 1000, components of the connector module 144 associated with electrical and mechanical interconnection to the sections 540 of modular plug assembly 130 will be briefly summarized, although these components were described in detail in prior paragraphs herein.

With reference to FIGS. 21-30, and 37-44A, the connector module 144 included a connector plug 828, having a connector plug housing 829. The connector plug housing 829 was adapted to mate with the male terminal of the housing 624 of each of the previously described modular plugs 576 associated with sections 540 of the modular plug assembly 130. A set of eight female terminals 830 extended toward the end of the connector plug 828 to the opening of the connector plug housing 829. The terminals 830 included a set of three female terminals forming a communications female terminal set 832. When the receptacle connector module 144 was electrically and mechanically coupled to section 540 of the modular plug assembly 130, the communications female terminal set 832 could be electrically connected to the communications male terminal set 646 previously described herein with respect to FIG. 28A. Correspondingly, five of the female terminals 830 formed an AC power female terminal set 834. When coupled to a modular plug 576 of section 540 to the modular plug assembly 130, the AC power female terminal set 834 would be electrically engaged with the previously described AC power male terminal set 648 of the modular plug 576, as also shown in FIG. 28A.

Turning again to the receptacle connector module 1000, the module 1000 also electrically and mechanically interconnects to a section of a modular plug assembly. As earlier mentioned, the modular plug assembly which is associated with the receptacle connector module 1000 is functionally and substantially structurally similar to the previously described modular plug assembly 130. However, the modular plug assembly which functions with the receptacle connector module 1000 has some structural differences, relative to the previously described modular plug assembly 130. However, because of the similarities, and for purposes of clarity of description, numerical references for components of the modular plug assembly used with the receptacle connector module 1000 will be substantially identical to numerical references for similar components of the modular plug assembly 130, but with a “prime” number notation. Accordingly, the modular plug assembly utilized with the receptacle connector module 1000 will be identified by numerical reference 130′.

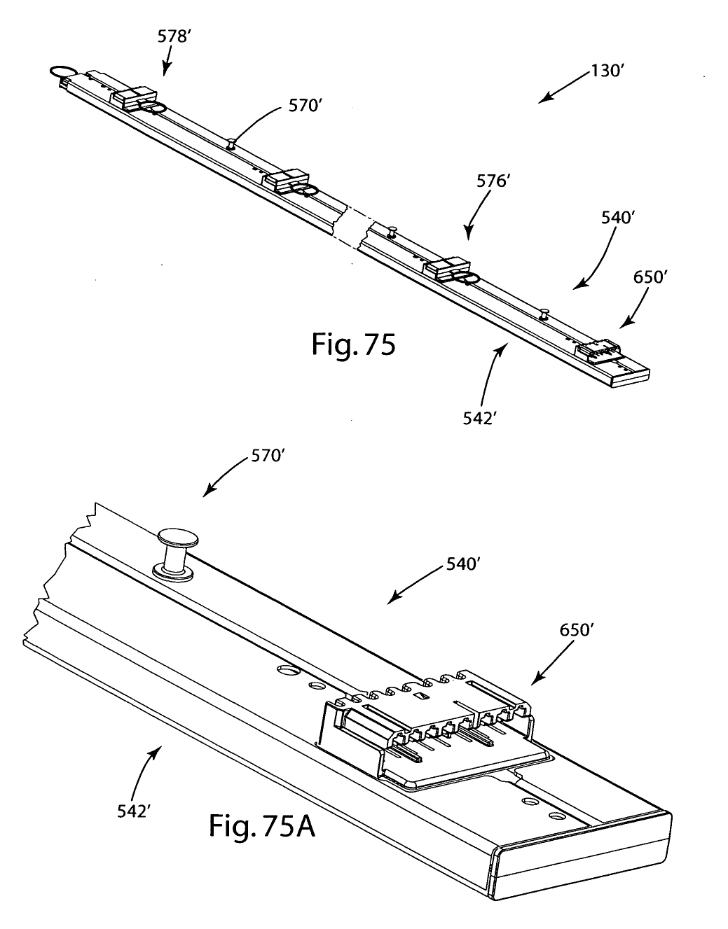

The modular plug assembly 130′, its electrical and mechanical interconnections to the receptacle connector module 1000 and its potential coupling to both the receptacle connector module 1000 and a main structural channel rail 102 are illustrated in FIGS. 75-83. Turning first to FIGS. 75-80D, the modular plug assembly 130′ may consist of a number of modular plug assembly sections 540′, only one of which is generally illustrated in the drawings. Each section 540′ of the modular plug assembly 130′ may be mechanically interconnected to a main structural channel rail 102. In this manner, power and communications carried on the modular plug assembly sections 540′ may be mechanically distributed throughout a structural grid or other structural network comprising the structural channel rails 102. Also, it should be emphasized that as previously described herein, with respect to modular plug assemblies 130, the assemblies do not necessarily have to be carried on structural channel rails. Instead, for example, the plug assemblies can be utilized in a “stand alone” configuration, such as being mounted to or within modular walls or the like. Still further, the modular plug assemblies may be utilized for carrying power and communication signals in any location associated with a spatial configuration, including within under floor or other types of floor access systems. In general, the modular plug assembly 130′ provides means for distributing power and communication signals throughout an electrical network, and also provides for network distribution for communication signals which may be applied among connector modules associated with various types of application devices.

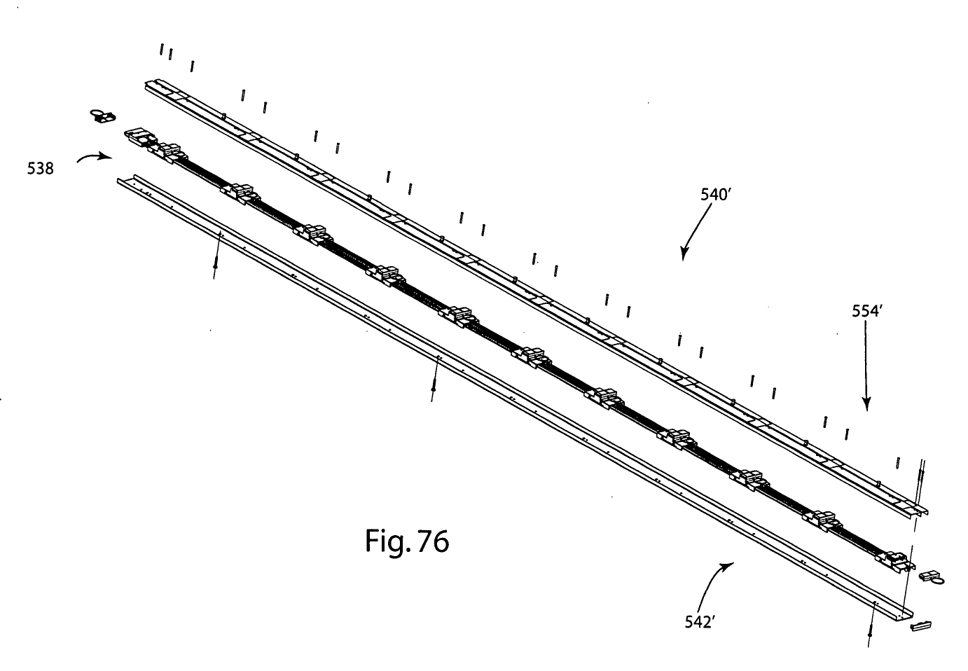

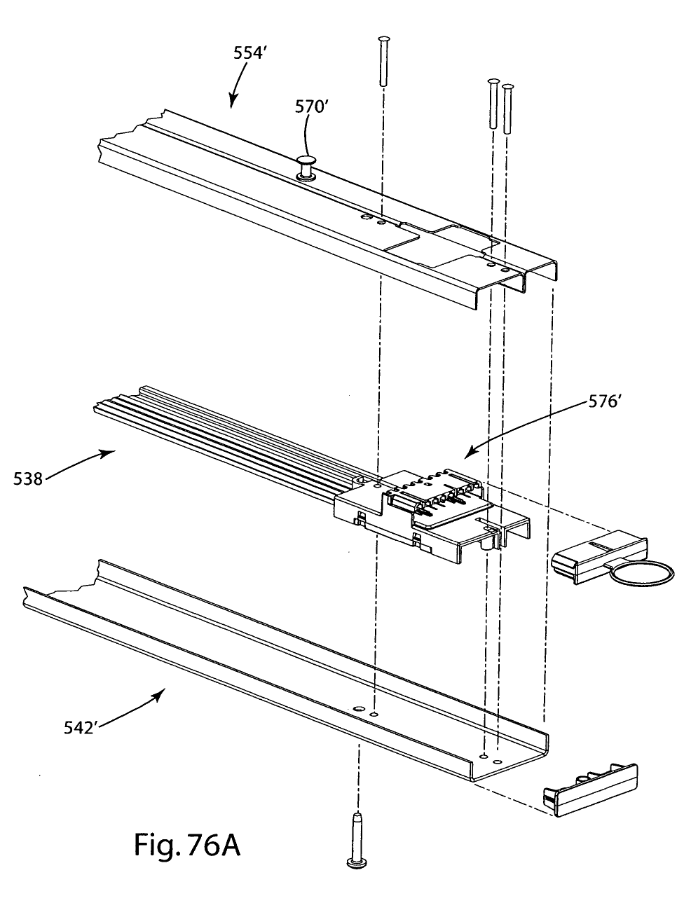

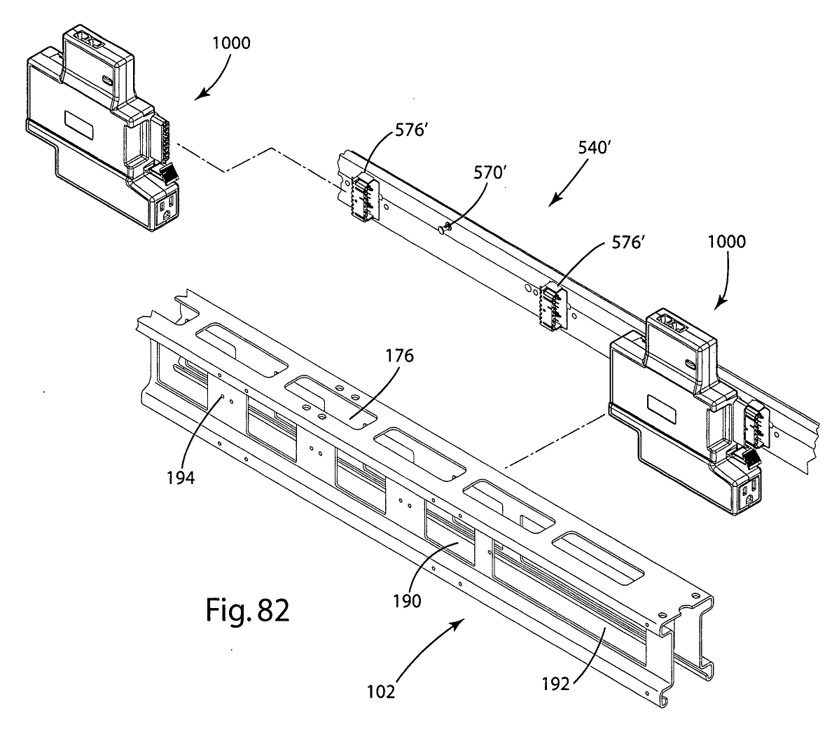

With reference to FIG. 82, the modular plug assembly section 540′ may be mechanically interconnected to a main structural channel rail 102, so as to provide for mechanical distribution of a number of modular plug assembly sections 540′ throughout a structural grid or other structural network. The main structural channel rail 102 illustrated in FIG. 82 corresponds to the main structural channel rail 102 previously described herein with respect to FIGS. 76-83. Accordingly, the main structural channel rail 102 will not again be described in detail. As also previously described herein, individual plug assembly sections 540 were capable of electrical interconnection together for the use of flexible connector assemblies. Similarly, the individual plug assembly sections 540′ are also capable of electrical interconnection through the use of the flexible connector assemblies.

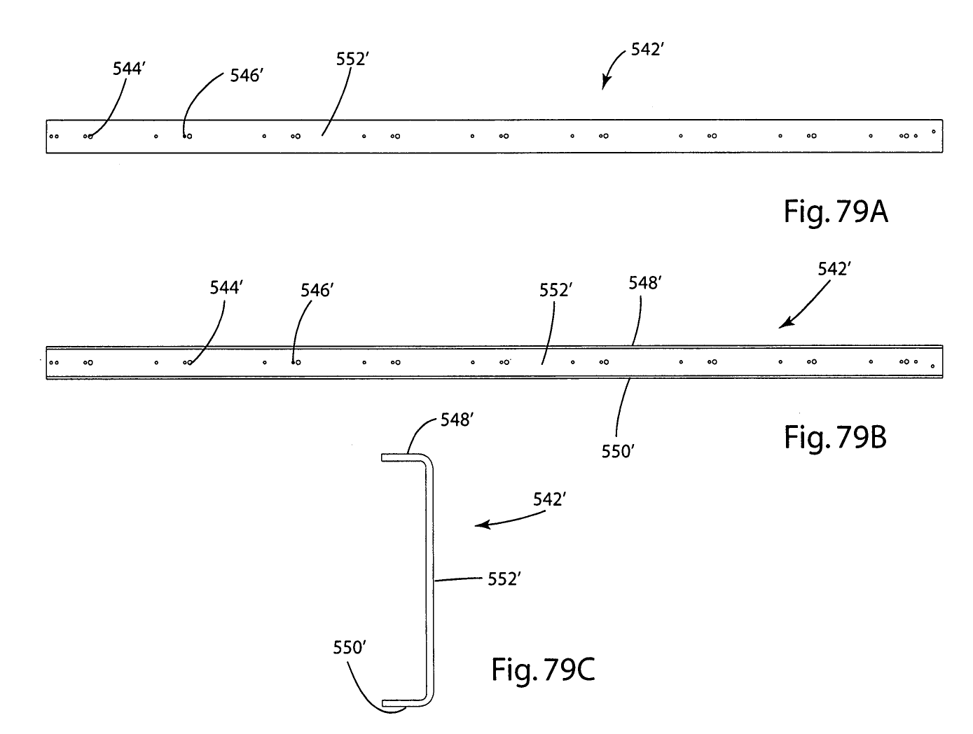

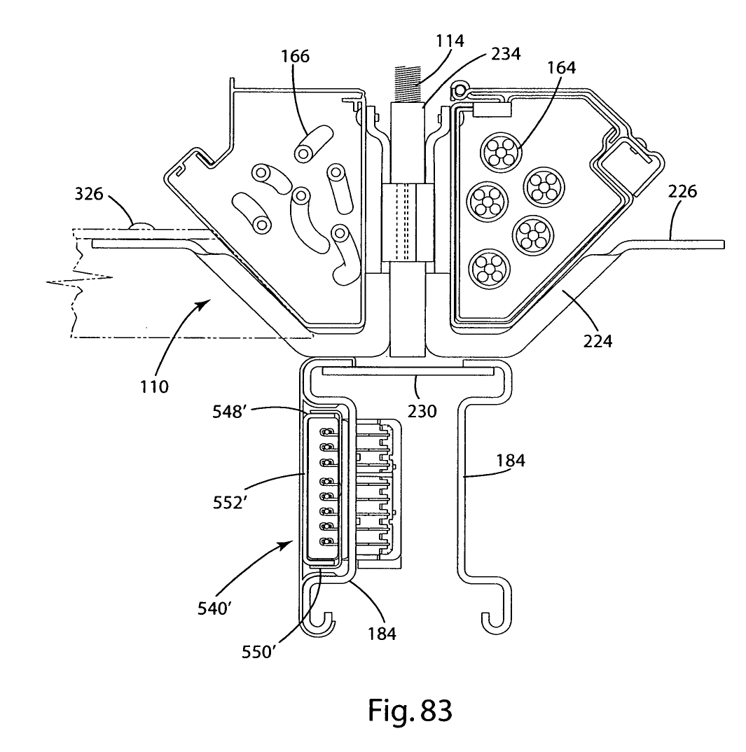

With reference primarily to FIGS. 76, 76A and 79A-79C, the elongated power assembly section 540′ includes an elongated power assembly cover 542′. The cover 542′ has a cross-sectional configuration as primarily shown in FIG. 79C. The cover 542′ includes a cover side panel 552′ which will be vertically disposed when the modular plug assembly section 540′ is secured within a structural channel rail 102. Integral with the cover side panel 552′ and curved inwardly therefrom is an upper section 548′, having a horizontally disposed configuration relative to the side panel 552′, as primarily shown in FIG. 79C. Extending inwardly from the lower portion of the side panel 552′ and integral therewith is a lower section 550′, again as shown in FIG. 79C. As shown primarily in FIGS. 5A, 8A and 8B, a first set of through holes 544′ are spaced apart and extend through the cover side panel 552′. Correspondingly, a second set of through holes 546′ are also spaced apart and extend through the cover side panel 552′. The power assembly cover 542′ is utilized to provide an outer cover for individual lengths of the elongated modular power assembly section 540′. When a power assembly section 540′ is mounted to a main structural channel rail 102, as illustrated in FIG. 83, the cover 542′ is positioned outwardly from the other components of the section 540′.

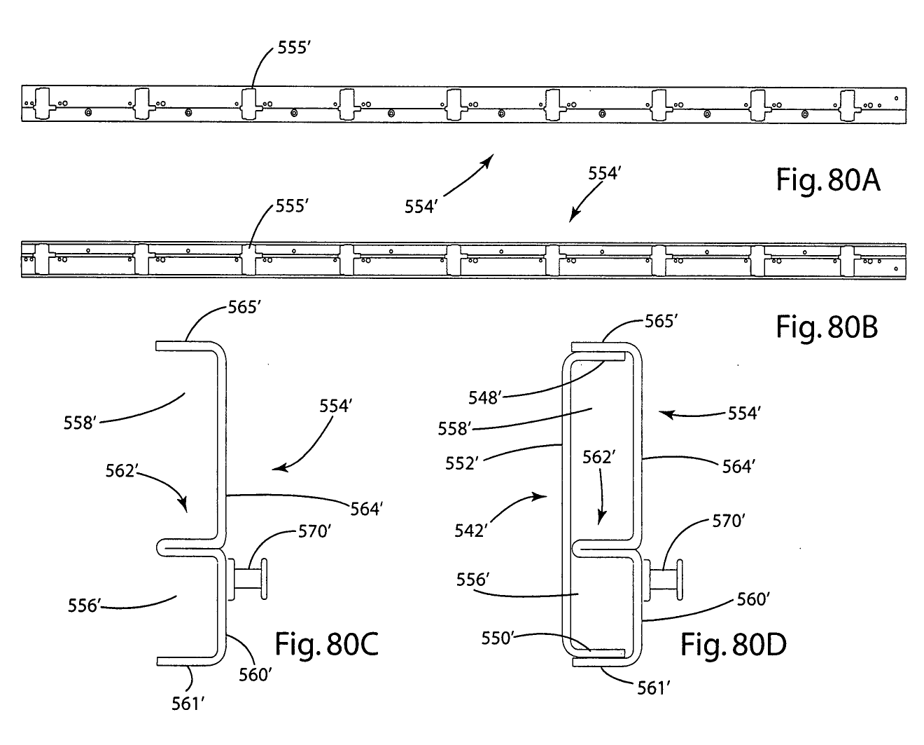

Each section 540′ of the modular plug assembly 130′ also includes what is characterized as an electrical divider 554′. One of the electrical dividers 554′ will be described primarily with respect to FIGS. 76 and 80A-80D. Each electrical divider 554′ provides an inner side of a modular plug assembly section 540′, and also forms channels for carrying communication cables and AC power cables, with electrical isolation there between. The electrical divider 554′ includes a communications channel 556′. The purpose of the channel 556′ is to carry the communications cables 572, which will be referenced in subsequent paragraphs herein and were described in detail in prior description herein. The communications channel 556′ is formed by an inner side panel 560′ integral with the section 561′, which is horizontally disposed and curves outwardly from the side panel 560′. The electrical divider 554′ also includes an AC power channel 568′. The purpose of the channel 568′ is to carry the communication cables 574, which will be referenced in subsequent paragraphs herein and were described in detail in prior description herein. The AC power channel 568′ is formed by an inner side panel 564′ integral with the section 565′, which is horizontally disposed and curves outwardly from the side panel 564′. Integral with and extending perpendicularly and outwardly from both the inner side panel 560′ and inner side panel 564′ is an inwardly directed divider tongue 562′. The divider tongue 562′ separates the communications channel 556′ and the AC power channel 568′. The divider tongue 562′ is primarily shown in FIGS. 80C and 80D, and curves inwardly on itself. Integral with and extending from the divider tongue 562′ is another inner side panel 564′. The inner side panel 564′ terminates with an integrally formed and perpendicularly curved lower section 565′. For purposes of connection of the electrical divider 564′ with the power assembly cover 542′, screw holes 568′ extend through the inner side panel 564′. These holes align with a second set of screw holes 546′ in the plug assembly cover 542′. Pan head or similar screws (with locking nuts) may be utilized for interconnection. Also extending through the lower inner side panel 564′ are a set of screw holes 566′. These holes 566′ are aligned with the first set of screw holes 554′ and the plug assembly cover 542′. Rivets or similar connecting means may be utilized with these holes, for purposes of interconnecting electrical divider 554′, power assembly cover 552′ and the modular plugs 576′ as described in subsequent paragraphs herein.

In addition to the foregoing components of the electrical divider 554′, the divider 554′ also includes a series of spaced apart ferrules 570′. The ferrules 570′ are best illustrated in FIGS. 75A, 76A and 80D. The ferrules 570′ may be secured to the inner side panels 560′ of the electrical divider 554′ in any suitable manner. The ferrules 570′ function in the same manner as previously described ferrules 570, for purposes of providing of coupling of connector modules to the modular plug assembly section 540′. The ferrules 570′ may have a stool or mushroom-shaped configuration, as hence will be shown in FIGS. 75A, 80C and 80D.

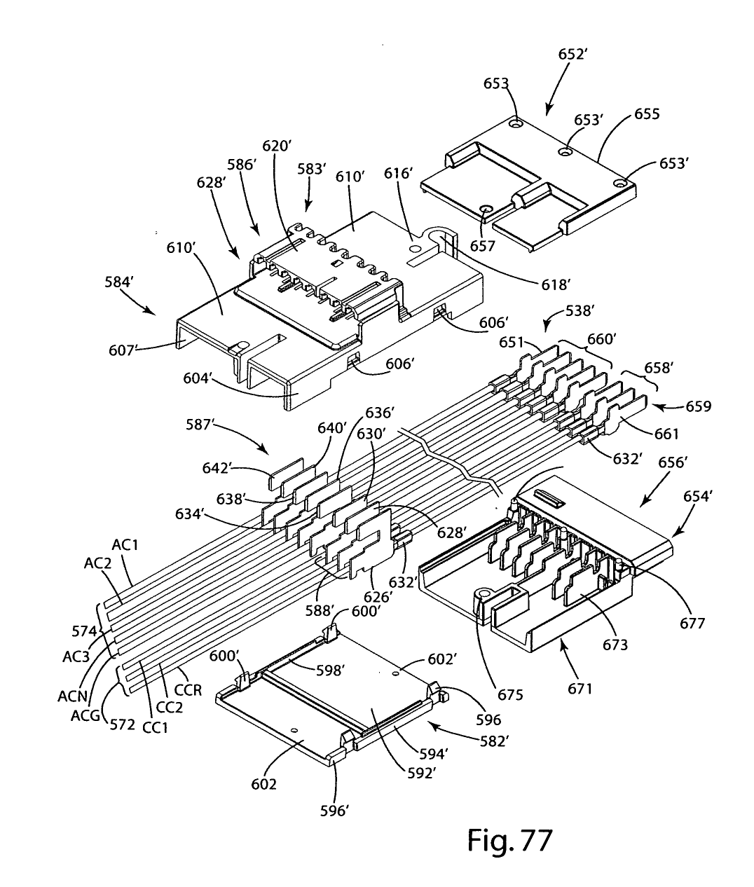

In addition to the power assembly cover 542′ and the electrical divider 554′, the plug assembly section 540′ also includes a wire assembly 538. The wire assembly 538 is substantially similar to components previously described herein with respect to the modular plug assembly sections 540. That is, the wire assembly 538 carries a set of the previously described communication cables 572, and a set of the previously described AC power cables 574. These are best illustrated in FIG. 77. The cables 572 and 574 function, in the modular plug assembly sections 540′, in the same manner as the cables 572 and 574 in the previously described modular plug assembly sections 540. The communication cables 572 carry digital communication signals throughout an electrical network, for purposes of providing programmability of connection modules associated with the application devices, and reconfiguration of control and controlling relationships among the application devices. In addition, the communication cables 572 can also be used, if desired, to carry low voltage DC power. As also previously described herein, the communication cables 572 can be singularly identified as communication cables CC1, CC2 and CCR. Correspondingly, the AC power cables 574 can be identified as AC cables AC1, AC2, AC3, ACN and ACG. With a five cable configuration as shown in FIG. 77, and is also previously described herein, the configuration can provide three separate circuits, with the circuits utilizing a common neutral and common ground. With this capability of selecting one of three AC circuits, the distributed network formed by the modular plug assembly 130′ can be effectively “balanced.”

As will be described in subsequent paragraphs herein, the modular plug assembly sections 540′ include modular plugs (and a distribution plug for each section 540′) substantially identical in function to the previously described modular plugs 576 and distribution plugs 650 associated with the modular plug assembly sections 540. As also previously mentioned, however, the modular plugs and distribution plugs used with the sections 540′ have a slightly differing structural configuration. These slightly differing modular plugs and distribution plugs will now be described, along with the means for electrical interconnection of these plugs to the wire assembly 538. More specifically, and primarily with reference to FIG. 77, the wire assembly 538 includes a series of modular plug blade set assemblies 587. Each modular plug blade set assembly 587 includes a series of three male communication blade terminals, forming a communications male blade set assembly 588′. The three communication blade terminals are identified in FIG. 77 as blade terminals 626′, 628′ and 630′. Attached to each of the three blade terminals 626′, 628′ and 630′ is a separate crimp portion of the corresponding blade terminal, which is referred to in FIG. 6 as a window stripping crimp 632′. In this regard, it would be possible to use crimping elements which are referred to as insulation displacement crimps. However, in this particular and preferred embodiment, the wires can be “window stripped,” thereby exposing a certain portion of the wire. The blade terminals are then crimped to the wire exposed by the window stripping operation. With this coupling connection, the crimp connectors 632′ will cause the communication cables 572 to each be conductively connected to one of the communications blade terminals 626′, 628′ or 630′. For example, the communication blade terminal 626′ may be conductively connected to the communications cable 572 previously designated as CCR. Correspondingly, male blade terminal 628′ may be conductively connected to cable CC2. Male blade terminal 630′ may be connected to cable CC1. As will be described subsequently herein, the communications male blade set 588′ may be appropriately positioned within a modular plug so that the terminating ends of the communication blades 626′ 628′ and 630′ extend outwardly and into the modular plug.

In addition to the communications male blade set 588′, the blade set assembly 587 also includes AC power male blade set 590′. As again shown in FIG. 77, the AC power male blade set 590′ has a configuration substantially similar to that of the communications male blade set 588′. The male blade set 590′ includes a series of five terminal blades, identified as blades 634′, 636′, 638′, 640′ and 642′. Connected to each blade of the male blade set 590′ is at least one crimp connector 632′. The crimp connector 632′ will be utilized to electrically and conductively interconnect each of the individual blades of the male blade set 540′ to different ones of the AC power cables 574. For example, FIG. 77 illustrates blade terminal 642′ connected to AC power cable AC1. Blade terminal 640′ is connected to AC power cable AC2, while blade terminal 638′ is connected to AC power cable AC3. Correspondingly, blade terminal 636′ is connected to power cable ACN, while blade terminal 634′ is connected to power cable ACG. As with the communications male blade set 588′, the AC power male blade set 590′ will be positioned within the subsequently described modular plug so as to be accessible to selectively interconnect to connector modules.

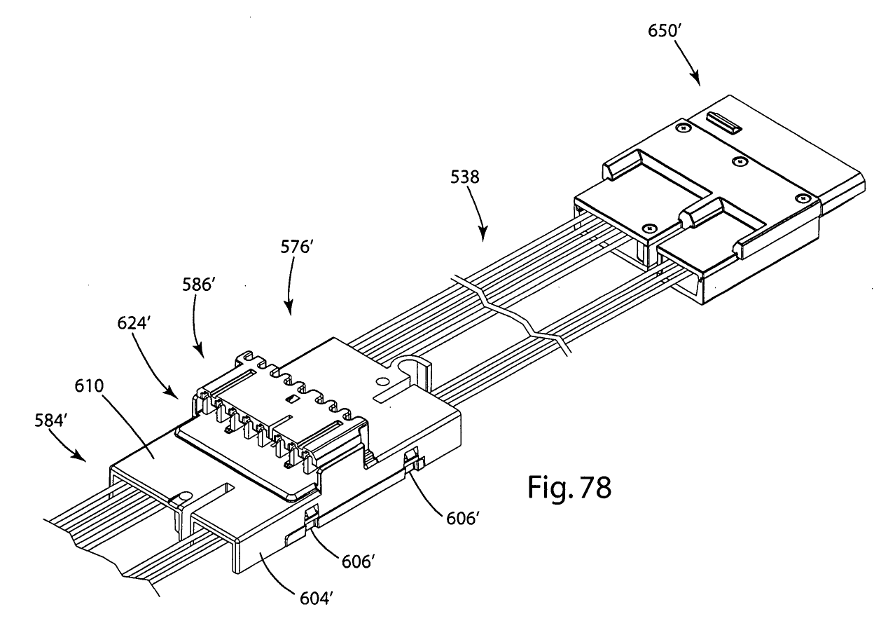

The previously described blade set assembly 587 can be characterized as being part of not only the wire assembly 538, but also as part of one of the modular plugs 576′ which is electrically coupled to the wire assembly 538 through the modular plug blade set assembly 587. With reference primarily to FIGS. 77 and 78, each modular plug 576′ includes a lid 582′ which is positioned on one side of the wire assembly 538. More specifically, the lid 582′ is positioned on the same side of the wire assembly 538 as is the elongated power assembly cover 542′. With reference primarily to FIG. 77, the plug lid 582′ includes a panel 592′. The panel 592′ includes a first edge 594′, with a pair of first tabs 596′ located at opposing ends of the edge 594′. A second edge 598′ extends along the opposing side of the panel 592′. A second pair of tabs 600′ are located at opposing ends of the second edge 598′. A pair of rivet holes 602′ are located at opposing sides of the panel 592′.

The modular plug 576′ also includes what could be characterized as a connector housing 583′, also best viewed in FIG. 77. The connector housing 583′ is positioned on the side of wire assembly 538 which opposes the side on which the lid 582′ is positioned. The connector housing 583′ is adapted to receive the blade set assembly 587 and to provide a position for connection of the blade assembly 587 to the connector module 1000. The connector housing 583′ includes an inner panel 584′. The inner panel 584′ includes a side panel 610′, with a first edge 604′ running therealong. Positioned on the first edge 604′ are a pair of slots 606′. When assembled, the projecting tabs 596′ of the lid 582′ will snap into place within the slots 606′. Although not shown in the drawings, slots similar to slots 606′ are located along a lower edge 607′ projecting inwardly from an opposing side of the side panel 610′. When assembled, the projecting tab 600′ will snap into place within the slots located along the edge 607′. As further shown in FIG. 6, extending through the side panel 610′ at one end thereof is a rivet hole 616′. Extending outwardly from this same end of the side panel 610 is a screw bail 618′.

The connector housing 583′ also includes a plug connector 586′. Again primarily with reference to FIGS. 77 and 78, the plug connector 586′ includes a projecting housing 620′, with the housing extending outwardly from the side panel 610′. Extending outwardly from one end of the projecting housing 620′ is a modular plug male terminal set housing 624′. For assembly of the modular plug 576′, the blade set assembly 587 can be inserted into the modular plug male terminal set housing 624′. The lid 582′ can then be coupled to the connector housing 583′, with the blade sets 588′ and 590′ externally accessible through the plug terminal housing 624′. In this regard, the tabs 596 of the lid 582′ can be secured within the slots 606′ of the panel 584′. Correspondingly, the tabs 600′ of the lid 582′ can be secured within slots (not shown) on the edge 607′ of the panel 584′. Rivets or similar connecting means can then be secured through the holes 602′ and 616′ so as to more rigidly secure together individual components of the modular plug 576′.

In addition to the modular plugs 576′ which are spaced apart and used along the sections 540′ of the modular plug assembly 130′, a somewhat modified plug is utilized at one end of each modular plug assembly section 540′. This plug is identified as a distribution plug 650′, and is illustrated in an exploded view in FIG. 77. The distribution plug 650′ substantially corresponds in function to the previously described distribution plug 650 as positioned on individual sections 540 of the modular plug assembly 130. That is, the distribution plug 650′ will be utilized, in combination with a flexible connector assembly (not shown) to electrically couple together adjacent sections 540′ of the modular plug assembly 130′. The distribution plug 650′ includes a top housing 652′ which is positioned on one side of the wire assembly 538. The top housing 652′ has a structural configuration as primarily shown in FIG. 77, and includes a set of through holes 653 extending therethrough at one end 655 of the housing 652′. A through hole 657 also extends through an opposing end of the top housing 652′.

In addition to the top housing 652′, the distribution plug 650′ can also be characterized as including a distribution plug blade set assembly 659. The blade set assembly 659 includes a communications male blade set 658′, and an AC power male blade set 650′. The communications male blade set 658′ includes three male blades 661. Correspondingly, the AC power male blade set 650′ includes a set of five blades 661. As with the blades previously described with respect to the modular plug 576′, the blades 661 are electrically coupled to appropriate ones of the AC power cables 574 and communications cables 572 through the use of crimp connectors 632′. For purposes of protectively receiving the blade set assembly 659, the distribution plug 650′ further includes a bottom housing 654′. Part of the bottom housing 654′ is a plug connector 656′. The bottom housing 654′ also includes a base section 671, having a set of dividers 673 for separating the individual sections of a terminal housing 656′. The base section 671 also includes a through hole 675 for receiving a rivet or similar connecting means. To assemble the distribution plug 650′, the bottom housing 654′ is brought into position with the wire assembly 538 so that the distribution plug blade set assembly 659 is received within the housing 656′. The top housing 652′ is then brought into position on the opposing side of the wire assembly 538, and appropriate connecting means are received through the through hole 653 and through hole 677 together with the separate components of the distribution plug 650′. Appropriate connecting means are also received through the through hole 657 and the through hole 675.

For assembly of the modular section 540′, the electrical divider 554′ includes a series of apertures 555′ positioned at spaced apart locations along the modular section 540′. These apertures are used to access the modular plugs 576′ and the distribution plug 650′.

Returning to the description of the connector module 1000, and as previously described herein, secured within the connector housing 1002 is a module circuit board assembly 1014, as primarily shown in FIGS. 74, 81 and 82. The board assembly 1014 includes various circuit components for purposes of functional operation of the receptacle connector module 1000. Many of these components substantially correspond to the structure and function of circuit board components previously described herein with respect to the receptacle connector module 144 and the board assembly 826. Accordingly, certain of the components of the board assembly 1014 will not be described in detail herein.

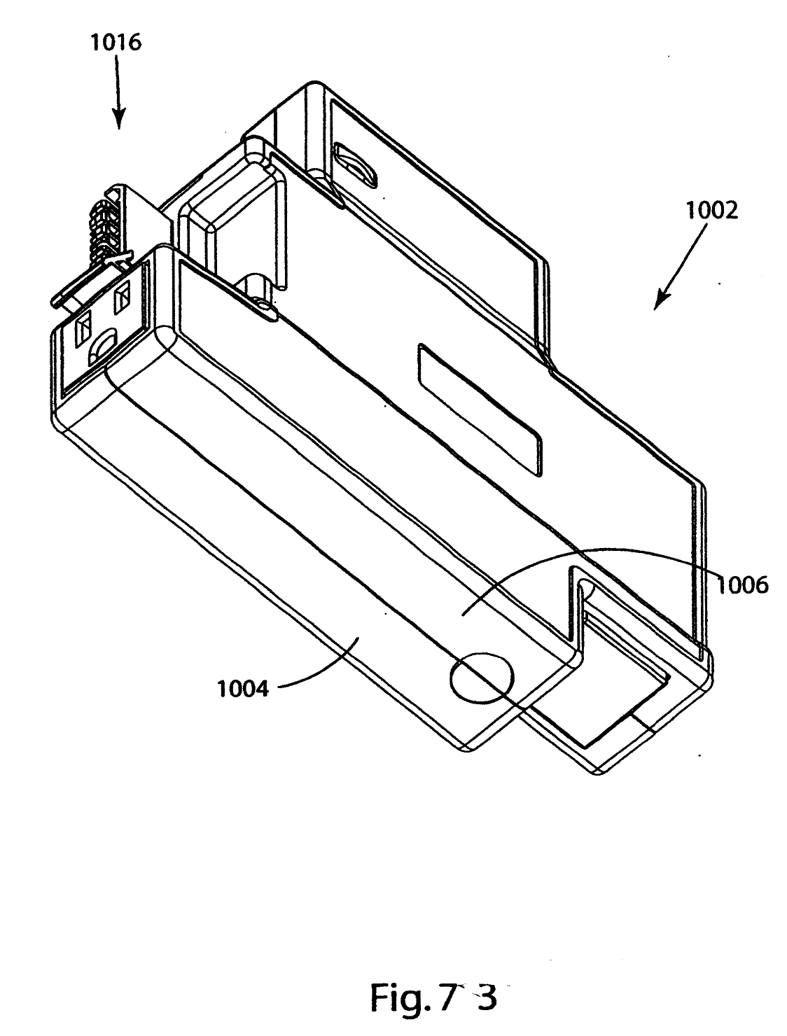

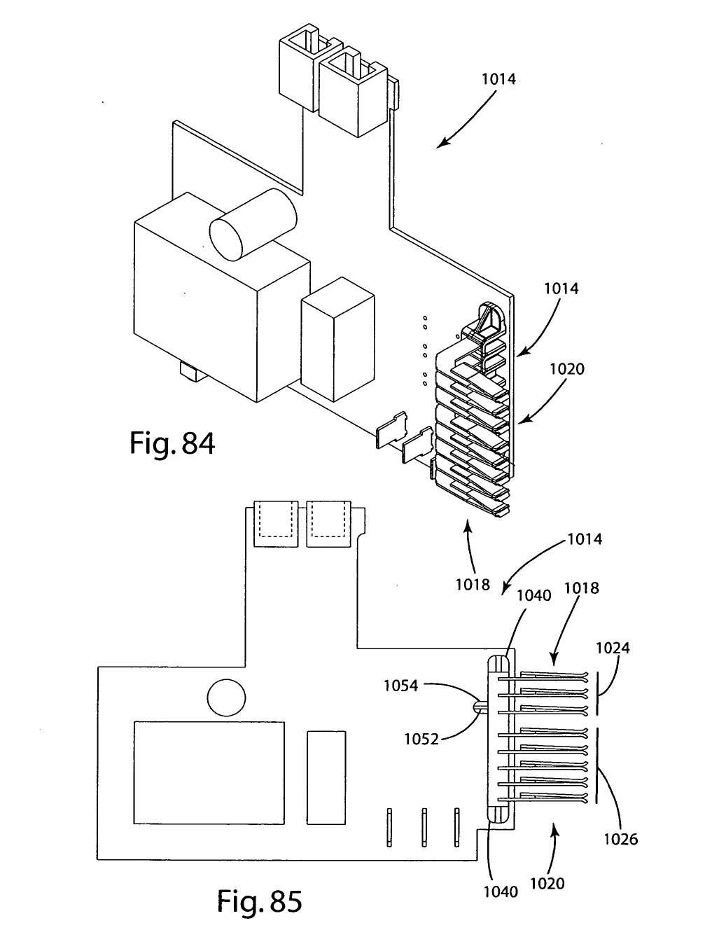

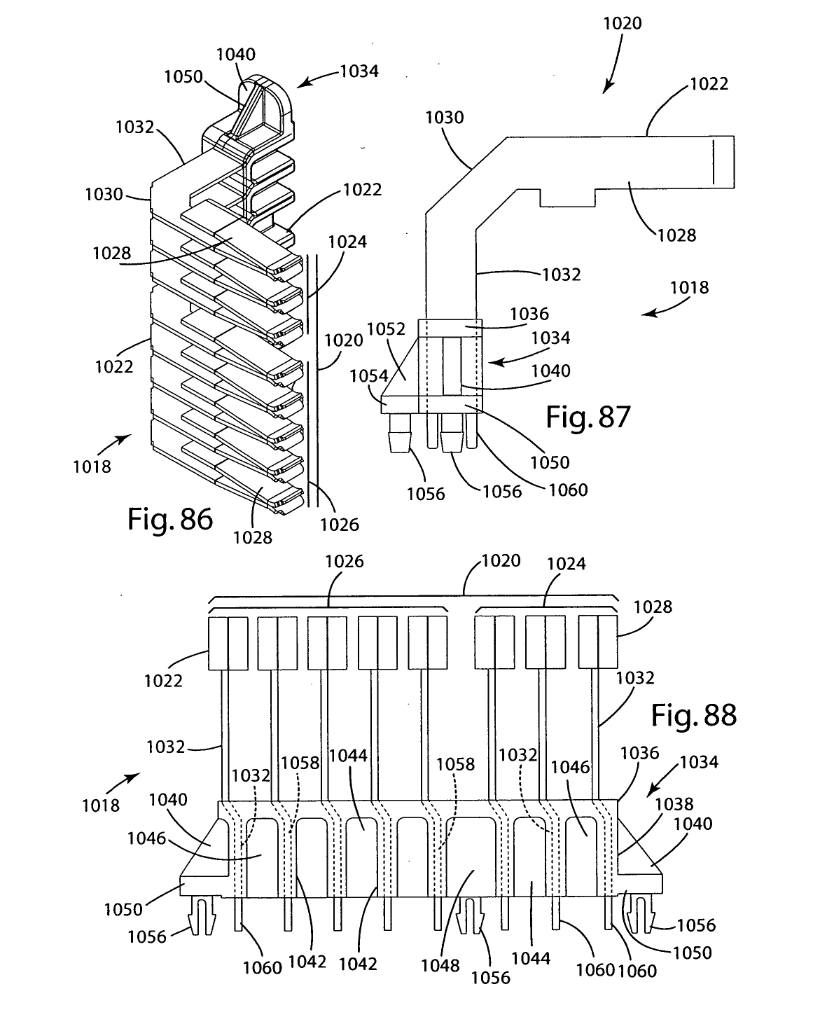

However, other components of the module circuit board assembly 1014 will be described in detail, particularly those which form an embodiment of certain of the aspects of the invention. In this regard, attention is directed primarily to FIGS. 73 and 84. As illustrated therein, the module circuit board assembly 1014 includes a module connector plug 1016 (FIG. 73). As will be apparent from subsequent description herein, the module connector plug 1016 is adapted to electrically mate with any of the various modular plugs 526′ which may be associated with a section 540′ of the modular plug assembly 130′ previously described herein and shown in FIGS. 75-80. As shown in FIG. 86 and a number of the other drawings, the module connector plug 1016 includes a module connector set 1018. The module connector set 1018 includes a terminal set 1020 comprising a series of vertically disposed eight female terminals 1022. For purposes of description, the female terminals 1022 can be characterized as consisting of a communications terminal set 1024 and a power terminal set 1026. When the receptacle connector module 1000 is electrically and mechanically coupled to a section 540′ of the modular plug assembly 130′, the communications terminal set 1024 will be electrically connected to the communications male terminal set 588′ previously described herein with respect to FIGS. 77 and 78. Correspondingly, five of the female terminals 1022 form the AC power female terminal set 1026. When coupled to a modular plug 576′ of a section 540′ of the modular plug assembly 130′, the AC power female terminal set 1026 will be electrically engaged with the AC power male terminal set 590′ of the modular plug 576′. In this manner, power and communications signals can be applied to the female terminal set 1020.

Turning primarily to FIGS. 86-91, and with reference first to FIG. 87, each of the eight female terminals 1022 includes a forwardly extending or distal section 1028. Extending rearwardly from the distal section 1028 and integral therewith is an angled section 1030. The angled section 1030 of each terminal 1022 is integral with a proximate section 1032. Each of the proximate sections 1032 of the female terminals 1022 has one end embedded within a plastic holder 1034. The plastic holder 1034, along with the terminal set 1020, forms the module connector set 1018.

The plastic holder 1034 will now be described primarily with respect to FIGS. 87, 88 and 89. With reference thereto, the plastic holder 1034 includes an upper rectangular section 1036 (the term “upper” referring to the view of the plastic holder 1034 shown in FIG. 88). Integral with the upper rectangular section 1036 and extending downwardly from each end thereof is a pair of outer walls 1038. Extending laterally from the outer walls 1038 are outer support ribs 1040. The support ribs 1040 facilitate rigidity and strength of the plastic holder 1034. Again primarily with respect to FIG. 88, the plastic holder 1034 also includes individual ones of interior sidewalls 1042 extending outwardly from opposing sides of backwall 1044. Although FIG. 88 only shows the sidewalls 1042 on one side of the plastic holder 1034, the sidewalls 1042 also extend outwardly from the other side of the plastic holder 1034. The sidewalls 1042 and backwalls 1044, on each of the opposing sides of the plastic holder 1044, form sets of recesses 1046. As shown in FIG. 88, the recesses 1046 are all of substantially equivalent size, with the exception of one recess identified as the relatively larger recess 1048. As apparent from FIG. 88, the relatively larger recess 1048 exists between and separates the communications terminal set 1024 from the AC power terminal set 1026.

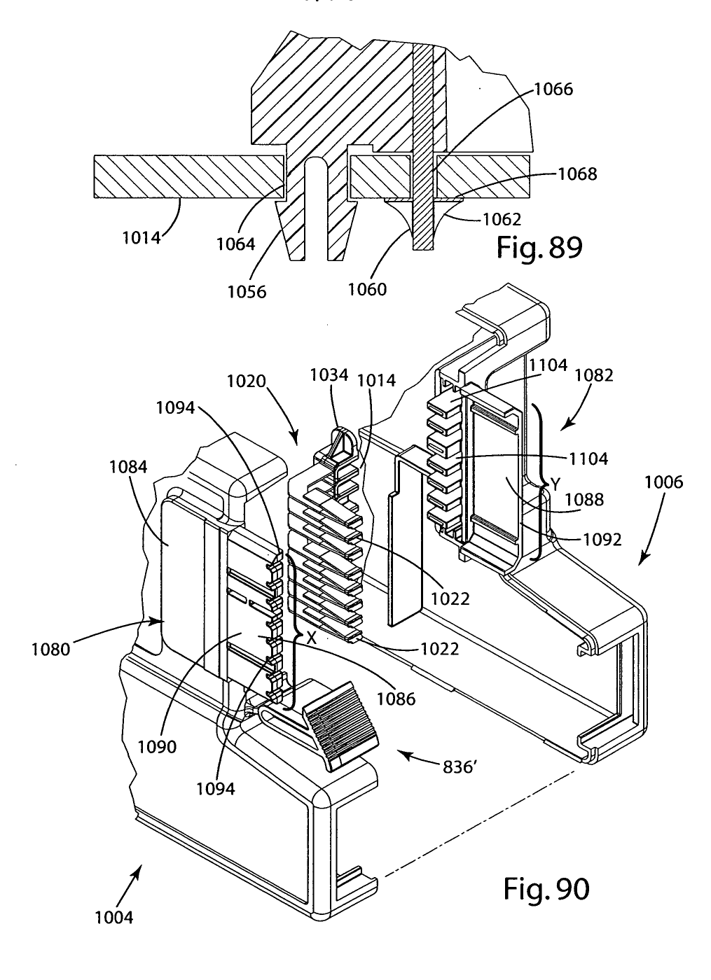

As further shown in FIGS. 87 and 88, the plastic holder 1034 also includes a pair of opposing, outer support bases 1050. The bases 1050 are integral with the outer walls 1038. In addition to the outer support ribs 1040 and outer support bases 1050, the plastic holder 1034 also includes an interior support rib 1052 shown in FIG. 87. The interior support rib 1052, although not apparent from FIG. 87, extends outwardly from within the relatively large recess 1048 on the side of the plastic holder 1034 opposing the side of the plastic holder 1034 which is visible in FIG. 88. Integral with the interior support rib 1052 is an interior support base 1054, also shown in FIG. 87. Extending downwardly from the outer support bases 1050 and the interior support base 1054 are individual ones of a set of three resilient snap tabs 1056. As shown in FIG. 89, the snap tabs 1056 can be utilized to provide a means for securing the plastic holder 1034 to the module circuit board assembly 1014. The snap tabs 1056 are integral with the support bases 1050 and 1054, and are formed as part of the molded plastic holder 1034.

Also formed as part of the plastic holder 1054 during the molding process is a set of molded slots 1058 (FIG. 88). As also shown in FIG. 88, the proximate sections 1032 of the female terminals 1022 extend into the molded slots 1058. During the molding process for the plastic holder 1034, the distal sections 1032 of the female terminals 1022 are intermolded to the plastic holder 1034.

Extending downwardly from the proximate sections 1032 of the female terminals 1022 and integral therewith are a set of terminal contacts 1060. The terminal contacts 1060 are actually an extension of the proximate sections 1032. To assemble the module connector set 1018, with the terminal set 1020 and plastic holder 1034, to the circuit assembly 1014, the resilient snap tabs 1056 can be snap fitted into appropriate recesses 1064 (FIG. 90) within the circuit board assembly 1014. Correspondingly, the terminal contacts 1060 can be inserted through recesses 1066 within the circuit board assembly 1014. The terminal contacts 1060 can be somewhat secured to the board assembly 1014 through grommets 1068 which are electrically connected to printed circuits on the circuit board assembly 1014. With the terminal contacts 1060 extended through the grommeted other recesses 1066, solder 1062 can be applied to each of the terminal contacts 1060, through processes such as wave soldering. The soldering thereby provides a secure and rigid electrical connection between the terminal contacts 1060 and appropriate circuits on the circuit board assembly 1014.

The aforedescribed modular connector set 1018 provides several advantages in accordance with the invention. For example and as earlier described herein, the AC power terminal set 1026 may include five terminals. Three of these terminals may represent “hot” terminals, while another may represent a neutral terminal, and a still further one may represent a ground terminal. The five terminals 1022 thereby provide for a selection among three AC power circuits. Correspondingly, the three female terminals 1022 which form the communications terminal set 1024 may be utilized to provide for a low voltage communications system. The module connector set 1018 as described herein therefore provides for different voltage contacts to be simultaneously wave soldered to the circuit board assembly 1014. Several advantages are provided by the foregoing, including cost savings through facilitating the simplicity of associated processes, and relatively easier production.

As previously described herein, the receptacle connector module 1000 is similar in structure and function to the previously described receptacle connector module 144. However, as also previously described herein, the receptacle connector module 1000 includes modified structure in the form of a module connector plug 1016 which is formed through a module connector set 1018. The module connector set 1018 includes a terminal set 1020 and a plastic holder 1034. The advantages of this configuration of a module connector plug in accordance with the invention have been set forth in the prior description herein.

The receptacle connector module 1000 also includes certain other features in accordance with the invention, and distinct from the receptacle connector module 144 as illustrated in FIG. 37. More specifically, and with reference first to FIG. 37, the connector plug 828 of the receptacle module 144 includes a connector plug housing 829. The connector plug housing 829 was adapted to mate with the male terminal set housing 624 of each of the module plugs 576 of the module plug assembly 130. As apparent from FIG. 37, the connector plug housing 829 comprises a structure which is mounted to the board assembly 826 and essentially forms somewhat of a separate “element” of the connector module 144. In particular, it is apparent that the connector plug housing 829 is a structure separate and independent from either the front housing cover 822 or the rear housing cover 824 of the connector housing 820. As well known in the manufacturing arts, and in particular with the manufacture of molded parts, costs tend to increase as the number of separately manufactured parts tends to increase. Accordingly, it would be advantageous if the connector plug housing 829 was not a required part for the receptacle connector module 144. However, such a housing 829 is required, not only for appropriate mechanical and electrical interconnection to modular plugs 576 of the modular plug assembly 130, but also in accordance with governmental regulations and specifications for electrical components. In this regard, the connector plug housing 829 clearly provides a protective housing for the female terminals 830 of the connector plug 828.

In view of the foregoing, and in accordance with certain aspects of the invention, the receptacle connector module 1000 provides for an appropriate housing for the female terminal set 1020, while not requiring such a housing to be manufactured as a component separate and independent from other components of the receptacle connector module 1000. In fact, the appropriate housing for the female terminal set 1020 is actually formed as a pair of components integral with the front housing cover 1004 and the rear housing cover 1006. This housing will now be described in effect to FIGS. 74, 89 and 90. As earlier described herein, and with reference to FIG. 74, the receptacle connector module 1000 includes a connector housing 1002 having a front housing cover 1004 and rear housing cover 1006. The circuit board assembly 1014 is located within the connector housing 1002, when the connector module 1000 is fully assembled. The module connector plug 1016 having the module connector set 1018 was also previously described herein. The module connector set 1018 includes the female terminal set 1020 and the plastic holder 1034.

The housing of the module connector plug 1016 will now be described, primarily with respect to FIGS. 74, 89, 90 and 91. With respect first to FIGS. 74 and 90, the front housing cover 1004 includes a raised, front terminal housing cover 1080. Preferably, the raised front terminal housing cover 1080 is formed integral with the remaining portions of the cover 1004. This formation is also preferably achieved through a molding process. The module connector plug 1016 also includes a rear terminal housing cover 1082. The rear terminal housing cover 1082 is preferably formed integral with the rear housing cover 1006. The raised front terminal housing cover 1080 includes a raised front base portion 1084 formed on the front housing cover 1004. With reference to the view of FIG. 90, a front terminal blade cover 1086 is formed integral with the molded front base section 1084 and extends toward the right of the molded front base section 1084 as viewed in FIG. 90. Correspondingly, the rear terminal housing cover 1082 includes a rear terminal blade cover 1088, formed integral with the rear housing 1006.

As further shown in FIGS. 74 and 90, the front terminal blade cover 1086 includes a first terminal housing sidewall 1090. Still further, the module connector plug 1016 includes an opposing second terminal housing sidewall 1092, formed as part of the rear terminal blade cover 1088. The first terminal housing sidewall 1090 forms a front housing blade containment section, in the form of a vertical with a beveled edge at the top and bottom. The vertical has a height X as shown in FIG. 90. Correspondingly, the opposing second terminal housing sidewall 1092 has a “reversed C-shaped” (as viewed in FIG. 90) configuration, with a height Y, which is less than height X. These sidewalls 1090 and 1092 are configured so as to appropriately mate when assembled together. Further, the sidewalls 1090 and 1092 are also appropriately sized and configured so as to appropriately mate with the housing 624′ of a modular plug 572′ associated with a modular section 540′.

With further reference to FIGS. 74 and 90, the connector terminal assembly further includes, as part of the front terminal blade cover 1086, a series of terminal blade slots 1094 formed in the blade cover 1088. The terminal blade slots 1094 include a separate blade slot 1094 for each of the eight female terminals 1022 which form part of the module connector set 1018. When the connector housing 1002 is fully assembled, the forwardly extending distal sections 1028 of the female terminals 1022 will be received within the terminal blade slots 1094.

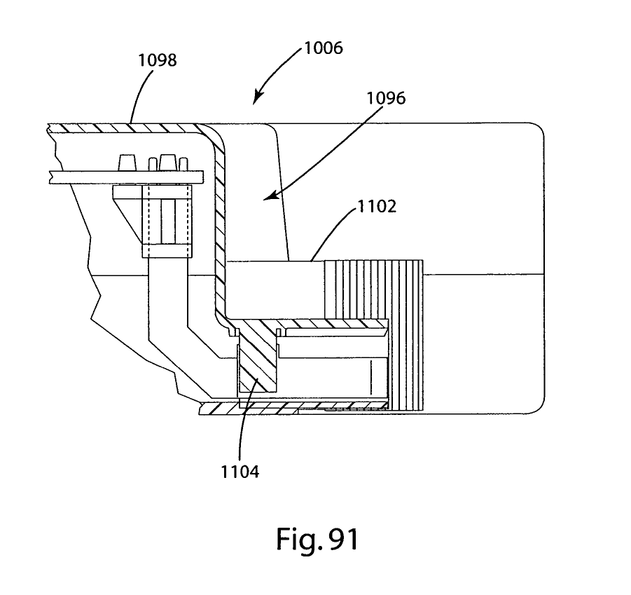

FIG. 91 is a cross-sectional view of a portion of the module connector plug 1016, when the connector housing 1002 is fully assembled. As illustrated therein, the rear housing cover 1006 includes a wall 1096, shown in cross-sectional configuration in FIG. 91. The wall 1096 includes the first section 1098, right-angle section 1100 and further section 1102. Extending inwardly from the further section 1102, and preferably formed integral therewith, are a set of stabilizing fingers 1104. The stabilizing fingers 1104 are also shown in FIG. 90. Turning now to the assembled configuration of the connector housing 1002 and the module connector plug 1016, the front housing cover 1004 can be (with reference to FIG. 90) moved toward the rear housing cover 1006, with the board assembly 1014 appropriately secured to the housing covers 1004, 1006. The housing covers 1004, 1006 can then be secured together through the use of projecting and recessed rims associated with the edges 1007, 1008, along with ultrasonic welding at the sonic weld locations 1013, as previously described and illustrated in FIG. 74. With the housing covers 1004, 1006 assembled together, the raised front terminal housing cover 1080 and rear terminal housing cover 1082 form a complete terminal housing which physically captures and “isolates” the module connector set 1018 from the other portions of the interior environment of the connector housing 1002 and from the exterior environment of the connector housing 1002, with the exception of the distal sections 1028 of the terminal set 1020 being made accessible for electrical and mechanical interconnection to male terminals of module plugs associated with modular plug assemblies. In the assembled configuration, each of the eight female terminals 1022 is captured within a corresponding one of the terminal blade slots 1094. Correspondingly, each of the raised separation teeth 1104 extends in between the corresponding pairs of the female terminals 1022. The teeth 1104 extend beyond the plane of the rear housing, and sit within a channel in the mold, in the inside portion of the front housing. When the two housings 1004, 1006 are secured together, each female terminal 1022 is separated from the adjacent terminal on each side by the separation teeth 1104. In accordance with the foregoing, and in accordance with certain aspects of the invention, the module connector plug 1016 has been formed with a protective terminal housing formed from the raised front terminal housing cover 1080 and the rear terminal housing cover 1082 integrally molded with the front housing cover 1004 and rear housing cover 1006, respectively. It is believed that this configuration meets current national and other governmental standards for electrical apparatus in the form of the module connector set 1018, including standards such as one commonly known as Underwriters Laboratories (UL) Standard 183. Further, it is apparent from the foregoing description that an appropriate protective housing has been formed for the module connector set 1018, without requiring the molding or other manufacturer of a protective cover as a component separate and independent from any other components associated with the receptacle connector module 1000.

For purposes of securing the connector module 1000 to a modular plug 576′, a connector latch assembly 836′ is provided, as illustrated in FIG. 74. The connector latch assembly 836′ shown in FIG. 74 substantially corresponds to the connector latch assembly 836 previously described herein with respect to connector module 144 and illustrated in FIGS. 42 and 43. More specifically, with reference to FIG. 74, the plug connector includes a mating ramp 870′. The mating ramp 870′ has an inclined ramp surface, with the lower end thereof terminating in a ramp edge 874′. The connector latch assembly 836′ also includes a brace 876′ integral with or otherwise coupled to a lower portion of the connector plug of the connector module 1000. Projecting outwardly from the brace 876′ is a resilient arm 878′. The distal end of the resilient arm 878′ terminates in a pair of fingers 880′. The fingers 880′ are integral with or otherwise connected to an inclined latch shoe 882′. The resilient arm 878′ and fingers 880′ are sufficiently flexible so that the latch shoe 882′ can be flexed outwardly. The remaining functional operation of the connector latch assembly 836′ is substantially identical to the functional operation of the previously described connector latch assembly 836, illustrated in FIGS. 42 and 43.

The internal circuitry of the receptacle connector module 1000 is represented by the board assembly 1014. The internal circuitry on board 1014 can essentially correspond to the circuitry previously described herein and illustrated on board assembly 826 as illustrated in FIG. 37. More specifically, this internal circuitry is illustrated in the diagram of FIG. 44A. That is, the receptacle connector module 1000 includes an IR receiver adapted to receive spatial IR signals from a manually operable and hand-held device, such as the wand 892 previously illustrated in FIG. 44A. The wand 892 is operated by a user and functions as previously described herein. Incoming spatial IR signals are received by the IR receiver, and converted to electrical signals applied as input signals to a processor and associated repeater circuitry. Communication signals are received from communication cables running through sections of a corresponding modular plug assembly, with the signals tapped off from a plug connector of one of the modular plugs spaced along a section of the modular plug assembly. The functionality associated with the application of electrical power signals and communication signals would correspond to the functionality previously described herein with respect to receptacle connector module 144.

Other aspects of the invention related to connector modules and other sensors and actuators will now be described with respect to FIGS. 72-101. With the connector modules, switches and other type of sensors which have been previously described herein, certain features are relatively apparent. First, the application devices which have been previously described herein, and which can be characterized as sensors, have been shown as being electrically interconnected to associated connector modules solely through the use of patch cords connected to connector ports associated with the sensor and connector ports associated with the connector module. For example, FIG. 58E illustrates a switch 823 having connector ports 849. A partial patch cord 851 is shown as being interconnected to one of the connector ports 849. Correspondingly, FIG. 44A illustrates the receptacle connector module 144, with connector port 840. Although not shown in FIG. 44A, the patch cord 851 could be interconnected at its other end to one of the connector ports 840. Communication signals and DC power from the connector module 144 could be transmitted through lines 922 and/or 924 through the connector ports 840 to the interconnected switch A23. Correspondingly, the interconnected switch 823 can also transmit communication signals back to the receptacle connector module 144 through the patch cord 851, connector ports 840 and lines 922, 924. With the foregoing types of interconnection, several features associated with the sensors (e.g., switch 823) and connector modules (e.g., connector module 144) previously described herein are relatively apparent. First, with the previously described interconnection of the connector module 144 to the switch 823, the switch 823 essentially acts as a physical and electrical component separate and independent from the connector module 144. Further, it is also apparent that if the user desires to physically move the switch or other sensor to be relocated, the switch or other sensor would only need to be reconnected to the system through the use of a patch cord.

Another issue arises with respect to the types of sensors which the user wishes to interconnect to the electrical network. For example, certain types of sensors, such as occupancy detectors, require low voltage DC power for operation. In this regard, a number of known types of occupancy detectors typically require 24V power for operation. As will be described in subsequent paragraphs herein, certain aspects of the invention are associated with connector modules which can be directly mechanically connected to sensors, and electrically connected to a sensor so that the sensor and connector module can essentially be characterized as a “single” unit. Further, such a connector module can be appropriately wired so that when the combination of the connector module and sensor are mechanically and electrically connected to the modular plug assembly 130, the modular plug assembly 130 can be characterized as “directly” providing requisite power to the sensor. That is, the sensor can be characterized as having a “direct connection” to the modular plug assembly 130.

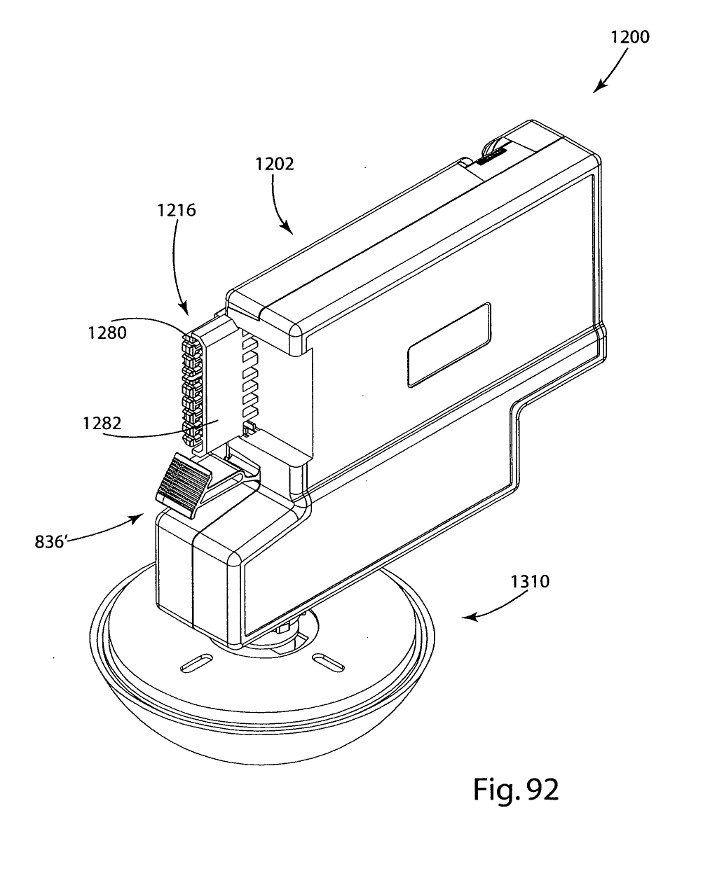

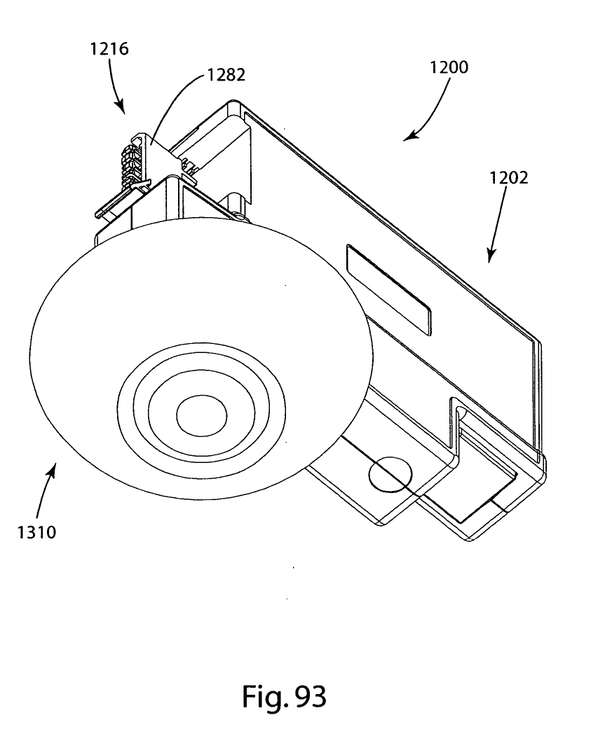

A connector module having these additional features in accordance with certain aspects of the invention is illustrated in FIG. 92 as low voltage connector module 1200. The connector module 1200 is further shown in FIGS. 93-97, 98 and 99. The connector module 1200 can include a number of features previously described with respect to connector module 1000, with these features comprising certain aspects of the invention. In view of similarities between the connector module 1000 and the connector module 1200, various elements associated with the physical structure of the connector module 1200 will not be described in detail. As shown particularly in FIGS. 92, 93 and 94, the low voltage power connector module 1200 includes a connector housing 1202, having a front housing cover 1204 and rear housing cover 1206. The housing covers 1204, 1206 are coupled together in the same manner as the housing covers 1004, 1006 were coupled together, as previously described with respect to FIG. 74. As shown in FIG. 93, the connector module 1200 can include a board assembly 1214 which can be substantially similar to the board assembly 1014 previously described with respect to connector module 1000. In accordance with certain aspects of the invention, the connector module 1200, like the connector module 1000, can include a module connector plug 1216, formed in part by the front terminal housing cover 1280 and rear terminal housing cover 1282. The module connector plug 1216 also includes a module connector set 1218, comprising a terminal set 1220 and plastic holder 1234. These components of the connector module 1200 correspond in structure and function to identically named components of the connector module 1000.

As apparent from the name identification for the connector module 1200, the module 1200 is adapted to be mechanically and electrically connected to a device requiring application of low voltage, such as an occupancy detector. Such an occupancy detector is illustrated as detector 1310 in FIGS. 92-94, 98 and 99. As will be explained in greater detail in subsequent paragraphs herein, the occupancy detector 1310 is mechanically directly connected to the connector module 1200, and is also directly wired to electrical components of the connector module 1200.

One problem which exists for connector modules directly connected to sensor devices (such as the occupancy sensor 1310) relates to wiring connections between the connector module 1200 and the occupancy sensor 1310. Within the industry, there are many different types and brands of occupancy sensors or motion detectors. Accordingly, it would be preferable if the desired occupancy sensor (and other types of sensors requiring low voltage power) could be “field wired” to the connector module on site. However, one obstacle to such field wiring relates to governmental and institutional codes and regulations regarding electrical apparatus and assembly processes. For example, the National Electric Code, Article 604 governs the use of “manufactured wiring systems.” Underwriters Laboratories Standard 183, previously referenced herein, also relates in part to modular pre-wired systems. The basis of these codes and standards essentially relate to the concept that the relationship between current-carrying parts should be established at the time of manufacture, and should not be dependent upon installation personnel. On the other hand, however, field wiring terminals are allowed for connection to building power and the like. In this regard, and as these codes and standards apply to electrical apparatus such as the connector module 1200 (and other connector modules previously described herein), field wiring of electrical devices to the connector module is not permitted, if such wiring would require “opening” of the connector module by disassembly of the housing. Such disassembly would expose the circuits and other electrical components on the circuit board assembly.

An alternative to field wiring of sensor devices to the low voltage power connector module would be to actually have the connector modules and associated sensor devices pre-wired prior to transport to the field. However, such pre-wired connector modules and sensor devices would still need to be approved by UL for each different type and brand of sensor devices which may be assembled with the connector module. Such processes are essentially untenable. In addition, such pre-wired devices would result in substantial complexity with respect to inventory.

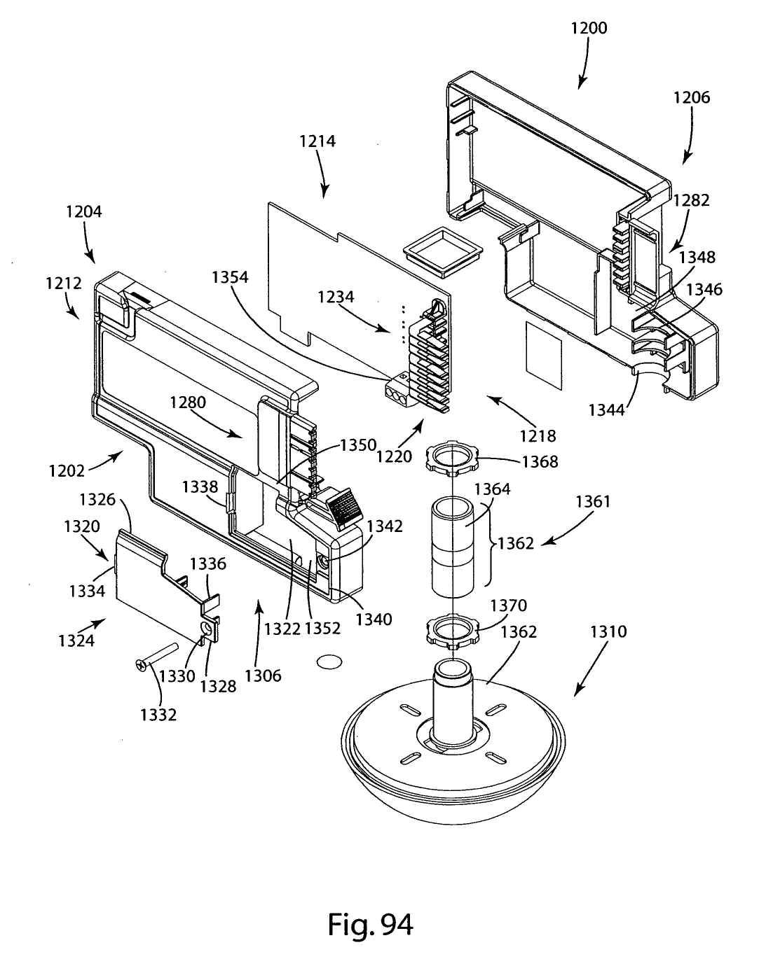

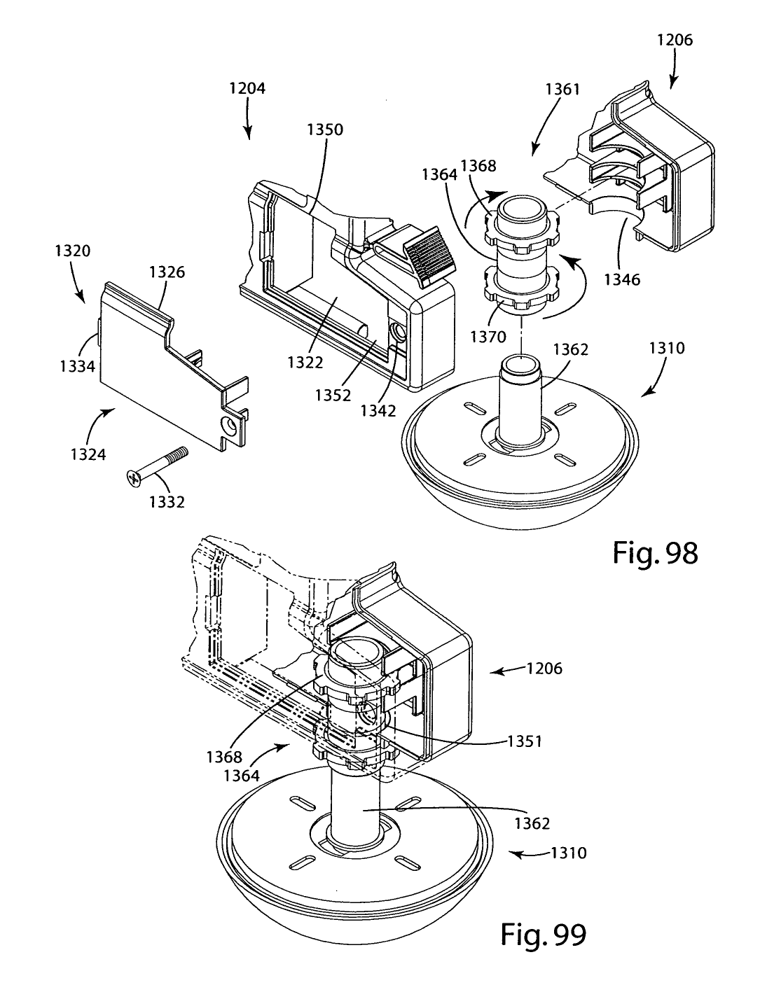

To overcome these problems, the connector module 1200 in accordance with certain aspects of the invention includes a wiring compartment 1320, as primarily illustrated in FIGS. 94-100. It will be apparent from subsequent description herein that the wiring compartment 1320 provides a means for field wiring of various types of application devices directly to appropriate connector modules, while still meeting various governmental and institutional electrical codes and regulations. Turning first to FIGS. 94-96, the wiring compartment 1320 is essentially formed within the front housing cover 1204 and rear housing cover 1206 when the connector housing 1202 is fully assembled. The wiring compartment 1320 includes an interior wiring closet 1322. The interior wiring closet 1322 is formed as a spacial area within the front housing cover 1204 and rear housing cover 1206, and is enclosed in the back by a compartment back 1348 formed within the rear housing cover 1206 (FIG. 94). To open the enclosed wire compartment 1320, the compartment 1320 also includes a compartment lid 1324 as also primarily shown in FIG. 94. The compartment lid 1324 includes a horizontal latching ledge 1326 and a side latch 1334. The side latch 1334, when the compartment lid 1324 is to enclose the interior wiring closet 1322, engages a latch slot 1338 on the front housing cover 1204. The supporting latch ledge 1326 engages an upper wall 1350 of the interior wiring closet 1322. As further shown in FIG. 94 and FIG. 98, the compartment lid 1324 includes a screw tab 1328 extending laterally from the lid 1324. Extending through the screw tab 1328 is a screw hole 1330. The screw hole 1330 is adapted to engage a machine screw 1332 or similar type of connecting means for releaseably securing the compartment lid 1324 to the wiring closet 1322. As partially shown in FIG. 23, a pair of nipple half flanges 1336 are secured within or otherwise integral with the interior surface of the compartment lid 1324. Turning to components of the wiring compartment 1320 associated with the front housing cover 1204 and rear housing cover 1206, a screw flange 1340 is located on the front housing cover 1204 and positioned laterally of the interior wiring closet 1322. The screw flange 1340 includes a threaded screw hole 1342. When the wiring compartment 1320 is to be closed, the compartment lid 1324 is brought into abutment with the front housing cover 1204, with the screw hole 1330 aligned with the threaded screw hole 1342. The machine screw 1332 can then be used to removeably secure the lid 1324 to the front housing cover 1204.

As shown primarily in FIGS. 94 and 98, the rear housing cover 1206 includes a nipple half opening 1344 located on a lower rim of the housing cover 1206. A corresponding nipple half opening 1352 is formed in the front housing cover 1204. The nipple half opening 1352 is only partially shown in the drawings. When the connector housing 1202 is assembled with the front housing cover 1204 and rear housing cover 1206, the nipple half openings 1344, 1352 mate together so as to form a circular nipple opening 1351 (FIG. 99) of appropriate diameter.

The wiring compartment 1320, as earlier described, is utilized to provide a means to field wire the occupancy sensor 1310 to the electrical components and low voltage power access of the connector module 1200, while still meeting electrical standards and codes, such as UL Code 183. For this purpose, the circuit board assembly 1214 of the connector module 1200 includes a terminal block 1354 as illustrated in several of the drawings, including FIGS. 94 and 96. The terminal block 1354 is mounted so that when the connector housing 1202 is assembled, the terminal block 1354 is accessible within the wiring compartment 1320. However, as clearly shown in FIG. 96, other electrical components and the printed circuitry of the circuit board assembly 1214 are not accessible within the wiring compartment 1320. Accordingly, field wiring can occur between the occupancy sensor 1310 and the terminal block 1354, without violating codes (such as UL 183) which prohibit field access to certain types of electrical components and the printed circuitry which exist on the circuit board assembly 1214. The terminal block 1354 can include a terminal set 1356 of conventional terminal connectors. These terminals of the terminal set 1356 can include, for example, a pair of low voltage power terminals 1358 and a common or ground terminal 1360.

Turning now to the mechanical coupling of the occupancy sensor 1310 to the connector module 1200, relatively simple connections can be made through the use of a connector assembly 1361. The connector assembly 1361 includes an electrical conduit nipple 1364. The electrical conduit nipple 1364 is threaded at opposing ends, and is of a diameter so as to securely be received within the diameter of the opening in the bottom of the connector housing 1202 formed by the nipple half opening 1344 in the rear housing cover 1206 and the nipple half opening 1352 formed in the front housing cover 1204. The connector assembly 1361 further includes a pair of conduit locknuts 1366. The locknuts 1366 include an upper conduit locknut 1368 and a lower conduit locknut 1370.

The occupancy sensor 1310 includes a threaded mounting post 1362. Extending outwardly from the threaded mounting post 1362 are a set of three wires 1372 as shown, for example, in FIG. 96 (although the drawing actually illustrates the wires 1372 after they have been passed through elements of the connector assembly 1361). The wires 1372 can be characterized as low voltage wires functioning so as to be connected to the connector module 1200 for purposes of receiving low voltage power for operation of the occupancy sensor 1310. The low voltage wires may include, for example, a common wire 1374, control wire 1376 and “hot” wire 1378. For purposes of assembly, the low voltage wires 1372 are threaded upwardly through the lower conduit locknut 1370 and electrical conduit nipple 1364. These wires are then further received within the lower opening of the connector module 1200 formed by the nipple half openings 1344, 1352. The upper conduit locknut 1368, as illustrated in FIG. 96, is positioned within the interior wiring closet 1322. This upper conduit locknut 1368 is then threadably received on the upper threaded portion of the electrical conduit nipple 1364. Correspondingly, the lower conduit locknut 1370 is threadably received on the lower threaded portion of the conduit nipple 1364. As illustrated in several of the drawings, including FIG. 96, a connecting flange 1380 is secured to or otherwise integral with the lower portion of the connector housing 1202 and may be formed by the nipple half openings 1344,1352. The electrical conduit nipple 1364 can then be received on the threaded mounting post 1362.

With the upper conduit locknut 1368 securing the electrical conduit nipple 1364 within the interior wiring closet 1322, and the lower conduit locknut 1370 threaded onto the conduit nipple 1364 so as to abut the connecting flange 1380, the occupancy sensor 1310 is mechanically secured to the connector housing 1200. The low voltage wiring 1372 can then be connected, within the interior wiring closet 1322, to the appropriate terminals 1358 of the terminal set 1356. Low voltage power is thereby supplied to the occupancy sensor 1310 through the terminal block 1354. With the appropriate electrical mechanical connections completed, the compartment lid 1324 can be fastened to the front connector housing 1204 through the use of the machine screw 1332. In accordance with the foregoing, which form certain aspects of the invention, the wiring compartment permits the capability of field wiring of electrical devices to the connector modules, while still meeting governmental and institutional codes, including UL Code 183.

In accordance with the foregoing description, the connector module 1200 is used to “directly” connect sensors requiring low voltage power (such as the occupancy detector 1310) to a modular plug assembly 130′. The mechanical connections and features of the modular plug assembly 130′, low voltage power connector module 1200 and occupancy detector 1310 have been described herein with respect to FIGS. 94-99. Additional description regarding electrical and communication features and connections between the connector module 1200 and occupancy detector 1310 are described in subsequent paragraphs herein.

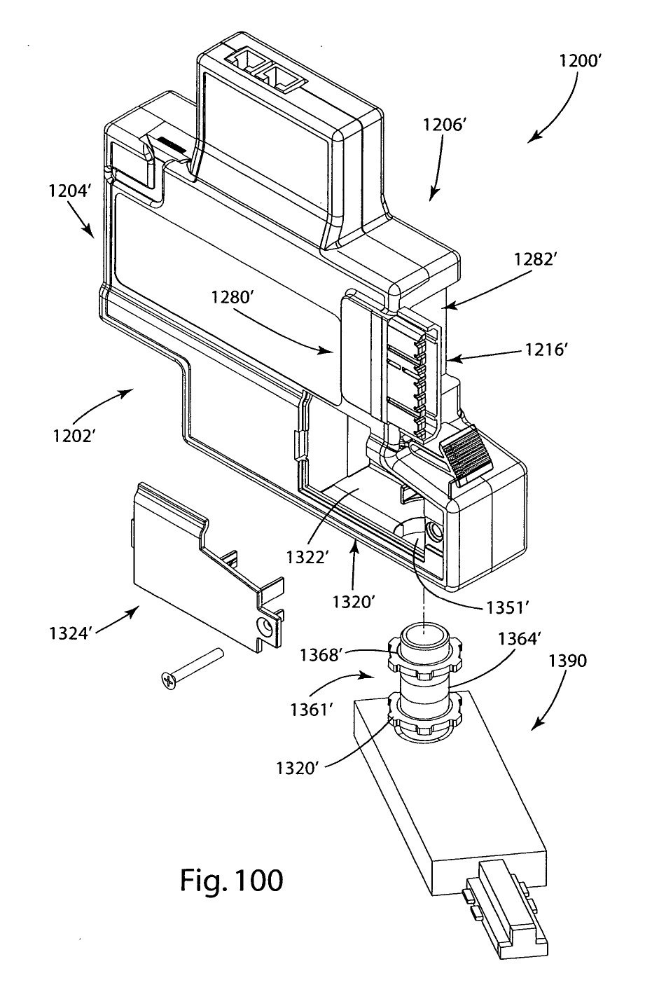

A connector module having certain characteristics similar to the low voltage power connector module 1200 is identified in FIG. 100 as high power dimmer connector module 1200′. Although similar in structural characteristics to the low voltage power connector module 1200, the high power dimmer connector module 1200′ is adapted to mechanically connect to and supply variable power to a lighting track (thus resulting in a “dimming” capability.) For purposes of describing the connector module 1200′, and in view of structures similar to the connector module 1200, the connector module 1200′ will be described with “prime” numerical reference designations, with the prime numerical reference designations corresponding to the numerical reference designations used with functionally and structurally similar elements of the connector module 1200. Also, in view of the similarities between the connector module 1200 and the connector module 1200′, various details associated with the physical structure of the connector module 1200′ will not be described in detail.

With reference specifically to FIG. 100, the connector module 1200′ includes a connector housing 1202′, with the front housing cover 1204′ and rear housing cover 1206′. The connector module 1200′ can include a circuit board assembly (not shown) which can be structurally similar to the board assembly 1214 of the connector module 1200. The connector module 1200′ can also include a module connector plug 1216′, formed in part by a front terminal housing cover 1280′ and rear terminal housing cover 1282′. The module connector plug 1216′ can also include a module connector set (not shown), connecting a terminal set (not shown) and plastic holder (not shown). These components of the connector module 1200′ will correspond in structure and function to the connector set 1218, terminal set 1220 and plastic holder 1234, respectively, of the connector module 1200.

As previously mentioned, the connector module 1200′ is adapted to be mechanically and electrically connected to a device requiring variable power, such as a light track. Although the entirety of the light track is not illustrated in FIG. 100, the lighting track end 1390 is illustrated in FIG. 100. The lighting track end 1390 can be a commercially available device comprising the end of a light track having lighting responsive to the application of variable power so as to selectively modify the light intensity (i.e., provide a “dimmer” function). As an example, the light track connected to the light track end 1390 may be one which would typically operate as a 120 VAC device, capable of receiving up to 1000 watts of variable power. As will be explained in greater detail in subsequent paragraphs herein, the light track end 1390 may be mechanically directly connected to the connector module 1200′, and also directly wired to electrical components of the connector module 1200′.

Various types of commercially available products may be utilized as light tracks and light track ends 1390 with connector modules in accordance with the invention, such as connector module 1200′. Also, various types of commercially available occupancy detectors may be utilized as occupancy detector 1310 with connector module 1200, in accordance with the invention. For example, light tracks (along with the light track ends 1390) are available from Lutron Electronics Company, Inc., of Coopersburg, Pa. Occupancy detectors which may be utilized as occupancy detector 1310 are available from the Leviton Manufacturing Company, Inc., of Little Neck, N.Y. Further, however, other light tracks and occupancy detectors which may be utilized in accordance with the convention are commercially available from other sources.

As with the connector module 1200, the connector module 1200′ can include a wiring compartment 1320′. The wiring compartment 1320′ will provide a means for field wiring of the light track end 1390 directly to the connector module 1200′, while still meeting governmental and institutional electrical codes and regulations.

The wiring compartment 1320′ is formed within the front housing cover 1204′ and rear housing cover 1206′. The compartment 1320′ includes an interior wiring closet 1322′ formed as a spatial area within the housing 1202′. A compartment lid 1324′ is provided for selectively opening the compartment 1320′. Formed at the bottom of the interior wiring closet 1322′ is a circular nipple opening 1351′. The wiring compartment 1320′, as with the wiring compartment 1320 of the connector module 1200, provides a means to field wire the application device (in this case, the light track end 1390) to the electrical components and variable power access of the connector module 1200′, while still meeting appropriate electrical standards and codes. For this purpose, the circuit board assembly (not shown) of the connector module 1200′ includes a terminal block (not shown) corresponding to the terminal block 1354 of the connector module 1200 as shown in FIGS. 94 and 96. The terminal block (not shown) is mounted within the wiring closet 1322′ so that when the connector housing 1202′ is assembled, the terminal block (not shown) is accessible within the wiring compartment 1325. However, as with the connector module 1200, all of the electrical components and the printed circuitry of the circuit board assembly (not shown) of the connector module 1200′ are not accessible within the wiring compartment 1320′. Accordingly, field wiring can occur between the light track end 1390 and the terminal block (not shown) of the connector module 1200′, without violating codes which prohibit field access to certain types of electrical components and the printed circuitry which exists on the circuit board assembly (not shown) of the connector module 1200′. The terminal block (not shown) can include a terminal set (not shown) of conventional terminal connectors. These terminal connectors can include, for example, connections to appropriate electrical lines which provide a “hot” line for providing variable AC voltage, along with lines comprising neutral and ground lines.

Turning now to the mechanical coupling of the light track end 1390 to the connector module 1200′, relatively simple connections could be made through the use of a connector assembly 1361′. With further reference to FIG. 100, the connector assembly 1361′ includes an electrical conduit nipple 1354′. The electrical conduit nipple 1364′ is properly threaded at opposing ends, and securely received within the nipple opening 1351′ formed in the bottom of the wiring closet 1322′.

The connector assembly 1361 further includes a pair of nipple locknuts, identified in FIG. 100 as upper nipple locknut 1368′ and lower nipple locknut 1370′. These locknuts are threadably received on the electrical conduit nipple 1364′. The connector assembly 1361′ also includes an upper connector module locknut and a lower light track end conduit locknut. The lower conduit locknut can be utilized so as to attach the light track end 1390 to the lower end of the electrical conduit nipple 1364′. With the lower end of the electrical conduit nipple 1364′ secured to the light track end 1390, electrical wires (not shown) can be fed upwardly through the electrical conduit nipple 1364′ and into the wiring closet 1322′ through the nipple opening 1351′. The upper connector module locknut 1369′ can then be positioned within the interior of the wiring closet 1322′, and the upper portion of the electrical conduit nipple 1364′ can be extended into the nipple opening 1351′. The upper nipple locknut 1368′ and the upper connector module locknut 1369′ can then be appropriately and threadably moved along the electrical conduit nipple 1364′ so as to secure the light track end 1390 to the connector module 1200′ through the connector assembly 1361′.

With the connector assembly 1361′ secured to the smart connector 1200′ and the light track end 1390, the wiring from the light track end 1390 can be appropriately connected to the terminals of the connector block (not shown) within the wiring closet 1322′. As earlier stated, it can be expected that the wires would comprise hot, neutral and ground wires, with the connector module 1200′ providing variable wattage to the wires in the light track end 1390 when the wires are appropriately connected to the terminal block (not shown).

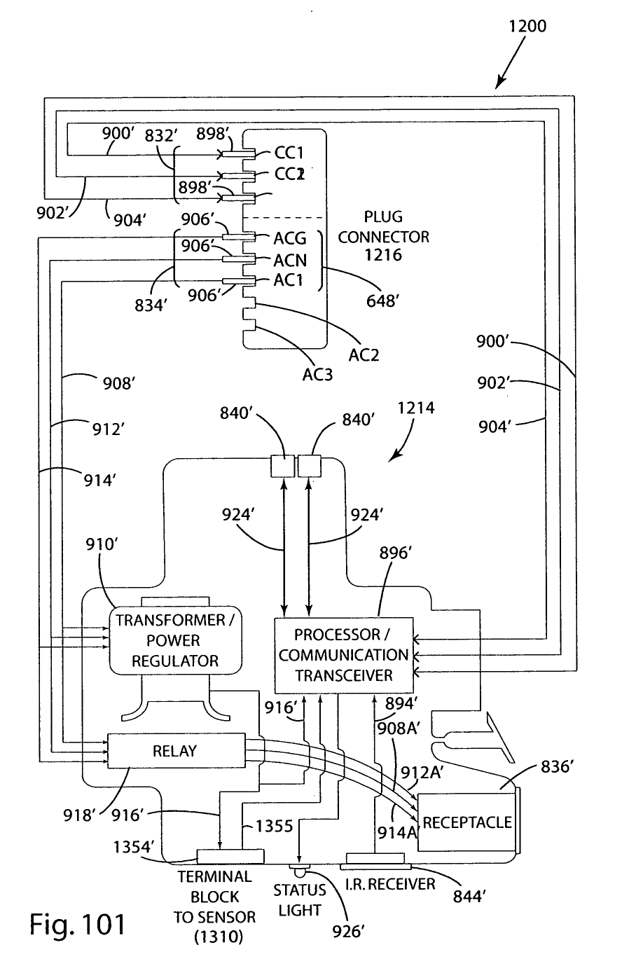

The internal circuitry of the connector module 1200 is illustrated in part in FIG. 23, as being mounted on the board assembly 1214. The internal circuitry of the connector module 1200′ will be substantially similar to that of connector module 1200. Correspondingly, the internal circuitry of the connector module 1200 is substantially similar to the internal circuitry of the receptacle connector module 144, previously described herein and set forth in detail in the illustration of FIG. 44A. This internal circuitry of the connector module 1200 will be described with respect to the diagram of FIG. 101. Because of the similarity between the circuitry in FIG. 101 and the circuitry of receptacle connector module 144 shown in FIG. 44A, the elements referenced in FIG. 101 will have the same numerical identification as similar elements in FIG. 44A, but with a “prime” number reference.

With specific reference to FIG. 101, the board assembly 1214 of the connector module 1200 includes an IR receiver 844′, adapted to receive spatial IR signals from a manually operable and hand-held device, such as the wand 892 illustrated in FIG. 44A. The wand 892 is operated by a user, and was previously described herein with respect to FIGS. 59, 60 and 61. Incoming spatial IR signals are received by the IR receiver 844′, and converted to electrical signals which can be applied as output signals on line 894′. The output signals on line 894′ (which is a symbolic line and may comprise a plurality of wires or cables) are applied as input signals to the processor/communication receiver 896′.

In addition to the signals received by the processor 896′ from the IR receiver 844′ through line 894′, the processor 896′ also receives communication signals from communication cables CC1, CC2 and CCR running through sections of the corresponding modular plug assembly. These signals are “tapped off” the plug connector 1216 (symbolically shown in FIG. 101) of one of the modular plugs 576′ spaced along a section 540′ of a modular plug assembly 130′. Specifically, signals from the communication cables CC1, CC2 and CCR are received through the communications cable terminal set of the plug connector 1216. The terminals of the communications cable terminal set are electrically coupled to a communications female terminal set of the connector module 1200. This connection is illustrated in FIG. 101 through what is shown as “symbolic” contacts 898′. Although shown as symbolic contacts, they represent an electrical interconnection of the modular plug and associated plug connector 1216.

As further shown in FIG. 101, communication signals from the cables CC1 and CC2 are applied through symbolic contacts 898′ and lines 900′ and 902′ as input signals to the processor 896′. Correspondingly, the return communication cable CCR is also connected through a symbolic contact 898′ and its signal is applied to the processor 896′ on line 904′.

Turning to the AC portion of the board assembly 1214, AC power is received through the AC power terminal set 648′ mounted on the plug connector 1216 and connected to the AC power cables. The AC power terminal set 648′ is electrically interconnected to the AC power female terminal set 834′ associated with the connector module 1200. This interconnection is illustrated through the use of “symbolic” contacts 906′. The symbolic contacts 906′ are illustrated so as to correspond to electrical interconnection to AC power cables AC1, ACN and ACG. AC1 corresponds to a “hot” cable. Although power is being supplied through cable AC1, the connector module 1200 can be rewired so that power could be received through cables AC2 or AC3.

As further illustrated in FIG. 101, the AC hot cable AC1 is electrically connected through one of the contacts 906′ and applied through line 908′ as an input to a conventional and commercially available transformer 910′. Correspondingly, neutral cable ACN is also electrically connected through line 912′ to transformer 910′. Further, ground power cable ACG may be electrically connected to a further one of the symbolic contacts 906′, and applied to the transformer 910′. The transformer 910′ can be any of a number of conventional and commercially available transformers, which provide for receiving AC input power on lines 908′, 912′ and 914′, and converting the AC power to an appropriate DC power level for operation of the occupancy sensor 1310. More specifically, the transformer 910′ applies the low voltage DC power required for the sensor 1310 to the terminal block 1354 through symbolic line 916′. It should also be noted that line 916′ is also utilized to apply a DC power level to the processor 896′, for purposes of functional operation of the processor 896′ and other components of the board assembly 1214. One type of commercially available transformer which may be utilized is manufactured and sold by Renco Electronics, Inc. of Rockledge, Fla.

In addition to the connection of the transformer 910′, the AC power signals may be also be applied as input signals to a receptacle relay 918′, as further illustrated in FIG. 101. The receptacle relay 918′, like the transformer 910′, can also be a conventional component. The relay 918′ can include three output lines, namely lines 908A′, 912A′ and 914A′. The relay 918′ can have two states, namely an “on” state and an “off” state, or multiple states. Depending on a particular state, the electrical signals on lines 908′, 912′ and 914′ can be switched through to the receptacle 836′, as desired.

Still further, with the board assembly 1214 and the connector module 1200 being associated with the occupancy sensor 1310, in accordance with prior description herein, sensor state signals can be generated by the occupancy sensor 1310 through cables 1376 and 1378 (see FIG. 96), and applied through line 1355 from the terminal block 1354 to the processor 896′. Accordingly, these state signals from the occupancy sensor 1310 can operate as control signals or “state indication” signals which can be operated on by the processor 896′, or passed through, in accordance with programming thereof. Such programming, for example, could cause the overall network to enable banks of light within the interior environment, in the event that the sensor 1310 senses motion within the interior environment. That is, with signals from the sensor 1310 being transmitted through the cables 1376, 1378 to the terminal block 1354, and the terminal block 1354 passing such signals through to lines 1365 which apply to signals to the processor 896′, the overall system can be programmed so as to digitally control the application of electrical signals to various types of application devices connected to the network, depended upon the states of the signals generated by the sensor 1310.

FIG. 101 describes the board assembly associated with a connector module adapted to directly connect to an occupancy sensor 1310. Similar circuitry would be associated with the board assemblies incorporated within connector modules, such as the connector module 1200′ illustrated in FIG. 100. Still further, such “directly connected” connector modules may be utilized not only with occupancy sensors, light banks or the like, but various other types of controlling and controlled devices, such as internet cameras and the like. It should also be emphasized that signals being received from sensors such as the occupancy sensor 1310, may consist not only of an on or off state, but may also represent multiple states, or a substantially continuous signal. For example, if the sensor is one which is to control the dimming function association with a variable intensity light track, the signals being received from the sensor would essentially represent a “continuum” (although the signals may be in digital format) representative of a particular intensity desired by the user from the lights associated with the light track. Therefore, and in accordance with the invention, the state signals being received from the sensor may consist of more than two states, and may actually represent a “continuum” of states, such as would be desirable when controlling a variable intensity light tract.

The principles of the invention will now be described by way of example, with respect to remote duplex receptacle systems 1600 and 1600′ as illustrated in FIGS. 102-111. As background, in most interior environments, the principal means of providing power to electrical devices is through a standard 120 volt duplex receptacle. Such conventional receptacles are usually either wall or floor mounted, with power continuously accessible at the plug. On occasion, the occupant may desire the power to the duplex receptacle to be controlled by a wall switch, which can enable or disable the receptacle. Most often, the switches are hard wired by an electrician to the desired duplex receptacles. Once initially wired, adding new receptacles to the switch control can be difficult. For example, if there is a duplex receptacle controlled by a switch, and another always powered, and the occupant wishes to have both duplex receptacles controlled by the switch, there could be considerable cost and disruption as an electrician seeks to access the wires powering the conventional duplex and connect the same to the wiring for the switch.

In addition, in larger interior environments (e.g. large office space, retail sites, etc.), there may be several switches hard wired to several conventional duplex receptacles, sometimes even in combination. In such instances, outside of trial and error, there is not any readily apparent way in which one would know which conventional duplex receptacles are wired to which switches.

In accordance with the invention as described in subsequent paragraphs herein with respect to the duplex receptacle systems 1600 and 1600′, remote duplex receptacles can be developed which are similar in construction to conventional duplex receptacles, except that the duplex receptacle systems in accordance with the invention can include an IR, LED lens on the externally facing side of the duplex receptacle, with signaling circuitry in turn connected to an RJ11 low voltage patch cable. In this regard, an electrician could wire the remote duplex receptacle system to the wall or a floor structure in a means similar to that of a conventional duplex receptacle, in accordance with the National Electric Code. The electrical wiring can be routed using standard flexible conduit through the building structure to an area near a connector module and an interconnected modular plug assembly. The flexible conduit can be wired into ajunction box, with a modular plug cord. The modular plug end can then be connected into a connector module, so as to provide power to the remote duplex receptacle, as well as having the RJ11 patch cable connected into the same connector module, for purposes of establishing communication signals between the duplex receptacle system and the connector module.

For an interior environment using a system such as the system described in the designation and protocol application, several advantages exist. Among these advantages are the following:

1. Following initial installation, any remote duplex receptacle on the electrical network by ______ can be “associated” to be controlled by any switch attached to the network. The user or occupant can point the wand at the IR receiver on the desired remote duplex receptacle system and, in turn, at the IR receiver on the desired switch. Of course, in accordance with prior discussion herein, multiple switches and multiple receptacles may be associated with each other in various combinations. Because the remote duplex receptacle system is connected by means of the RJ11 patch cable to the connector module, the association is created by the communications system programmed in accordance with the designation protocol application resident in the connector module and other portions of the electrical network 530. In this manner, a control relationship is established between the switch and the remote duplex receptacle system. Accordingly, this enables “at will” re-association of switches and any “smart” receptacles (e.g. mounted on walls, ceilings, floor, power poles or the like) connected to the electrical network 530. Accordingly, disruption to the interior environment is minimal, and no skilled trades rewiring costs are incurred.

Still further, the LEDs on the remote duplex receptacles provide signaling means to enable the occupants of the interior environment to easily determine which receptacles are associated with which switches. That is, for example, pointing the wand and initiating an LED signal at any smart receptacle will cause the LEDs on all of the receptacles in the group to “light up.” This means the occupant can readily determine which receptacles are in a group, without resorting to trial and error checking. In addition, when programming the particular receptacles to the associated group, the user only needs to point the wand either at the desired remote duplex receptacle, or the connector module to which it is connected. Because of the connection between the remote duplex receptacle and the connector module by means of the RJ11 patch cord, the association is automatically established.

With this background, FIG. 102 illustrates a remote duplex receptacle system 1600, adapted for use in a power pole or similar device. Correspondingly, remote duplex receptacle 1600′ is substantially identical to the remote duplex receptacle system 1600, but is structured so as to be mounted to a wall, floor or the like. As a brief summary description, the remote duplex receptacle systems 1600 and 1600′ can be characterized as ______ known duplex receptacles. The duplex receptacles 1600 and 1600′ include circuit boards which contain an IR receiver, LED and RJ11 port incorporated into a conventional duplex receptacle box. The receptacle system 1600 is powered from a power ______ connector module, in accordance with the connector module previously described herein. The circuit board in the receptacle system can be connected to the connector module by means of low voltage communication cabling, such as through RJ11 ports and patch cords. An advantage of the remote duplex receptacle system is the allowance of a switched receptacle and the control interface being located at the receptacle, as well as in the connector module. In this manner, the programmer (i.e. the user controlling the wand) does not have to determine which power connector is providing power to the receptacle system, when programming the electrical network 530.

Referring back again to FIGS. 102 and 103, each of the remote duplex receptacle systems 1600 and 1600′ include a junction or outlet box 1602. Mounted to the top portion of the junction box 1602 is a 4-wire connector (or relay) 1604. This is a conventional universal connector. The junction box 1602 is enclosed by a box cap 1606. Extending downwardly from the junction box 1602 is steel or flexible conduit 1608. The conduit 1608 carries 120 volt AC or a similar power from the junction box 1602 to the duplex receptacle assembly 1612. The conduit 1608 is mounted to the receptacle assembly 1612 through a clamp 1610. The duplex receptacle assembly 1612 includes a pair of receptacle 1616, conventional in nature. A patch cord 1614 with an RJ11 pigtail extends outwardly from the duplex receptacle assembly. For the duplex receptacle system 1600, which is adaptively mounted to a power pole, the system 1600 includes a power pole face plate 1618. For the duplex receptacle system 1600′, a conventional wall face plate 1620 is utilized.

As earlier stated, the duplex receptacle assemblies 1612 can include an IR receiver, such as the IR receivers 1624 illustrated in FIGS. 102 and 103. Also, although not specifically shows on the drawings, a circuit board similar to the circuit boards previously described herein with respect to various switches and connector modules can be utilized within the duplex receptacle assemblies 1612. The circuit board can be connected to an associated connector module with the low voltage communication cabling provided by the patch cord and pigtail 1614. The patch cord and pigtail 1614 will be connected to an additional patch cord or otherwise directly connected into an RJ11 port associated with the connector module to which the duplex receptacle system is connected.

The 4-wire connector 1604 or universal connector can be connected into a connector associated with one of the power connector modules, such as the power drop connector module 140 previously described herein. The connector 1604 can be connected to the connector 958 associated with the connector module 140, which, in turn, is connected to a flexible conduit 952 to the connector module 140. In this manner, AC power can be selectively transmitted to the remote duplex receptacle system 1600 from the electrical network 530 through the connector module 140. Correspondingly, the user can program the remote duplex receptacle system 1600 or 1600′ through transmission of signals from a wand to the IR receivers 1624.

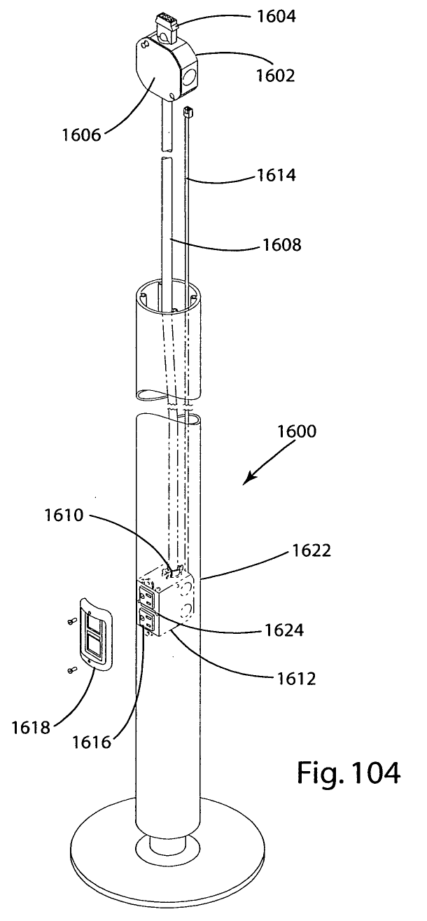

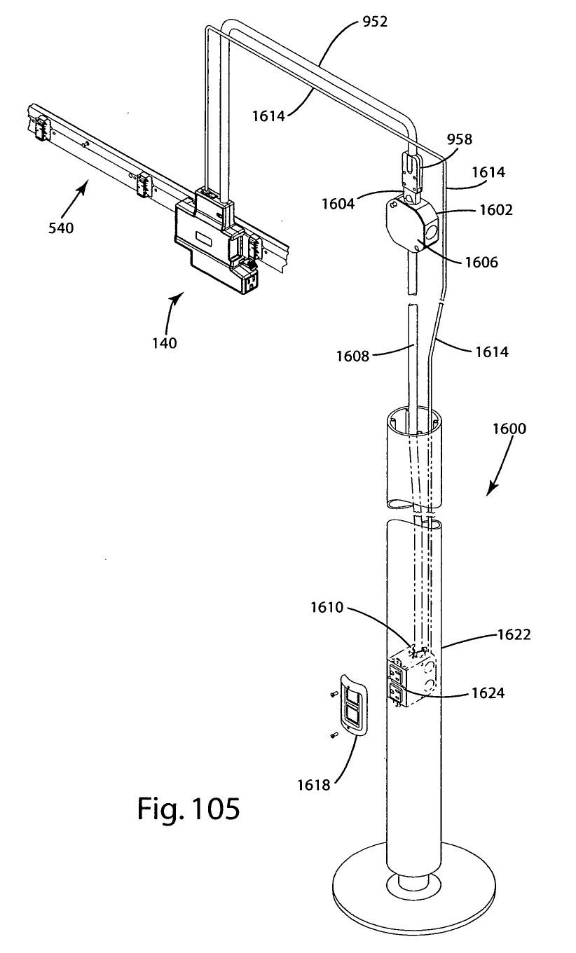

FIG. 104 illustrates the use of remote duplex receptacle 1600 with a power pole 1622. The power pole 1622 can substantially correspond to the power pole 962 previously described herein. As shown in FIG. 104, the power pole face plate 1618 can be utilized with the receptacle system 1600.

FIG. 105 illustrates the remote duplex receptacle system 1600 and power pole 1622, but further shows the interconnection of the duplex receptacle system 1600 with a connector module 140 electrically and mechanically connected to a modular plug assembly selection 540. It is in this manner that the remote duplex receptacle system 1600 is electrically connected into the electrical network 530.

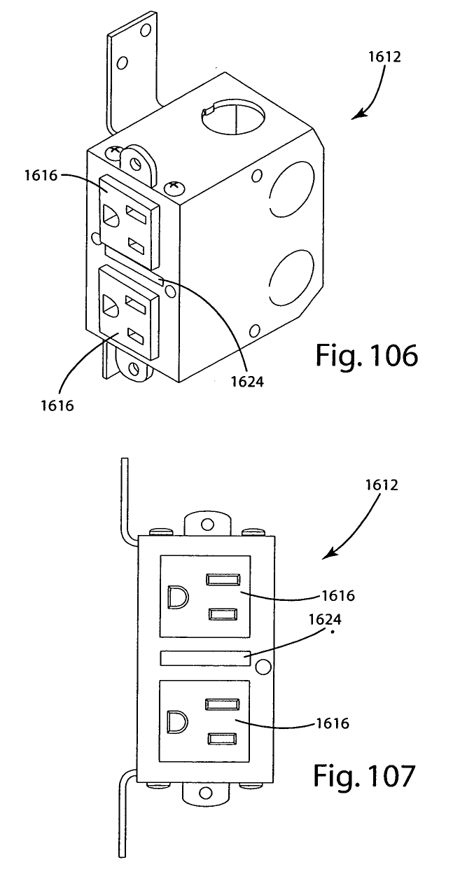

FIG. 106 illustrates a perspective view of the duplex receptacle assembly 1612, showing the conventional nature of the receptacle assembly. However, as previously described herein, the duplex receptacle assembly 1612 includes an IR receiver 1624, circuit board, LED and RJ11 port. FIG. 107 merely shows a front, elevation view of the receptacle assembly 1612.

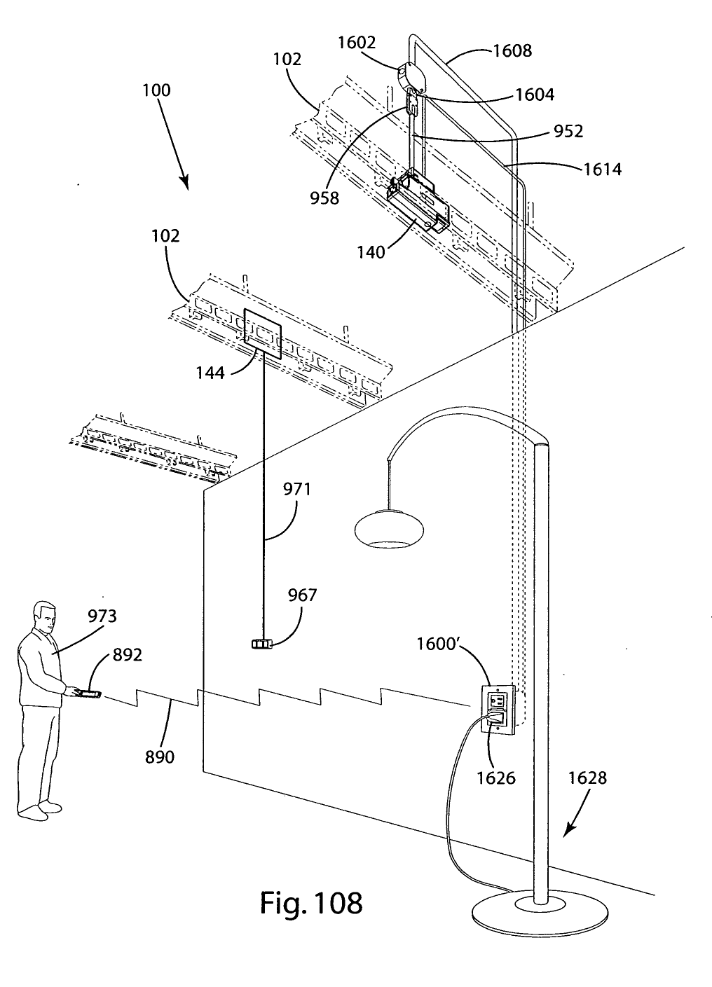

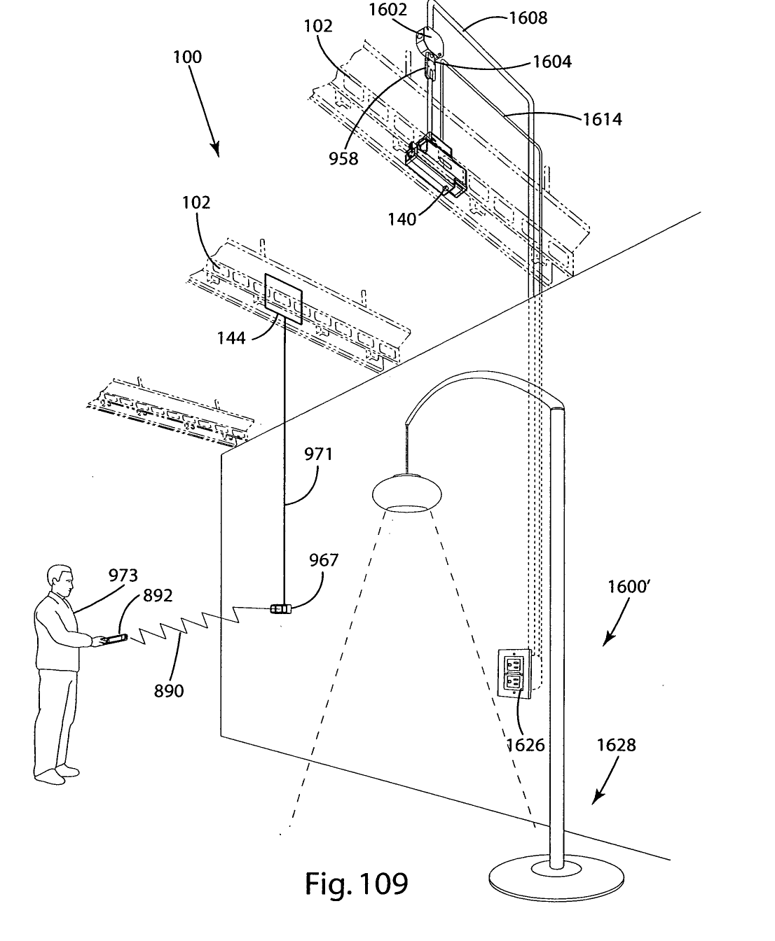

FIG. 108 illustrates a user 973 using the wand 892 to transmit IR signals 890 to a remote duplex receptacle system 1600′. As apparent from FIG. 108, a lamp 1628 is plugged into one of the receptacles 1616 of the receptacle system 1600′, through a plug 1626. With the activity in FIG. 108, the user 973 can “designate” the duplex receptacle system 1600′ as being part of the electrical network 530. In FIG. 109, the user 973 is shown transmitting IR signals 890 to a switch 967 (previously described herein). The switch 967 is connected through a patch cord 971 to a connector module, such as the previously described connector module 144. With this programming, the user 973 can essentially “designate” the switch 967 and establish the same as being part of the electrical network 530, as well as establish the control relationship between the switch 967 and the receptacle system 1600′. Accordingly, operation of the switch 967 will cause power to be selectively applied to the receptacle 1616 of the receptacle system 1600′.

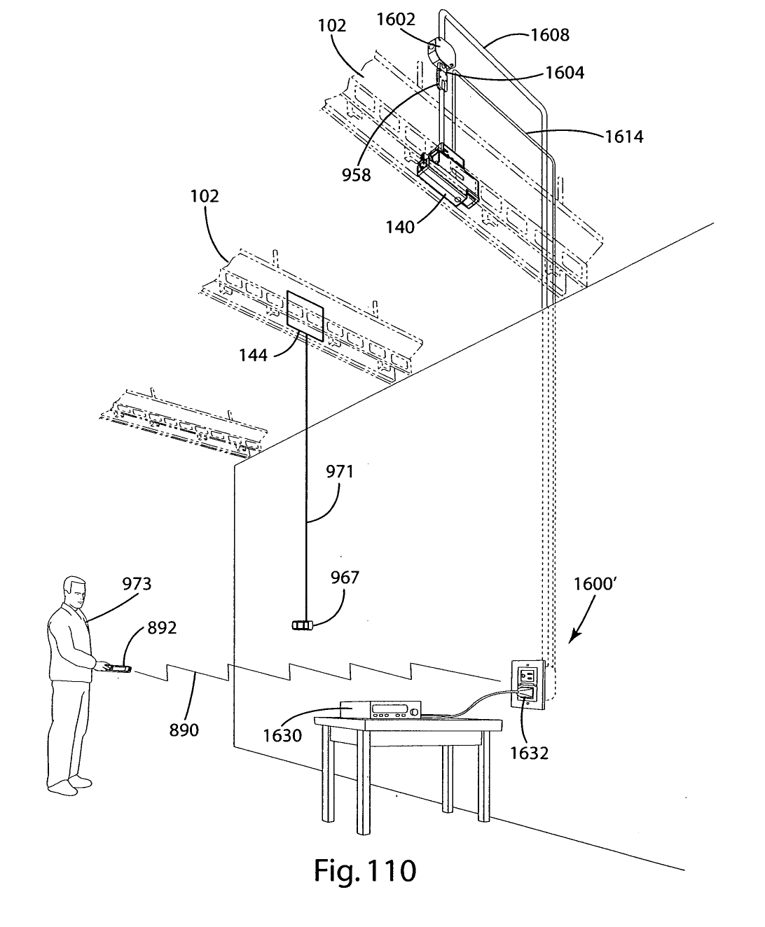

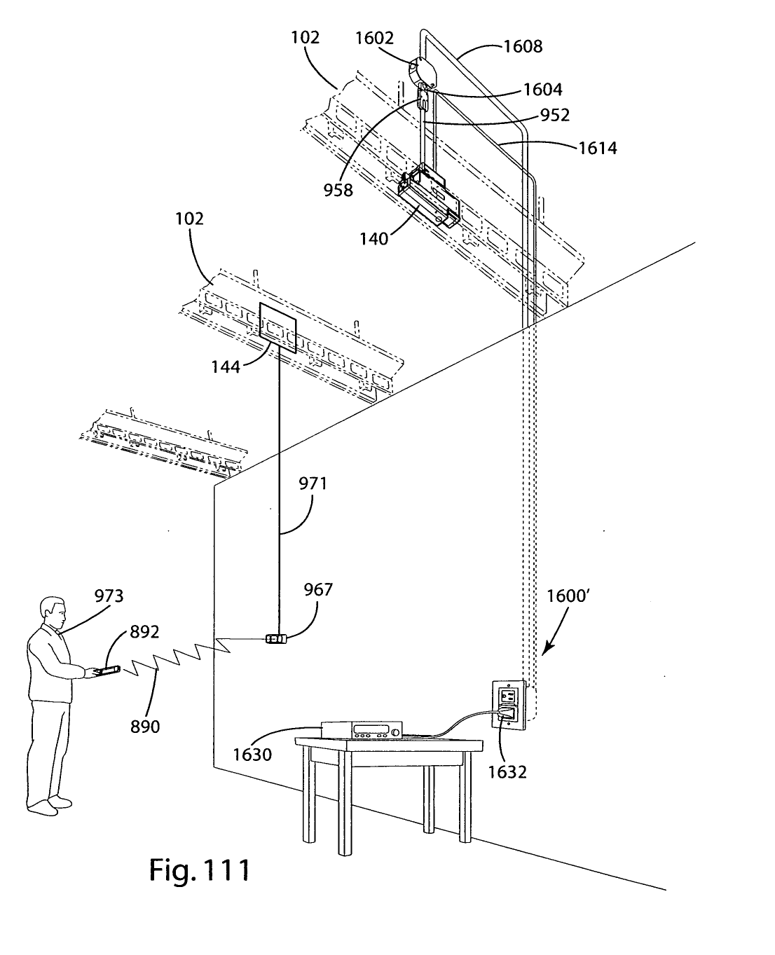

FIG. 110 illustrates programming of a receptacle system 1600′ in the same manner as shown in FIG. 108, but shows a receptacle 1616 as receiving a plug 1632 which is attached to a stereo 1630 or other type of appliance. FIG. 111 is similar to FIG. 109 in that it shows the user 973 programming the switch 967, for purposes of establishing a control relationship between the switch 967 and the receptacle system 1600′.

It would be apparent to those skilled in the ______ art that other embodiments of receptacle systems in accordance with the invention may be designed. That is, the principles of a receptacle system are not limited to the specific embodiments described herein. Accordingly, it would be apparent to those skilled in the art those modifications and other variations of the above-described ______ of the embodiments of the invention may be effected without departing from the spirit and scope of the novel concepts of the invention.

1. In a distributed network for use within an interior environment for ______ selectively engaged in the plurality of controlled application devices, the distributive network comprising:
power distribution means electrically connected to a source of electrical power, for distributing the electrical power throughout the network, the power distribution means comprising a plurality of connector modules electrically connectable to the source of electrical power through the power distribution means, and locatable at desired positions on the network;
communication distributions means for distributing communication signals on the network;
a first switch, having at least first and second states, and electrically connected to a first want of the connector modules;
designation means for a user to designate the first switch and a remote receptacle system, said remote receptacle system being electrically connected to said first one of said connector modules or to a second one of said connector modules;
implementing means for executing a control relationship between said first switch and said remote receptacle system, in response to said designation by said user; and
said remote receptacle system including a receiver for receiving spatial signals from said user, so as to effect a control relationship between said first switch and said remote receptacle system through said distributed network.
